(19) United States
(12) Patent Application Publication
(10) Pub. No.: US 2020/0193085 A1
(43) Pub. Date: Jun. 18, 2020

(54) NON-TRANSITORY COMPUTER-READABLE STORAGE MEDIUM, ELECTRONIC FILE GENERATION METHOD

(71) Applicant: HIROYUKI TANAKA, Tokyo (JP)

(72) Inventor: HIROYUKI TANAKA, Tokyo (JP)

(21) Appl. No.: 16/735,724

(22) Filed: Jan. 7, 2020

Related U.S. Application Data
(63) Continuation-in-part of application No. 15/669,937, filed on Aug. 6, 2017, now abandoned.

(51) Int. Cl. G06F 40/134; G06F 40/106; G06F 40/166

(52) U.S. Cl. CPC G06F 40/134; G06F 40/166; G06F 40/106

(57) ABSTRACT

This invention relates to efficient and automatic generation of jump setting regions which consist of hyperlinks and anchor (hereinafter referred to as “verbatim”) that makes cross-reference jumps among hyperlinks group.

[SOLUTION] An electronic file generation method of the present application comprises:
first, arranging verbatim setting regions in an electronic file. Then, applying the configuration that lower level segments of the respective names are the same. Next, sequentially generating electronic files which are changed to complete a one-round through only higher-level segments of the names. The lower level segments are automatically copied during the process of the above one-round. Finally, the electronic files are combined into one file or jumps to each other with another file that is not finally combined.
1. There are cases where an electronic file jumps to another file without final combining. In this case, even if there are many anchors and hyperlinks in the electronic file, these are not changed at all. Only a different html file has been created. In other words, replacing only file names that appear outside the file is efficient because of the small number of operations.
2. There are cases where hyperlinks jump in a final combined file. In this case, until then the hyperlinks do not jump to an anchor. At the start, the name of the hyperlink or the anchor is split into two parts. Then, the higher segment is replaced and connected to the lower segment.
3. The present application realizes the generation of hyperlinks corresponding to the number of diagonal lines obtained by the formula N(N−1). It is similar to the formula for finding the diagonal number. Thus, the range of applications that can be filed as business models is wide.
4. The present application also performs the above-described solution through automatic generation of hyperlinks and anchors. For this reason, the present invention means that jumping consisting of hyperlinks and anchors can be supplied as infinite industrial products.

### CIP

This application is a continuation in part application of the U.S. application Ser. No. 15/669,937.

### CROSS-REFERENCE OF RELATED APPLICATION

This is a continuation in part application of the U.S. application Ser. No. 15/669,937, filed on Aug. 6, 2016, at this moment is hereby incorporated herein by reference entirety. In that case, the description is omitted in this item.

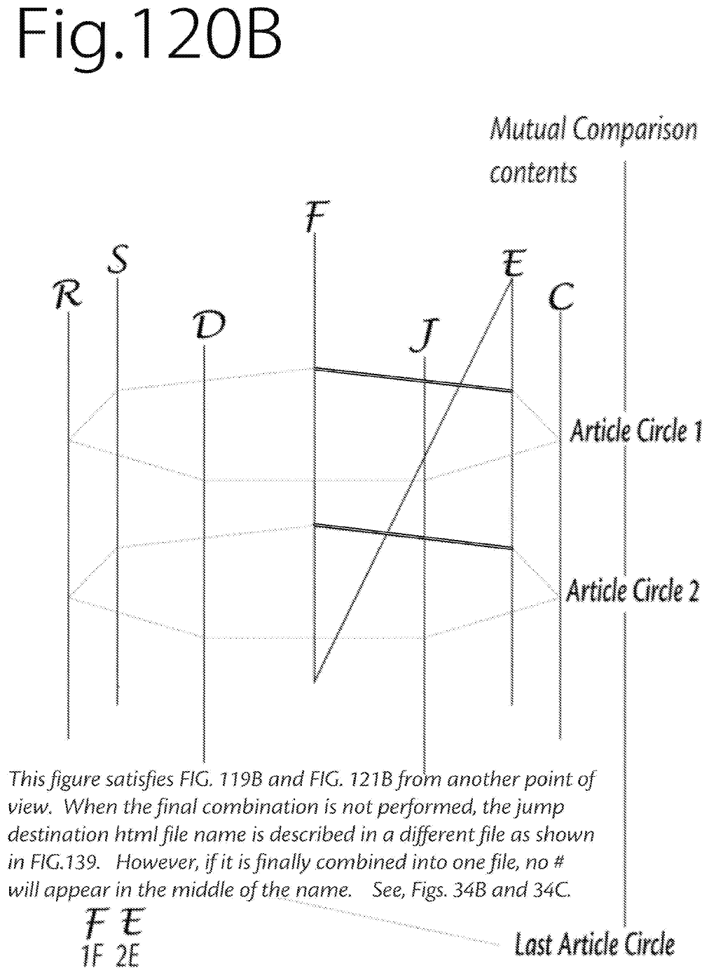

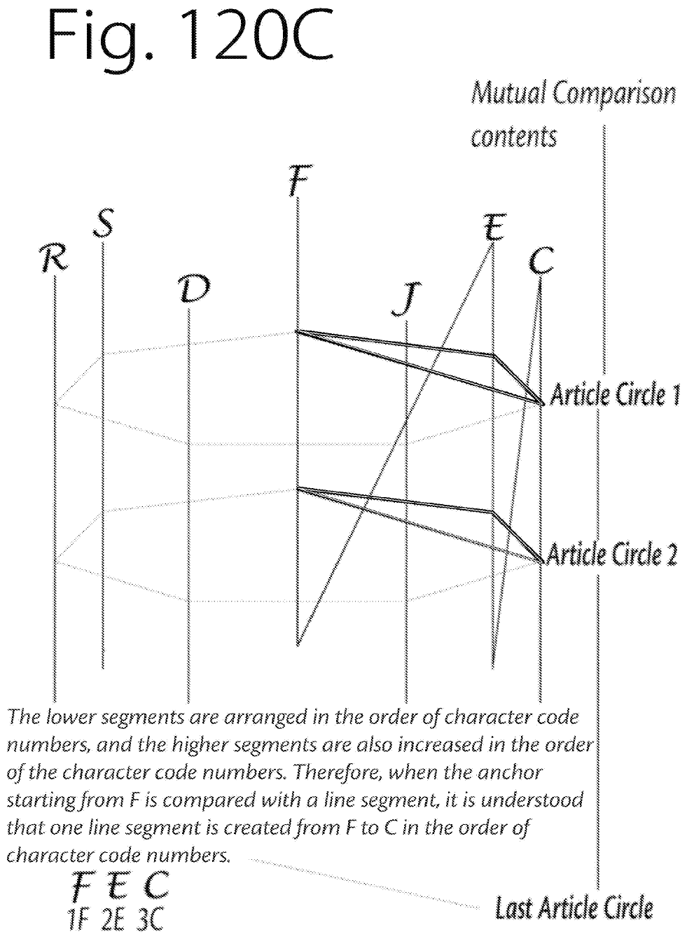

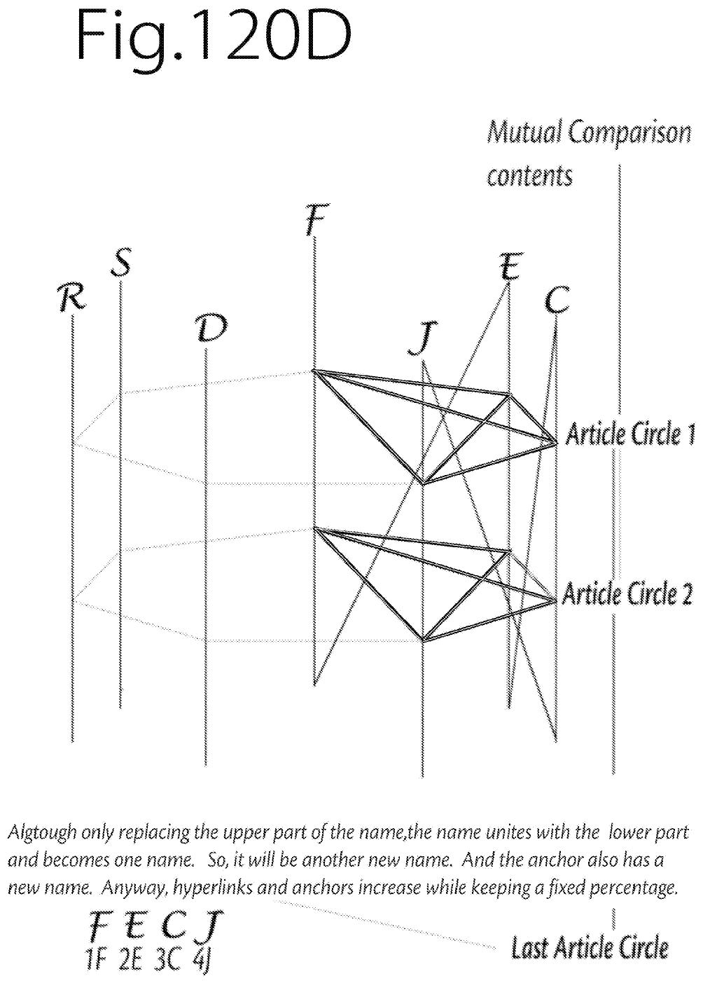

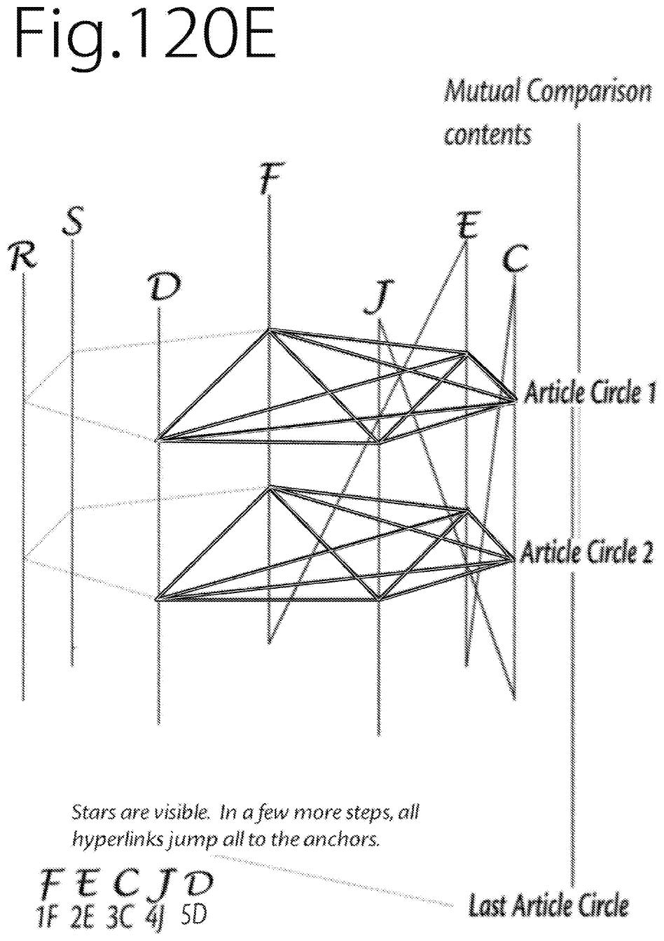

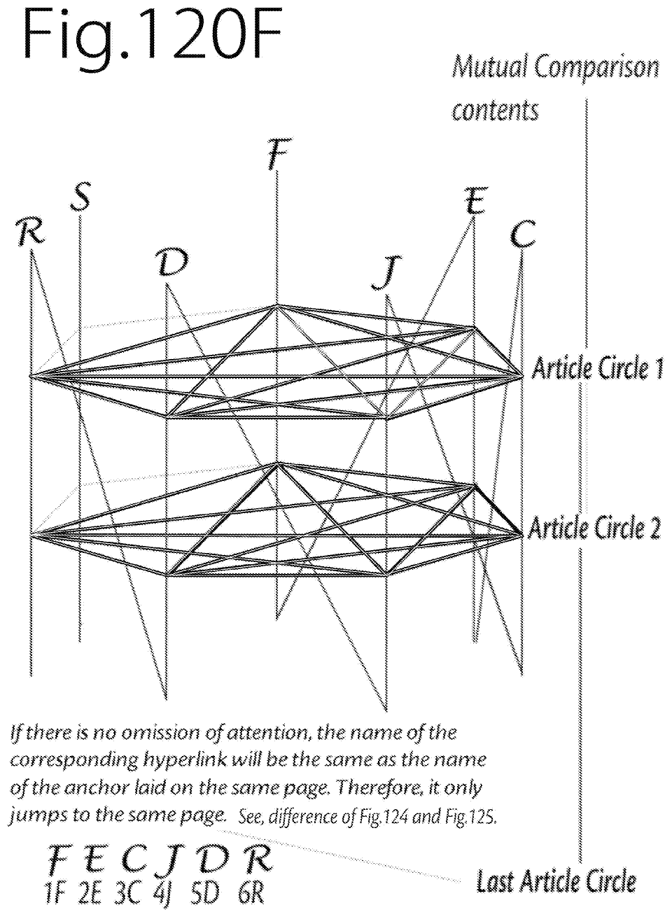

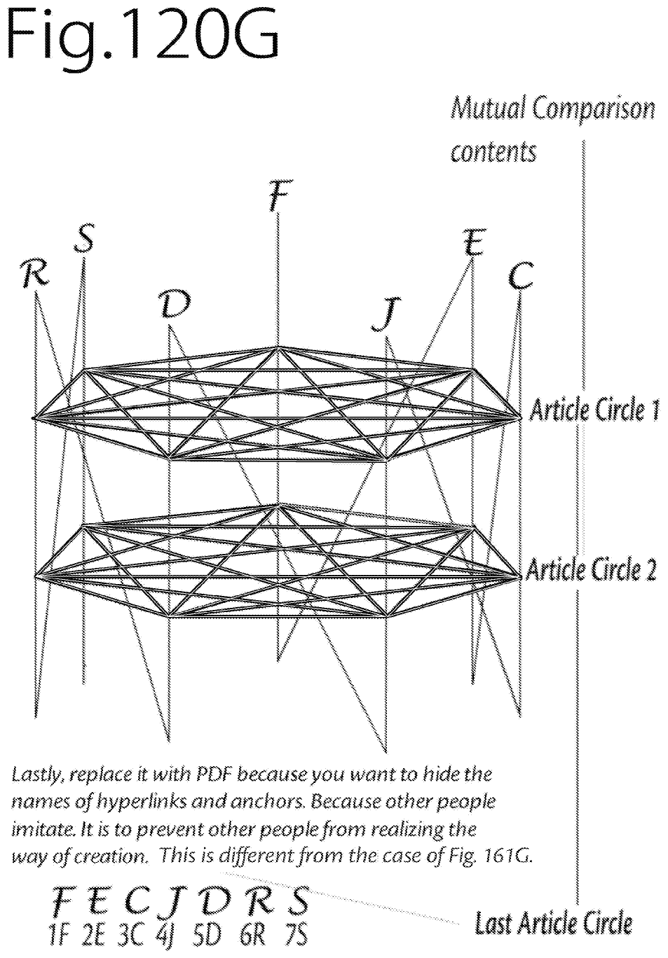

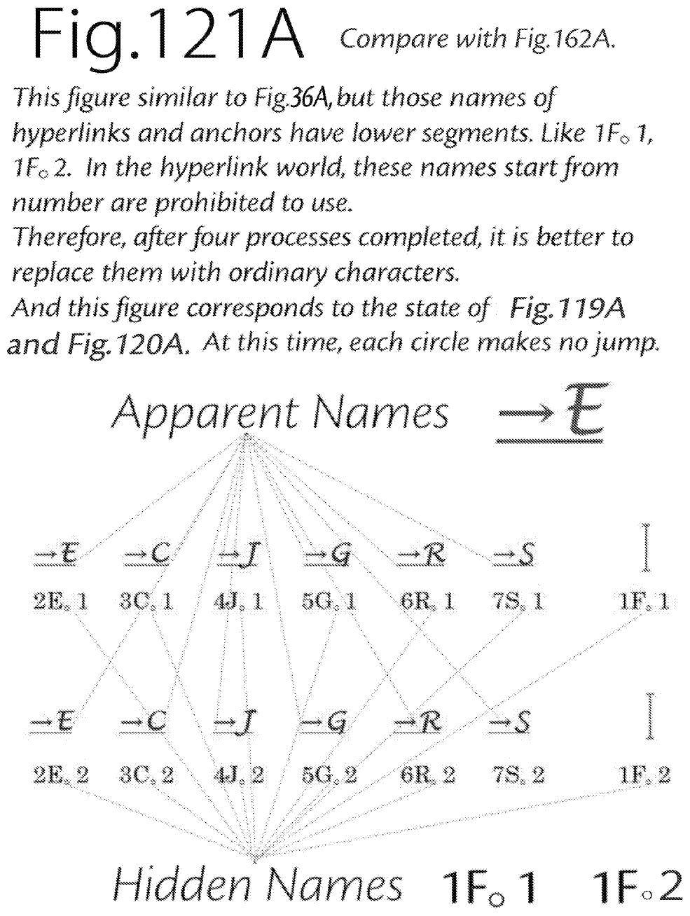

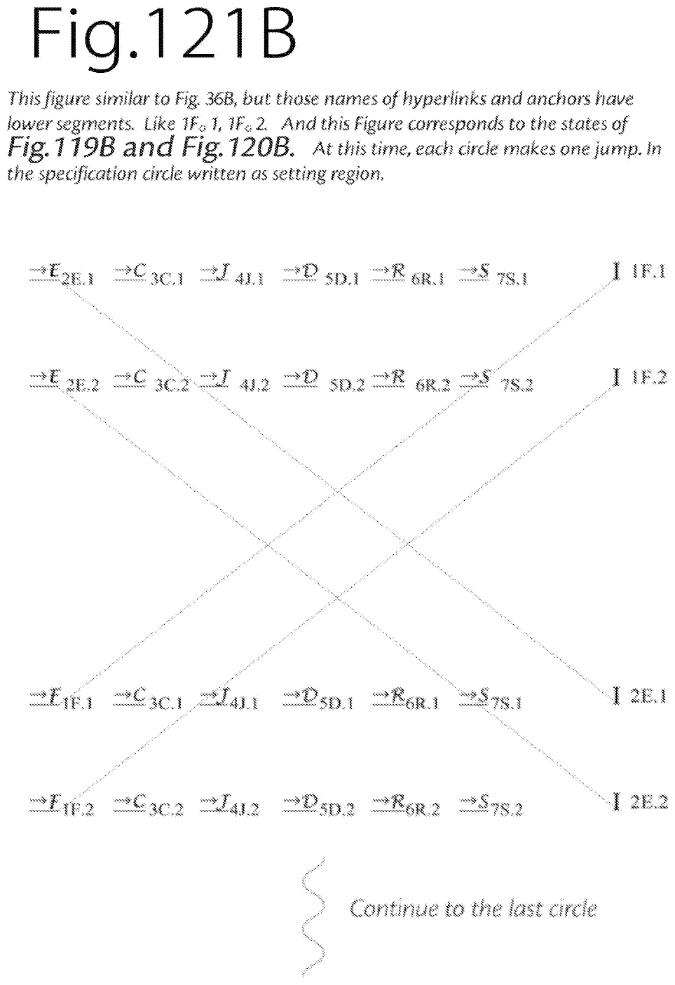

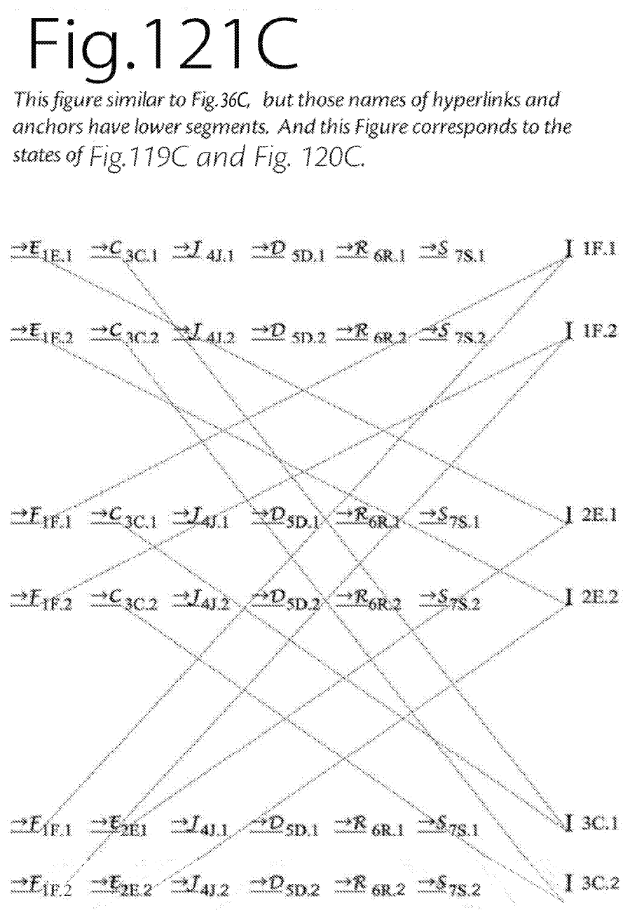

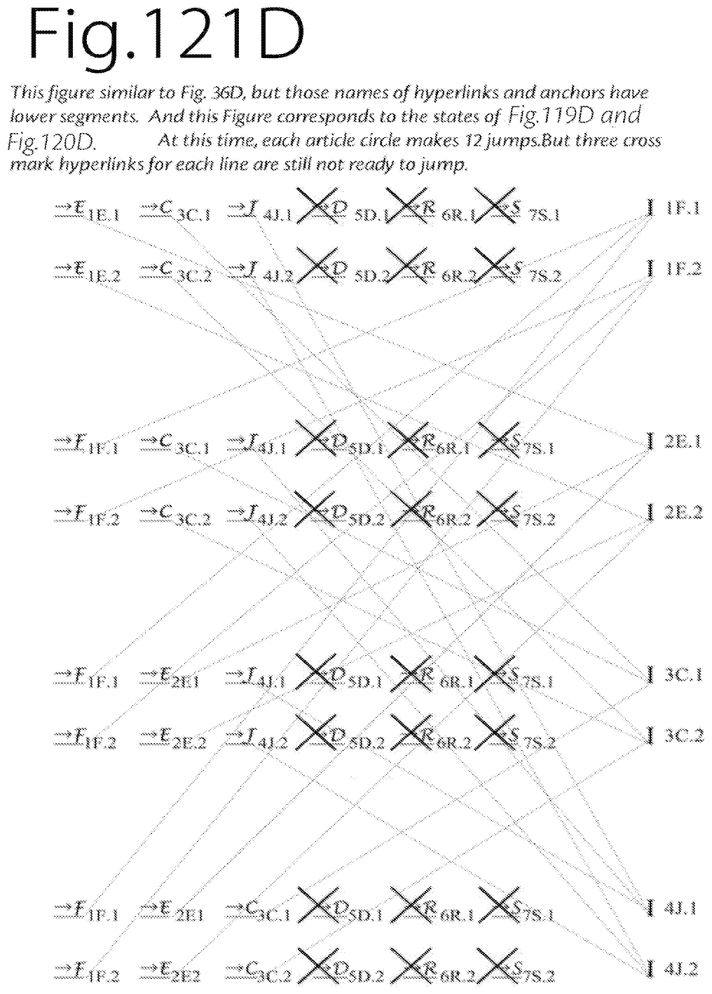

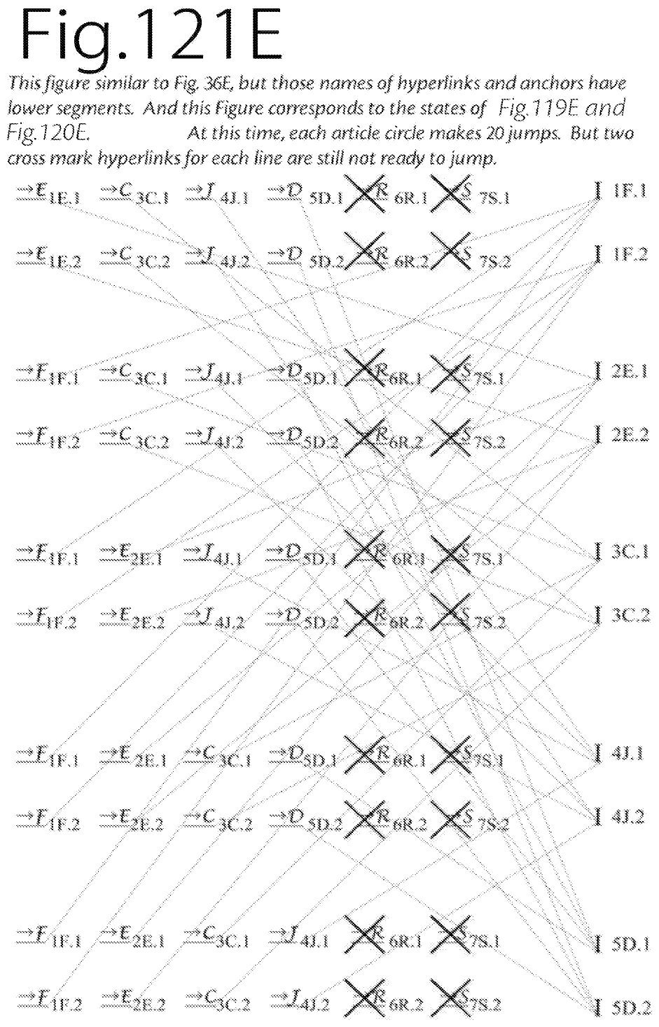

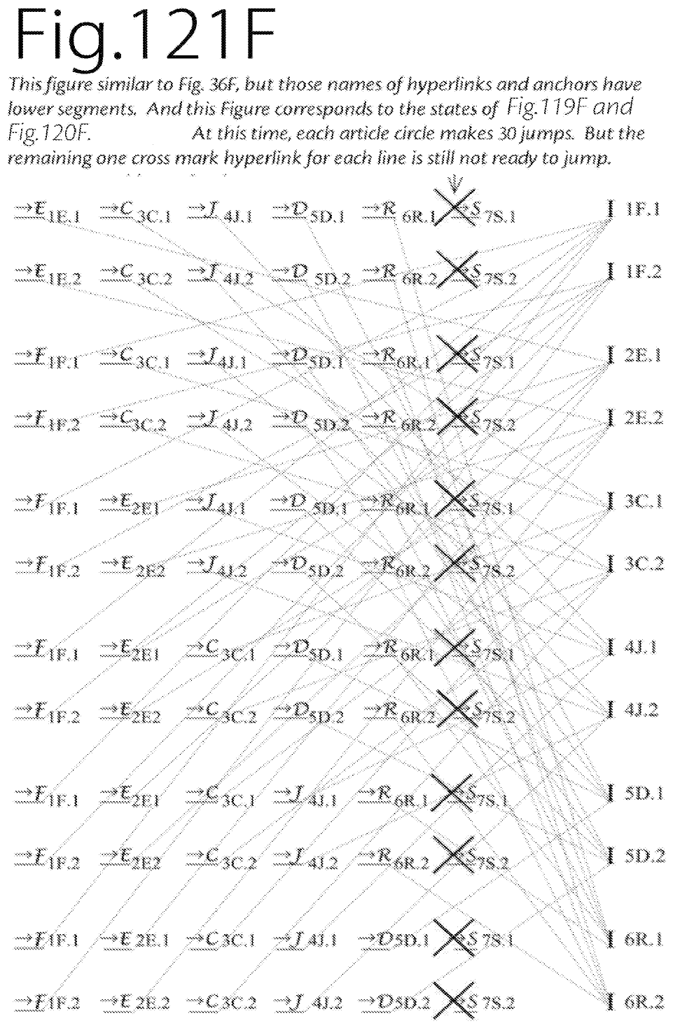

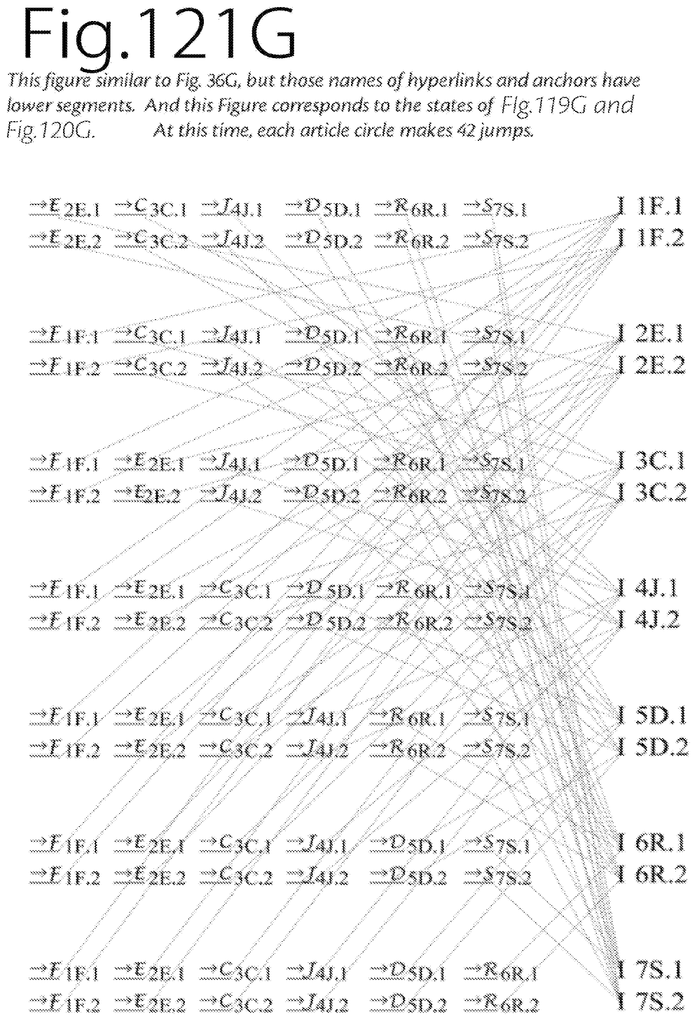

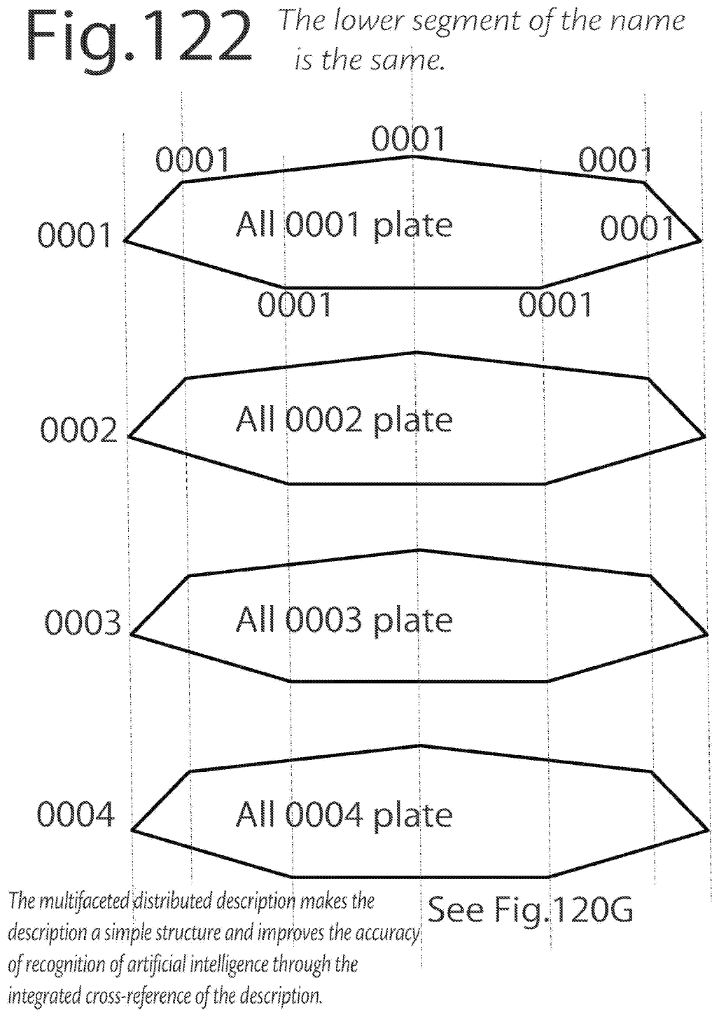

This specification and this drawings have been written mainly considering the final combination. It means, electronic files will be finally combined into one. For this reason, as the specification, it is written mainly on the internal links. However, some of the claims do not have a final conbine, and in that case, each time an electronic file is created in the third process, a jump occur between the different ones. It should be understood that the attached FIGS. 120A to 122G drawings are also used to explain such a case. In other words, when jumping to another file, the name of the corresponding html of another file is written, and when jumping to a specific part, # is added. Applicant does not make this correction. Therefore, when jumping to an external link, it is necessary to replace this description.

Differences from the Parent Application

The part described in italic typeface is same to the specification written in the previous parent application. The parts written in normal typefaces other than italic typefaces are different from the parent application.

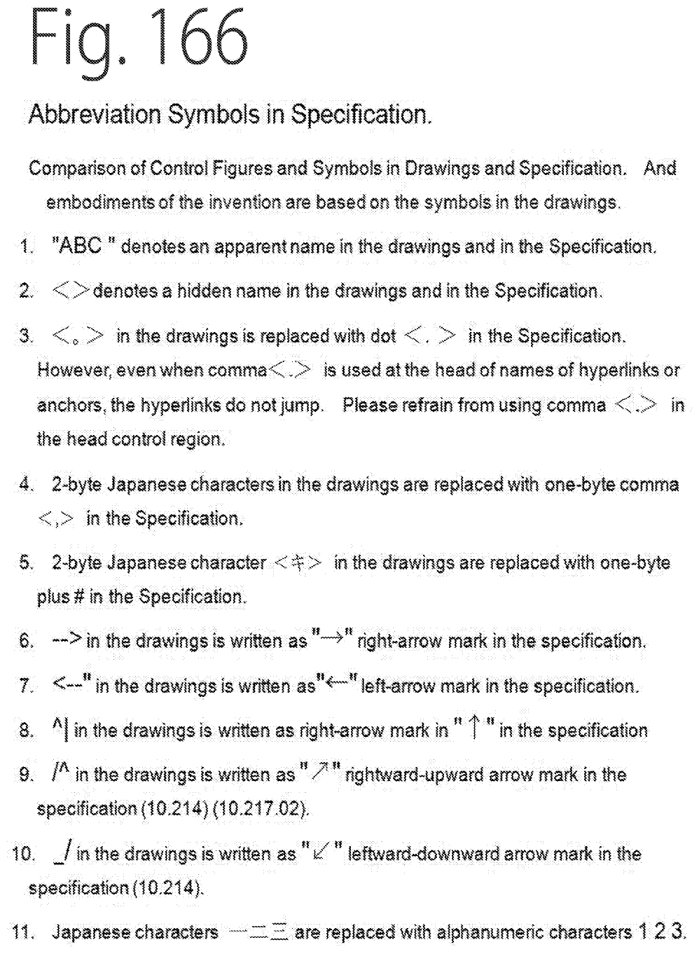

About Abbreviation.
1. If there is no special description in the drawing, it will be the same drawing number of the parent application of CIP.
2. Please refer to FIG. 166 of this application for the meaning of the symbols.
4. The last page of this application contains a description of the reference numbers.

### BACKGROUND OF THE INVENTION

### 1. Technical Field

The present invention relates to a non-transitory computer-readable storage medium, an electronic file generation method.

### 2. Description of the Related Art

(Role of Hyperlink)

A hyperlink is well known. When a viewer selects the text or image in the designed range, the display screen jumps to a location of the content that should be compared and associated. A hyperlink that enables an instant jumping on the display screen to a location with detailed information or supplemental information about the content and thus helps to increase understanding of the content.

(Method for Creating Anchors and Hyperlinks.)

The method for creating anchors and hyperlinks differ depending on software to be used. However, it is well known that document creators can create hyperlinks and anchors with MSWord, registered trademark of Microsoft. In Non-Patent Document 1, it is explained as follows. In this case, a bookmark corresponds to an anchor on MSWord.

### Insert a Bookmark

In the current document, perform the following operations:
Step 1: Select a character string or item to which you want to assign a bookmark, or click on where you want to insert a bookmark.
Step 2: On the Insert tab, in the Link, click Bookmark.
Step 3: Under Bookmark Name, type a name.
Both characters and numbers can be used for bookmark names, but no number can be used for the first character. Also, no space can be used. However, the name can be divided by using an underscore (_), for example, “First Chapter_heading”.
Step 4: Click Add
   Add a link
Step 5: Select the character string or object that you want to display as the hyperlink.
Step 6: Click with a right button of a mouse, and then click a button image (Hyperlink) on the shortcut menu.
Step 7: Click Place in this Document at Link Destination.
Step 8: In the list, select the heading or bookmark at the link destination.

(The Idea that Names Follow the Attribute Rules.)

The Web states that the names of hyperlinks and anchors must be created according to the attribute rules. This may come from Non-Patent Literature 3. Non-Patent Literature 3 states that ID and NAME tokens must begin with a letter <A-Za-z> and may be followed by any number of letters, digits <0-9>, hyphens <->, underscores <_>, colons <:>, and periods <.>. And input starting with the number is always restricted.

(The Way of Management of Names.)

In electronic files including of XML, anchors may be managed by not only names but also numeric values. The numeric value called ID. This ID is available in two types. One type of ID is automatically numbered given to electronic files by a scheme complying with the specification of XML. Those files are numbered from number 0, using simple numerals from the start of sentences depending on the locations of the files in the front direction. The processing is mechanical. The other type of ID is fixed ID that replaces the names. And, in the case of MSWord, the management is performed with names and automatically numbered ID (names and ID in FIG. 15).

(Relationship with External Links Using ASCII.)

The Web has been developed centering his interest on external links, and the design of URL has been performed by using the characters of ASCII as the principal components. Of course, while hyperlinks mainly use an external link for making references to different documents. However, there was little evolution.

### CITATION LIST OF PRIOR ART LITERATURES

### Patent Literatures

Citation list of prior art literatures are the following inventions.
1 JP2016-003253 Application day 2016 Jan. 12

This application has been electronically exchanged in the Ser. No. 15/158,618.
2 JP2016-102026 Application day 2016 May 22 The electronic exchange number for this application is DDA9.

### Non Patent Literatures

Non Patent Literatures are the following inventions.
3. WIPO WO/2016/066321 written in English.
4. U.S. patent application Ser. No. 15/158,618

(About Patent Literature 1.)

This application is a patent obtained by the applicant himself in Japan. The publication issued date of the application was 2016 May 25. Machine translation does not translate properly. Therefore, in order to IDS the Patent Literature 1, an English translation attached which created manually by a Japanese patent translator. The most important points are as follows. The drawing is similar to CIP Ser. No. 15/669,937. However, the drawing is up to 35B.
(6.30: Name Multiplicating Instruction.)
(12.21.01: Significance of the Lower Level Regions of Names being Common with Each Other.)
3. (12.22: Directions of Transitions of Anchors.)
4. (12.23: Covering all Diagonal Lines.)
5. (12.25: Covering all Diagonal Lines while Moving Through Adjacent Angles.)
6. (12.26: Setting Regions which can be Comprehensively Referred to.)

(About Patent Literature 2.)

This application is a patent obtained by the applicant himself in Japan, too. The publication issued date of the application was 2016 Dec. 28. The feature of Patent Document 2 is that the following 13 chapters are added to Patent Document 1. And this part is the same as the previous Ser. No. 15/669,937 application. The drawing is similar to CIP Ser. No. 15/669,937. However, the drawing is up to 35B. The most important points are as follows.

1. (13.00: The Fourth Process.)

2. (13.70: Implementation in the Case of No Drop-Off of Interest.)

### SUMMARY OF THE INVENTION

### Problems to be Solved by the Invention

There are problems to be solved by the present invention as described below.

(Problem 1: Automatically Generate Both Anchors and Hyperlinks at the Same Time.)

For some time past, there has been a desire that users want to generate both anchors and hyperlinks at the same time automatically. The desire, of course, is not only to generate the both but also it includes an unexpressed expectation that users want to generate them so that anchors and hyperlinks perform the jumping function. Further, the phrase “at the same time” implies “at the same time and easily”. And there still remains a problem, of how electronic files that solve these problems should be created.

(Problem 2: How to Perform Reliable Conversion.)

Further, it is wanted to reuse (6.40) names of already completed hyperlinks and anchors. For this purpose, the names of the hyperlinks and the names of the anchors must be changed. This is because, when files in which the names have been changed and files before replacement are combined, the names of the anchors can coexist alongside. However, the number of tags of hyperlinks and anchors in XML is larger in HTML, and thus it is even impossible to read and understand content items visually. Under these situations, what should be done to perform error-free conversion without exerting influence on the content items?

(Problem 3: How to Facilitate Checks of Names.)

A technique of mouse-over exists. The mouseover is used to read names of hyperlinks residing behind the characters. However, it is not efficient to place the mouse on points where a user wants to read one by one, and hyperlinks can be read only in the region. Further, when the above problems 1 and 2 can be solved, and it becomes possible to generate the hyperlinks automatically, the checks of the hyperlinks come to require a method for performing more simply and more efficiently, which must be more convenient. What should be done to cope with such problems and to create electronic files?

(Problem 4: Desired to Create Names that are Hard to be Falsified.)

In recent years, high importance is placed on genuine of documents. Thus, users want to make the hyperlink structure in electronic files that are hard to be falsified (10.61.01). How is it necessary to perform?

(Problem 5: Desired to Automatically Generate Files of which Contents can be Easy to Compare.)

It is very convenient that matter can be multilaterally examined. However, classical example, screen form is as shown in Non-Patent Literature 2 are divided screen into left and right. Non-Patent Literature 2 is a PDF that contains comparisons among the texts of EPC (European Patent Convention) in English, German, French) made by the European Patent Office. For this reason, the PDF is divided into left and right for English and German for each Rule of EPC, and the display area became narrow. Also, French is unnatural with one side being blank. Further, parts of English, German are also separated by French, and it becomes difficult to look for provisions of the next English, German. What should be done to make such multiple language sites easy to be seen?

(Problem 6: Automatically Create Files which Users can Examine from Multifaceted Perspectives.)

Further, in recent years, traffic and communication means has progressed. Therefore Websites with multiple languages information are needed. For example, there are many foreigners in a town where the applicant lives. They are also live. They put out the garbage. It sounds simple, but it is difficult because the trash must be sorted depending on the types of garbage. And collect places should be different for each type. Additionally, the day of collection and the time are different. So, there is a need to create Web pages make it understandable and communicable. Is there any way to create such an electronic file easily? What should be done to cope with such problems and to create electronic files?

(Problem 7: Desired to Automatic Creation of Jumps Covering all Diagonal Lines.)

Usually, unexpected jumping destinations are often described in hyperlinks. Therefore, hyperlinks that wasting time is conspicuous. However, hyperlinks are farmed extensively over contents so as to cover all diagonal lines, and if there are hyperlinks that cause users to anticipate jump destinations, the users can freely navigate back and forth between the hyperlinks. But then, when an attempt is made to create the files of Non-Patent Literature 5 by manual operation, each time the content to be referred to is incremented one by one, the number of diagonal lines is increasing at a high pace. In the case where the number of references, which will be the targets of jumping, has increased, is there any method of how to automatically create jumping?

(Problem 8: Individual Instructions from Users.)

Additional to automatic generation, it is desired to perform creation, addition, or deletion upon receiving individual instructions from users. If so, it is convenient for maintenance of an electronic file. In that case, how should each instruction be arranged?

(Problem 9: Replacement of Names that Enable Jumping.)

Even if hyperlinks and anchors could be automatically created in electronic files, it has no value unless jumping can be established and can be operated automatically. How should the names be replaced, and then the jumping be automatically generated?

(Problem 10: Wanted to Create a Stable Display Area where Users can Compare and Examine in Smartphones as Well.)

Screens of recent smartphones have small display areas. For this reason, when the left and the right information are compared and examined by dividing screens into left and right sections, the regions become narrower, and characters become smaller, and the screens become more difficult to be seen. How stable screens that allow users to compare and examine contents could be created on smartphones?

(Problem 11: Desired to Produce in Large Volume in a Short Time.)

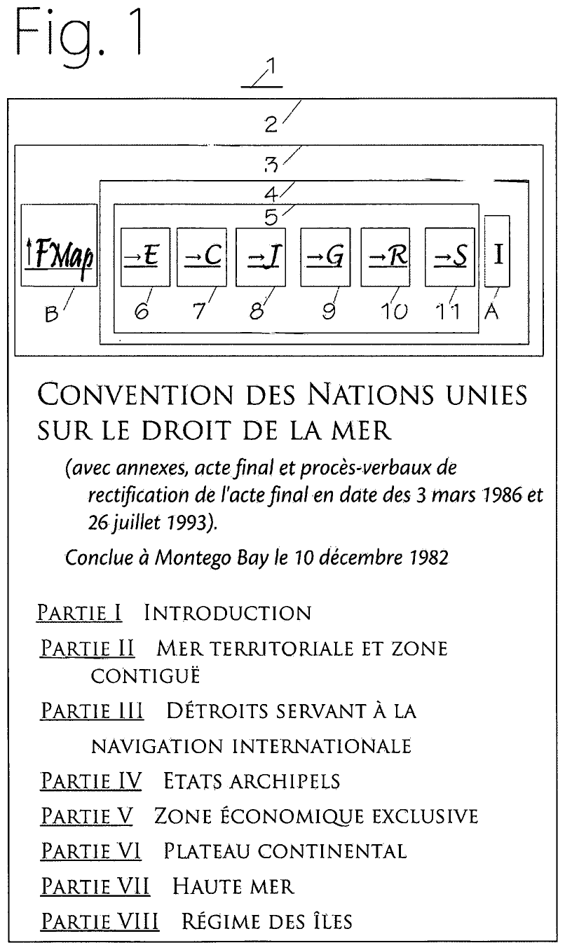

It is desired to automatically generate hyperlinks and anchors in a short time. In that case, it is wanted to automate replacements of names in a large scale too. Although, there remains an issue whether such a good method can be found to create complicated regions thoroughly without wasting time is present. From now on, the complicated setting region 4 in FIG. 1 is abbreviated as “verbatim”. In the complicated regions, jumping to different languages is enabled in Patent Literature 5 which is the invention of the applicant. However, it will take an enormous of time.

(Problem 12: Mount of Cross-Reference to Make Artificial Intelligence

Function Work Efficiently.) The present invention uses a repetitive jump so as to be able to return between a plurality of setting areas for the purpose of making things easier to understand.

In a similar case, in recent years, there has been a great deal of research using artificial intelligence to perform understanding beyond human understanding. Even in this case, it is more accurate to perform the mechanical processing on the information classified as a plurality of sorted different data than to perform the data processing without a certain relation between the original data. Because, artificial intelligence that mimics human intelligence will make the same mistakes as humans, so if it is placed in an environment where humans are less likely to make mistakes, the machines may be the same too.

However, the case that artificial intelligence verifies is a huge data correlation. Therefore, is there any surprisingly easy way to create a hyperlink without the hassle that enables such data arrangement with a cross-reference area suitable for artificial intelligence?

### Means for Solving Problems

In view of the above-described backgrounds, the present invention has the following configurations in order to solve the above problems.

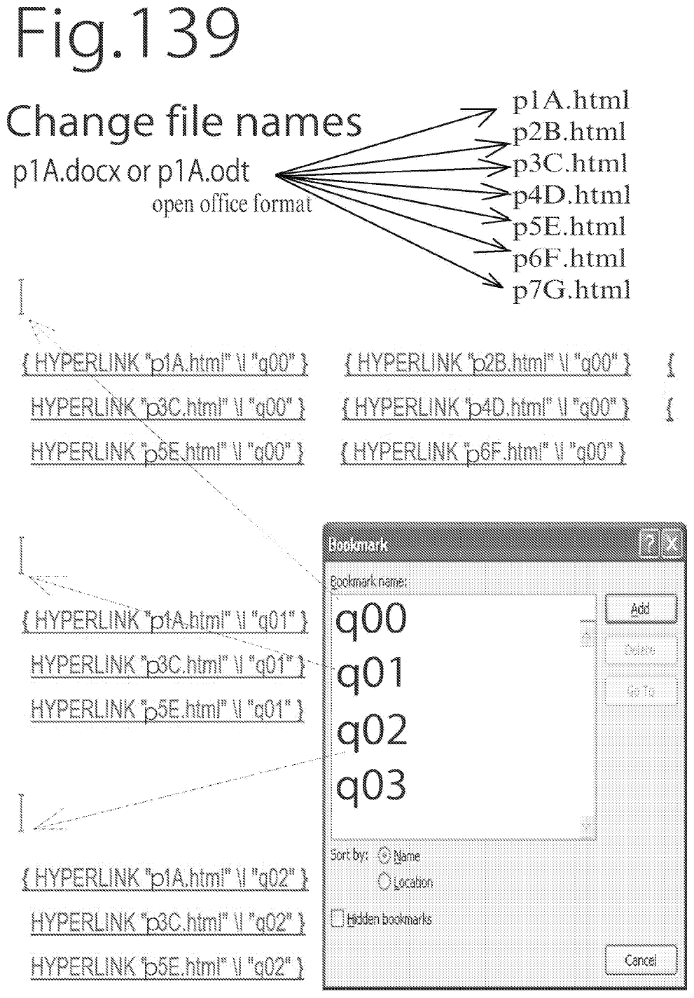

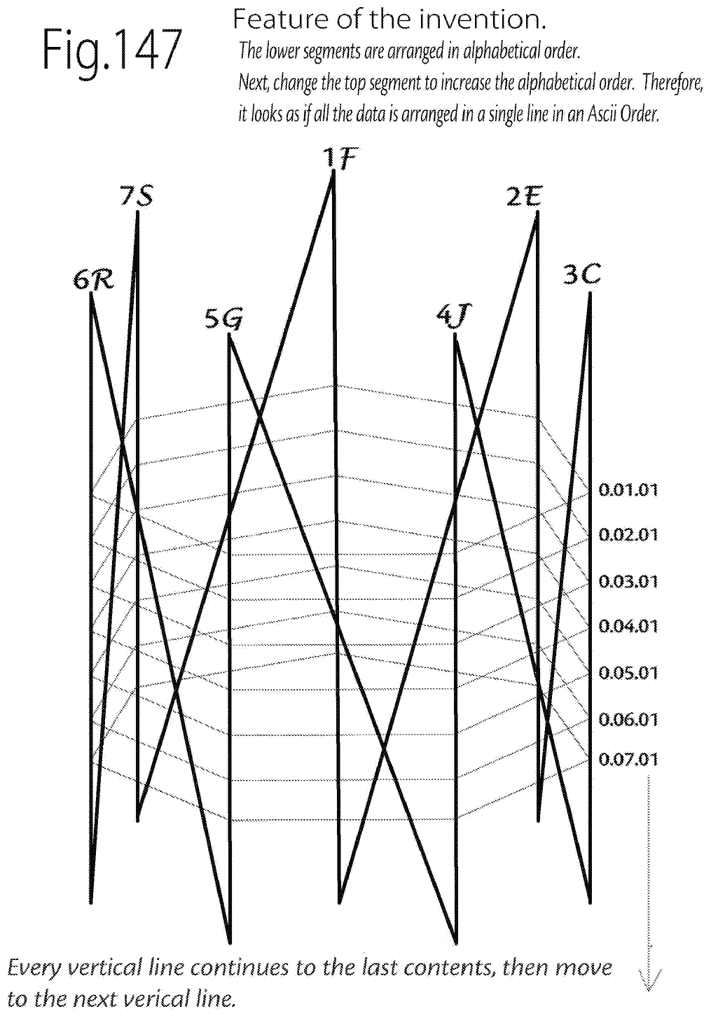

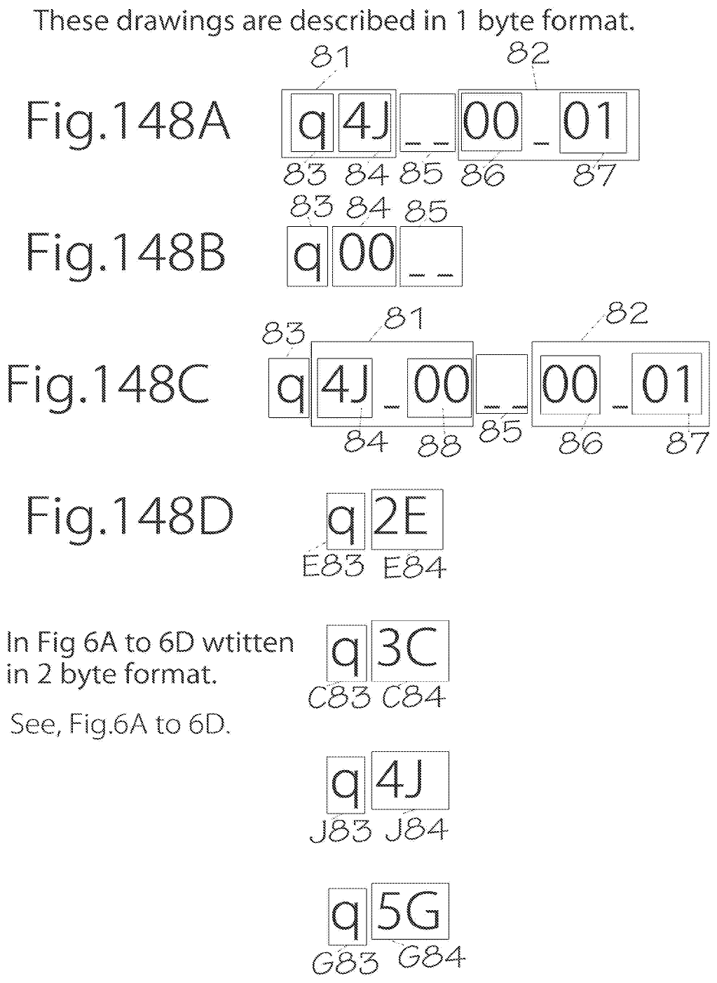

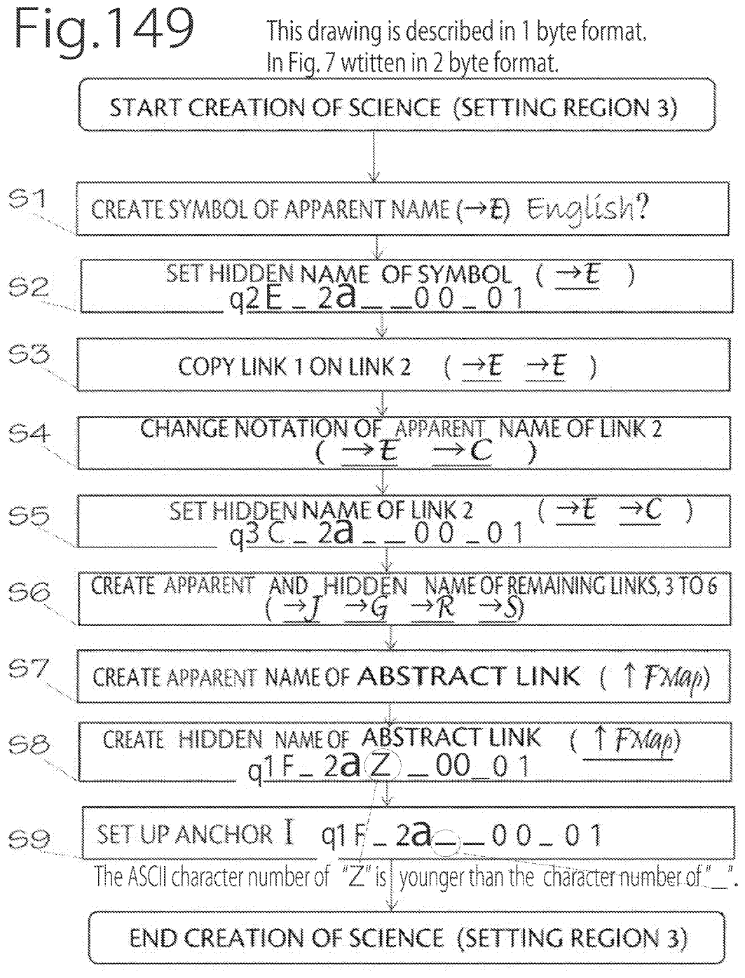

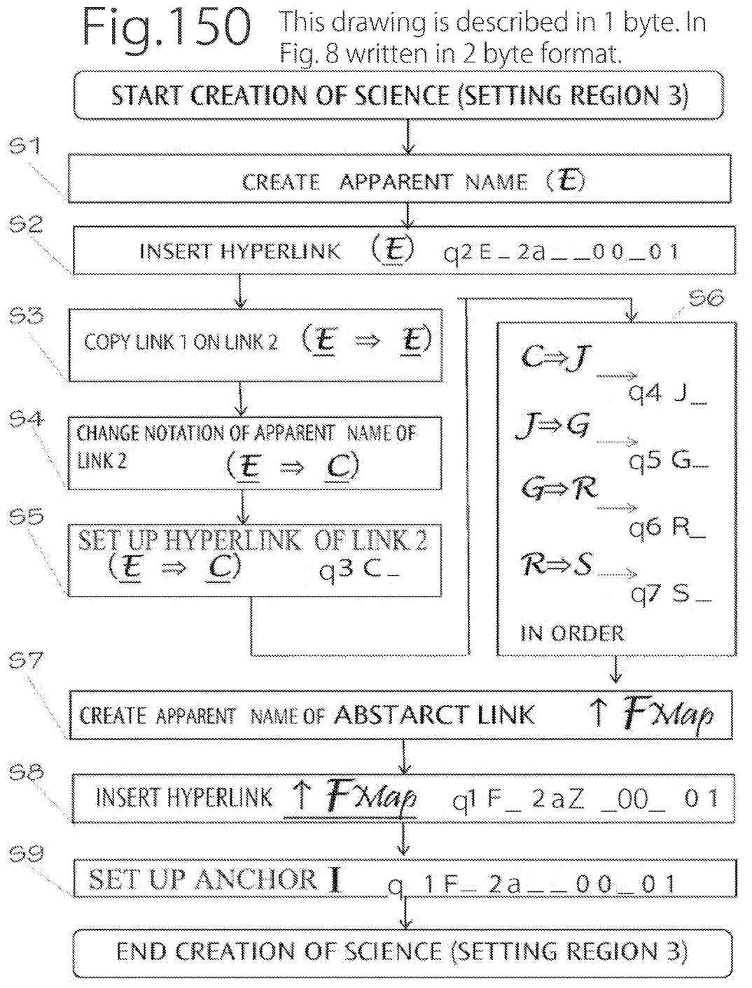

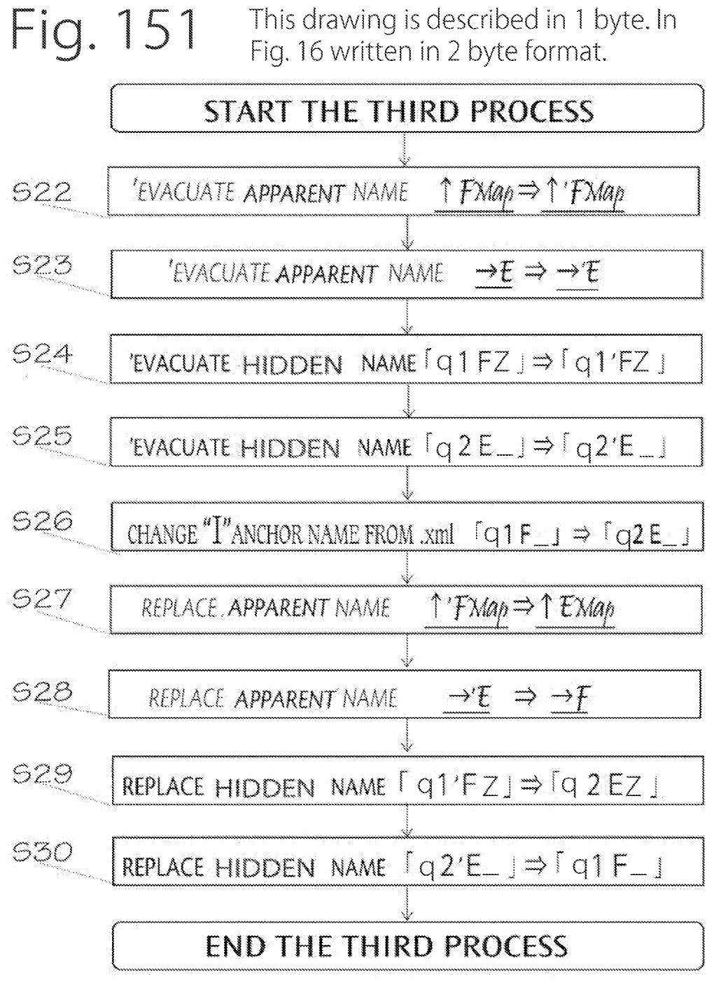

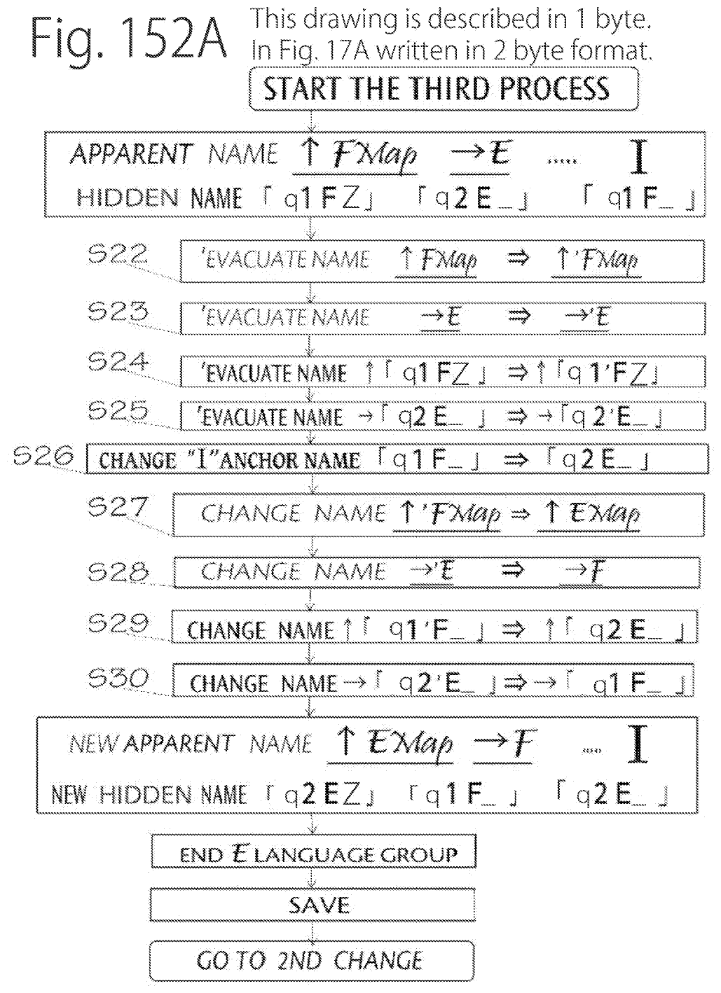

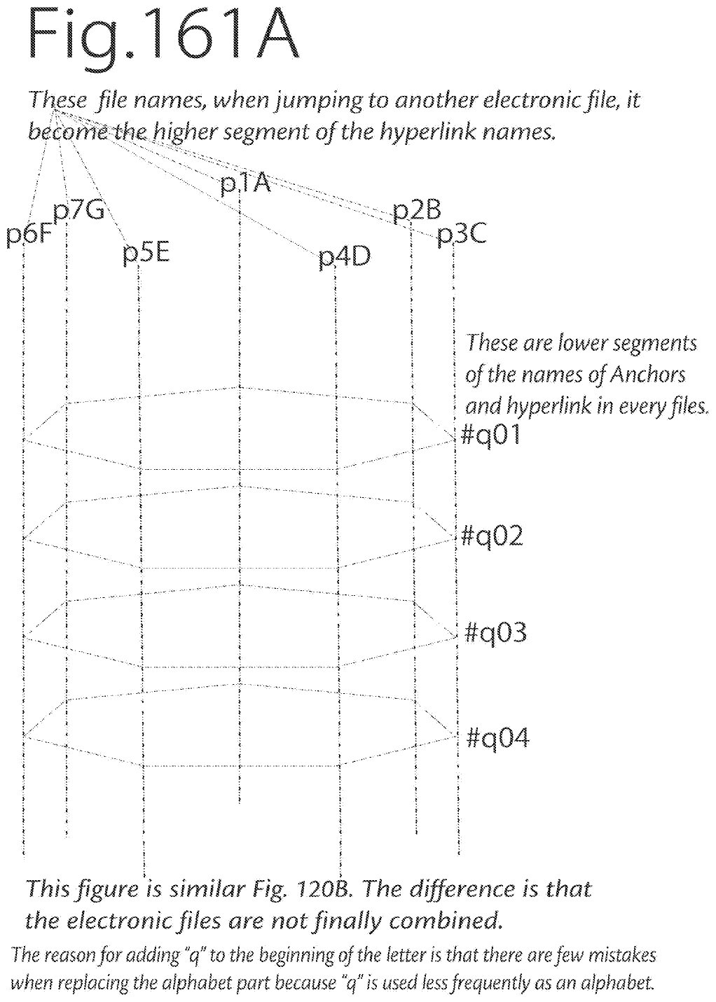

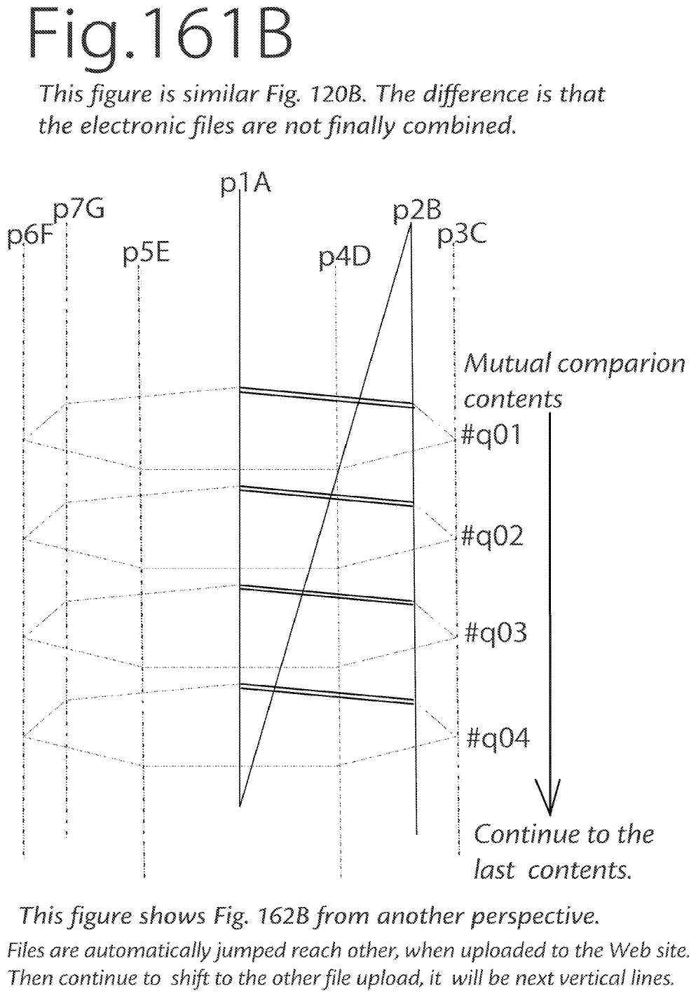

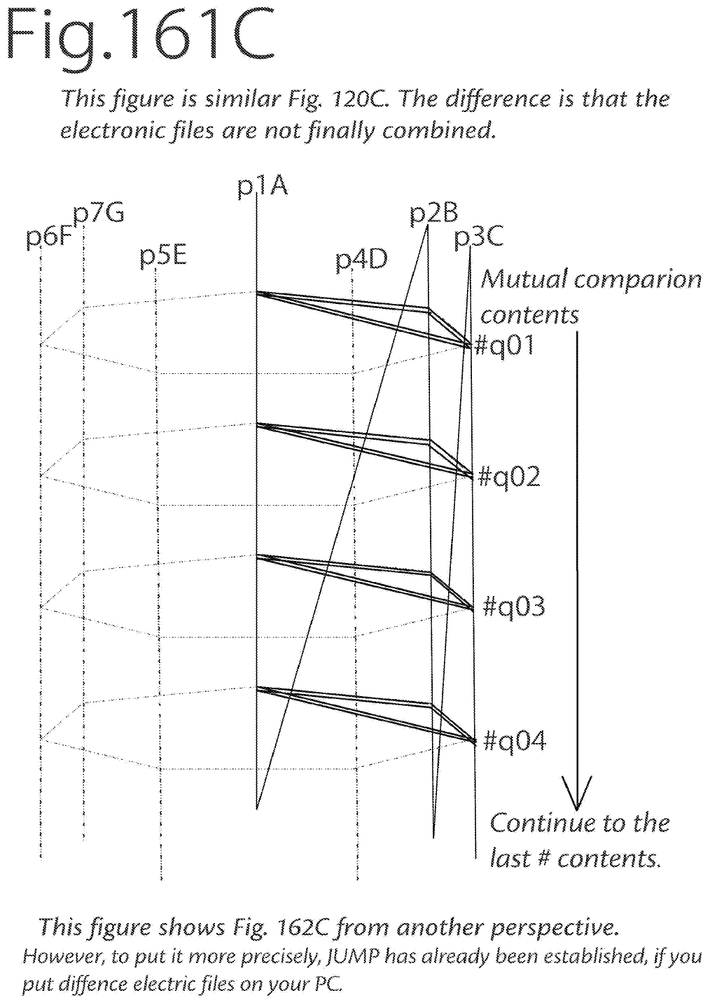

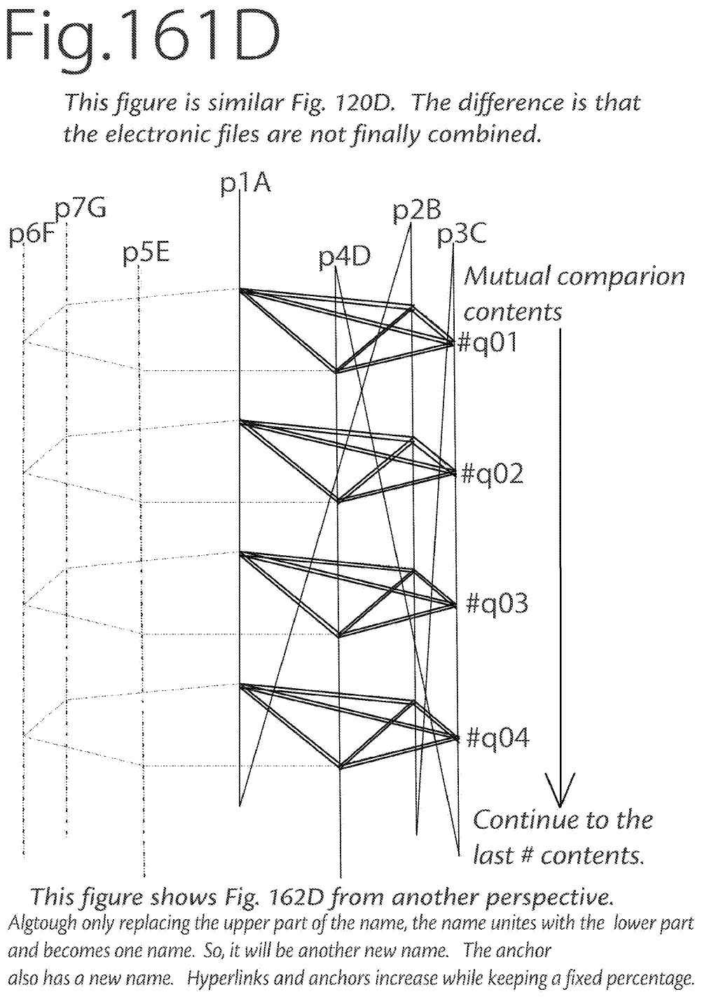

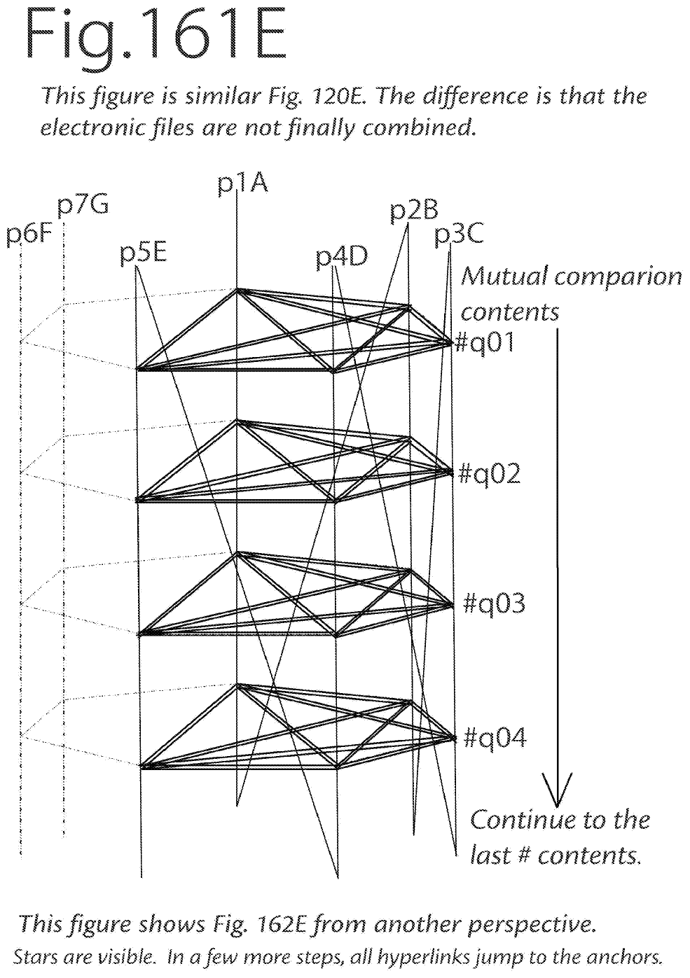

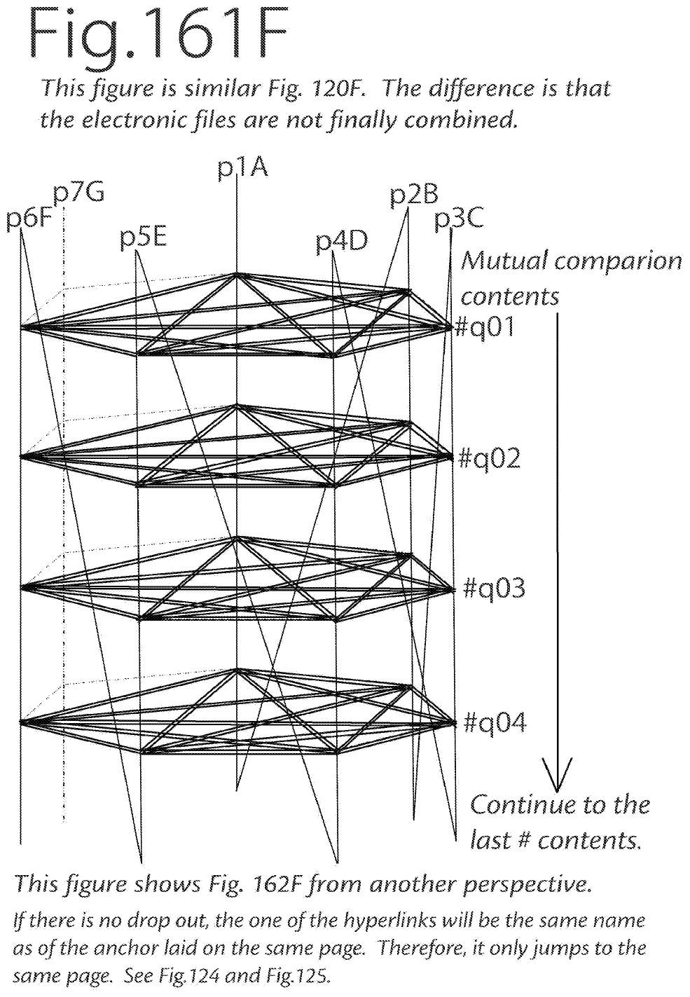

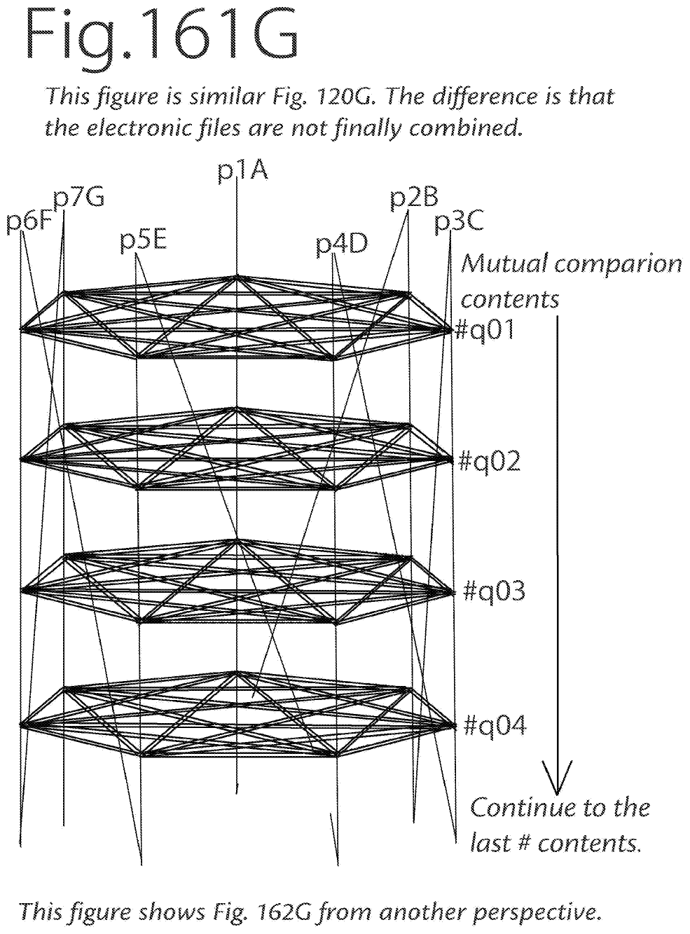

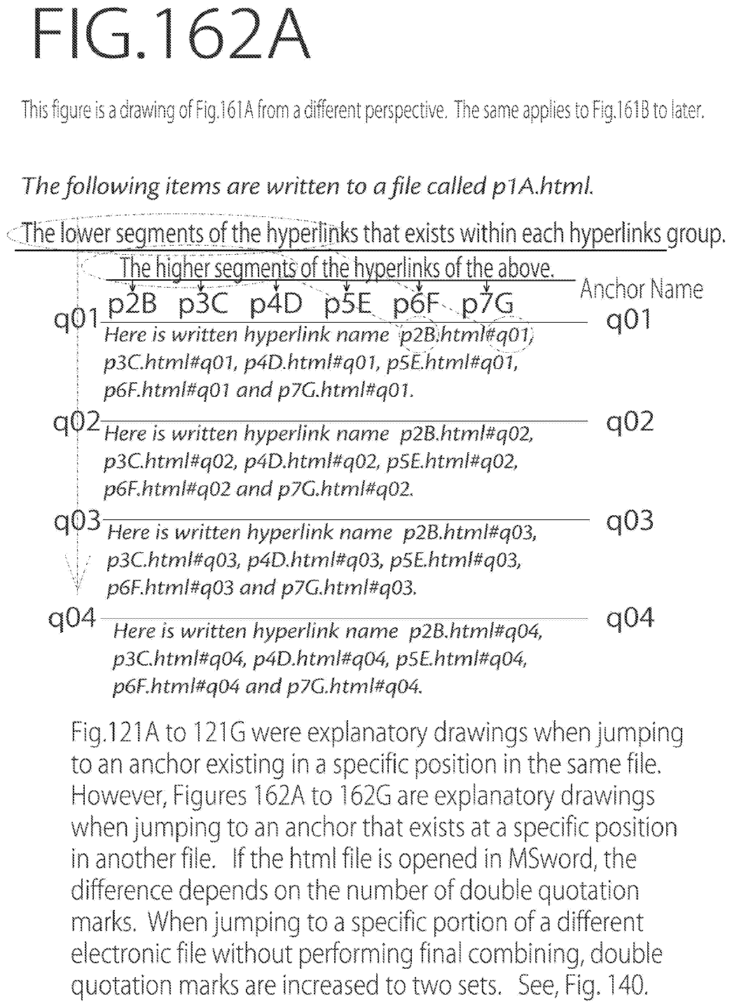

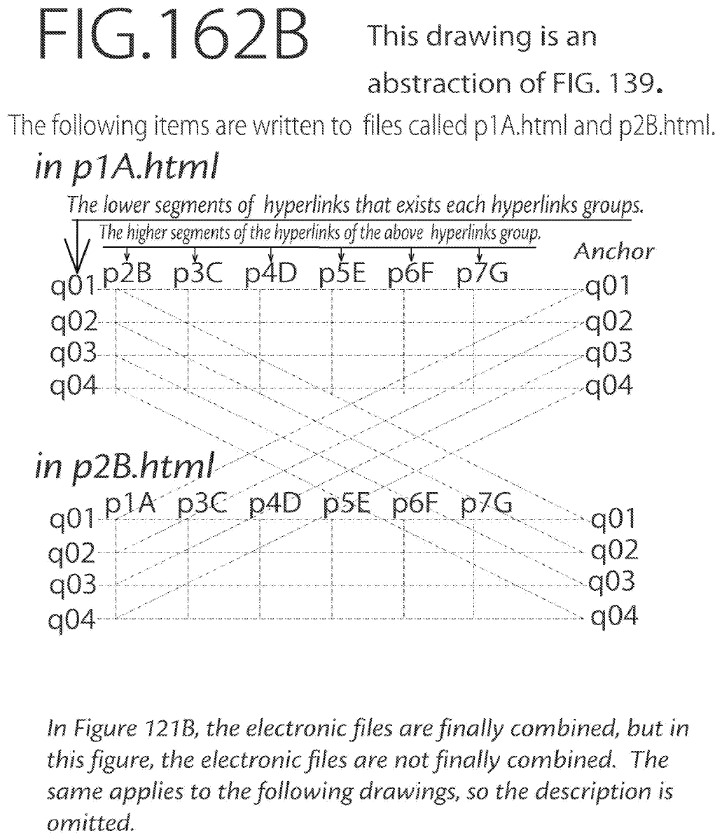

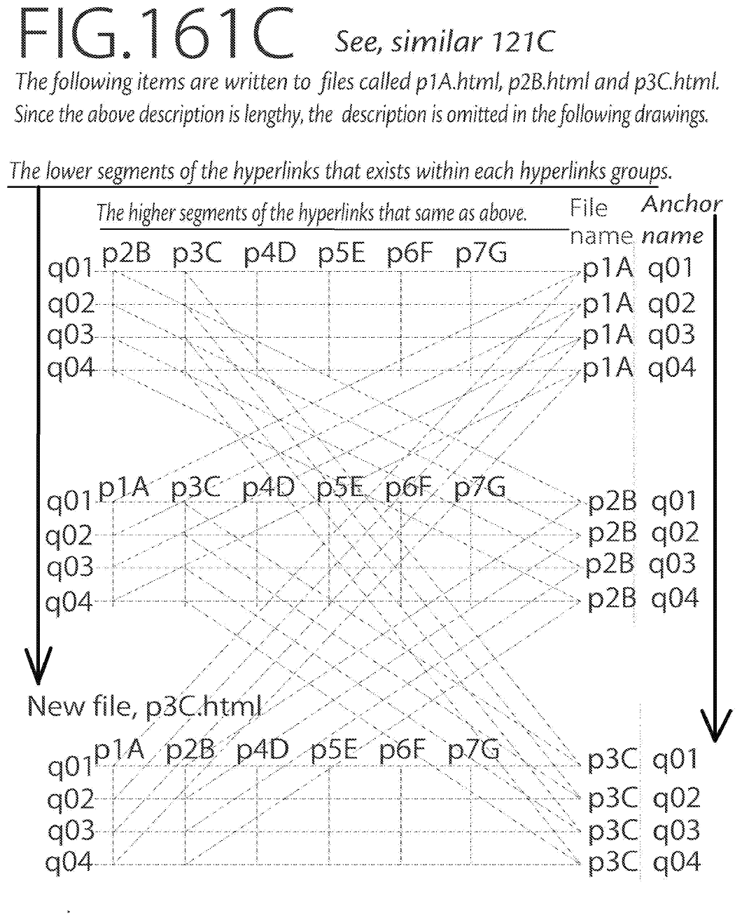

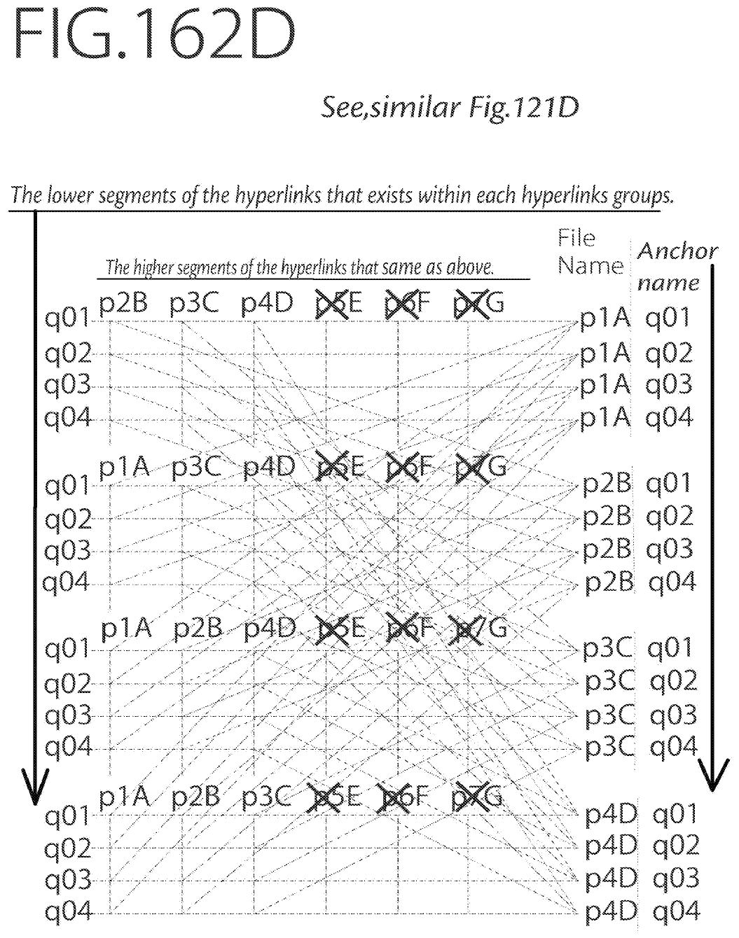

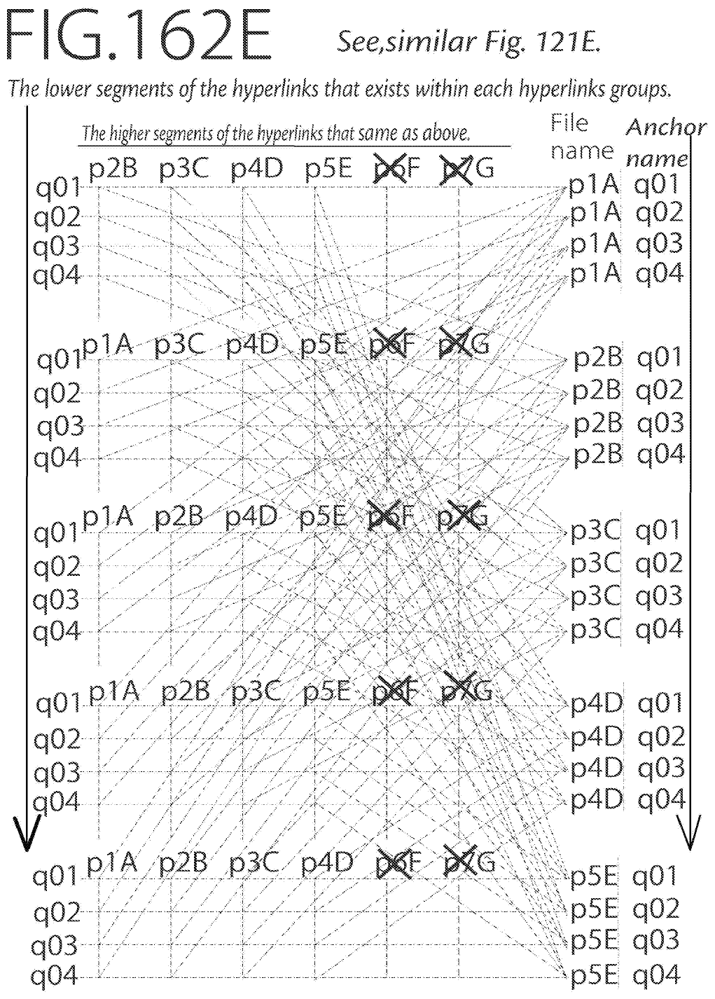

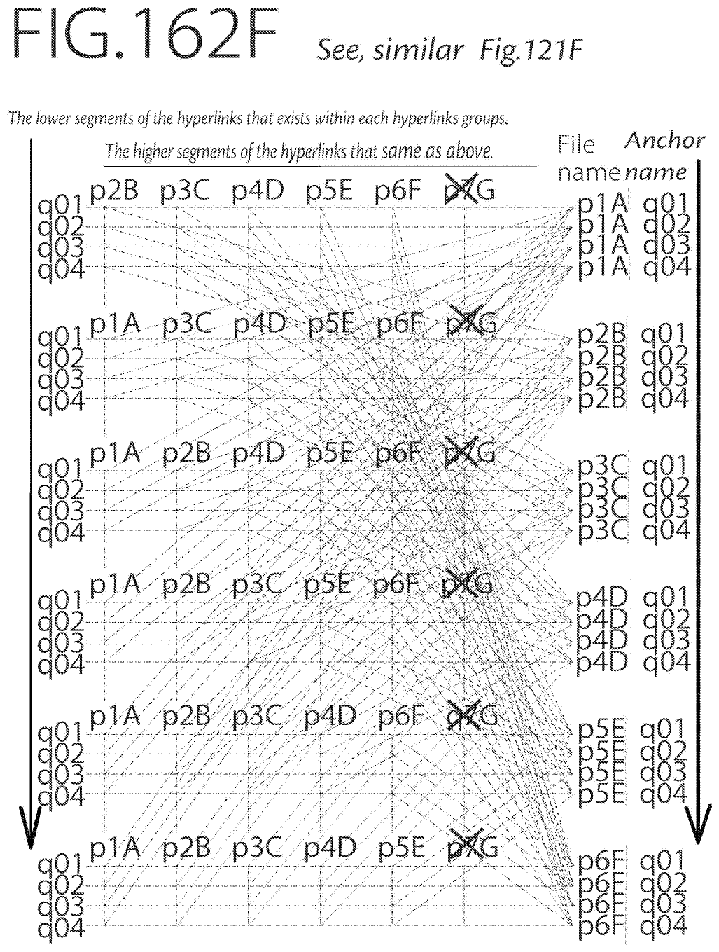

Configuration 1:
1. An electronic file generation method comprising the steps of: firstly, in one electronic file, creating verbatim setting regions (e.g. Region 4 in FIG. 1 or FIG. 126), which consist of the anchor and of the hyperlinks group, of which configuring to have same lower level segments of the names (e.g. q00, q01 and q02 of FIG. 139. These will form the each plate of FIG. 161A in the future. However, in this embodiments, there is a polygon having a huge plate jump total number determined by N(N−1) as shown in FIG. 126), secondly, executing one-round replacement through the file names (e.g. from p1A.html to p7G.html of FIG. 161A) and thereby generating a plurality of different electronic files (e.g. Seven vertical line of FIG. 147 means file name. In the case of the huge plate of FIG. 126, a total of N is created for the number of corners of the plate) and thereby generating a plurality of different electronic files, and thirdly, putting the files in the same folder (e.g. FIG. 161G), thereby realize returnable multiply jumps among the same lower level segments of the verbatim setting regions in the different electronic files (e.g. FIG. 162G).

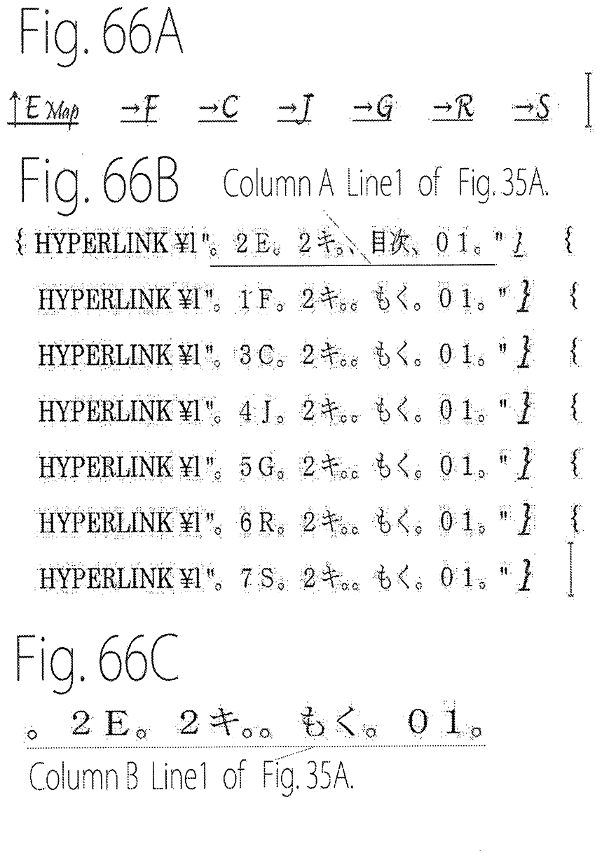

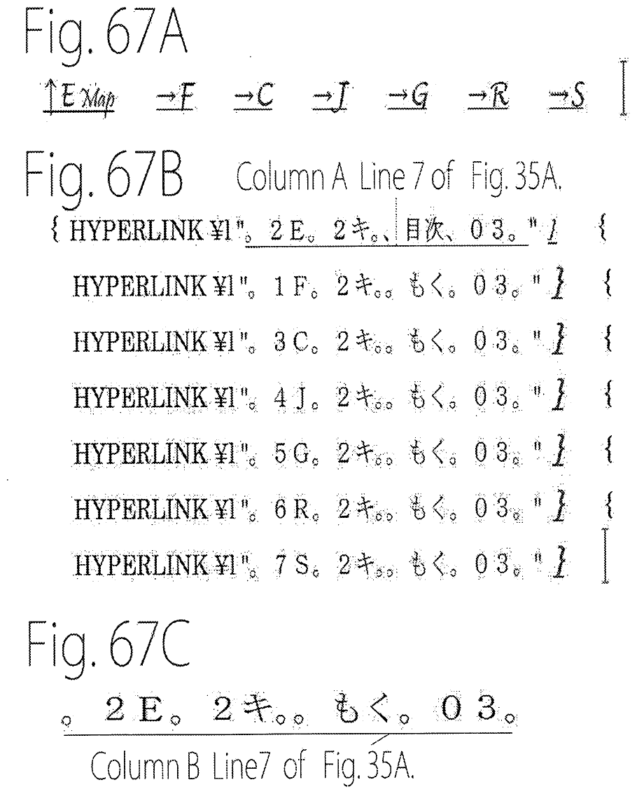

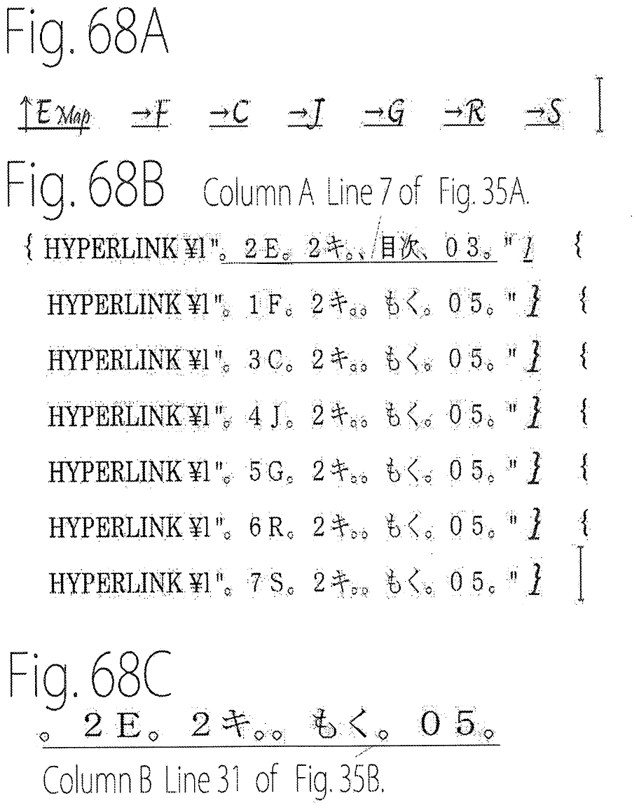

Configuration 2:
2. The electronic file generation method according to claim 1, in the middle of several generation processes,
   maintaining a constant magnification regularity that the number of hyperlinks corresponding to one anchor is always the same ratio within the respective verbatim setting regions (e.g. From FIG. 66 to FIG. 114. The ratio in these drawings means that all hyperlink groups indicated by right-pointing arrows are each composed of 6, and that the right end anchor is one), so that the hyperlinks enabled to make directly jumping to anchors existing in respective verbatim setting regions in different electronic files (e.g. FIG. 162G) as a result and returnings are enabled directly to other anchors so that cross reference between the verbatim setting regions in the other different electronic files (e.g. FIG. 161G).

Configuration 3:
3. The electronic file generation method according to claim 1, in the middle of several generation processes, the hyperlinks are arrayed in the ascending order of the character codes (FIG. 139 configures each six as a set of hyperlinks group is aligned from p1A.html to p6F.html. Each set is arranged such that the number increases from q1A to q6F) and samely copied to another file (e.g. Top of FIG. 139), therefore, front and back relationship among the hyperlinks in the verbatim setting regions are not changed.

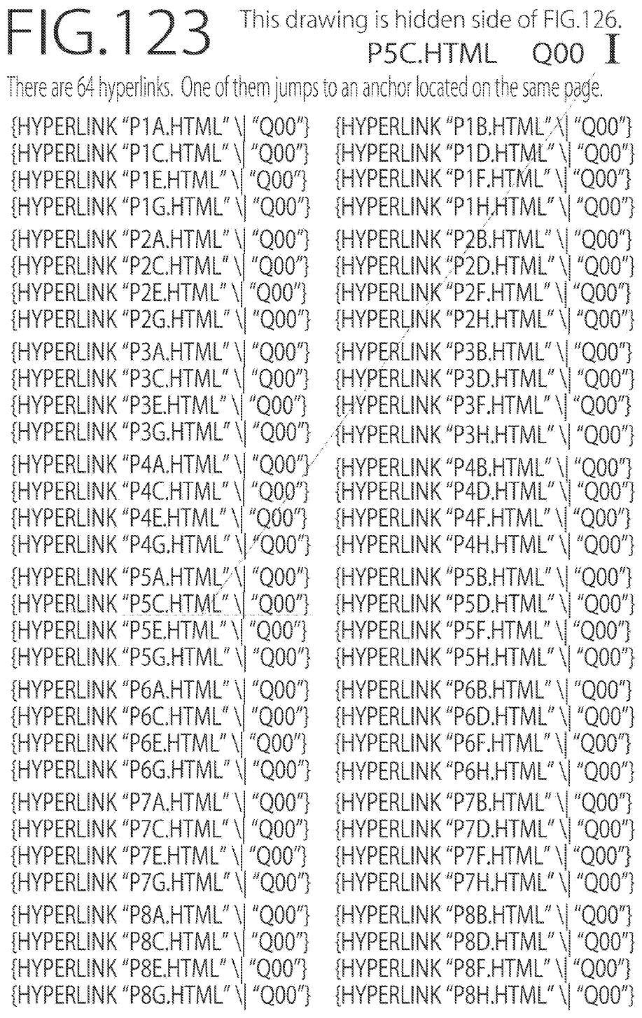

Configuration 4:
4. The electronic file generation method according to claim 1, in the middle of several generation processes, the hidden names of the hyperlinks in the verbatim setting regions are opened from field code side, the character strings of the names of the hyperlinks are slipped down through a word-wrap function and as a result, the column positions of the character strings of the names of the hyperlinks can be synchronized in the vertical and can be confirmed orderly aligned from the younger character code number (e.g. In FIG. 139 every hyperlink names are aligned from p1A.html to p6F.html. e.g. FIG. 123).

Configuration 5:
5. The electronic file generation method according to claim 1, further comprising;
   the names of the anchors of verbatim setting regions and the names of the hyperlinks in verbatim setting regions employ character types, of which use is prohibited by the World Wide Web Consortium (FIG. 31 shows an anchor starting from a numerical value, but functions as a hyperlink).

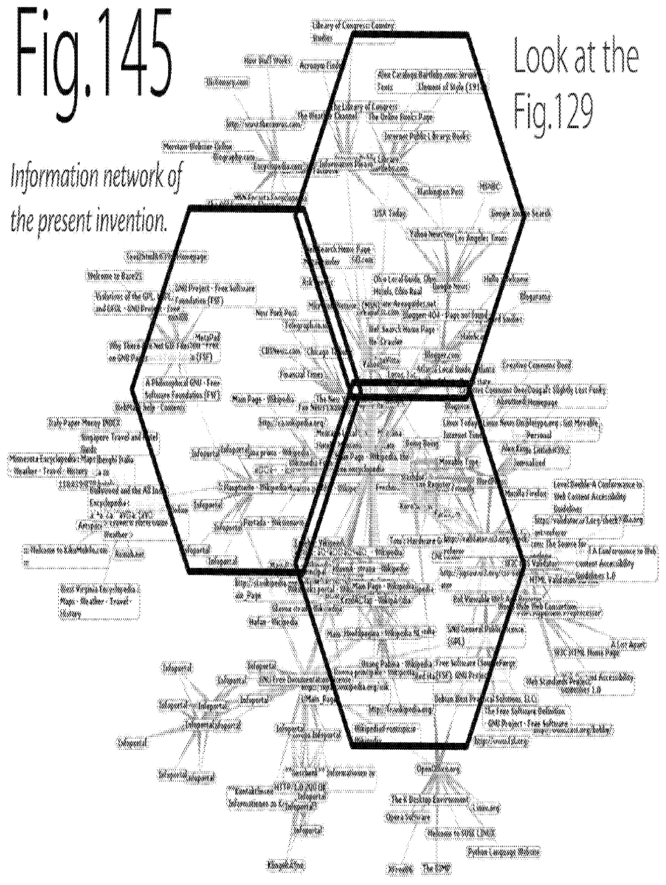

Configuration 6:
6. A non-transitory computer-readable storage medium executes to display the following results of the steps:
   firstly, in one electronic file, creating verbatim setting regions, which consist of the anchor and of the hyperlinks group, of which configuring to have same lower level segments of the names, (e.g. each 0.01.01 to 0.007.01 circle of FIG. 147. e.g. e.g. q00, q01 and q02 of FIG. 139), secondly, executing one-round replacement through the file names (See, overlap of FIG. 142), thereby, generating a plurality of different electronic files, and thereby, realize returnable multiply jumps among the verbatim setting regions which consist of the same lower level segments between different electronic files (e.g. FIG. 161G or FIG. 162G).

Configuration 7:
7. The non-transitory computer-readable storage medium for storing the setting regions according to claim 6 having, wherein when the storage medium maintains a constant magnification regularity (From FIG. 161A to FIG. 161G) that the number of hyperlinks corresponding to one anchor is always the same ratio within the respective verbatim setting regions (e.g. FIG. 139 configures each six as a set of hyperlinks group is aligned from p1A.html to p6F.html. The ratio in these drawings means that all hyperlinks groups indicated by right-pointing arrows are each composed of 6, and that the right end anchor is one. However, one of each six jumps to the same page), so that all the cross reference are enabled directly to other anchors in the other verbatim setting regions in the other different electronic files (e.g. FIG. 162G).

Configuration 8:
8. The non-transitory computer-readable storage medium for storing setting regions according to claim 6, further comprising,
   in the middle of several generation processes the hyperlinks groups are arrayed in the ascending order of the character codes (FIG. 139 configures each six as a set of hyperlinks group is aligned from p1A.html to p6F.html. Each set is arranged such that the number increases from q1A to q6F) and samely copied to another file (e.g. Top of FIG. 139), so that front-and-back relationship among the hyperlinks in the verbatim setting regions are not changed.

Configuration 9:
9. The non-transitory computer-readable storage medium for storing setting regions according to claim 6 further comprising,
   wherein when the hidden names of the hyperlinks in the verbatim setting regions are opened from field code side, the character strings of the names of the hyperlinks are slipped down through a word-wrap function and
   wherein the column positions of the character strings of the names of the hyperlinks can be synchronized in the vertical and can be confirmed orderly aligned from the younger character code number (e.g. In FIG. 139 every hyperlink names are aligned from p1A.html to p6F.html).

Configuration 10:
10. The non-transitory computer-readable storage medium for storing setting regions according to claim 6 further comprising;
   the names of the anchors of verbatim setting regions and the names of the hyperlinks in verbatim setting regions employ character types, of which use is prohibited by the world wide web Consortium (FIG. 31 shows an anchor starting from a numerical value, but functions as a hyperlink).

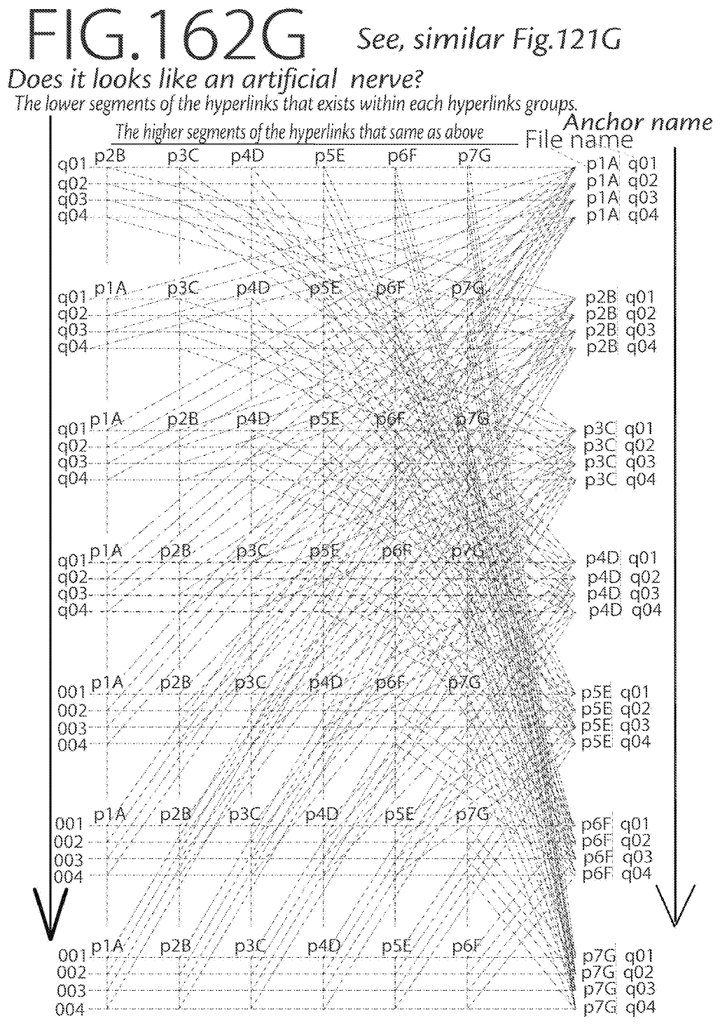

Configuration 11:
11. An electronic file generation method for the artificial intelligence comprising the steps of:
   firstly, in one electronic file, creating verbatim setting regions, which consist of the anchor and of the hyperlinks group, of which configuring to have same lower level segments of the names (e.g. each plate from 0.01.01 to 0.007.01 of FIG. 147. e.g. q00,q01 and q02 of FIG. 139. e.g. FIG. 163), secondly, executing one-round replacement through the file names (See, overlap of FIG. 142) and thereby generating a plurality of different electronic files, so that it enables accurately recognizes information on contents by the returnable multiply jumps among the contents under the verbatim setting regions which consist from the same lower level segments (e.g. FIG. 161G or FIG. 162G).

Configuration 12:
12. The electronic file generation method for the artificial intelligence according to claim 11 further comprising of,
   wherein when the hyperlinks corresponding to one anchor is always the same ratio within the respective verbatim setting regions in one electronic file (e.g. The ratio between the hyperlinks and the anchor in FIGS. 66 to 114 is always constant), and further,
   when despite increment of the electronic file, maintains a constant magnification regularity (e.g. FIG. 161G),
   so that all the cross references are enabled directly to other anchors in the other verbatim setting regions in the other different electronic files (e.g. FIG. 162G).

Configuration 13:
13. The method for generating electronic files for the artificial intelligence according to claim 11 further comprising of,
   the setting regions of the hyperlinks groups (e.g. Each hyperlinks of FIG. 139) are arrayed in the ascending order of the ASCII character codes and copied to another file (e.g. Top of FIG. 139),
   therefore front-and-back relationship among the hyperlinks in the verbatim setting regions are not changed.

Configuration 14:
14. The method for generating electronic files for the artificial intelligence according to claim 11 further comprising,
   wherein when the hidden names of the hyperlinks in the verbatim setting regions are opened from field code side, the character strings of the names of the hyperlinks are slipping down through a word-wrap function and
   wherein the column positions of the character strings of the names of the hyperlinks can be synchronized in the vertical and can be confirmed orderly aligned from the younger character code number (e.g. In FIG. 139 every hyperlink names are aligned from p1A.html to p6F.html).r.

Configuration 15:
15. The method for generating electronic files for the artificial intelligence according to claim 11 further comprising,
   incrementing the ASCII code number of the anchors in the setting regions (The plus part of FIG. 124), then reducting the ASCII code of the hyperlinks in the setting regions (The minus part of FIG. 124),
   in the meanwhile, the file names remaining unchanged.

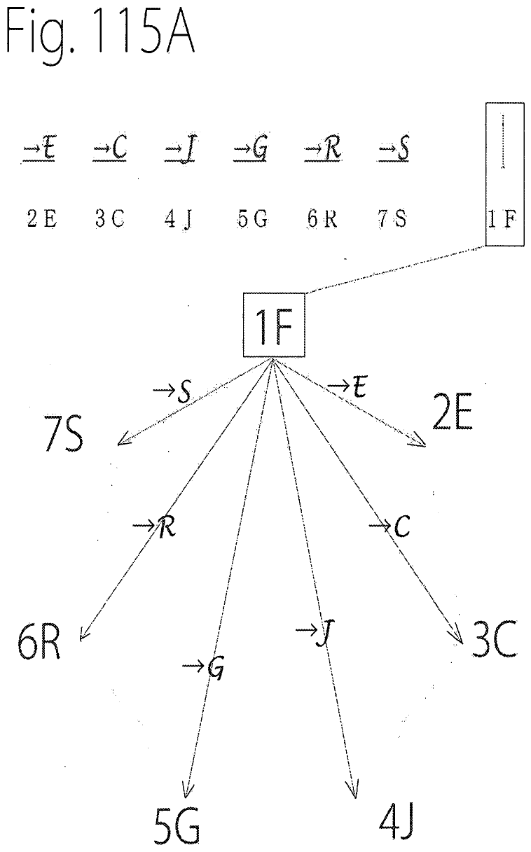

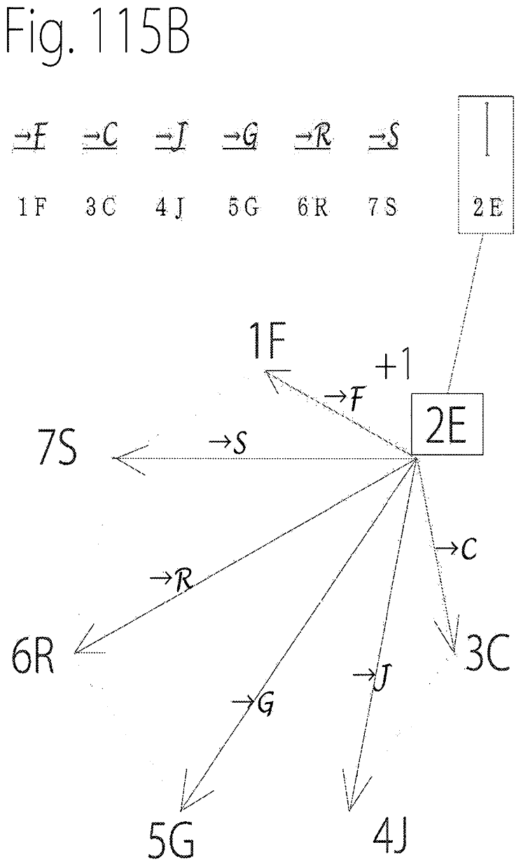

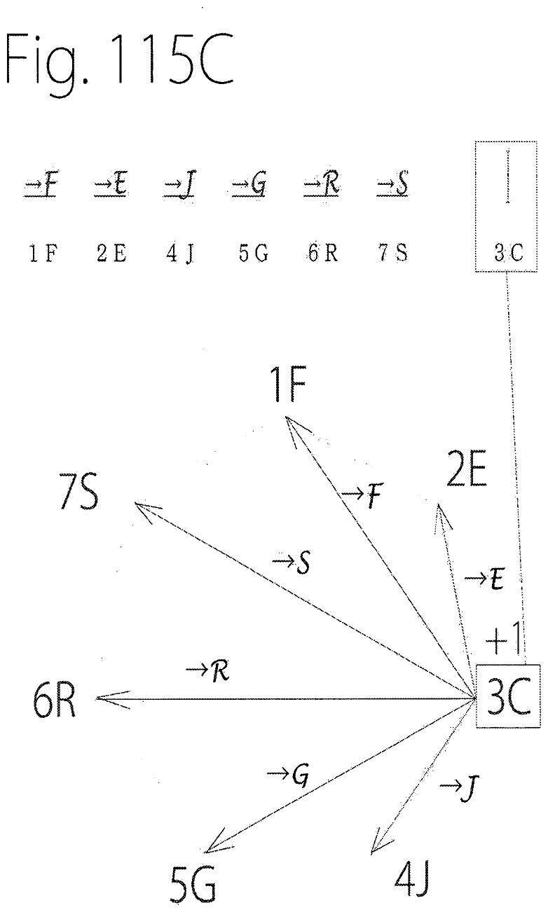

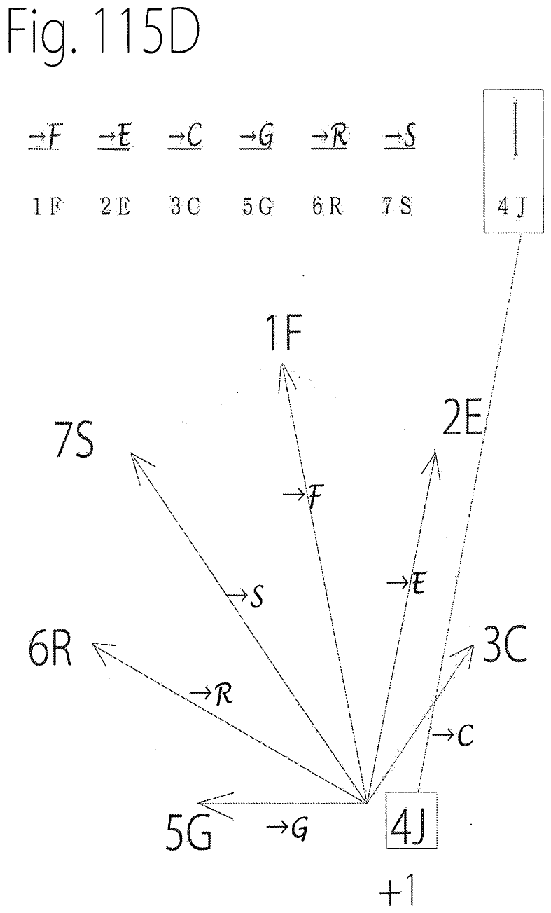

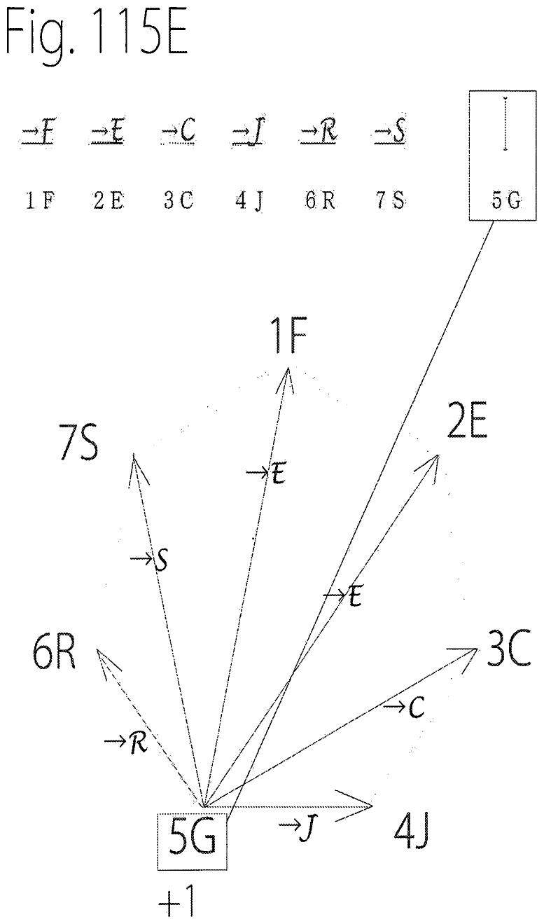

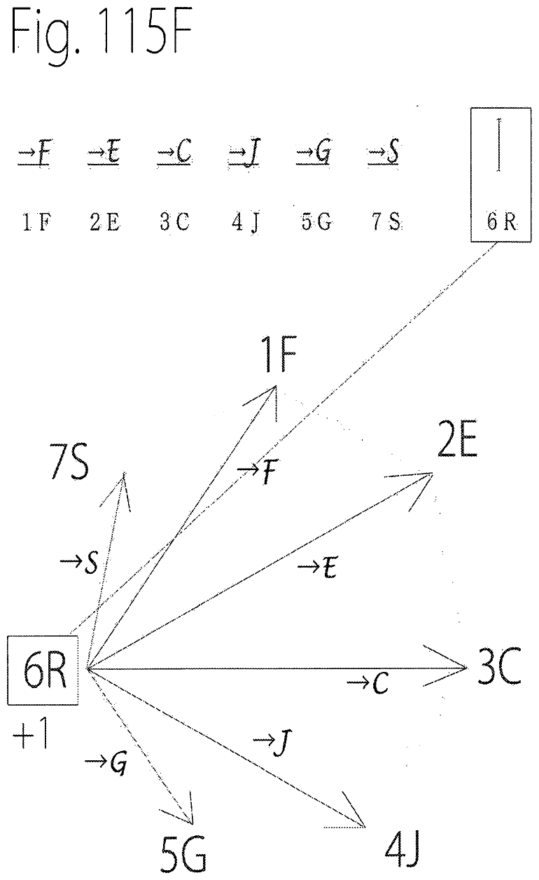

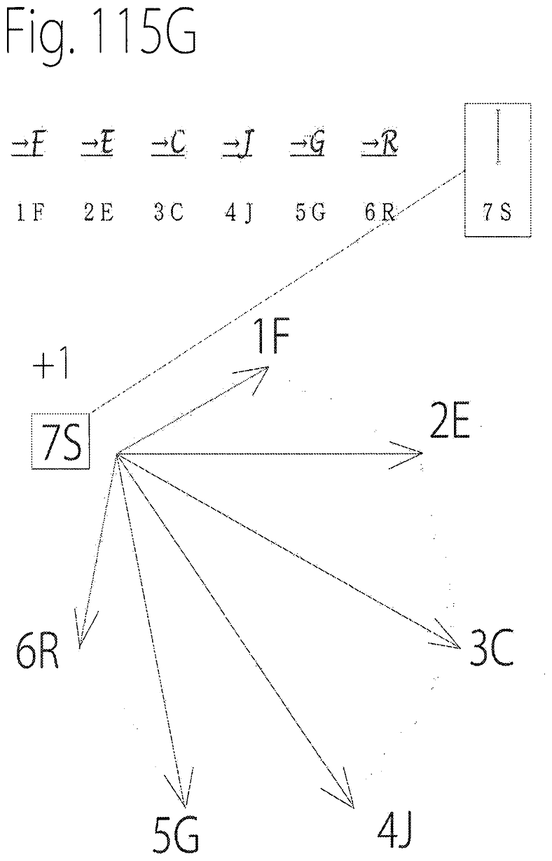

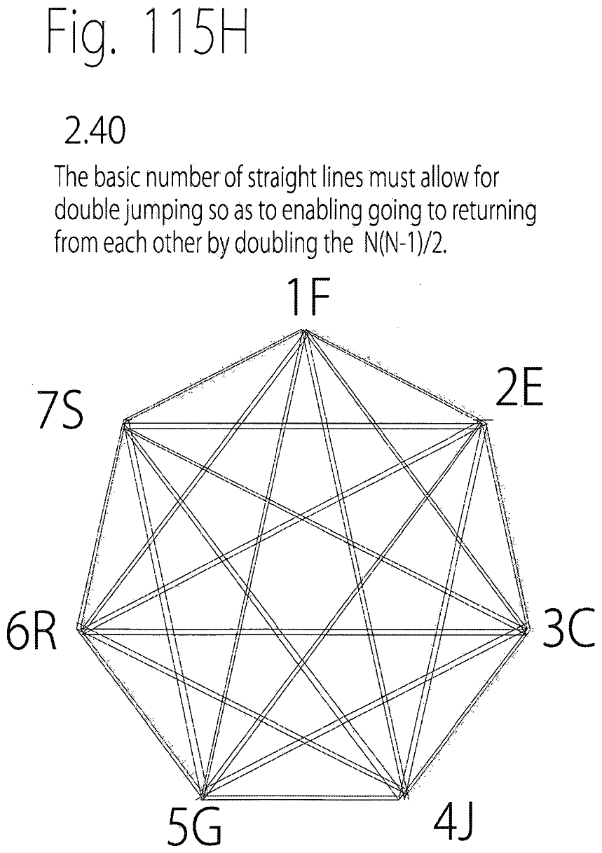

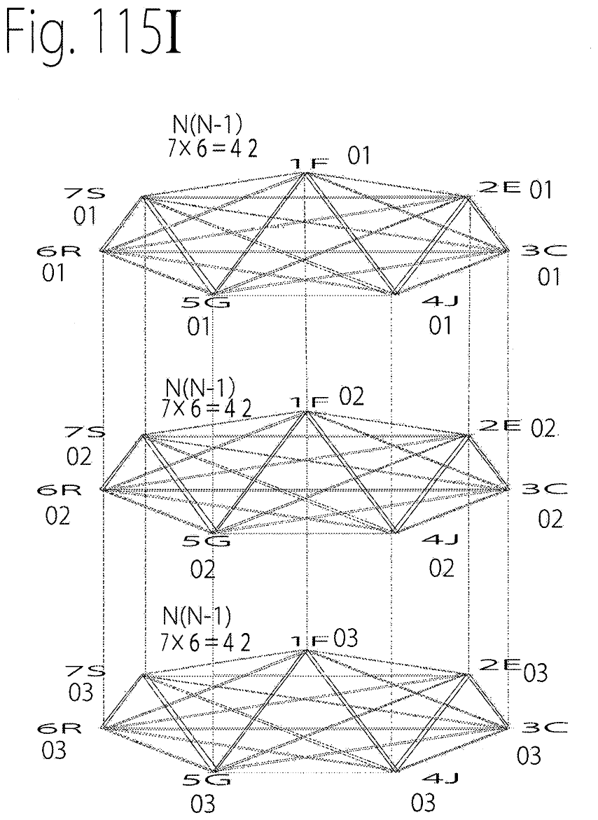

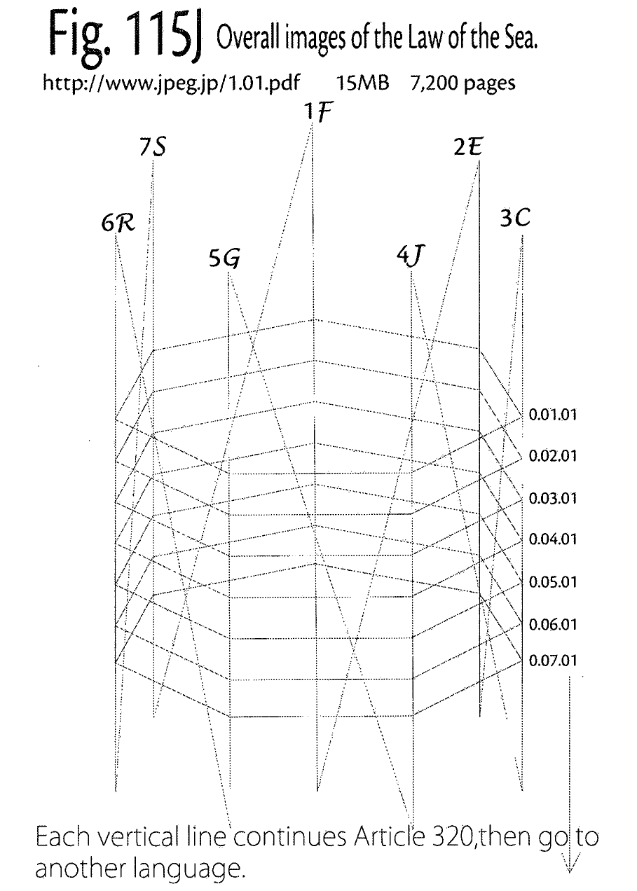

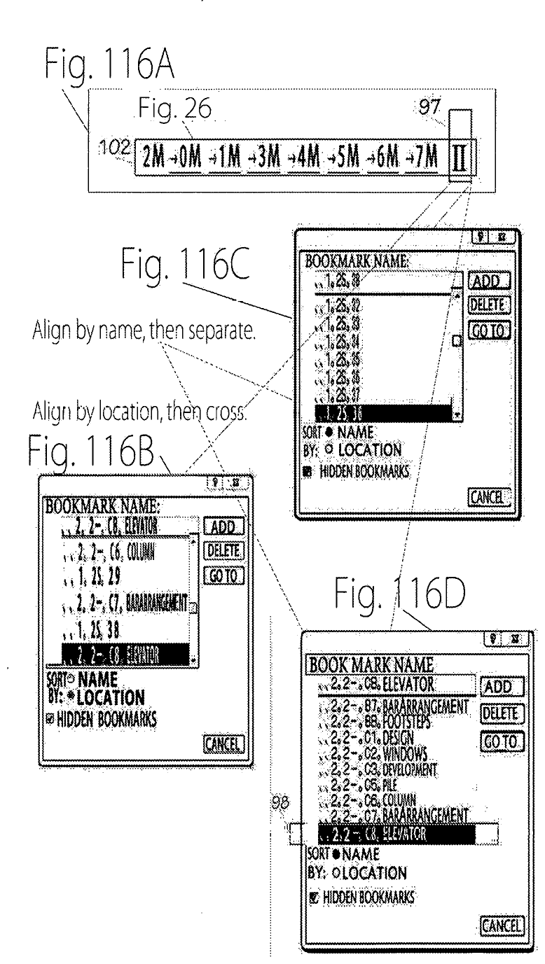

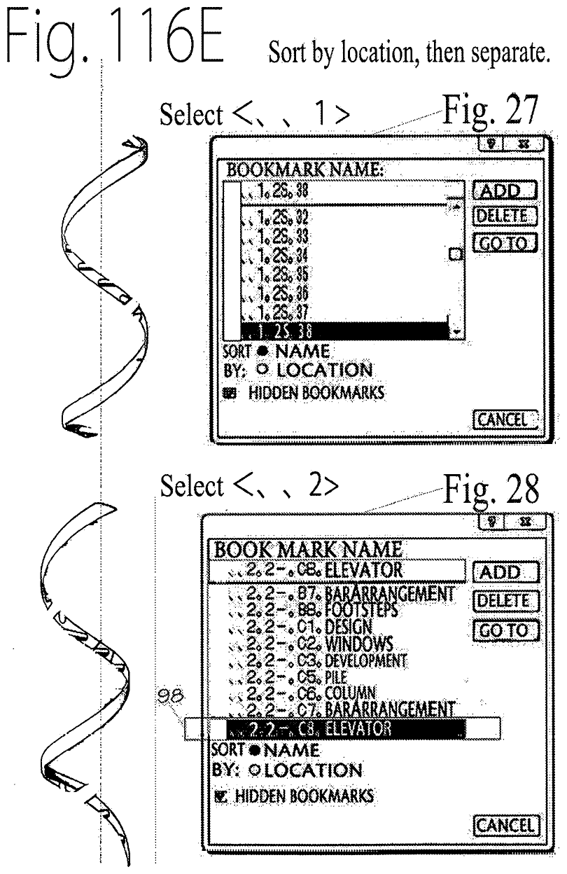

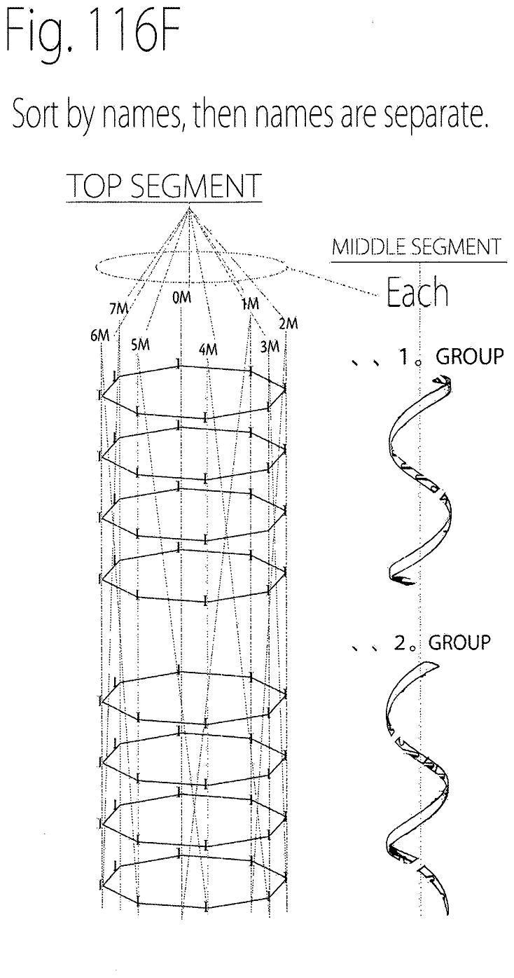

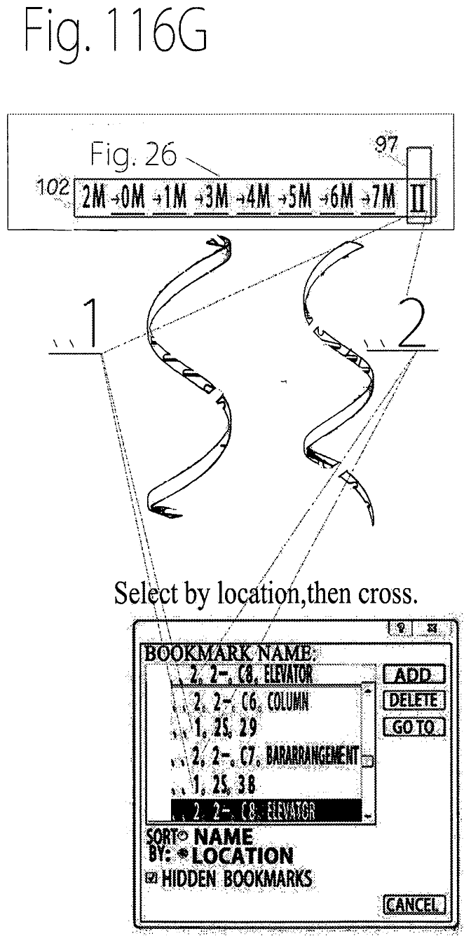

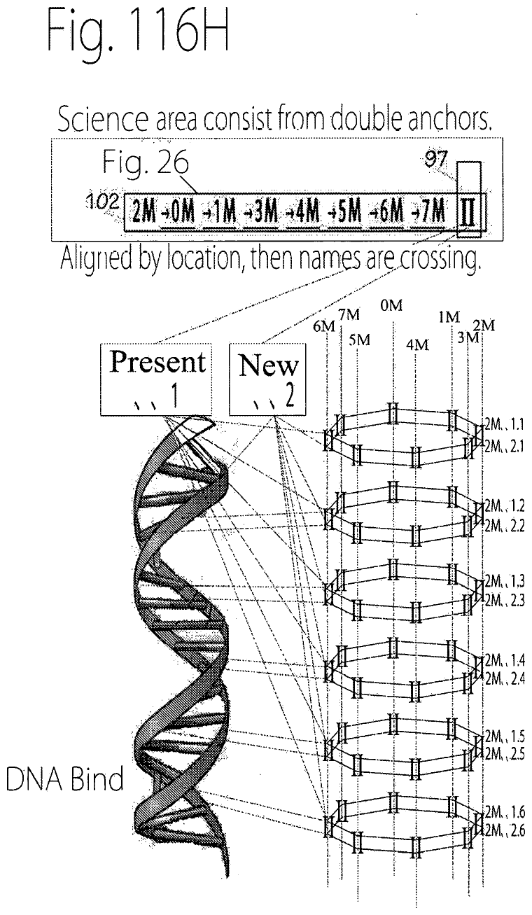

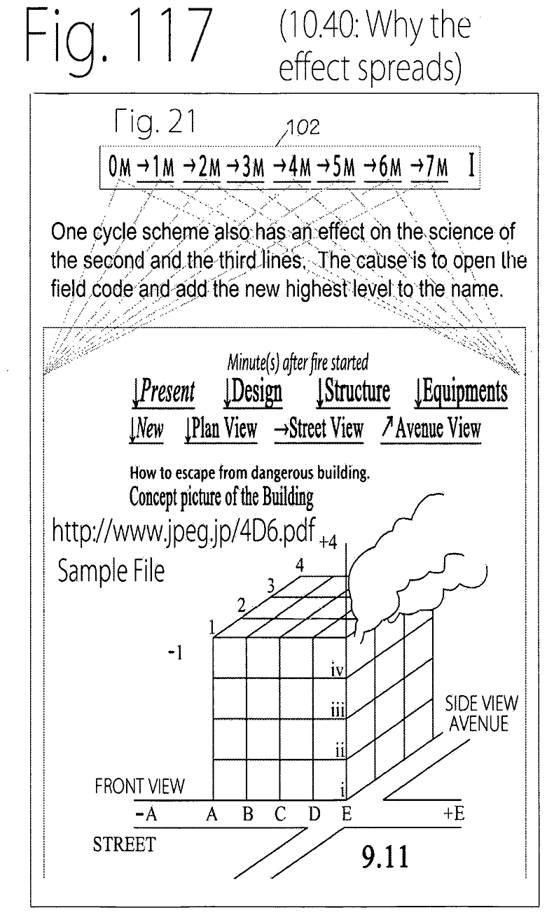

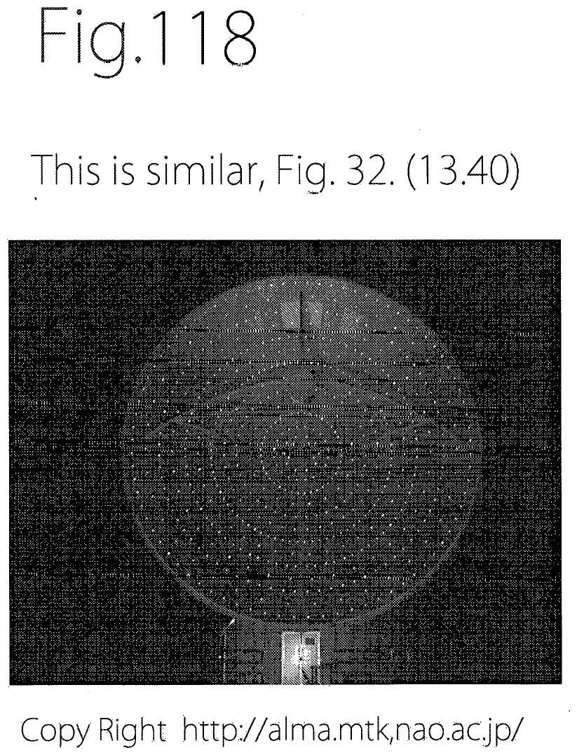

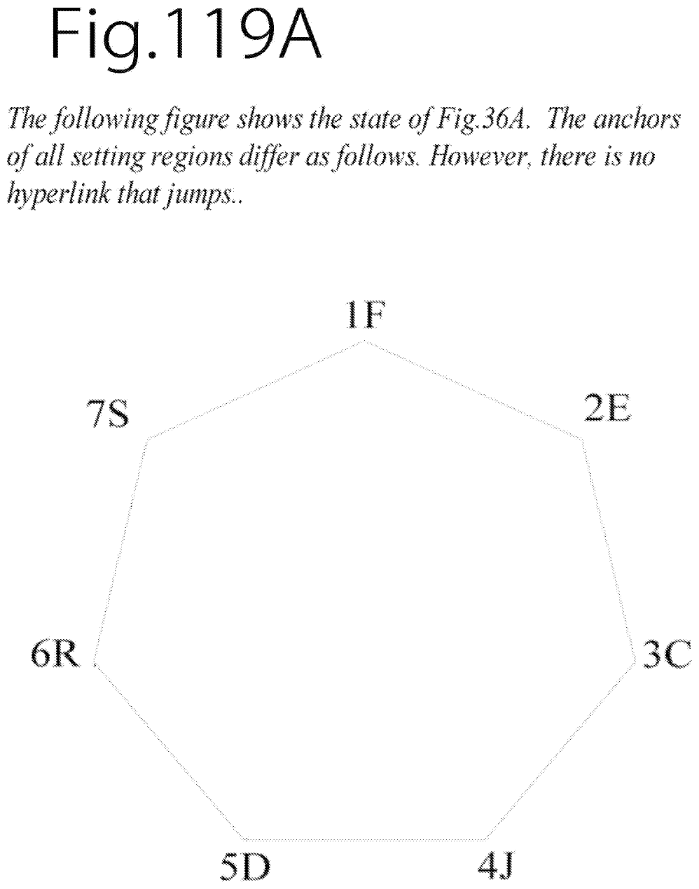

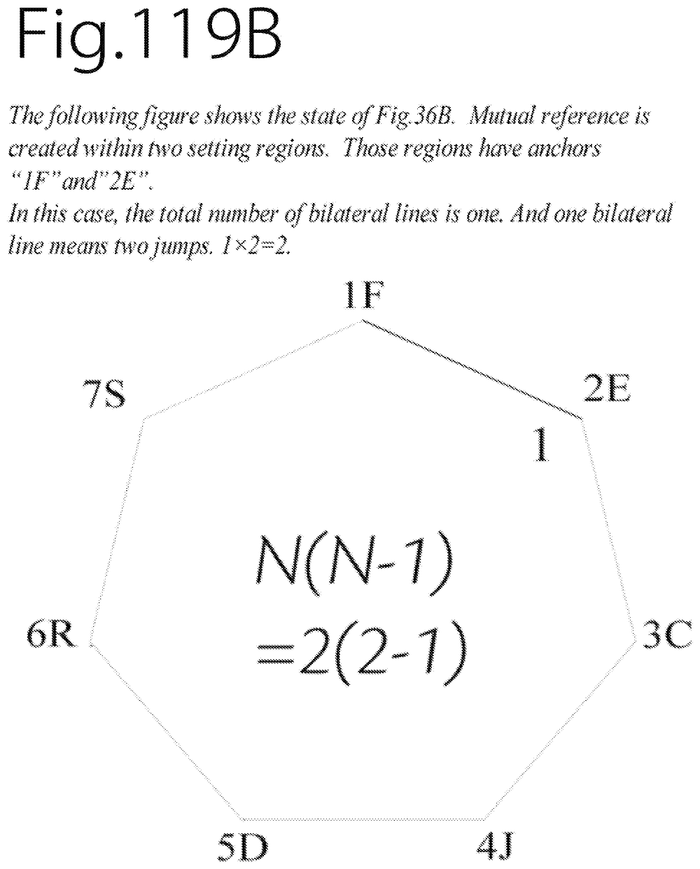

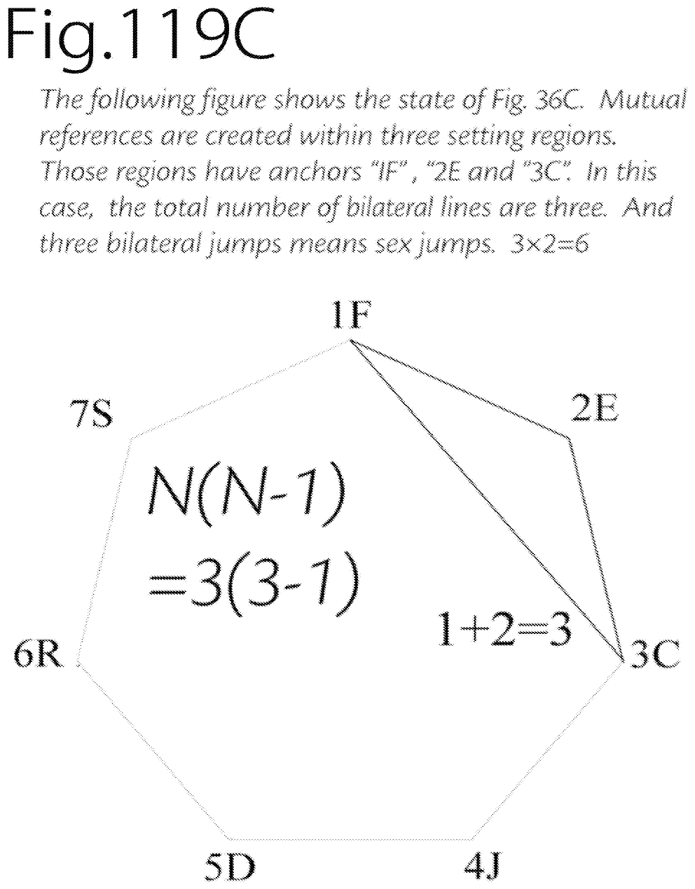

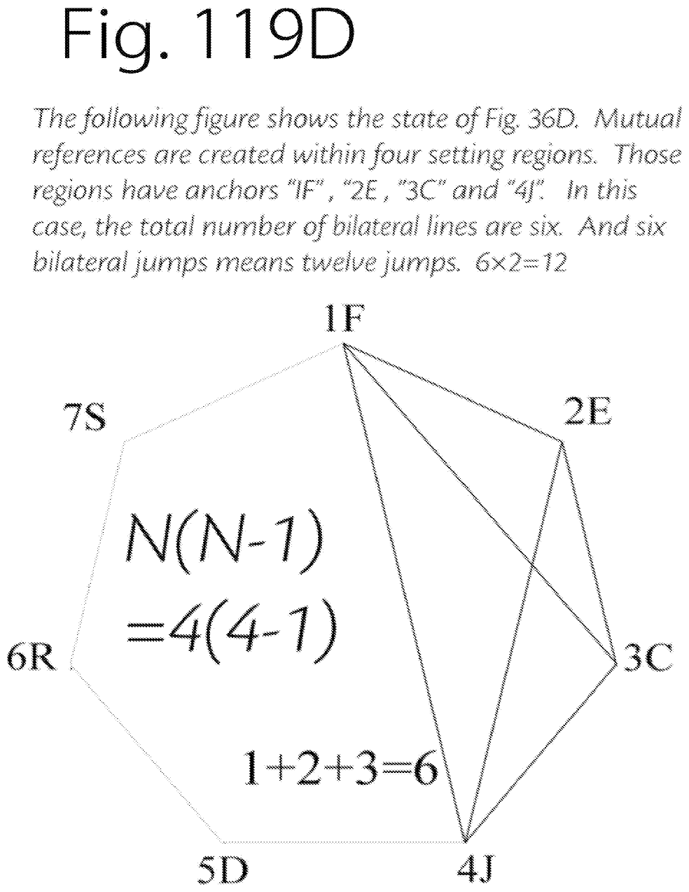

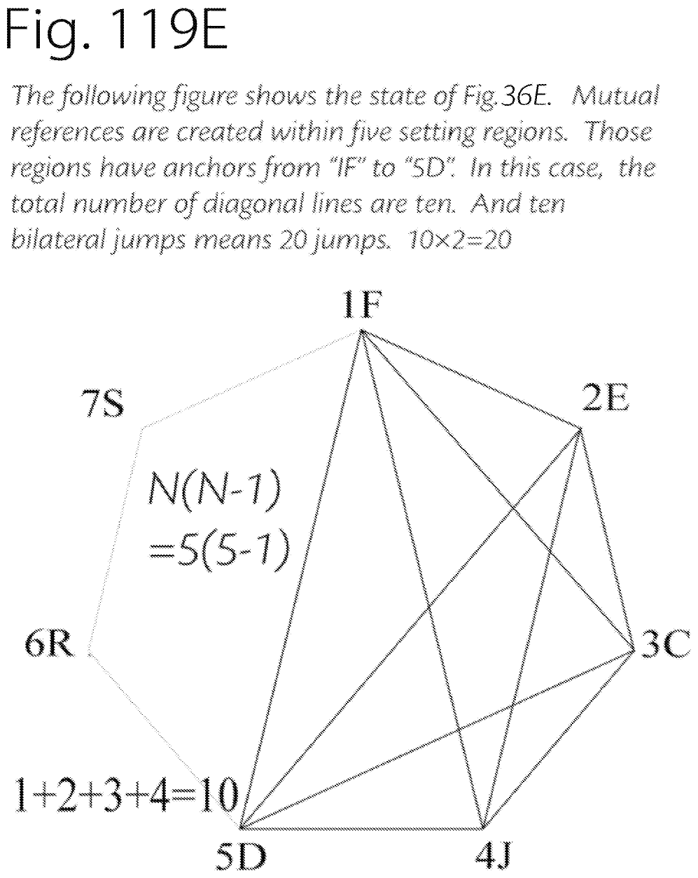

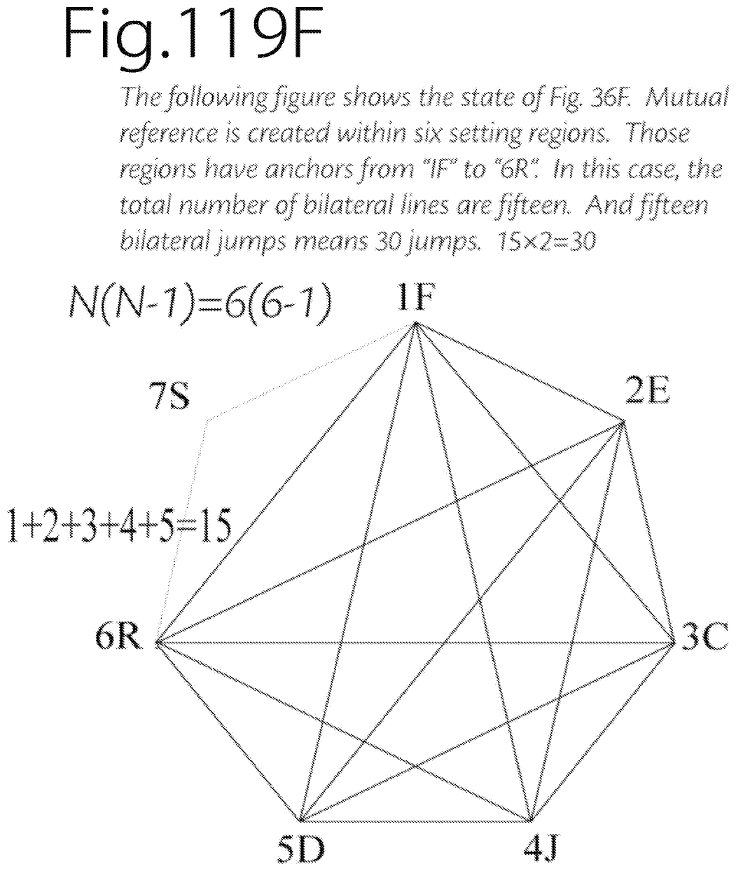

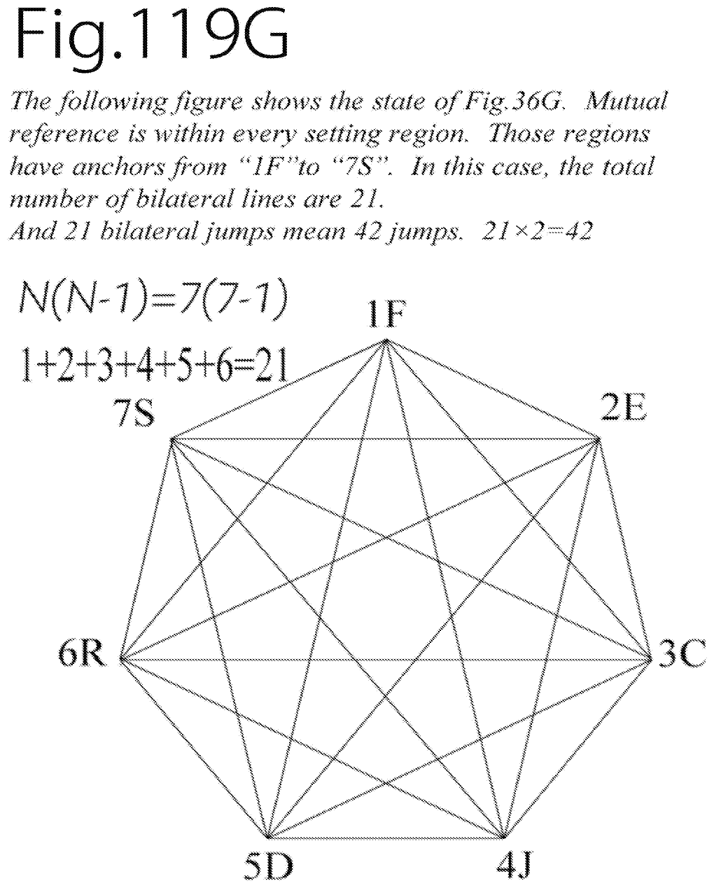

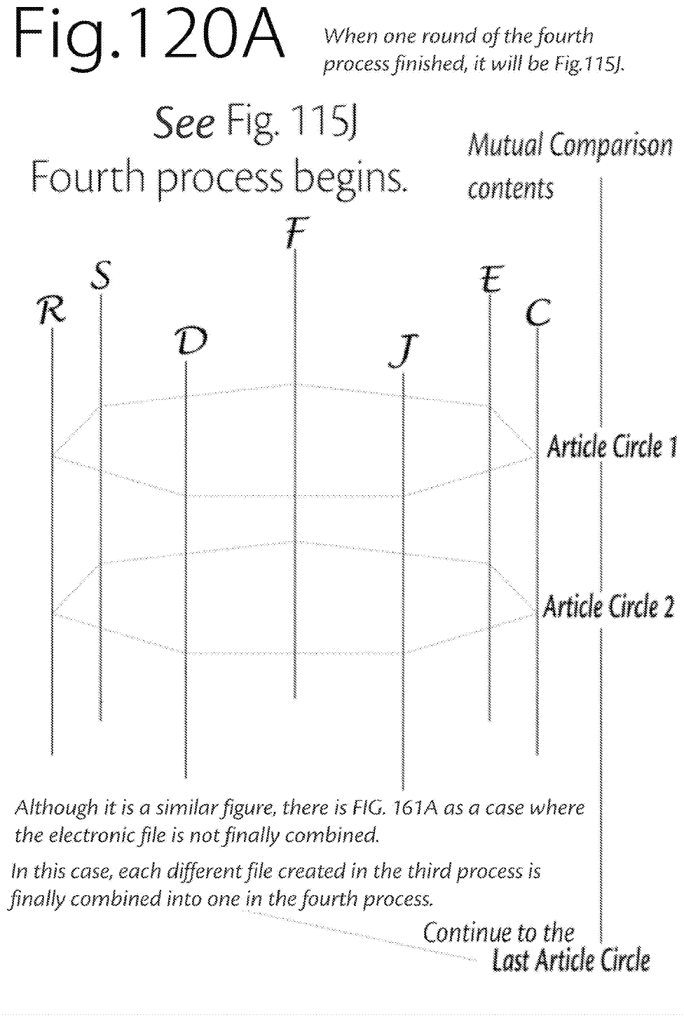

Configuration 16:
16. A non-transitory computer-readable storage medium executes to display the following results of the steps:
   firstly, in one electronic file, creating verbatim setting regions, which consist of the anchor and of the hyperlinks group, of which configuring to have same lower level segments of the names (e.g. Verbatim means the hyperlink from the second line onwards and its anchor in every B of FIGS. 66 to 114. is always constant. Here, it means that some characters are same, counting from the bottom),
   secondly, executing one-round replacement through the higher level segments of the names of the anchor and thereby generating a plurality of different electronic files (e.g. Change 1F to 2E under the top of FIG. 115J), and
   thirdly, adding a combination of a plurality of different electronic files, thereby, realize returnable multiply jumps between the verbatim setting regions which consist from the same lower level segments in one electronic file (e.g. FIG. 120G and FIG. 121G).

Configuration 17:
17. The non-transitory computer-readable storage medium for storing setting regions according to claim 16 having,
   wherein when the storage medium maintains a constant magnification regularity that the number of hyperlinks corresponding to one anchor is always the same ratio within the respective verbatim setting regions (e.g. The ratio between the hyperlinks and the anchor in FIGS. 66 to 114 is always constant),
   so that the hyperlinks enabled directly jumping to anchors existing in respective verbatim setting regions, and
   the cross reference is enabled directly between other anchors in the other verbatim setting regions in the same electronic file (e.g. FIG. 121G).

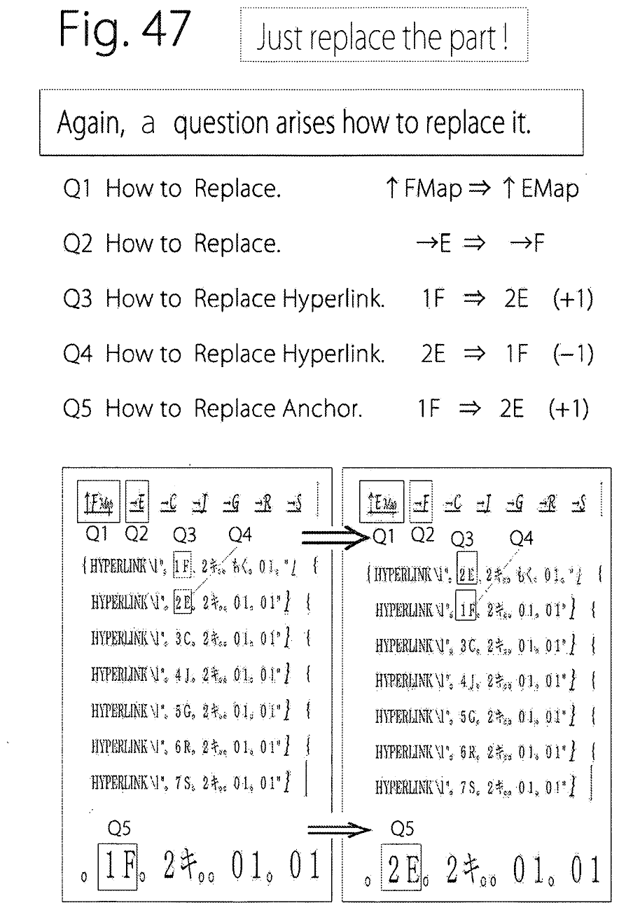

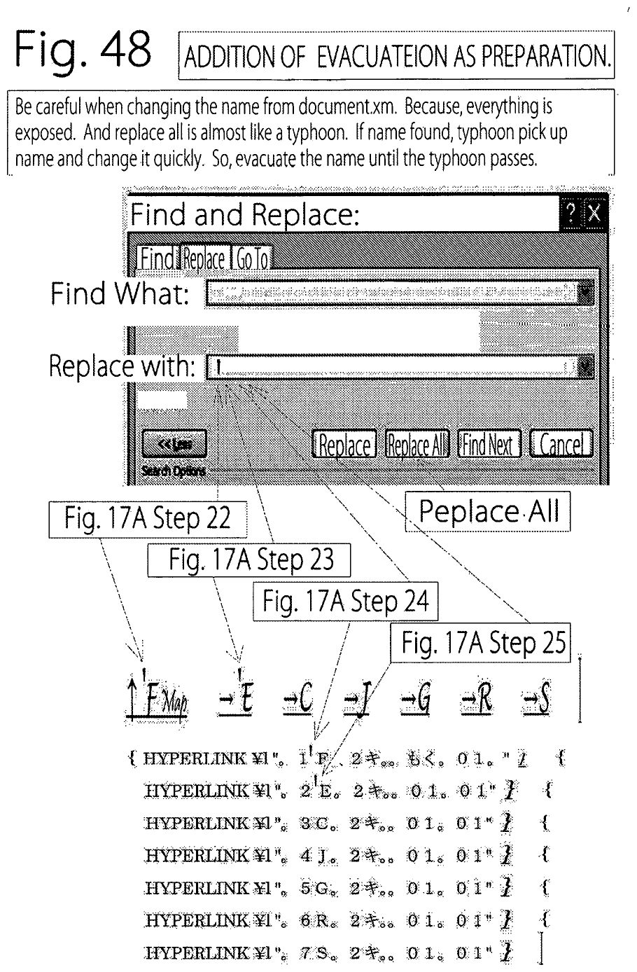

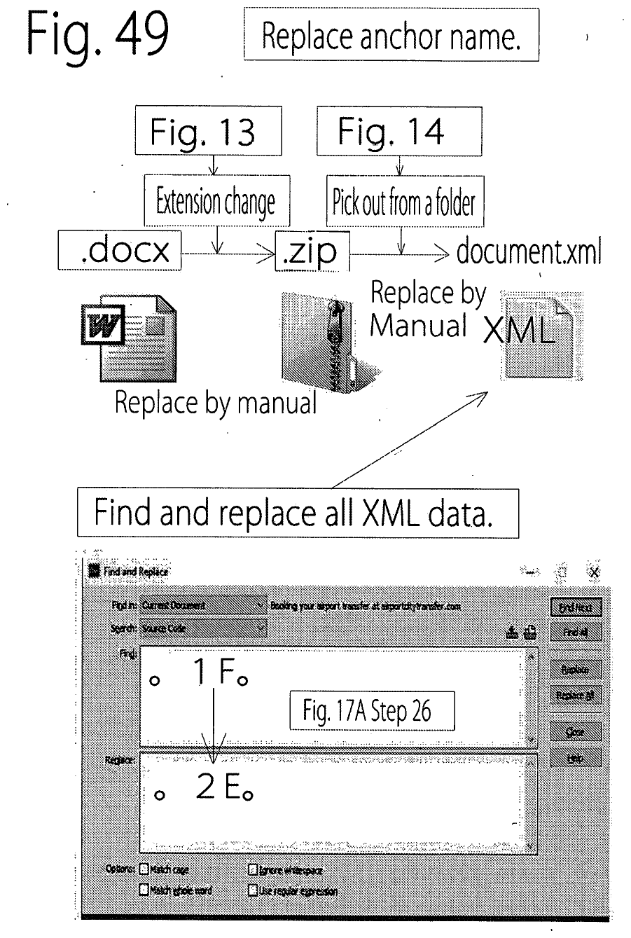

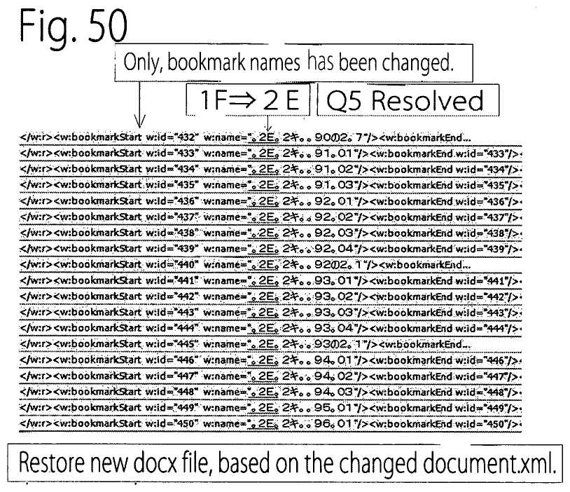

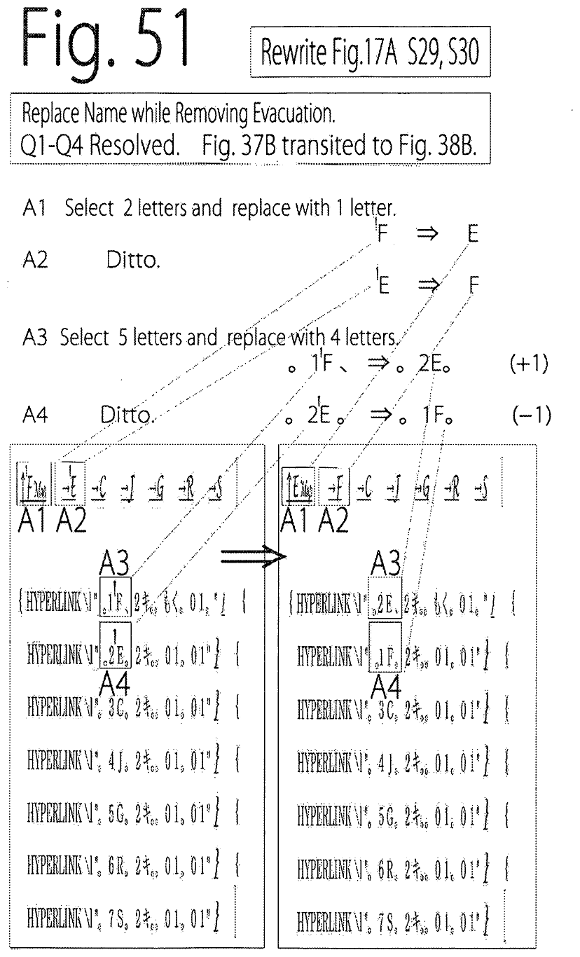

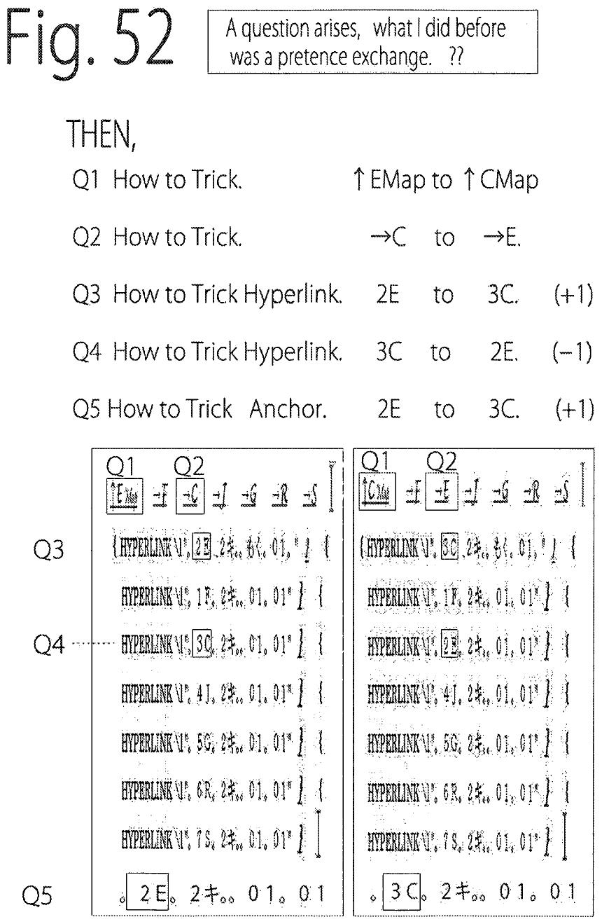

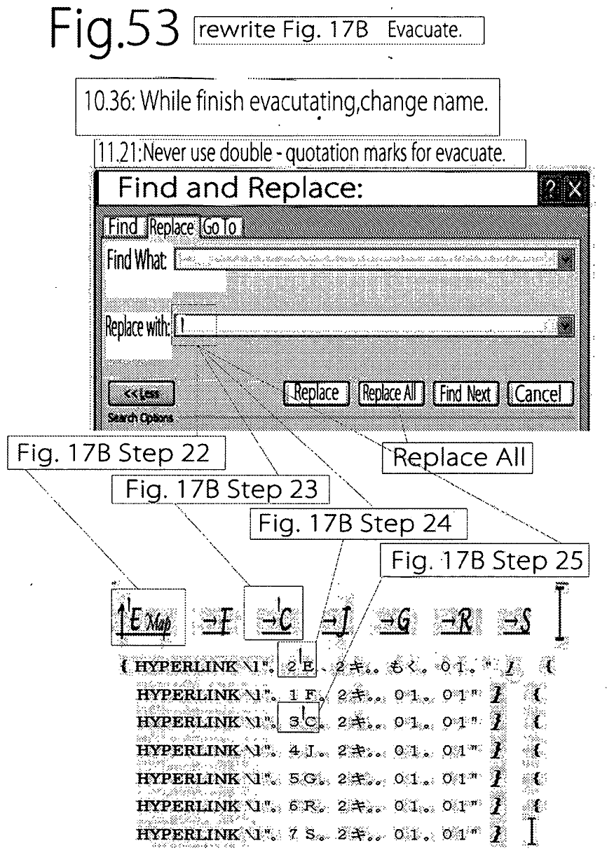

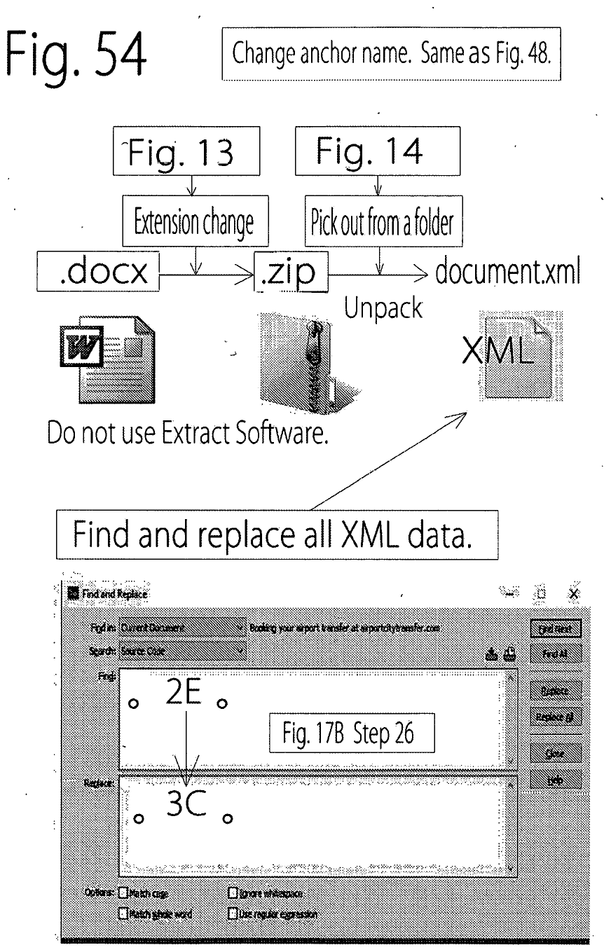

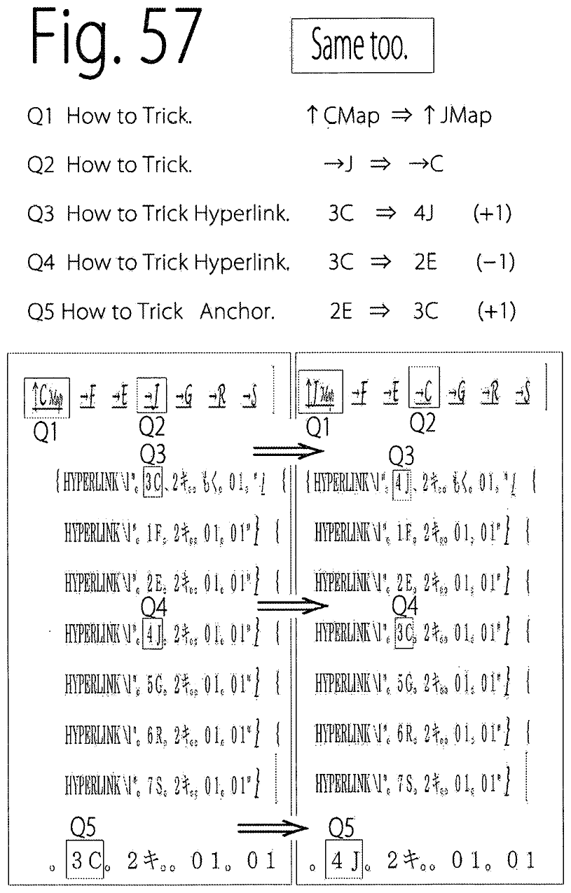

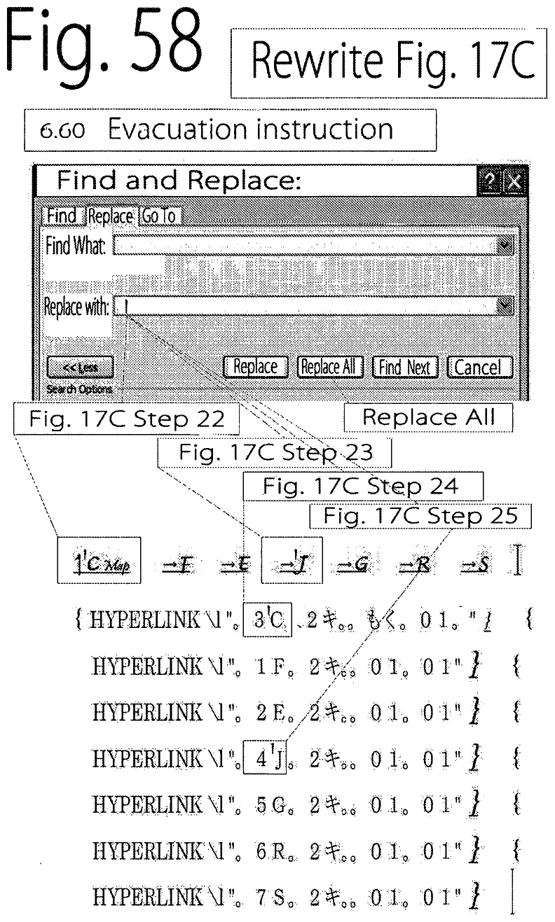

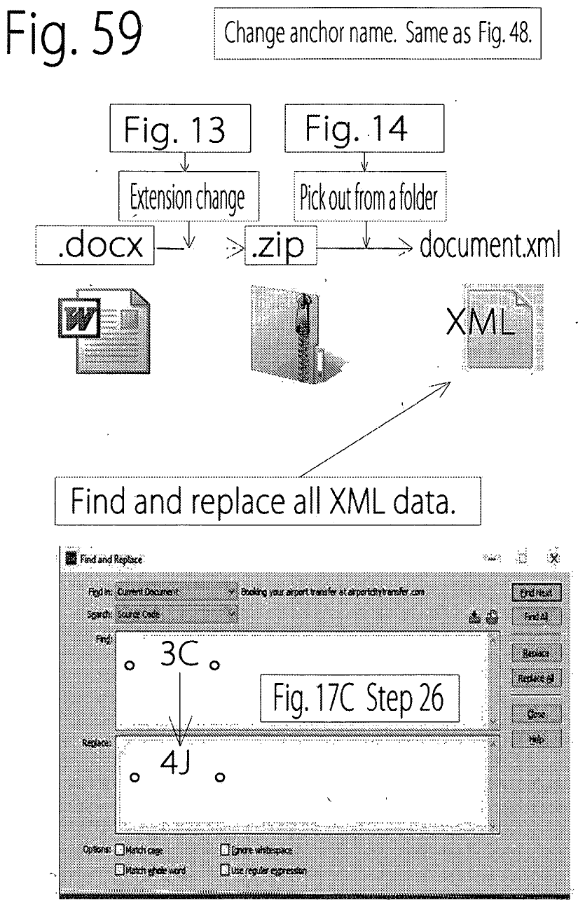

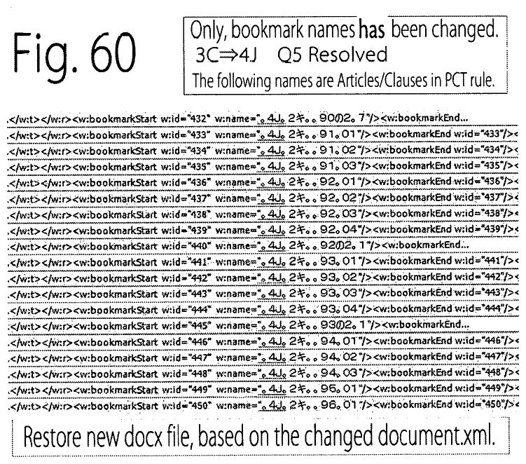

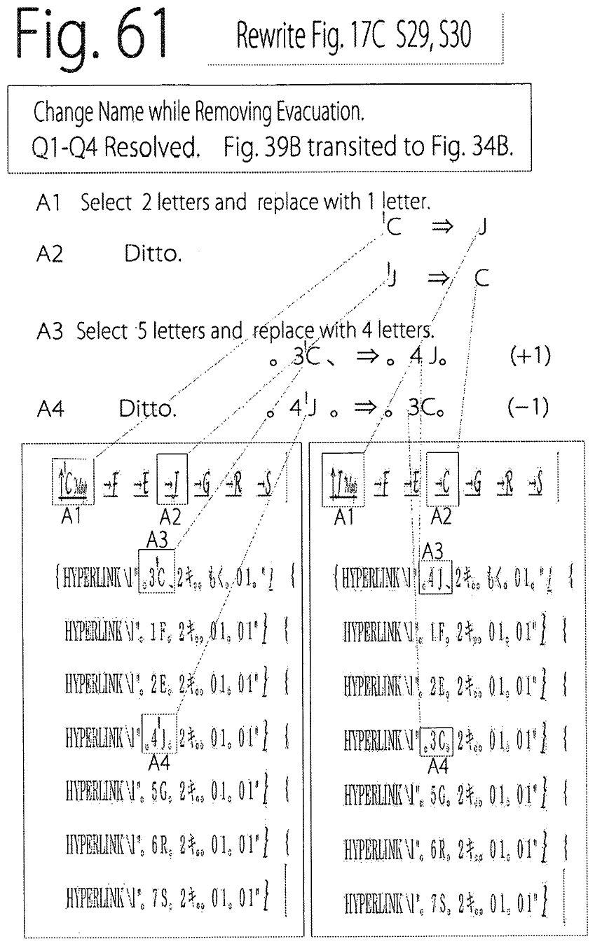

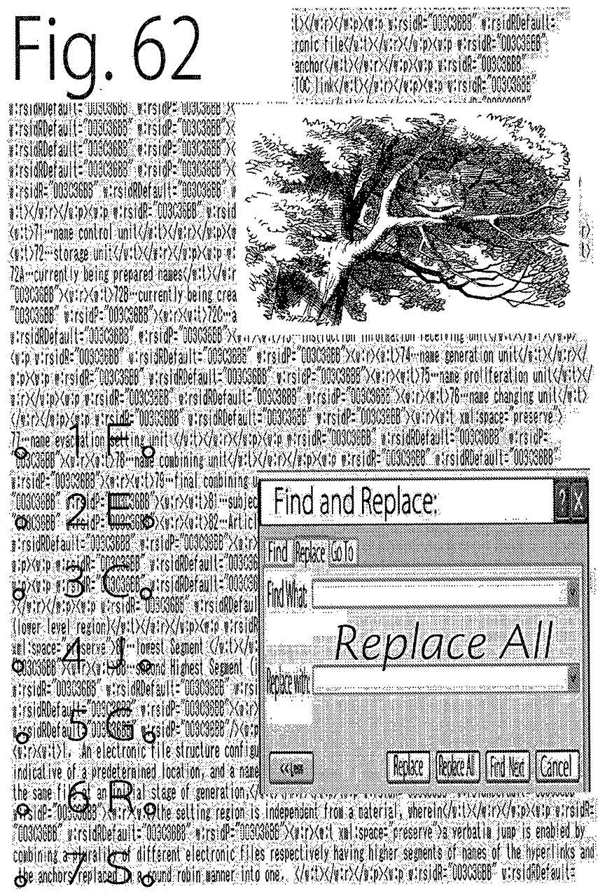

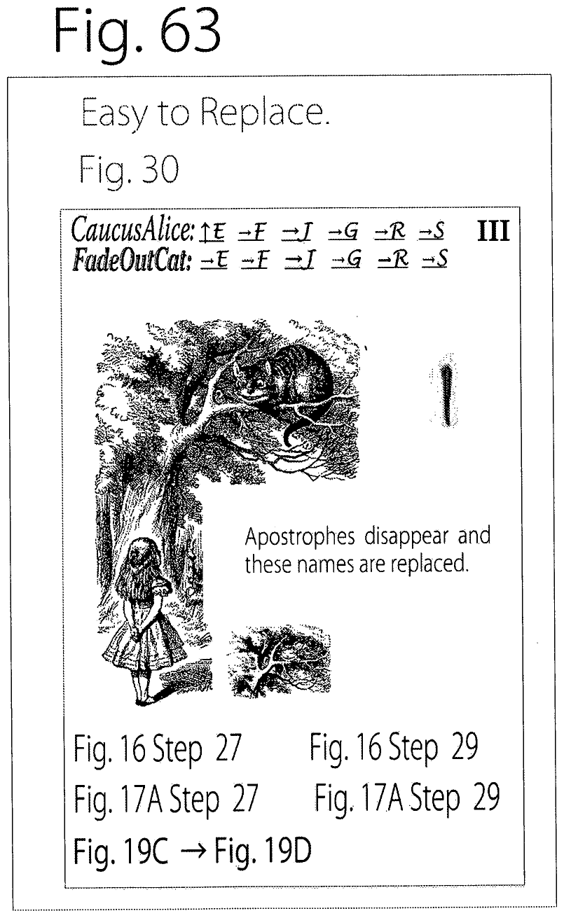

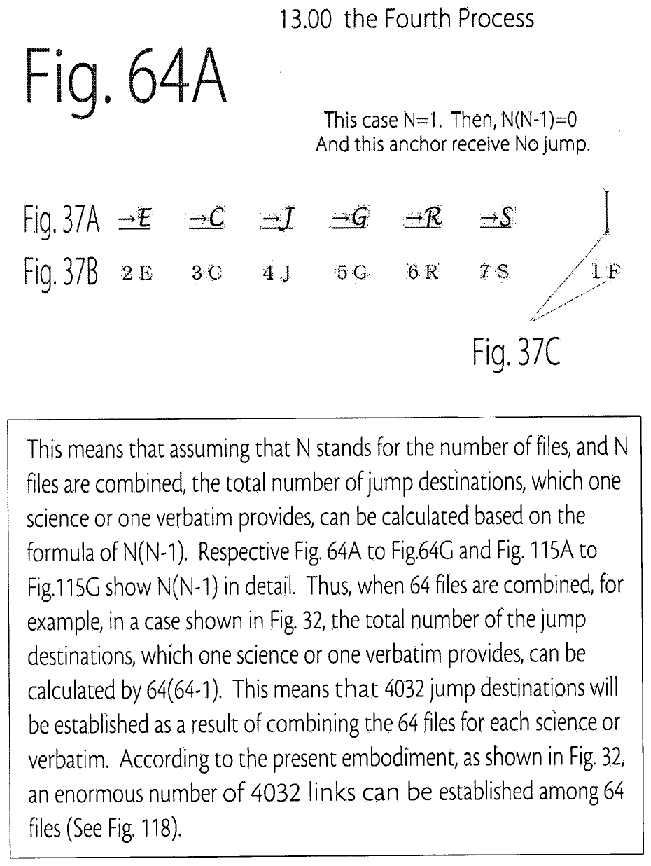

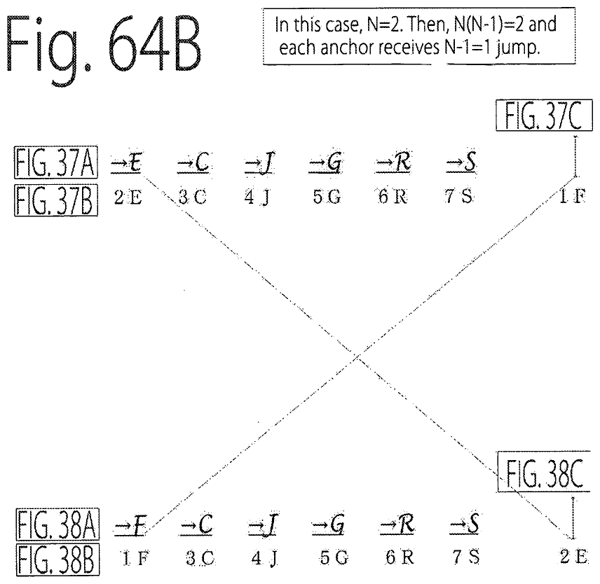

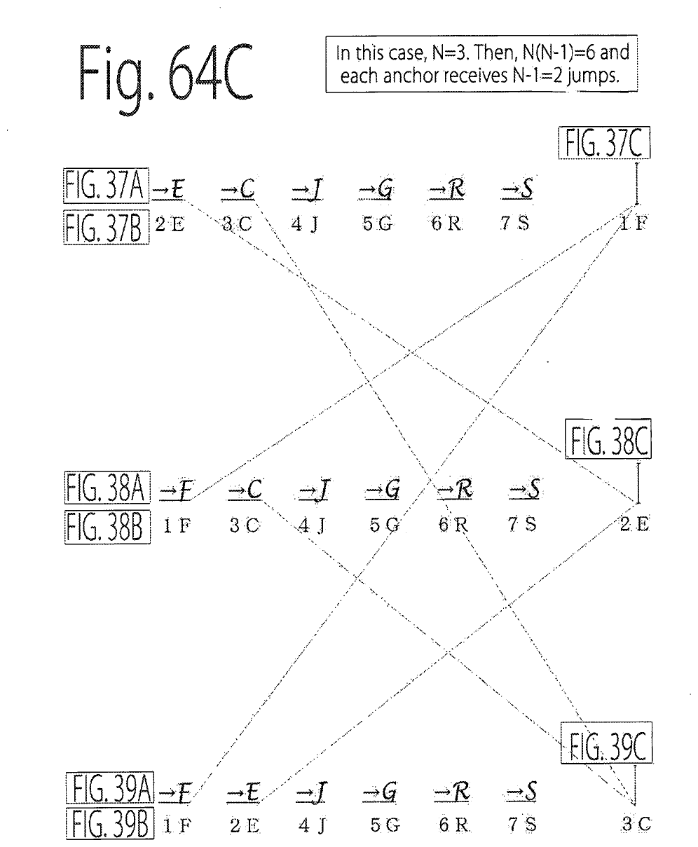

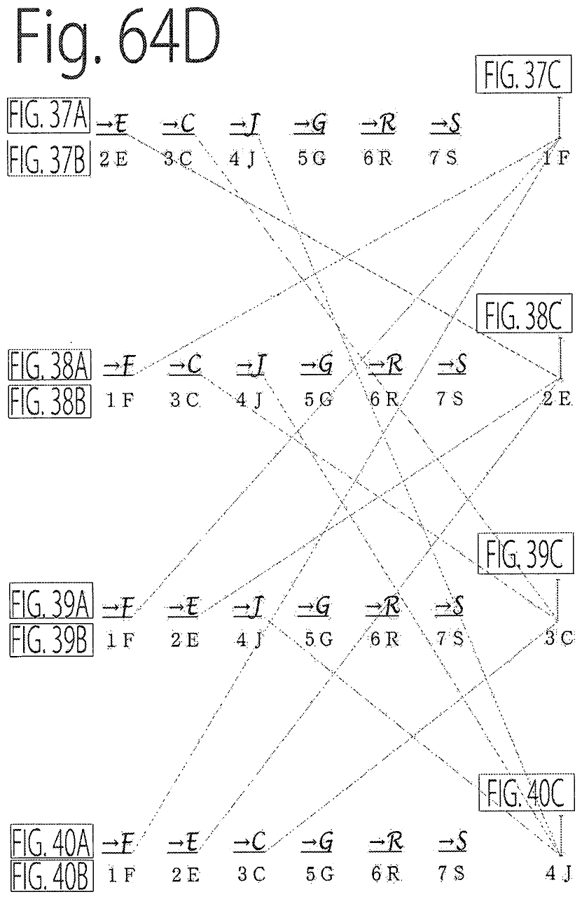

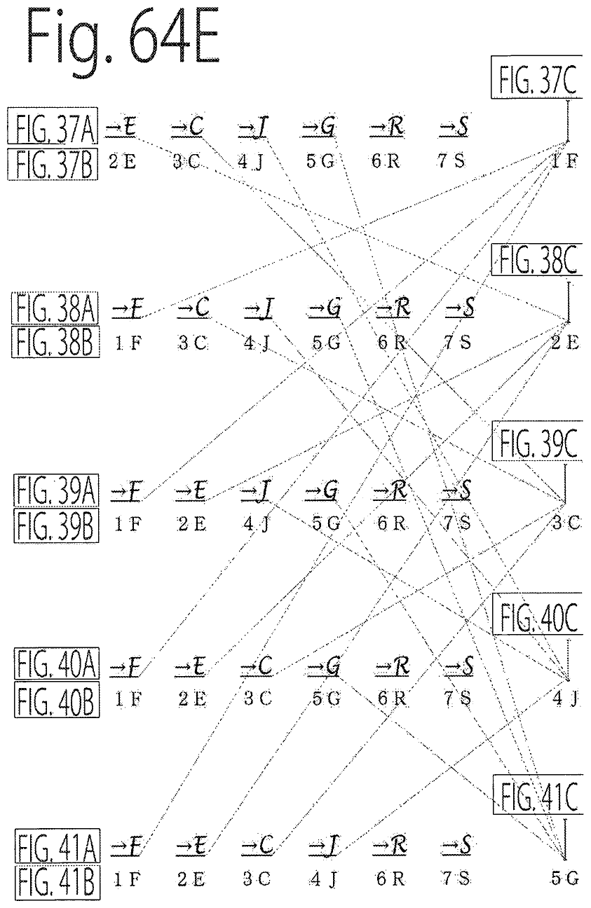

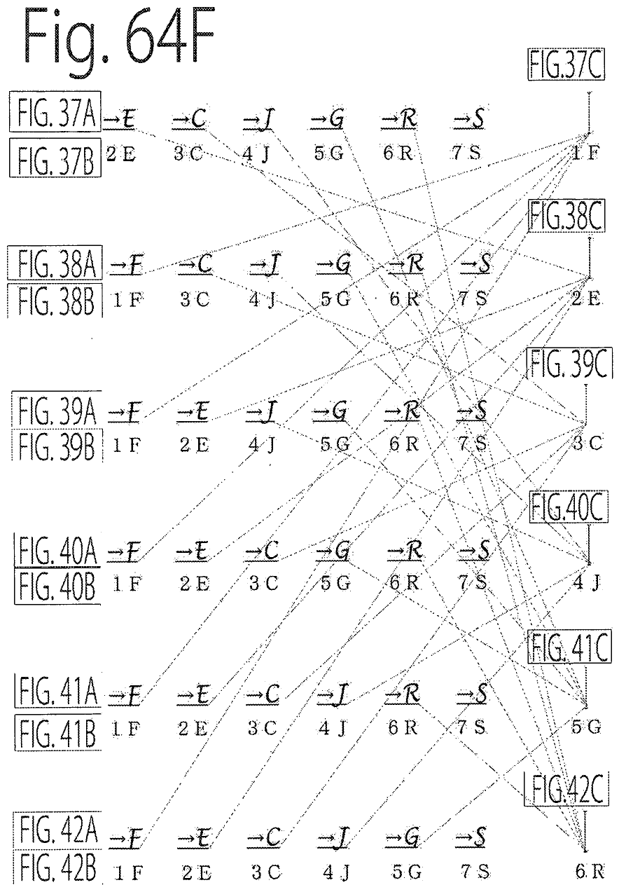

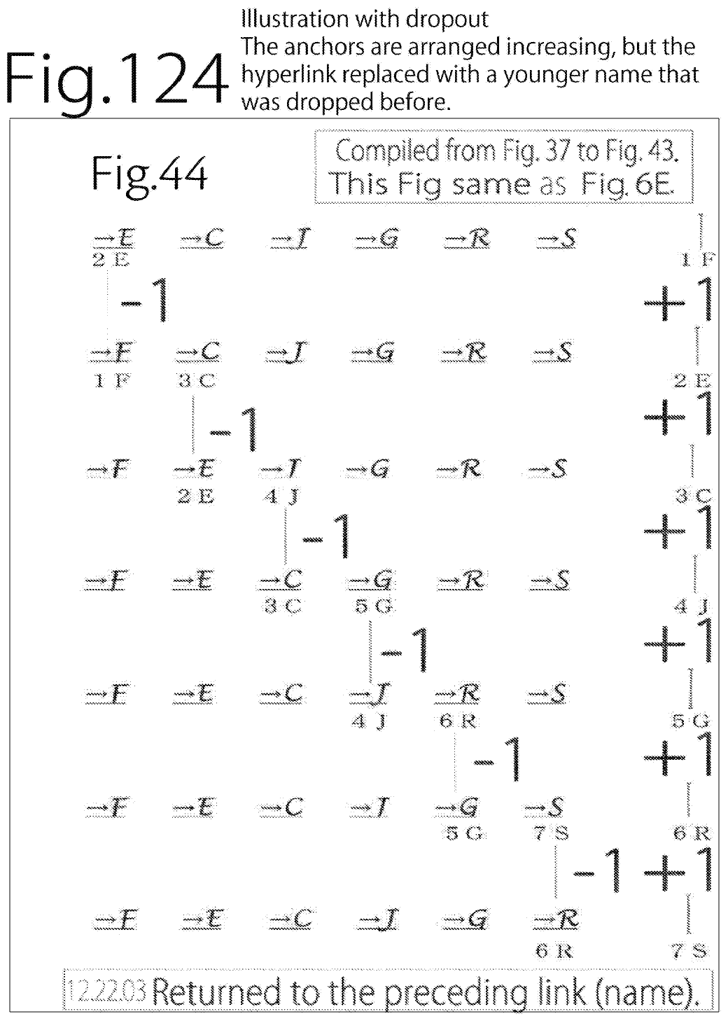

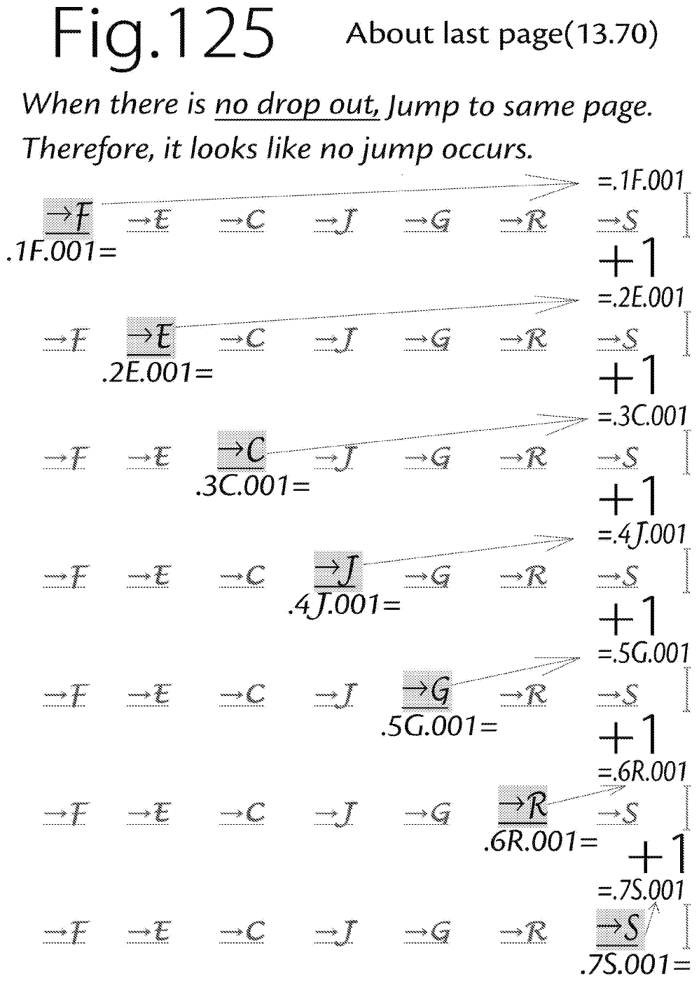

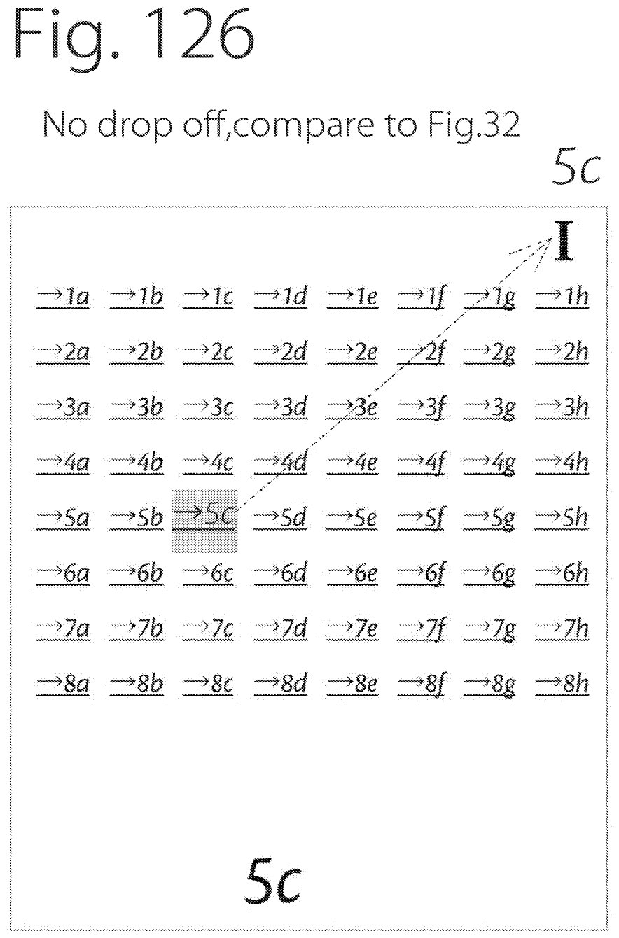

Configuration 18:
18. The non-transitory computer-readable storage medium for storing setting regions according to claim 16, further comprising,
   in the middle of several generation processes the hyperlinks group in setting regions are arrayed in the ascending order of the character codes (Lower left of FIG. 47, FIG. 52 and FIG. 57. The character codes mean the opening numbers attached to these hyperlink groups. Therefore, the first line is excluded because it does not belong to the hyperlink group) and replacing anchor to the increasing character code (Plus parts of FIG. 124 and FIG. 125), therefore, front-and-back relationship among the hyperlinks in the verbatim setting regions are not changed (Lower right of FIG. 47, FIG. 52 and FIG. 57).

Configuration 19
19. The non-transitory computer-readable storage medium for storing setting regions according to claim 16 further comprising,
   wherein, when the hidden names of the hyperlinks in the verbatim setting regions are opened from field code side, the character strings of the names of the hyperlinks are slipped down through a word-wrap function and
   wherein the column positions of the character strings of the names of the hyperlinks can be synchronized in the vertical and can be confirmed orderly aligned from the younger character code number (In all the diagrams B in FIGS. 66 to 114, the starting numerical values of the character strings at the beginning of the hyperlinks in the second and subsequent lines are all arranged so as to increase from a small character number to a large character number).

Configuration 20:
20. The non-transitory computer-readable storage medium for storing setting regions according to claim 16 further comprising replacement of the hyperlink with the following continuous iteration;
   firstly, drop off (The minus part of FIG. 44) the name of the hyperlink that become the same as the name of the anchor from the hyperlink group,
   secondly, after the character code of the name of the anchor has increased, restores the name of the hyperlink previously dropped off (The minus part of FIG. 44) from the hyperlink group.

### Advantageous Effects of the Invention

The present invention not only allows hyperlinks and anchors in electronic files to be automatically created but also allows them to be automatically created so that they execute the jumping function. For this purpose, the present invention provides infinite switches consisting of hyperlinks and anchors, which are industrial products, to the digital world. In retrospect, analog data is the long lasting sentence like the railroad, where hyperlinks are not present. It dominated human society for 2000 years. However, from now onward, the majority of sentences will be rewritten to simple sentences or graphics which refer to each other by the hyperlinks and the anchors. In that case, conventional documents and drawings are replaced with the controlled circulation by the hyperlinks. See FIG. 115H. Seven languages in 7,200 pages are easy to return, compare and deepen knowledge.

In a case of a law textbook, definitions, requirements, purposes, effects can be separated from each other, and hyperlinks combine these texts. Therefore, the description can be provided by dividing into a collection of definitions, a collection of requirements, a collection of purposes, and a collection of effects. These are linked with each other. And, the collection of definitions describing only definitions is used for memorization. Further, from the collection of requirements containing only the requirements, necessary and sufficient characteristics of the requirements can be compared and examined. Further, in explaining the purposes, only the collection of the purposes is described sequentially one after another. By using these, similarity and singularity on the different explanations of the purposes can be checked each other. Is the principle of regulation derived from the liberalism of the French Revolution? Or was it born as a provision based on the revision principle that distribution of profits cannot be done well due to free competition distortion? In explanation of the collection of effects, only the effectiveness portions are described over several ten pages sequentially. For this reason, attempts will be easily made to further think commonness and difference with and from other systems having similar effects. In this way, learning from varied viewpoints becomes easy. For this reason, the contents layout order of almost all law books will be replaced. Regarding comparisons between the amendment law and the before amendment law, instead of only two times, further many amendments can be compared to each other. The comparative law needs to make the difference clear. The history of law needs to make the difference clear.

For example, taking eBook as an example, this invention will change the way of reading, quickly switching using jump by hyperlinks. For this purpose, eBooks will be reformed to files in which data is written. Further, readers will compare data repeatedly. It changes reading so as to repeat as the data. It is natural that comparison reference leads to understanding. In other words, the popular eBooks are written so that readers can understand by reading character strings in sequentially and continuously like literature. However, the present invention changes document qualitatively to the database that allows readers to think while comparing and making references to data, by using hyperlinks.

The structured setting regions of hyperlinks and anchors according to the present invention can be created automatically, and as a result, the need to take much labor for the creation of setting regions one by one can be eliminated. In this case, as well, the present invention revolutionizes a display method. For example, classical displays of multinational treaties or conventions in multiple languages were handled by displaying a screen divided into left and right parts. However, the present invention revolutionizes database that enables replacing with contents in other languages, keeping one screen region as it is. Therefore, when used in smartphones launched in recent years, the present invention transforms paragraph to the database that can be compared and associated with different paragraph before and after jumping, by using one screen as it is not divided, and overcomes the defects of small displays. From here, index numbers, from 0.00 to 13.70, will be used in place of paragraph numbers since close cross-references can be made efficiently, which help readers to understand better.

### Definition

### 0.00: Definition and Precondition; Names

Hyperlink name refers to a name that is described in a hyperlink. An anchor name refers to a name that is described in an anchor. Then, if the names are the same, the name described in the hyperlink makes one-way jumping to the name in the anchor.

### 0.10: Definition; Naming Rule

The naming rule in a narrow sense is to create an anchor name to give the younger character code to the younger page. Therefore, if the names are separated from the contents, alignment is the same in the order of the character code. This rule stems from performing a mistake-free combination with the name of the anchor. In the following, the naming rule of anchors described as the naming rule as an abbreviation. Also, the naming rule in a broad sense defines that the names in the location order are that the contents suggest even if the names are placed in the locations to make mistake-free combinations. For example, Japanese one two three means 123. However, if they are arranged from young character codes, they are continuous with firstly comes one, secondly comes three, thirdly comes two. The anchor A in the setting region 4 of FIG. 1 is based on the naming rule. There is a case that a name in a narrow sense and a name in a broad sense are mixed in one file. In that case, it is only necessary for each of them to fulfill its function, so it is not a relationship to exclude opponents from each other.

### 0.20: Definition; Hyperlink

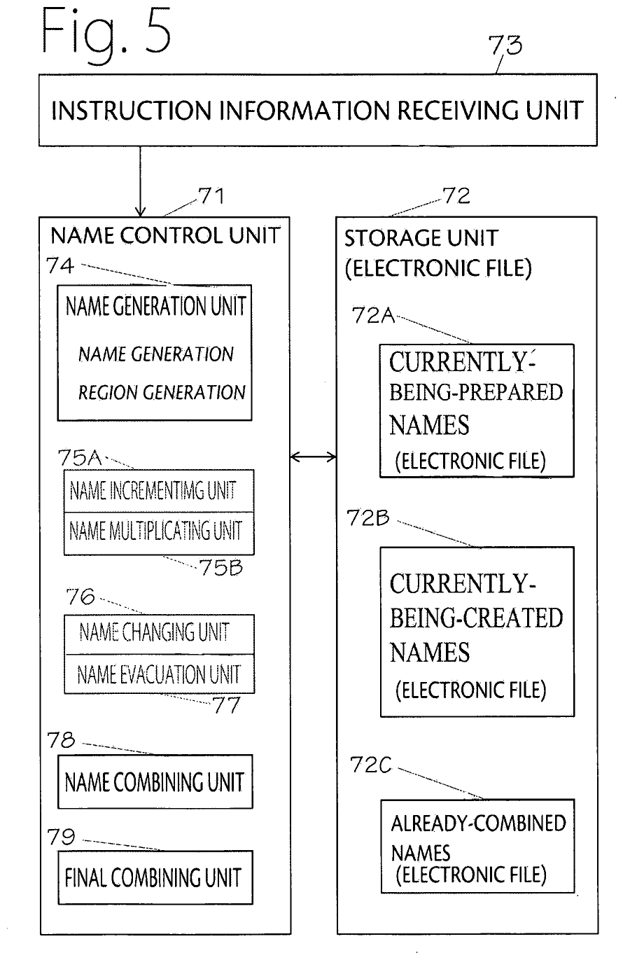

The name of the hyperlink is usually the same as the name of the anchor already existed in another electronic file beforehand and jumps to the name of its anchor. In another case, especially when jumping is to the same file, the names of both are the same. These are called as inside link. However, in the case of the following hyperlinks, hyperlinks are not yet associated with the predetermined jumping places in the same electronic file. These hyperlinks cannot jump because there is no anchor. These are defined as a hyperlink in a broad sense. Of course, a hyperlink in a broad sense will be the files that are combined at the final combining (79 in FIG. 5). At the time, an anchor with the same name of the hyperlink is set in the same file; it becomes the hyperlink of a narrow sense. That will jump.

### 0.30: Definition; Verbatim

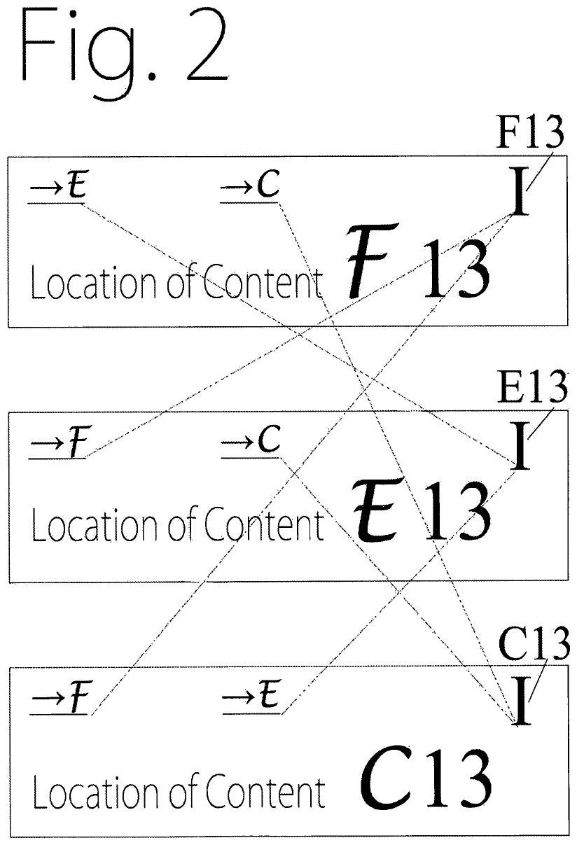

As shown in FIG. 2, on the other hand, anchors are one after another described in the order of written contents, while hyperlinks are similarly written in the order of the written contents. In such a case, verbatim refers to an arrangement portion (the setting region A in FIG. 1) of an anchor and hyperlinks follow the naming rule that allows both to jump, between respective locations sequentially. At this time, the hyperlinks (the setting region 5 of FIG. 1) of verbatim are referred to as a hyperlinks group. For example, in this application, verbatim refers to setting regions in which jumps are made sequentially between individual Articles/Clauses among different languages. It means verbatim is for reference sequentially between different Articles/Clauses.

### 0.40: Definition; Science, Abstract Link

In this application, a part (“\hat{ }|FMap” in the example in FIG. 1) that is indicated in the first setting region B of the setting region 3 in FIG. 1 is named as an abstract link. Further, the setting region that begins with an abstract link and ends with an anchor is described as science (the setting region 3 in FIG. 1). (Abbreviation symbol \hat{ }| is written in FIG. 166.)

### 0.41: Function; Science, Abstract Link

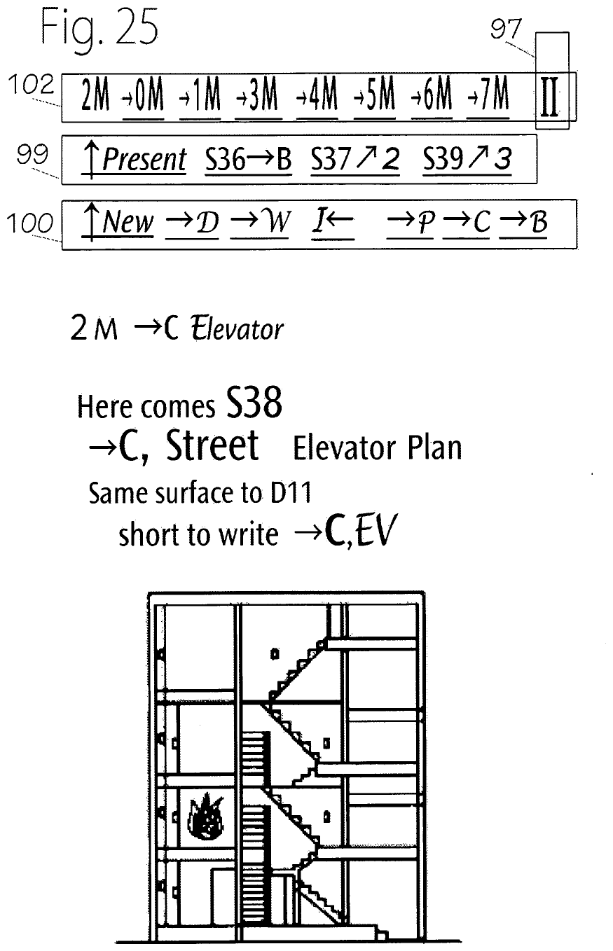

A verbatim is a part where to perform a comparative examination of related files while maintaining a system architecture, and an abstract link is a part where to condense the comparative examination and to abstract and sublime a selfdescription part. At this point, two or more tables of contents having different systems may be further created in one file. In the case, each of the anchors A that receive jumping from both systems, of which configuration is describe science in a narrow meaning. For example, the region 97 in FIG. 25. Science in the narrow sense tries to explain the function that contributes to the replacement and the comparison between the different systems through the hyperlinks through its jump. This is because all sciences used for replacement of systems and comparative examination.

### 0.42: Function; Science

Hereinafter, however, only sciences will be described, and therefore verbatim may not be consciously described. This is only because duplication of description is avoided since a science illustrated in the setting region 3 obviously includes therein a verbatim illustrated in the setting region 4.

### 0.43: Function; Circulation Structure of the Abstract Link

The TOC switch of Non-Patent Document 2 is a jump from the table of contents for the contents. However, the abstract link of the present application is a jump back from the content items to the table of contents. For example, the abstract link is described in Step 7, Step 8 of FIG. 7 of the present application. However, when both of them are equipped as an eBook, a circulation structure is produced in one book.

### 0.50: Definition; Link, Symbol

Furthermore, links illustrated in the setting regions 6 through 11 are referred to links 1 through 6, respectively. In the case of the example in FIG. 1, “-->E” is a link 1, “-->C” is a link 2, “-->J” is a link 3, “-->G” is a link 4, “-->R” is a link 5, and then “-->S” is a link 6. There is the one in a state where a hyperlink is not set up. It may be referred to as “symbol”. (Abbreviation symbols are written in FIG. 166.)

### 0.60: Definition; Apparent, Hidden

From now on, when a wording “apparent” is used, it indicating a displayed side when the corresponding MS Word is opened in an ordinary method, in a state of the extension called “docx”. When a wording “hidden” is used it indicating, a displayed side when an electronic file in “docment xml” state is opened, an edition state of a field codes side is opened, or a readable side when a bookmark icon is opened.

### 0.70: Definition; Apparent, Hidden; Definition of Name is Described in 0.00

The name from the field code side is described as a hidden name. :<.>:<..>:<,,>:<,>: If they are a display when an electronic file in document xml state is opened, same too. Conversely, names seen on front sides of the hyperlinks are described apparent names, and may sometimes be simply written with arrows attached. Like “\hat{ }|F”,“-->E”. (Abbreviation symbols are written in FIG. 166)

### BRIEF DESCRIPTION OF THE DRAWINGS

### 0.81: Drawings FIGS. 1 to 5

FIG. 1 is a diagram illustrating setting regions of an electronic file according to an exemplary embodiment of the present invention.

FIG. 2 is a diagram for briefly explaining jumping of hyperlinks in a setting region 4 illustrated in FIG. 1.

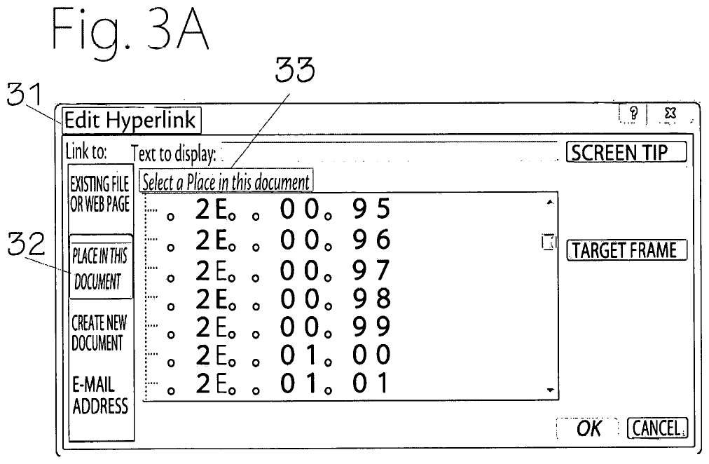

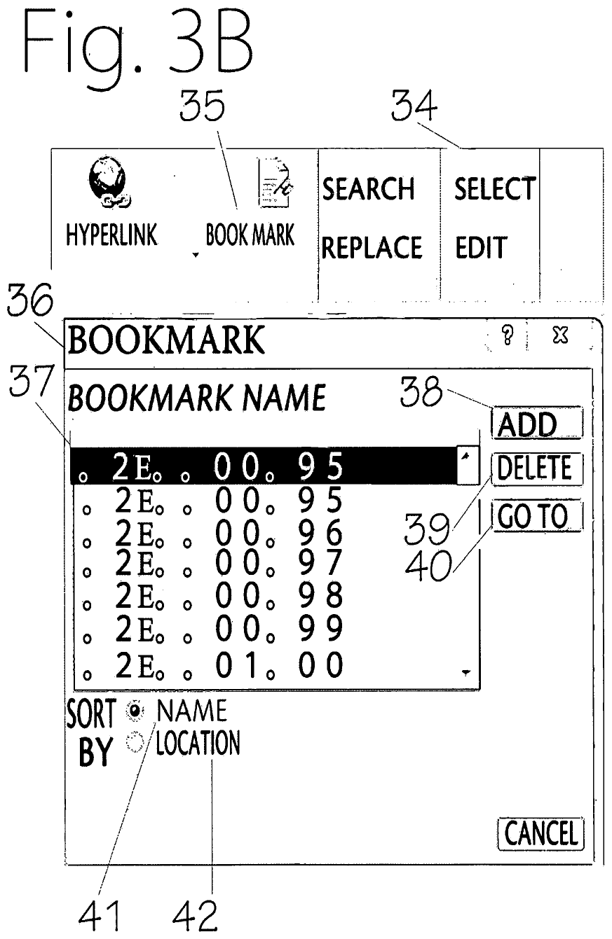

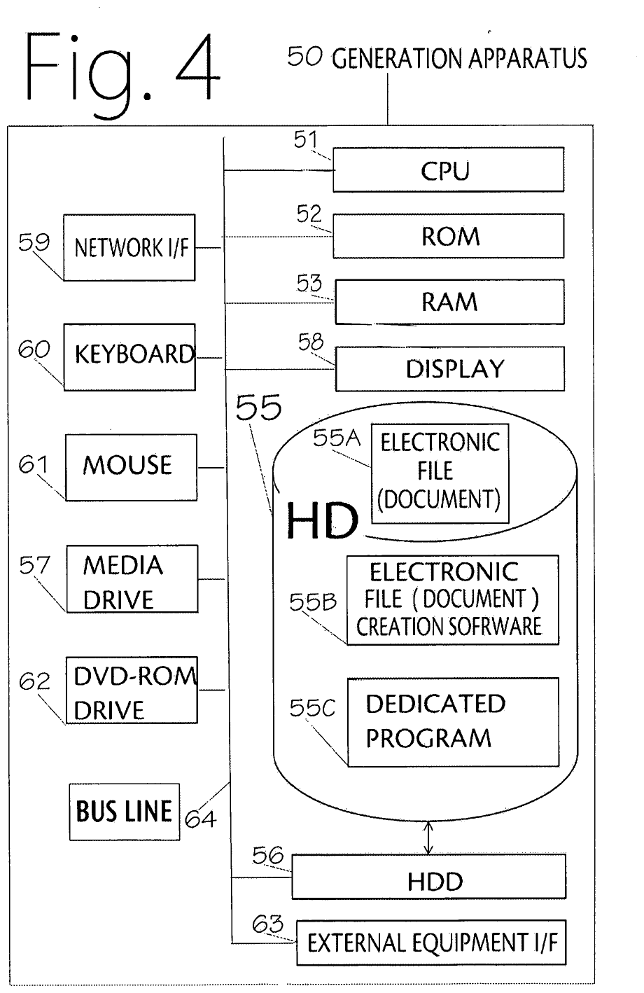

FIG. 3A is a diagram illustrating a hyperlink edit screen.

FIG. 3B is a diagram illustrating an edit screen of bookmarks (anchors) on MSWord.

FIG. 4 is a diagram illustrating a hardware configuration example of the electronic file generation apparatus that generates an electronic file 1, being the region 1 of FIG. 1 described in FIG. 1 and FIG. 3A to FIG. 3B.

FIG. 5 is a diagram illustrating a functional configuration of an electronic file generation apparatus according to an exemplary embodiment of the present invention.

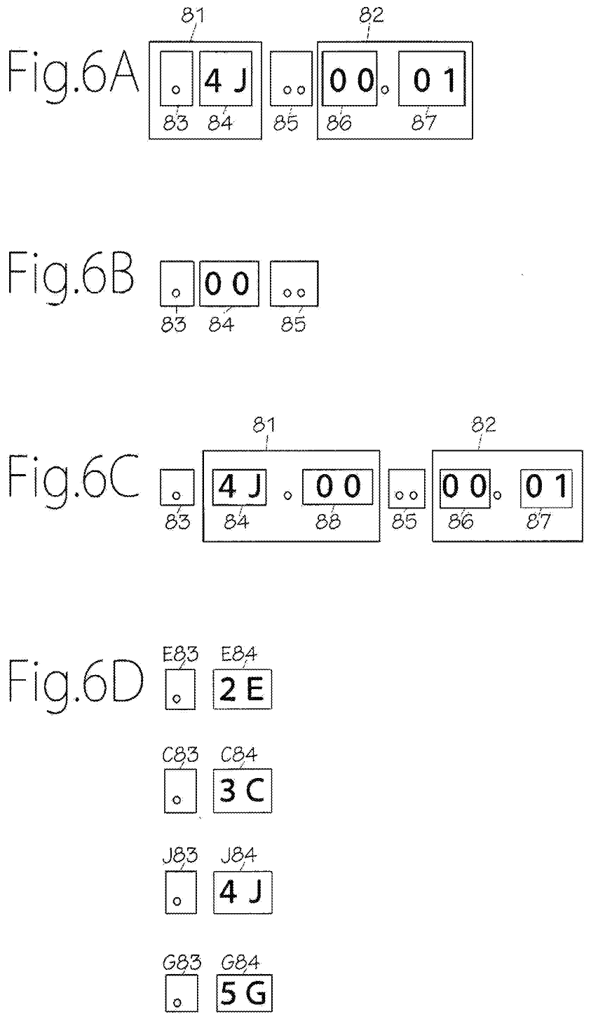

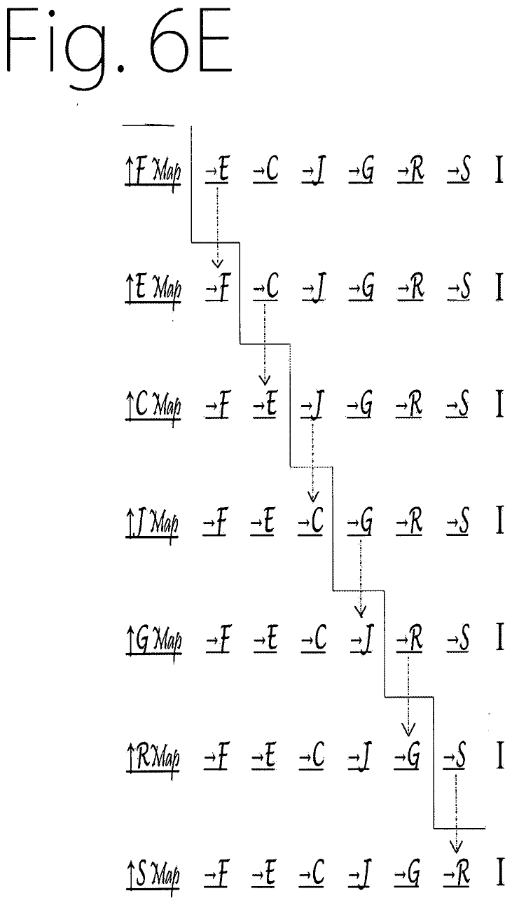

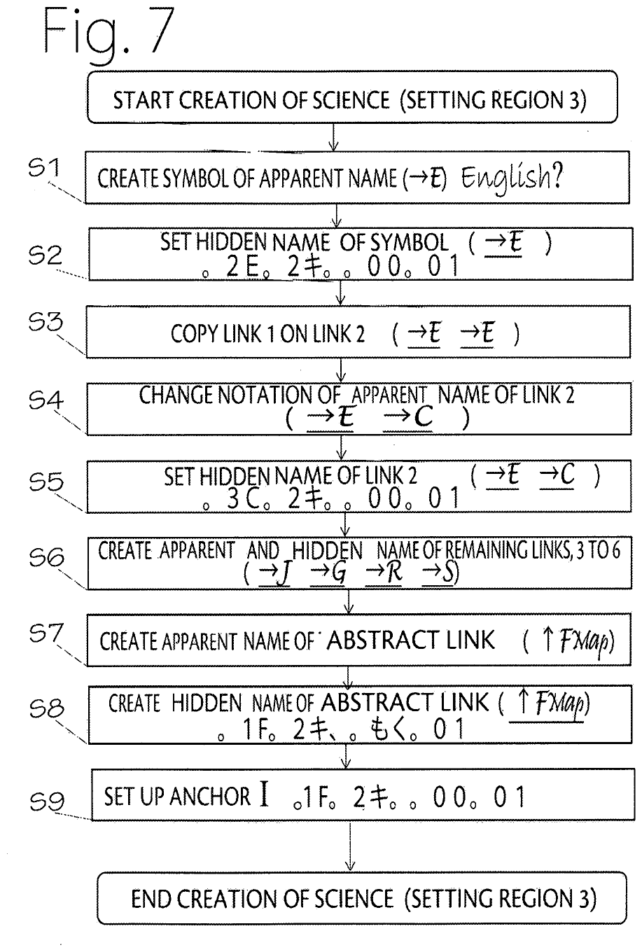

### 0.82: Drawings in FIGS. 6A to 6E

FIG. 6A is a diagram illustrating respective segments in the name of an anchor and field code side (hereinafter simply referred to as “hidden side”).

FIG. 6B is a diagram illustrating a segment in a hidden name.

FIG. 6C is a configurational diagram illustrating segments in a hidden name, with multiple hierarchical structures.

FIG. 6D is an arrangement diagram in which the highest level regions in hidden names arrayed according to the naming rule.

FIG. 6E is a diagram of the apparent side of the setting region 3 of FIG. 1 when the highest level regions of names of anchors are <1F>: <2E>: <3C>: <4J>: <5G>: <6R>: <7S>.

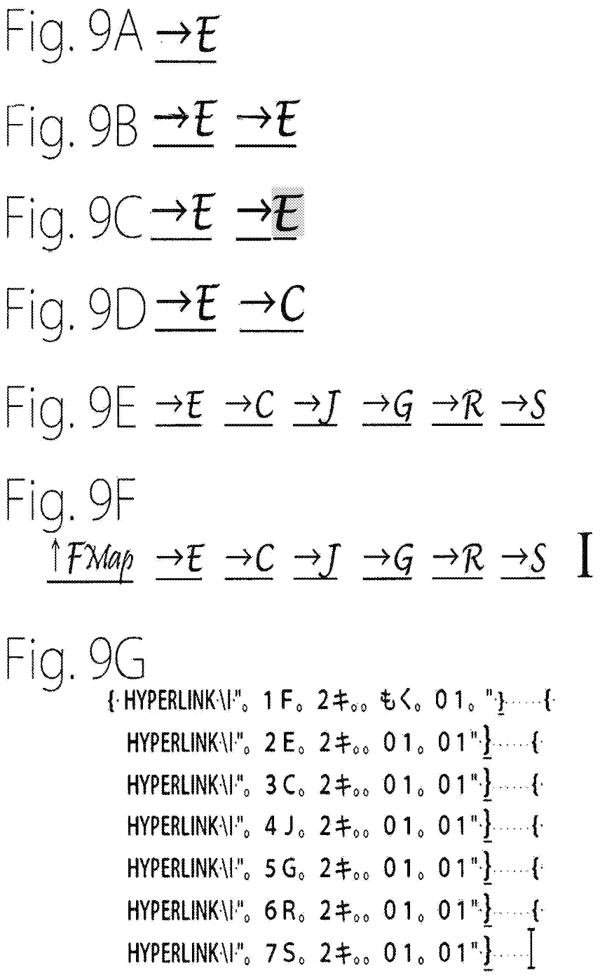

### 0.83: Drawings in FIGS. 7,8, and FIGS. 9A to 9G

FIG. 7 is a flow chart in the First Process where the electronic file generation apparatus illustrated in FIG. 4 generates the setting region 3 in FIG. 1.

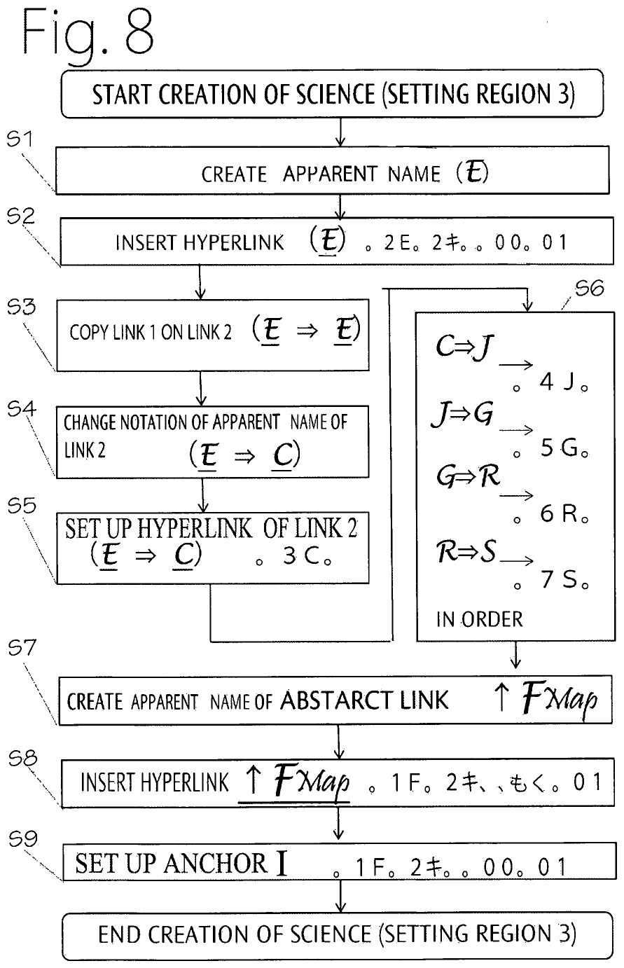

FIG. 8 is a detailed flowchart in the First Process where the electronic file generation apparatus illustrated in FIG. 4 generates the setting region 3 in FIG. 1.

FIG. 9A is a diagram illustrating an apparent name created in the region 6 of FIG. 1, which is executed in step S2 of FIG. 7 or step S2 of FIG. 8.

FIG. 9B is a diagram illustrating apparent names when the region 6 is copied onto the region 7 of FIG. 1, which is executed in step S3 of FIG. 7 or step S3 of FIG. 8.

FIG. 9C is a diagram when making characters in selection state of region 7 of FIG. 1 and replacing apparent names. FIG. 9C illustrates apparent names performed in step S3 of FIG. 7 or step S3 of FIG. 8.

FIG. 9D illustrates the region 7 of FIG. 1 which is selected, and the apparent name is replaced with “C”, performed in step S4 of FIG. 7 or step S4 of FIG. 8.

FIG. 9E is a diagram illustrating only a hyperlinks group, which are arranged in regions 6 to 11 in FIG. 1, and jump in verbatim by final combination, are gathered and arrayed. Also, FIG. 9E illustrates apparent names of science performed in FIG. 7 or FIG. 8.

FIG. 9F is another diagram of science arranged as region 3 of FIG. 1, illustrating apparent names performed in all steps of FIG. 7 or FIG. 8.

FIG. 9G is a diagram illustrating a scene in which names of hyperlinks in a science of FIG. 9F are opened from field code side and are orderly slipped down and arrayed in the respective lines as respective links through auto-loop back/wrap-round function. At the time, an anchor slipped down to the end of the seventh line. The backslash mark of FIG. 9G is a notation used in England and US and the like, and it is written as mark in Japan.

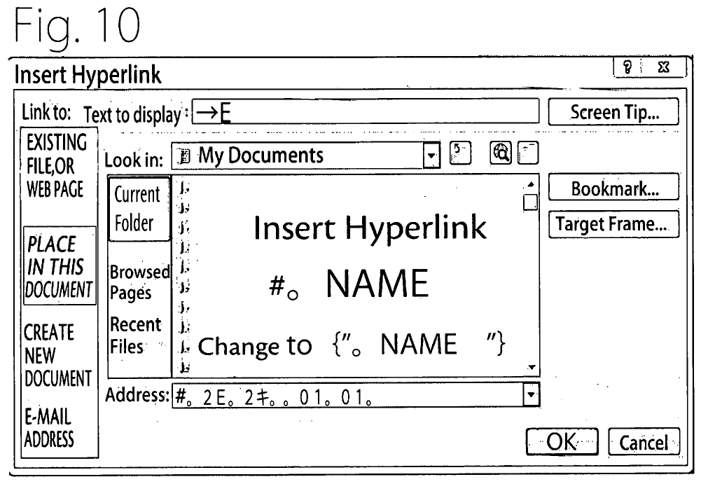

### 0.84: Drawings in FIGS. 10 to 15

FIG. 10 is a diagram for explaining the case where a hyperlink is inserted first when an anchor is not yet present.

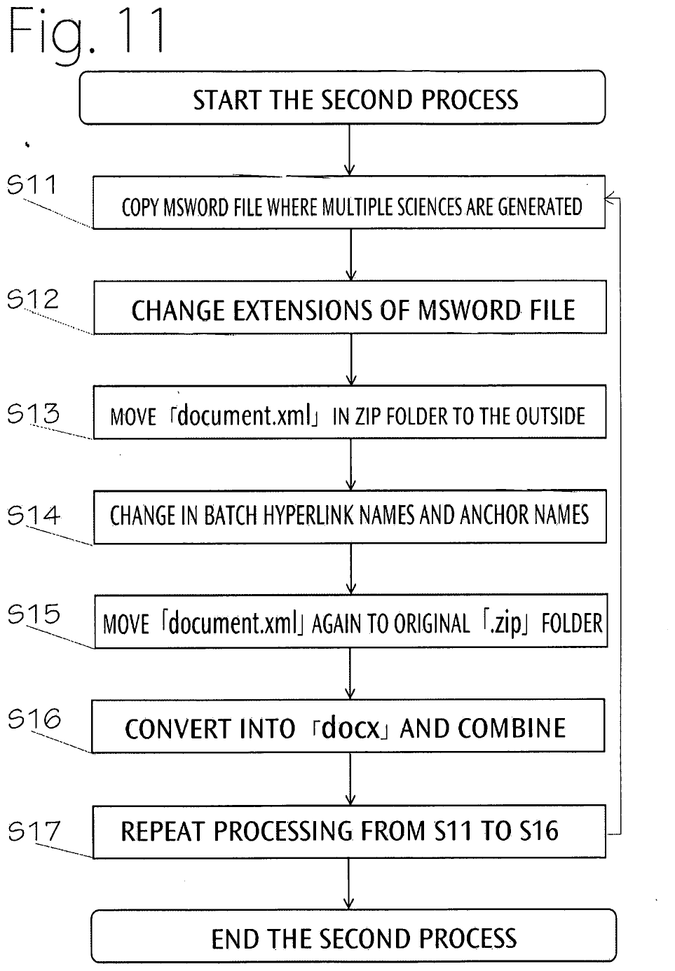

FIG. 11 is a flow chart illustrating processing when it is necessary to multiplicatively increase sciences in the Second Process, in the setting region 3 of FIG. 1 generated in FIG. 7 and FIG. 8.

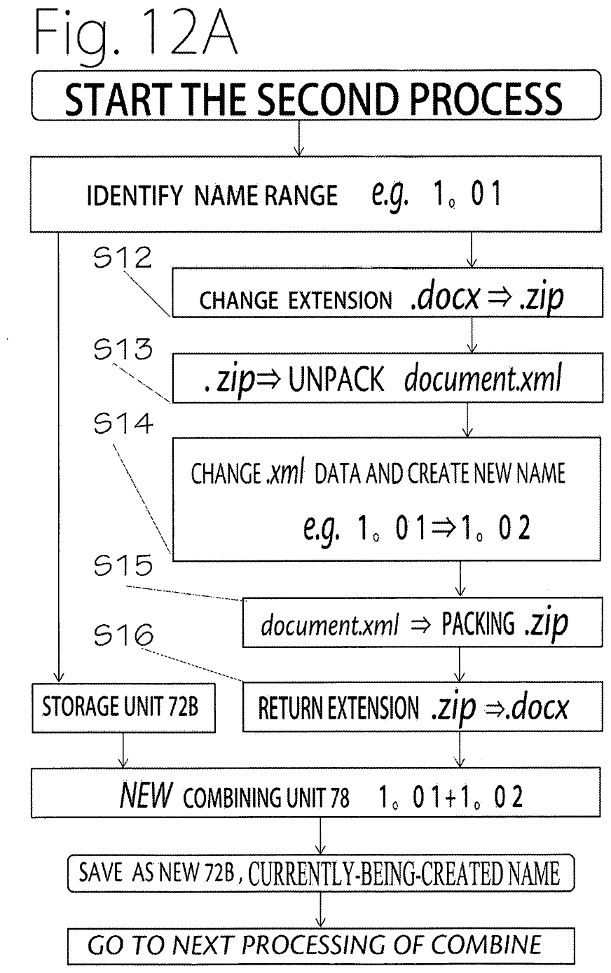

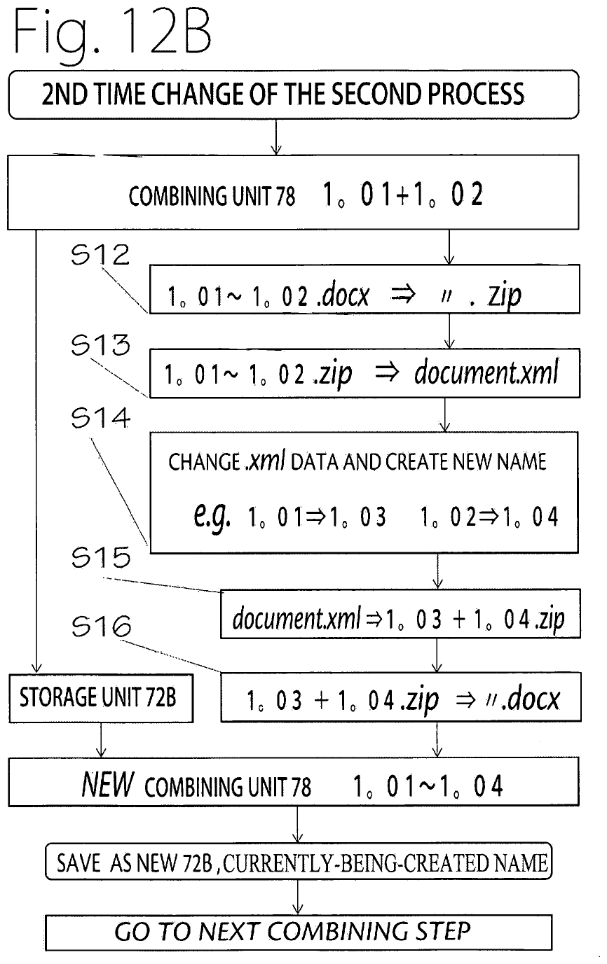

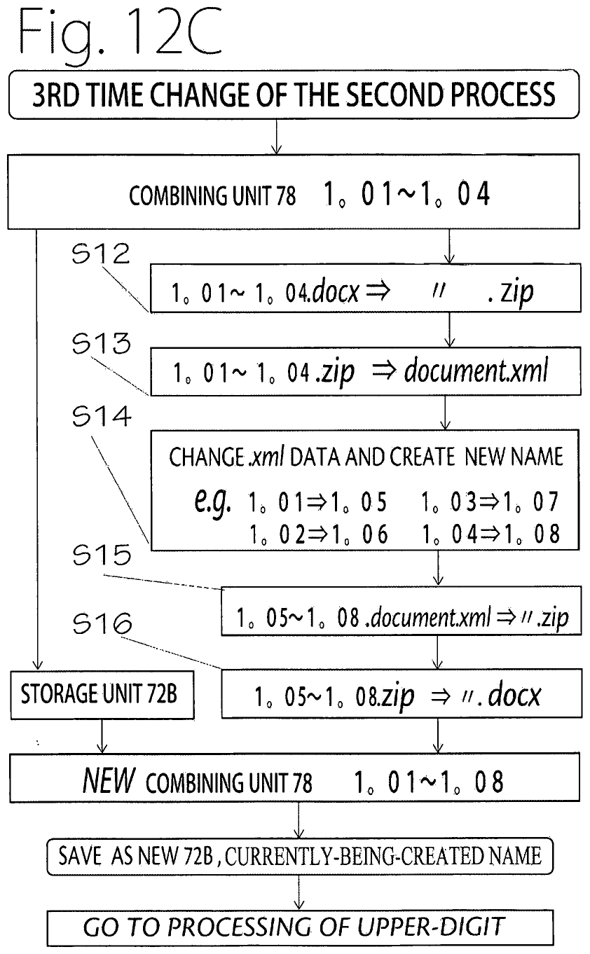

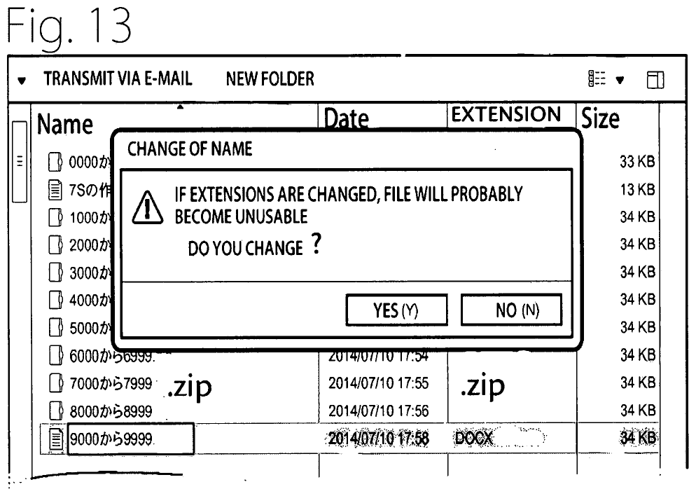

FIG. 12A is a flow chart illustrating processing of combining two files in which the lowest level regions of names (hereinafter abbreviated as “the lowest level regions”) of respective regions 87 of FIG. 6A or FIG. 6C are composed of 01 and 02.

FIG. 12B is a flow chart illustrating processing of combining two files of which the lowest level regions composed of 01:02 and 03:04, which are performed next to FIG. 12A.

FIG. 12C is a flow chart illustrating processing of combining two files of which the lowest level regions are made up of 01:02:03:04 and 05:06:07:08: which are performed next to FIG. 12B.

FIG. 13 is a warning diagram displayed when changing the extension of an electronic file from “docx” to “zip”.

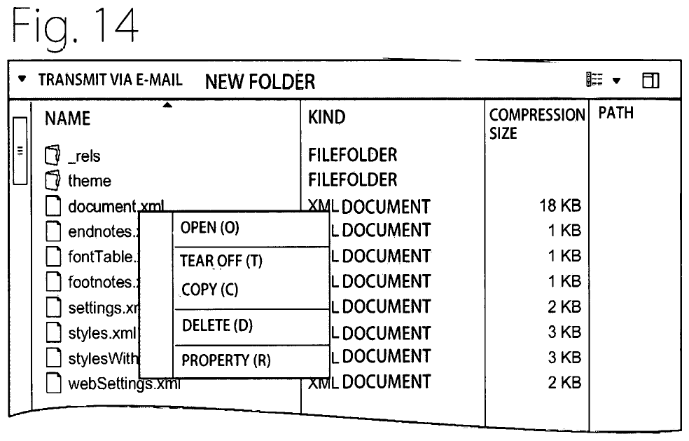

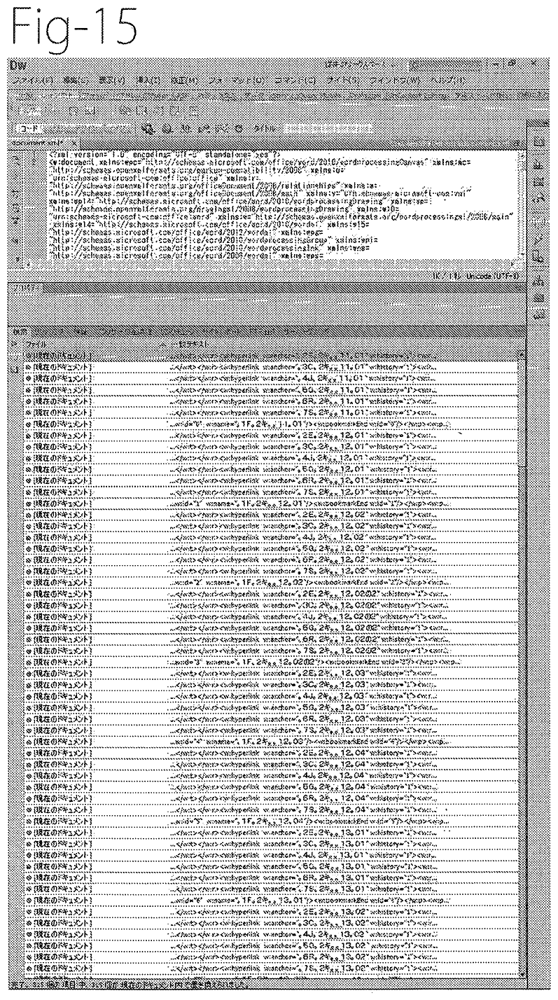

FIG. 14 is a diagram illustrating document xml included in a folder of an electronic file after the extension has been changed to “zip”.

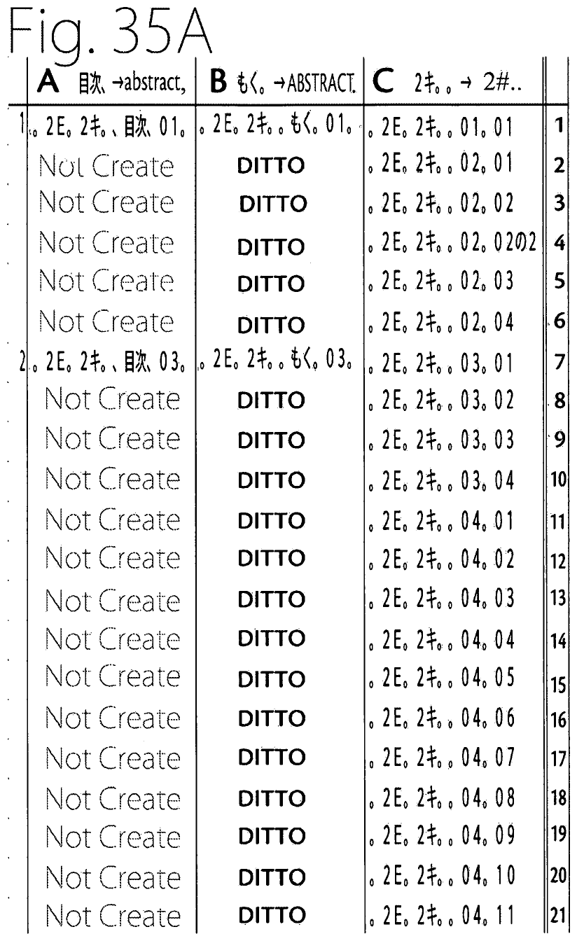

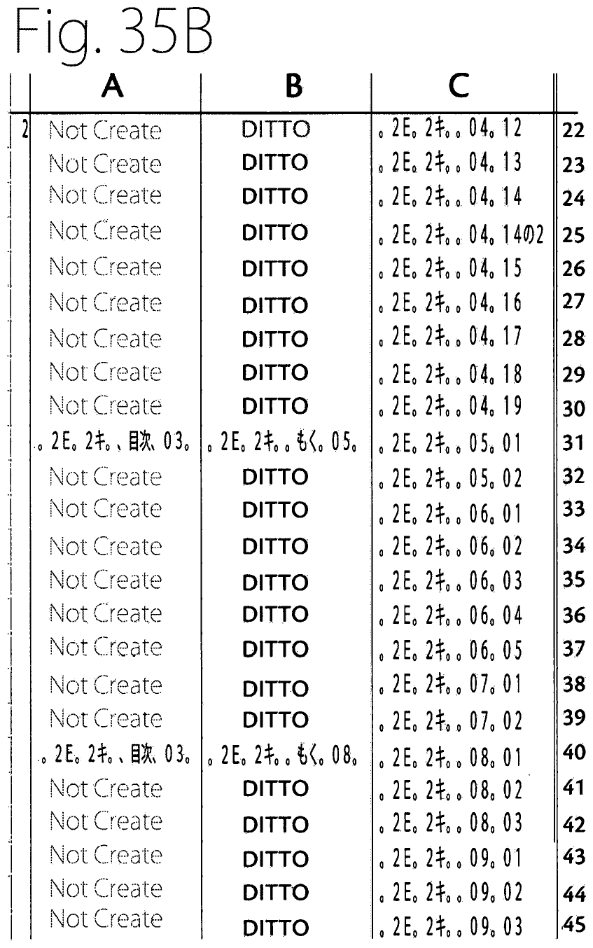

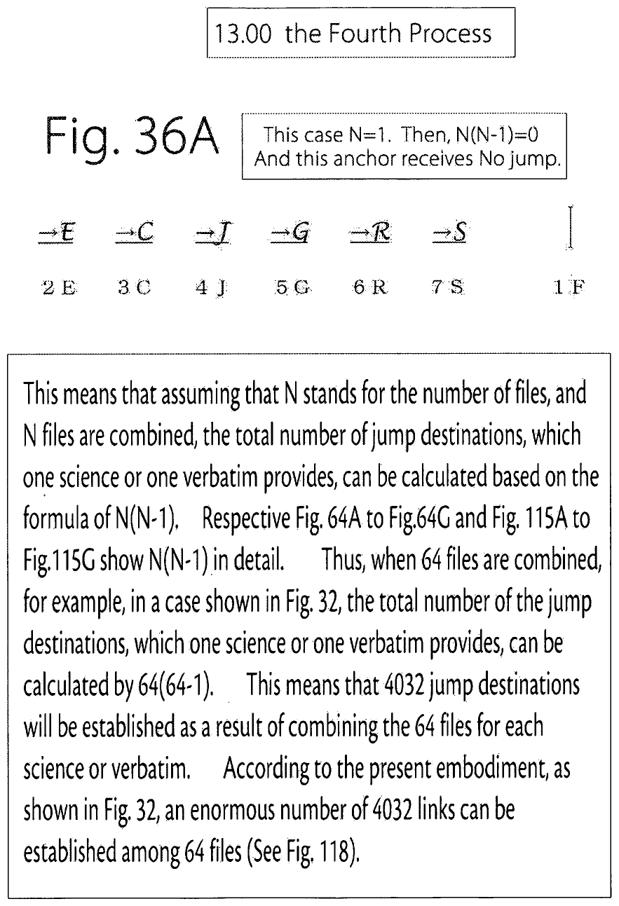

FIG. 15 is a photograph substitute for drawing (No. 1) indicating evidence by which it can be confirmed that hyperlinks and anchors have been simultaneously changed, in step S14 of FIG. 11. The fact that changed hidden names can be orderly aligned and displayed, by using names having the character length of FIG. 35A and FIG. 35B for files with a fixed display area, and can be read by visually while comparing the hidden names.

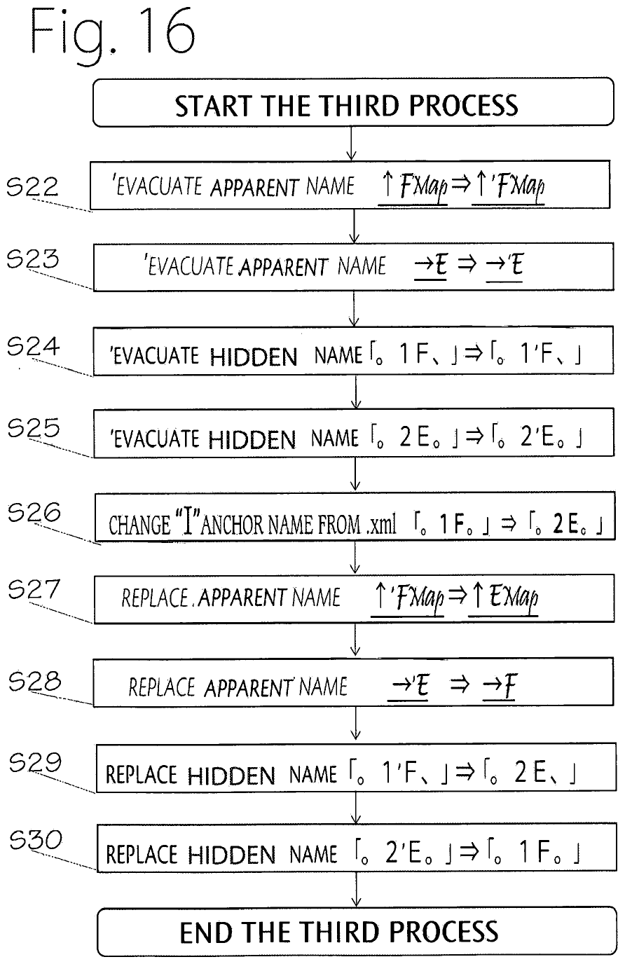

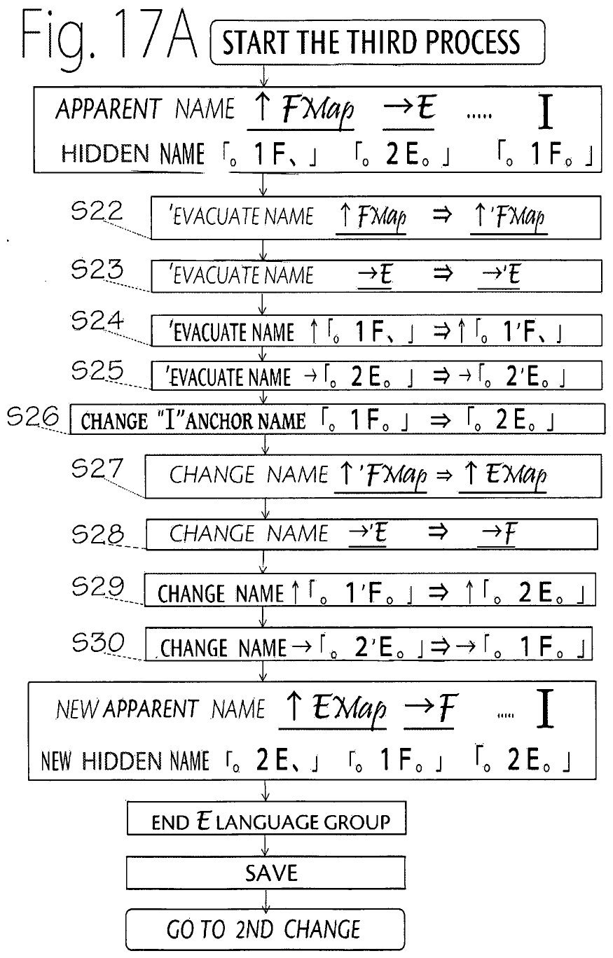

### 0.85: Drawings in FIGS. 16 to 18

FIG. 16 is a flowchart illustrating processing when replacing, in the Third Process, of the respective regions 84 of FIG. 6A or FIG. 6C (hereinafter abbreviated as “the highest level regions”). The Third Process begins directly from the names generated in the First Process of FIG. 7, FIG. 8, or begins indirectly from the names increased in the Second Process of FIG. 11.

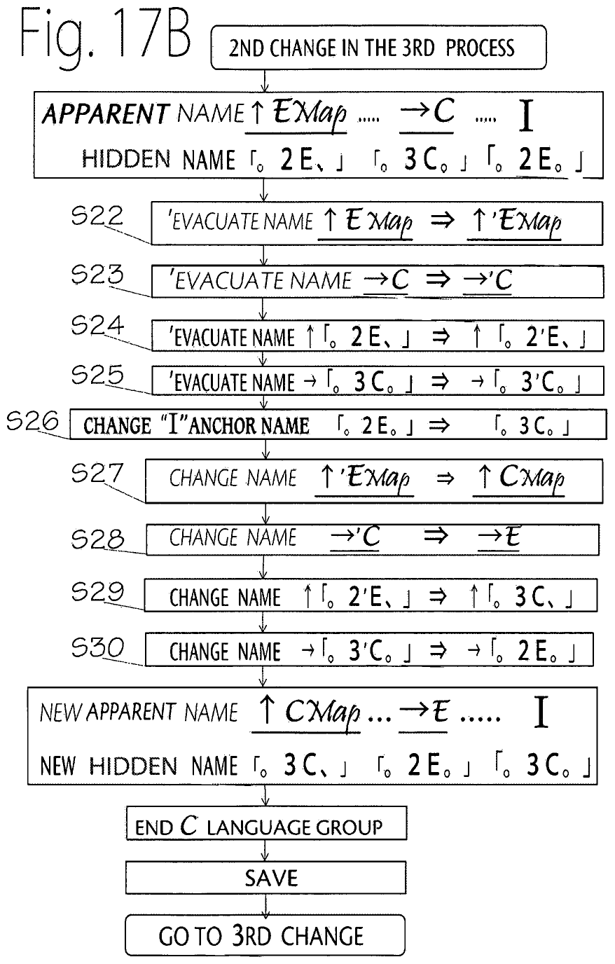

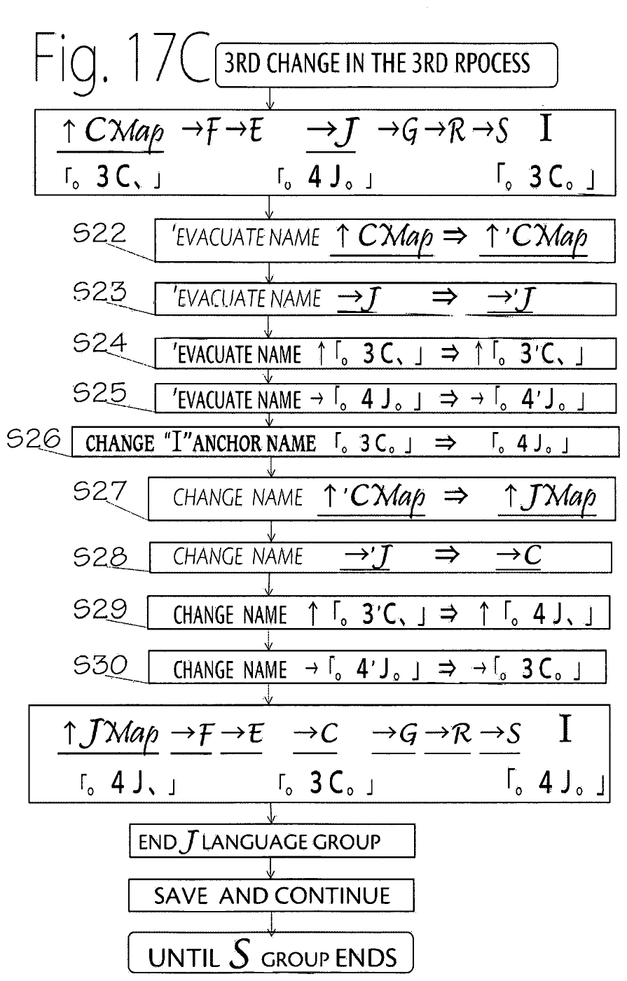

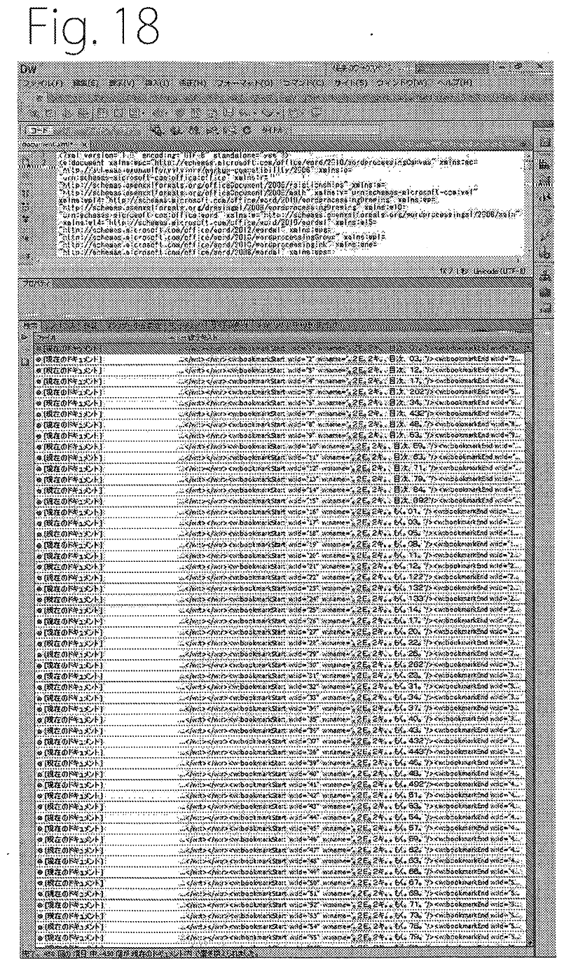

FIG. 17A is a flowchart illustrating processing of the setting region 6 of FIG. 16 and the setting regions A, B of FIG. 1.

FIG. 17B is a flowchart illustrating processing of the setting region 7 and the setting regions A, B of FIG. 1, to be performed after completion of the processing in FIG. 17A.

FIG. 17C is a flowchart illustrating processing of the setting region 8 and the setting regions A, B of FIG. 1, performed after completion of the processing of FIG. 17B.

FIG. 18 is a photograph substitute for drawing (No. 2) indicating evidence by which it can be confirmed that changes of only anchor names have been made, in step S26 of FIG. 16. The fact that changed hidden names can be displayed orderly and neatly, by using names having the length of FIG. 35A and FIG. 35B, to a fixed display area, therefore can be visually comparing the hidden names.

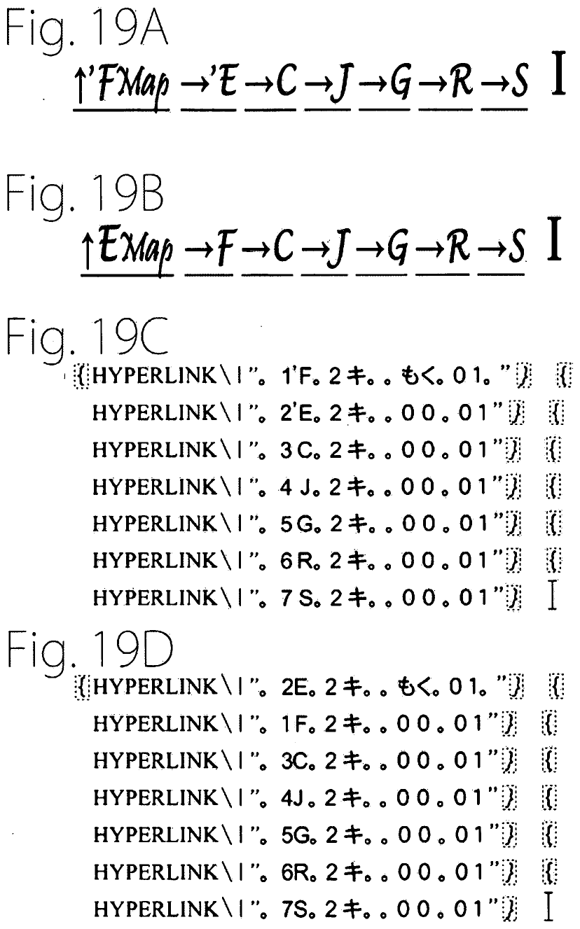

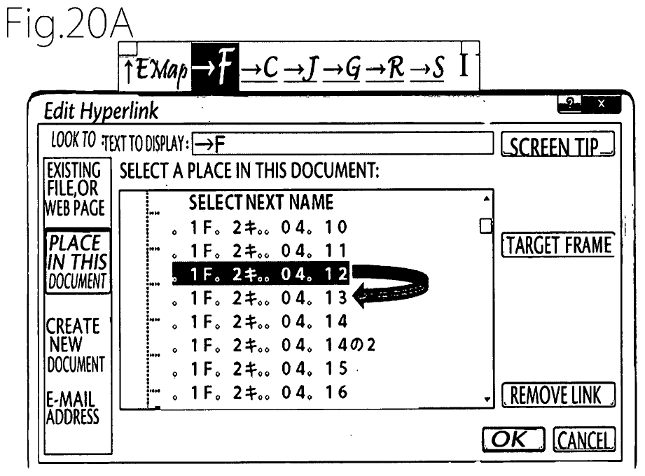

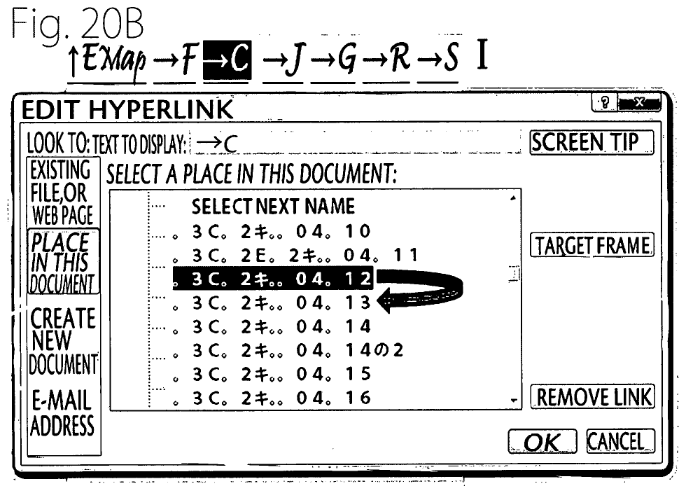

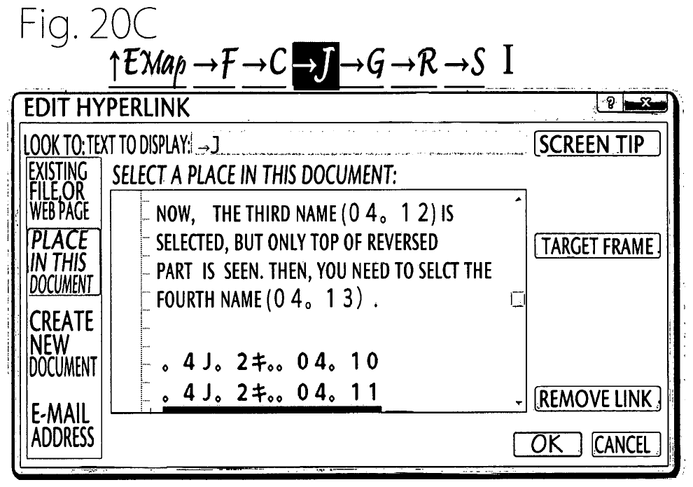

### 0.86: Drawings in FIGS. 19A to 19D and FIGS. 20A to 20C

FIG. 19A is a diagram illustrating evacuation of an apparent name in the region B and the setting region 6 of FIG. 1. The evacuation should be performed, before changing the anchor name. The process is also written in the step S26 of FIG. 17A.

FIG. 19B is a diagram illustrating finish of the evacuation of FIG. 19A, in which the names are changed into other names and performed in steps S27 and S28 of FIG. 17A. This diagram has similar apparent names to the setting region 3 of FIG. 1.

FIG. 19C is a diagram illustrating evacuations of hidden names of hyperlinks, for the region B of FIG. 1 and for the region 6 of FIG. 1, to be performed in steps S24 and S25 in FIG. 16. The evacuations are performed before changing the names of the anchors in step S26 in FIG. 16. This is a diagram corresponding to FIG. 19A.

FIG. 19D is a diagram illustrating hidden names of FIG. 19B, when the names, on which evacuation change of names of FIG. 19C has been performed in steps S29 and S30 of FIG. 17A, are changed to other names.

FIG. 20A is a diagram illustrating a method when an edition dialog box in FIG. 3A. FIG. 20A replaces French hyperlinks. In the case, hyperlinks are associated with hand work in a sequence where anchors were already laid out.

FIG. 20B is a diagram illustrating a method when Chinese hyperlinks are changed, after French hyperlinks in FIG. 20A.

FIG. 20C is a diagram illustrating a replacement closer to actual replacement and a method thereof, when Japanese hyperlinks will be replaced, after Chinese hyperlinks in FIG. 20B.

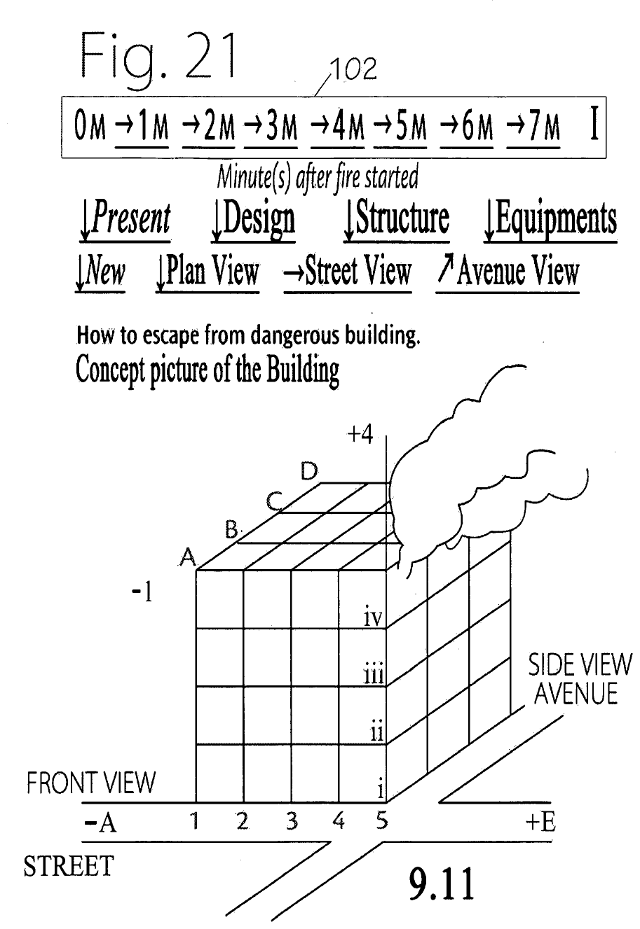

### 0.87: Drawings in FIGS. 21 to 30

FIG. 21 is a diagram illustrating a building concept diagram when replacement of building drawings is performed, unlike FIG. 1.

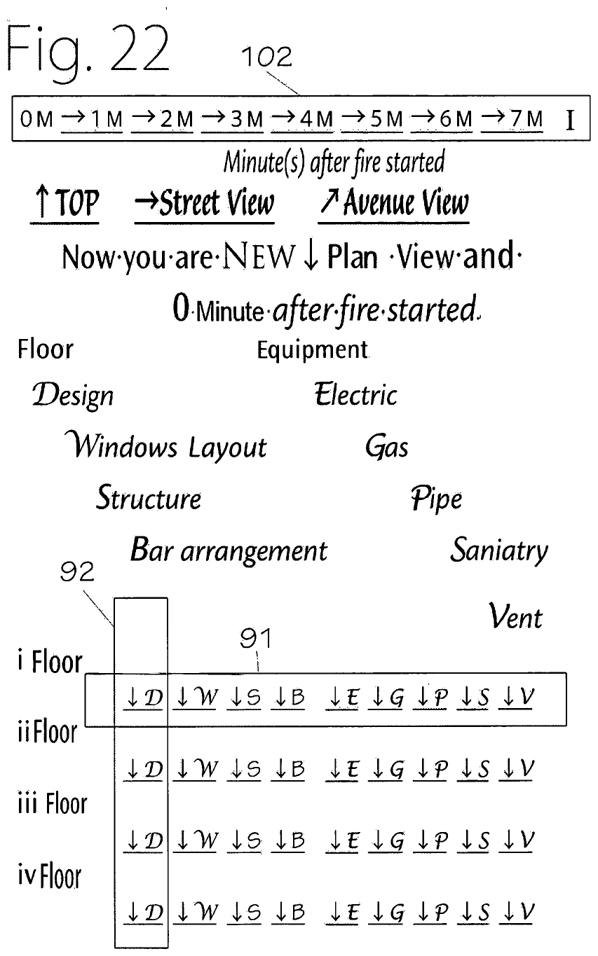

FIG. 22 is a table of contents of a drawing collection in which drawings in plane projection are collected and organized, from the building drawings in FIG. 21.

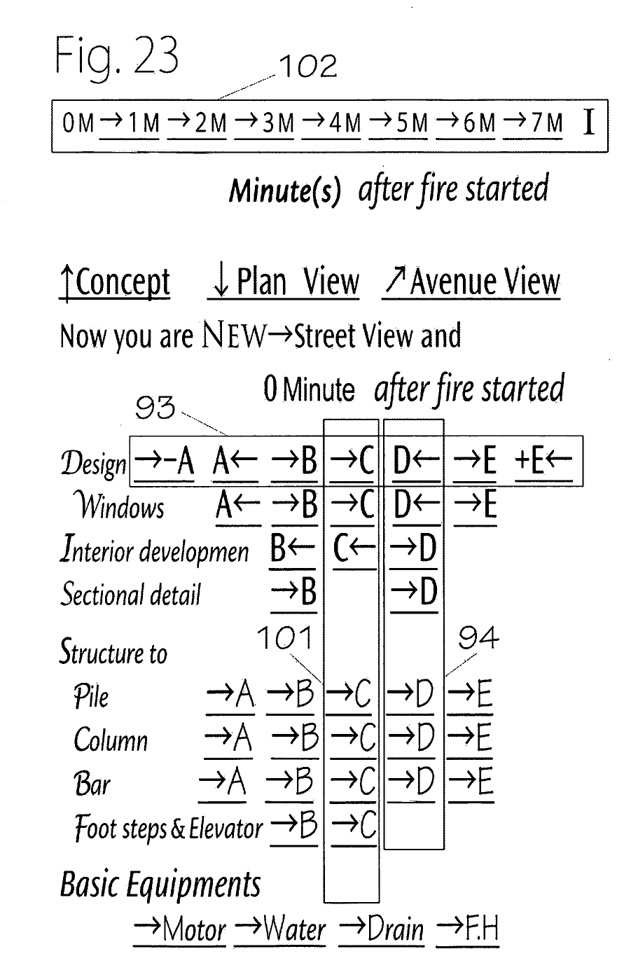

FIG. 23 is a table of contents of a drawing collection in which drawings in front projection are collected and organized, from the building drawings in FIG. 21.

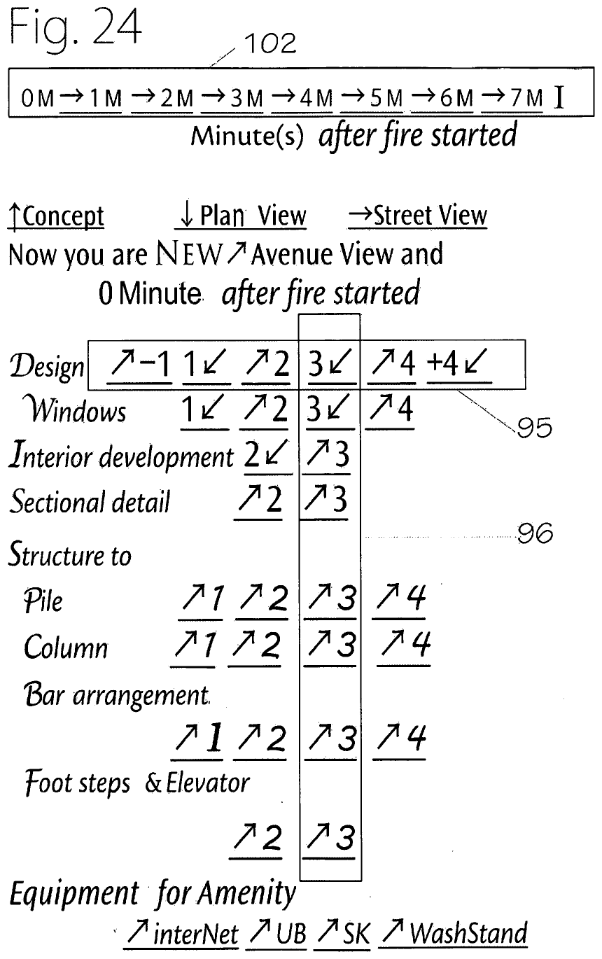

FIG. 24 is a table of contents of a drawing collection in which drawings side projection are collected and organized, from the building drawings of FIG. 21.

FIG. 25 is a diagram of virtual where the fire broke out from a part of the building of FIG. 21 after two minutes.

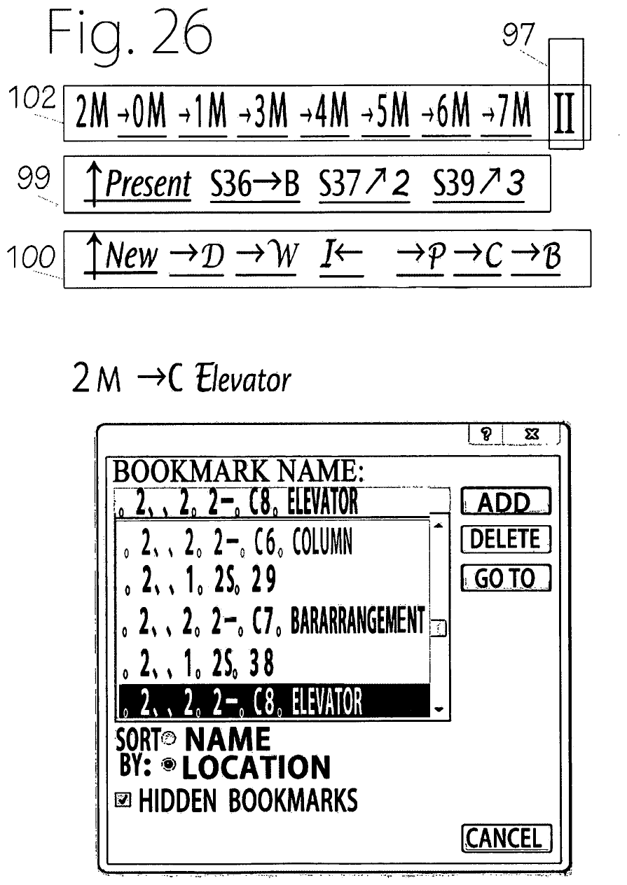

FIG. 26 is a diagram illustrating a state where any of two anchors located on right-top of FIG. 25 is selected, and names are arrayed in the location order of the content.

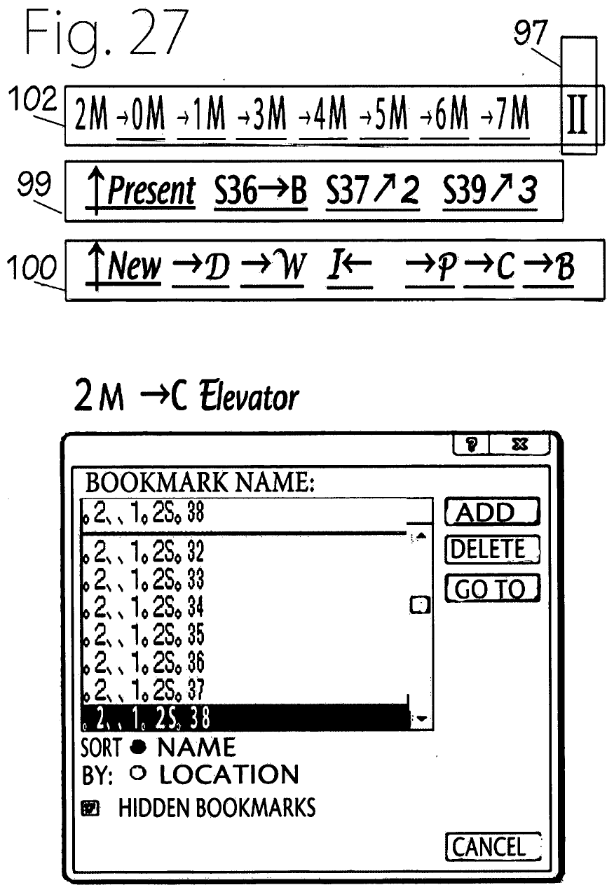

FIG. 27 is a diagram illustrating a state where the left side from two anchors located on right-top of FIG. 25 is selected, and names are arrayed in the name order of the current system.

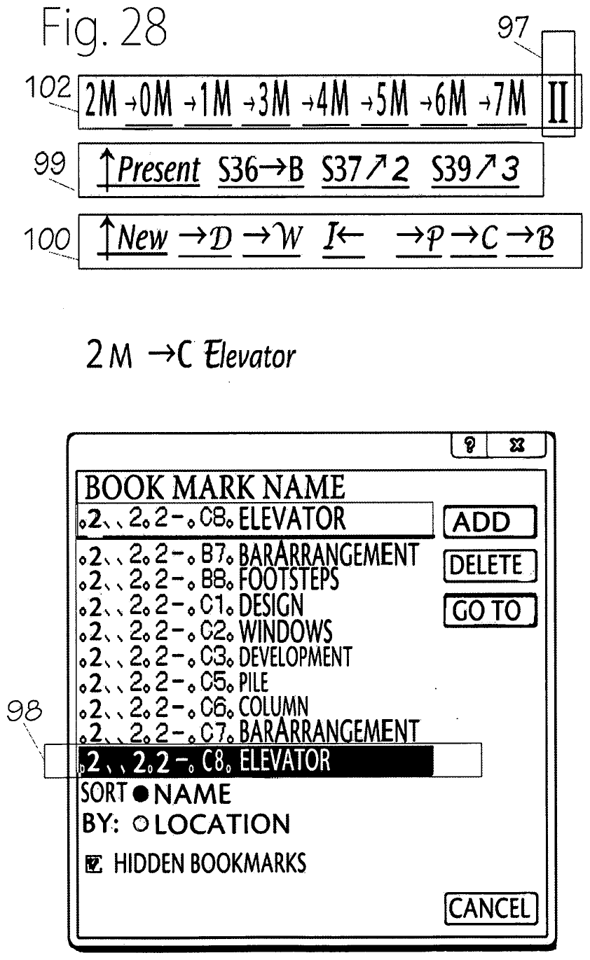

FIG. 28 is a diagram illustrating a state where the right side from two anchors located on the right-top side of FIG. 25 is selected, and names are arrayed in the name order of the new system.

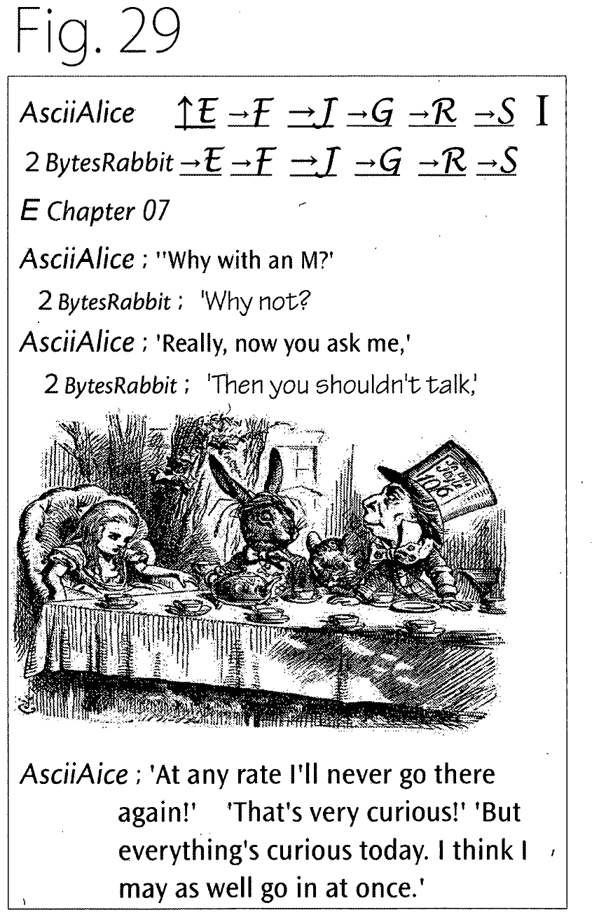

FIG. 29 is a diagram illustrating one example of another electronic file in which contents are different story characteristics, unlike FIG. 1, to be executed by a set of two lines of hyperlinks and two anchors.

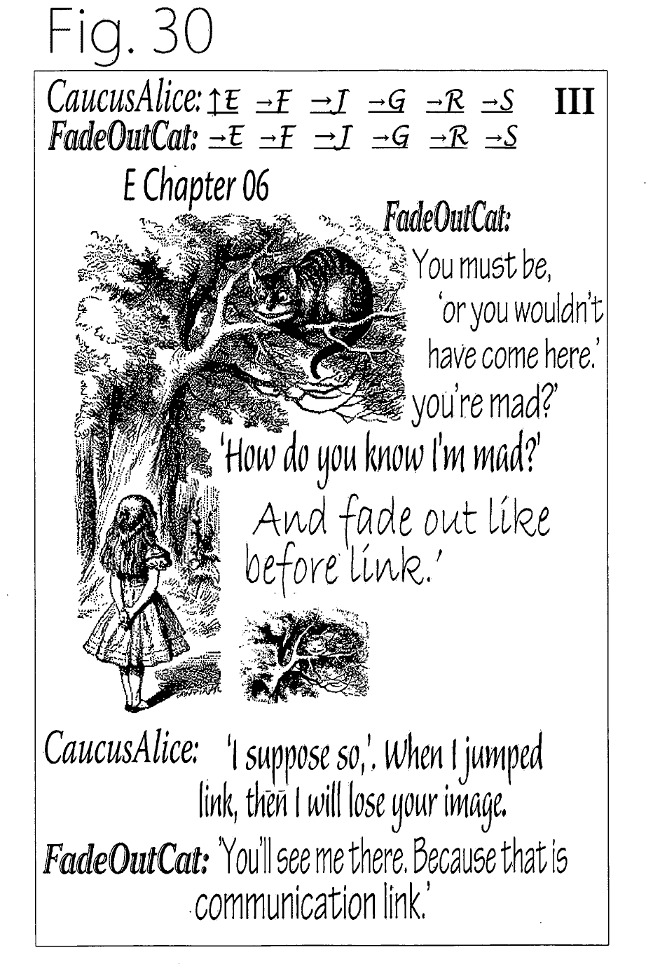

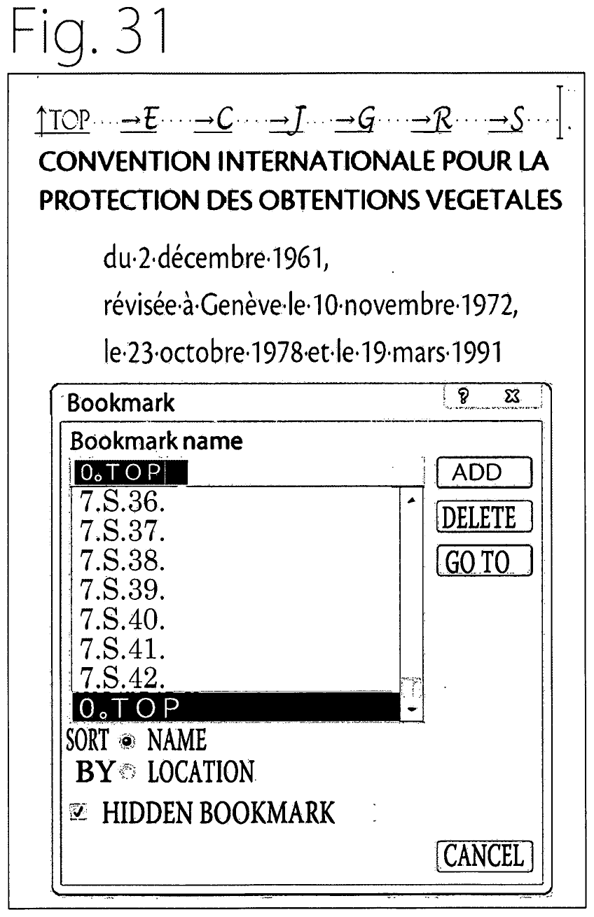

FIG. 30 is a diagram illustrating one example of another electronic file in which contents are different story characteristics, unlike FIG. 1, to be executed by a set of two lines of hyperlinks and three anchors.

### 0.88: Drawings in FIGS. 31 to 35

FIG. 31 is a diagram illustrating one example of an electronic file using dots for segments of hidden names, unlike FIG. 1.

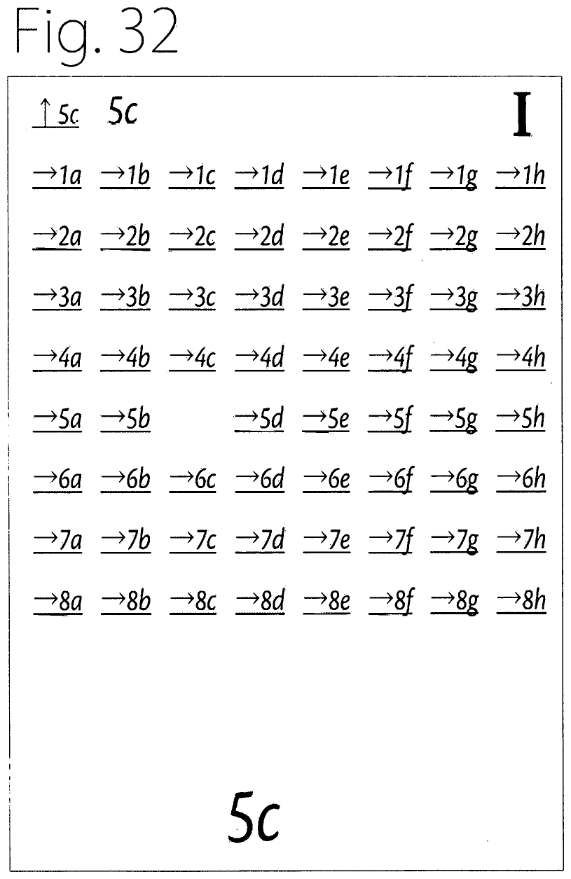

FIG. 32 is a diagram illustrating of an electronic file for comparing opinions of many one example people.

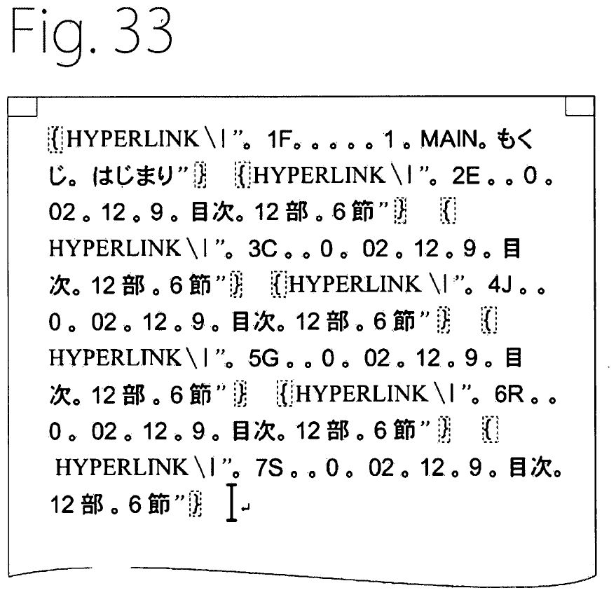

FIG. 33 is a display example of hyperlinks of an irregular arrangement of field codes.

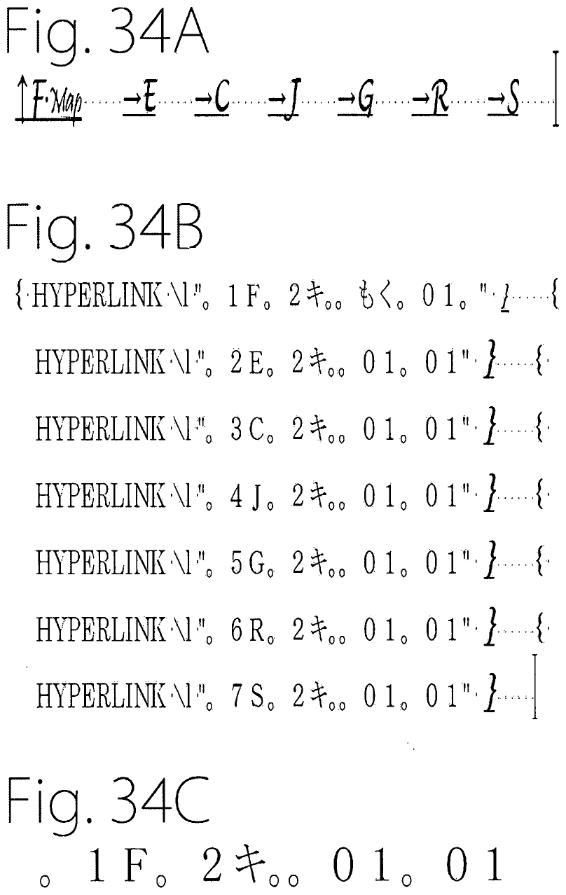

FIG. 34A is another diagram of the setting region 3 of FIG. 1.

FIG. 34B is a display example of names in which hyperlinks are aligned by word wrap functionality when the field codes (hidden) side of FIG. 34A are opened, and edit processing can be easily performed.

FIG. 34C is a name when an anchor arranged, at the end of FIG. 34B, is seen by opening FIG. 3B or document xml in FIG. 14.

FIG. 35A is a list up to the Clause 11 of Rule 4 of PCT created so that the names are orderly lined up when names replacements as illustrated in FIG. 15, FIG. 18 and FIG. 34B.

FIG. 35B is a list of the continued names from FIG. 35A.

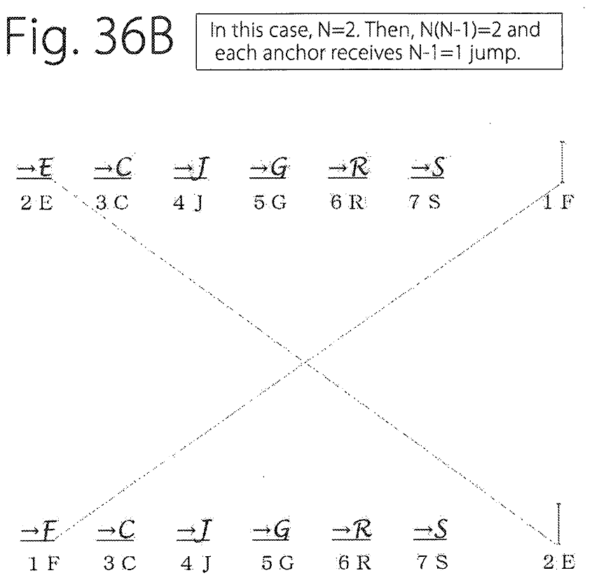

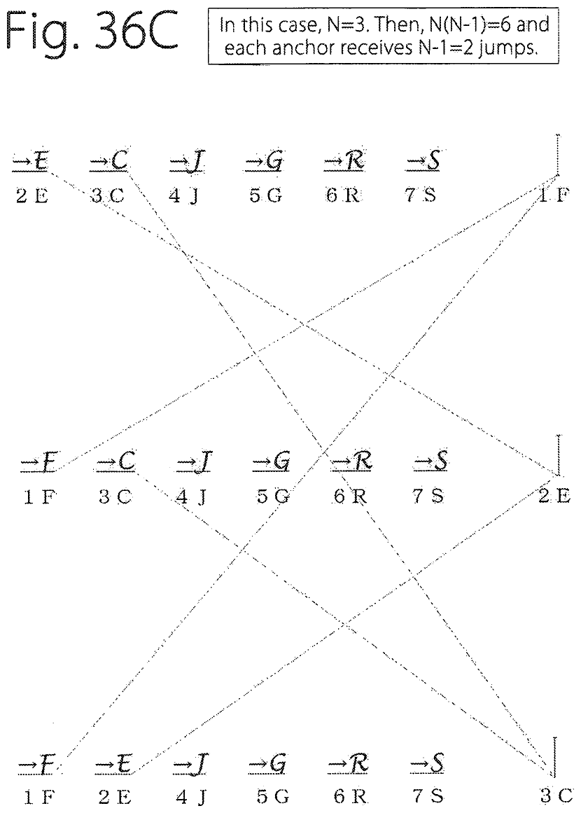

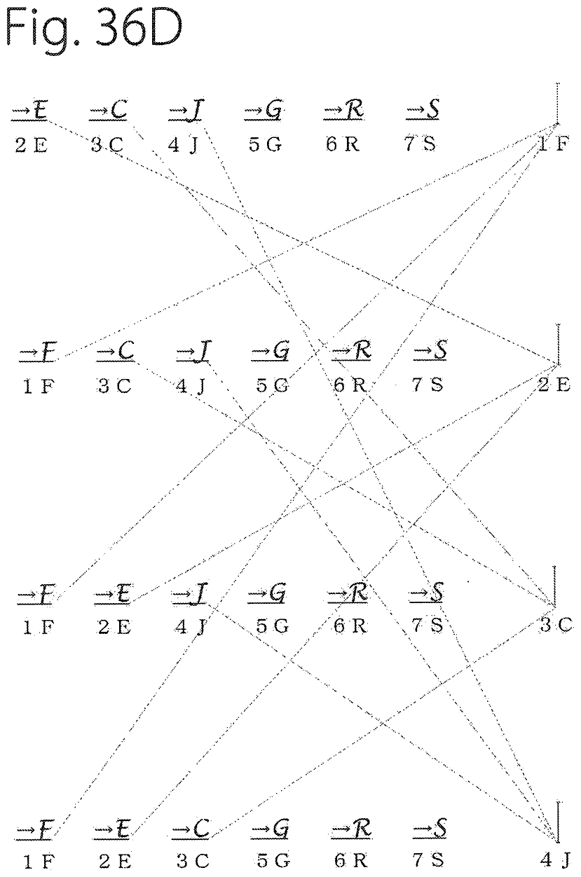

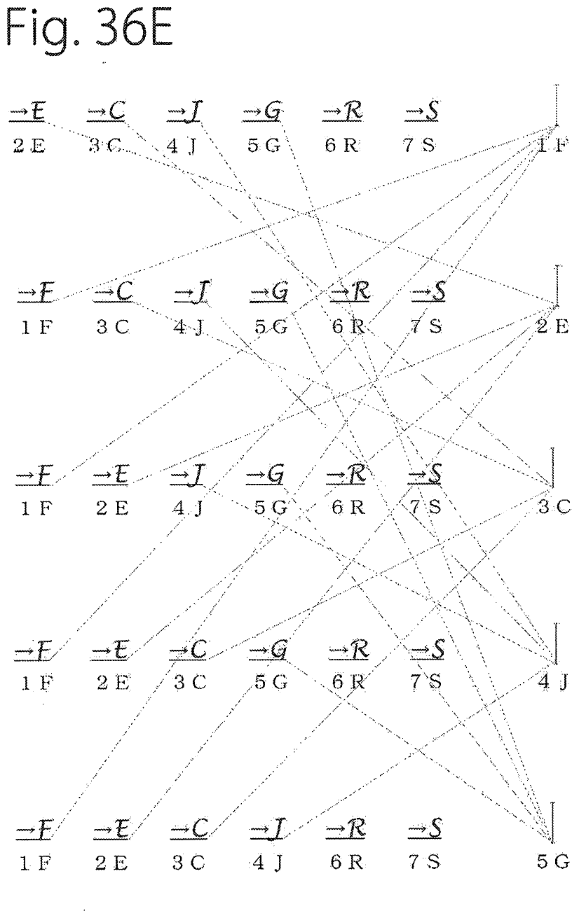

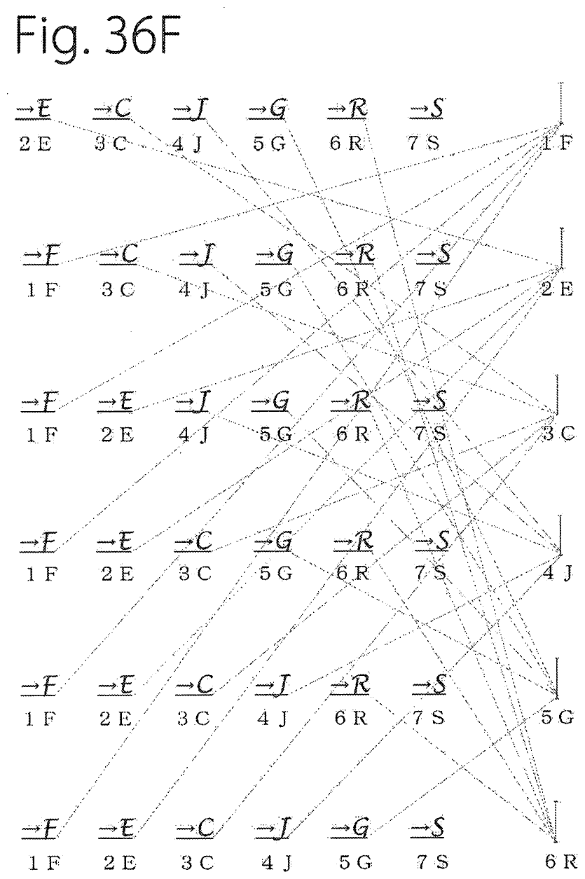

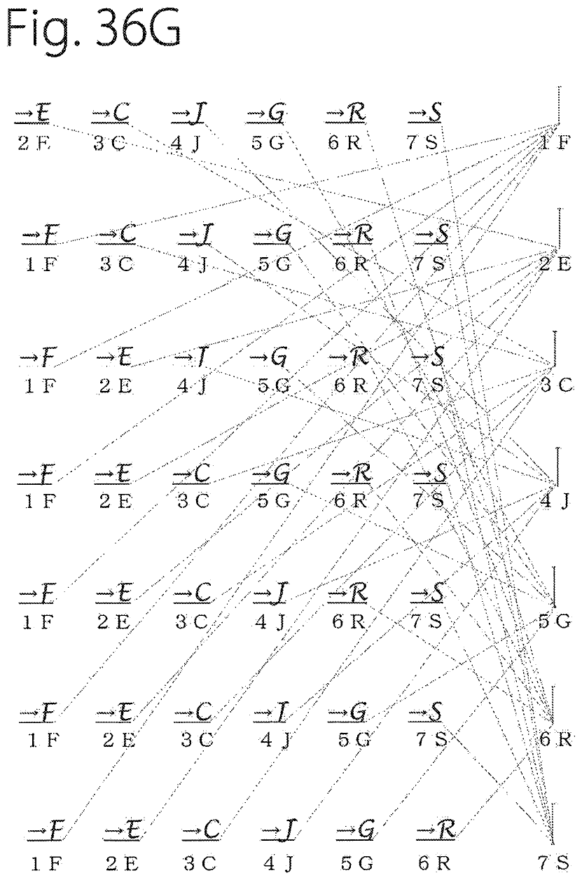

### 0.89: Drawings in FIGS. 36A to 36G

FIG. 36A is a diagram for explaining the fact that the jump is not established in a single verbatim, which corresponds to the first line in FIG. 6E.

FIG. 36B is a diagram for illustrating the final combination of the Fourth Process. In the figure, a newly combined electronic file is indicated in the last line, which corresponds to the second line of FIG. 6E. At this time, 2 is input into the formula of N(N−1)=2×1 in two verbatim. Accordingly, two verbatim jumps are established. The last line corresponds to the second line of FIG. 6E.

FIG. 36C is a diagram for illustrating a newly combined electronic file indicated in the last line, which corresponds to the third line of FIG. 6E. At this time, 3 is input into the formula of N(N−1)=3×2 in three verbatim. Accordingly, six verbatim jumps are established. The last line corresponds to the third line of FIG. 6E.

FIG. 36D is a diagram for illustrating four verbatim obtained by inputting 4 into the formula of N(N−1)=4×3. Accordingly, 12 verbatim jumps are established. The last line corresponds to the fourth line of FIG. 6E.

FIG. 36E is a diagram for illustrating five verbatim obtained by inputting 5 into the formula of N(N−1)=5×4. Accordingly, 20 verbatim jumps are established. The last line corresponds to the fifth line of FIG. 6E.

FIG. 36F is a diagram for illustrating six verbatim obtained by inputting 6 into the formula of N(N−1)=6×5. Accordingly, 30 verbatim jumps are established. The last line corresponds to the sixth line of FIG. 6E.

FIG. 36G is a diagram for illustrating seven verbatim obtained by inputting 7 into the formula of N(N−1)=7×6. Accordingly, 42 verbatim jumps are established. The last line corresponds to the seventh line of FIG. 6E. This figure shows that returnable jump was established between every setting region. Also, this is another figure of FIG. 115H.

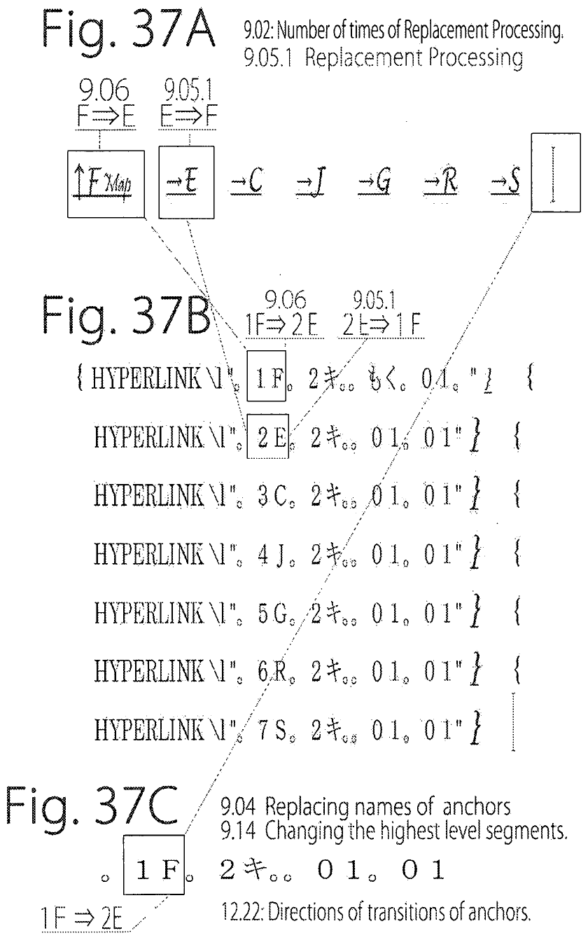

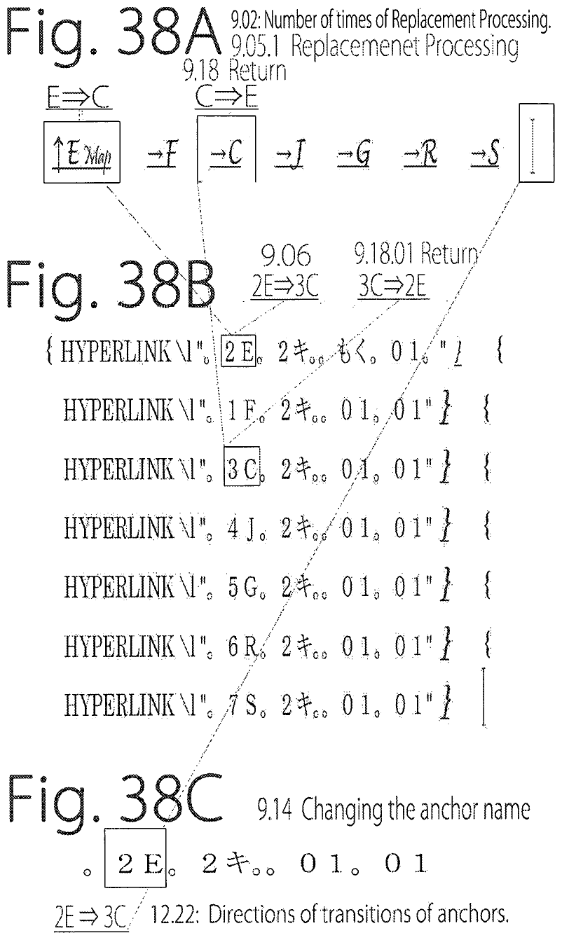

### 0.90.1: Drawings in FIGS. 37A to 37C

FIG. 37A is a diagram for illustrating the first replacement, namely the replacement of name of the highest level region performed in the Third Process. In FIG. 37A, replacement of the link 1 is performed. Regarding each A,B,C from FIG. 37A to FIG. 43C, “A” is viewed from apparent face of configuration of science, “B” is viewed from hyperlink side, and “C” is a name of an anchor arranged at the end of A. Then, respective names are combined with each other to configure one science. Also, in other figures, ABC are often arrayed in similar manner. For example, from FIG. 66A to FIG. 114C.

FIG. 37B is a diagram for illustrating the first replacement, namely the replacement of name of the highest level region performed in the Third Process. Then, the Order in verbatim is generated in 2nd line onwards of field code side. At this time, creation of the field code side is performed such that the segments of the names of the anchors are replaced in the ascending order of character codes (9.07). Then, the first drop-off is created to obtain <1F>.

FIG. 37C is a diagram for illustrating the first replacement, namely the replacement of name of the highest level region performed in the Third Process. Replacement of names of anchors starts from <1F> according to the naming rule (9.07). On the other hand, the same name of anchor <1F> is also present in an abstract link of the 1st line of FIG. 37B. This is because these two <2E> suggest (7.51) the same languages of interest. Then, in FIG. 37C, it is intended to change these two to <2E> together. In this case, the both become plus one (+1). When this idea is represented by a figure using different representation method, it becomes a figure when FIG. 115A shifts to FIG. 115B. In short, the both are identical separate figures.

### 0.90.2: Drawings in FIGS. 38A to 38C

FIG. 38A is a diagram for illustrating the second replacement. In FIG. 38A, replacement of the link 2 is performed.

FIG. 38B is a diagram for illustrating the second replacement. In FIG. 38B, <2E> is dropped-off from a verbatim which is present in 2nd line onwards of the field code side. In this state, apply change to <3C> of the link 2 (3rd line) of the field code side, create drop-off of the next new <3C>. At this time, it is intended to replenish with <2E> according to 9.18.01. In this case, minus 1 of the 3rd line will be created from the 2nd line of FIG. 44.

FIG. 38C is a diagram for illustrating the second replacement. After change as per FIG. 37C, since a name of an anchor follows the naming rule (9.07), the next becomes <2E>. On the other hand, <2E> which is the same name of this anchor is also present in an abstract link of the 1st line of FIG. 38B. This is because two <2E> suggest (7.51) the same languages of interest. Then, in the 1st line of FIG. 38B and FIG. 38C, it is intended to change these two to <3C> together. In this case, the both become plus one (+1). When this idea is represented by a figure using different representation method, it becomes a figure when FIG. 115B shifts to FIG. 115C. In short, the both are identical separate figures.

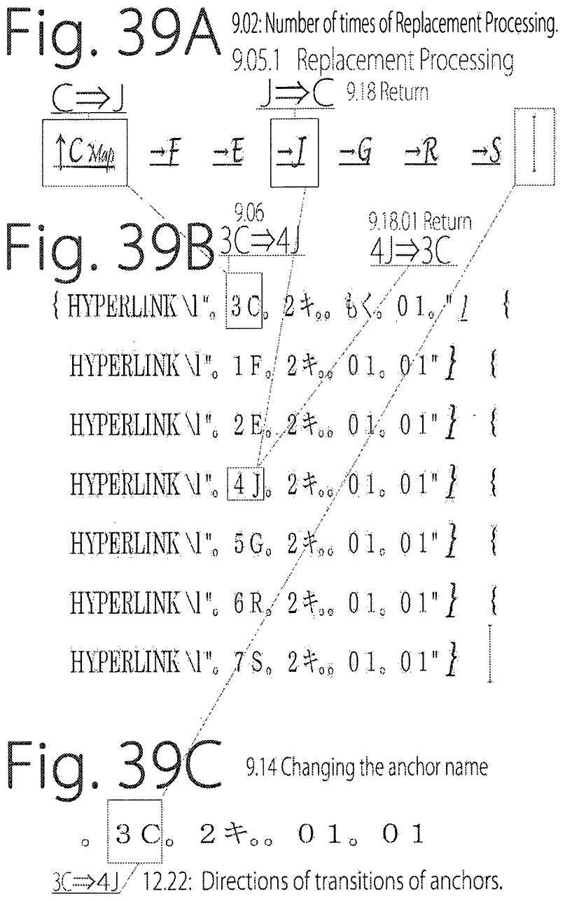

### 0.90.3: Drawings in FIGS. 39A to 39C

FIG. 39A is a diagram for illustrating the third replacement. In FIG. 39A, replacement of the link 3 is performed.

FIG. 39B is a diagram for illustrating the third replacement. In FIG. 39B, <3C> is dropped-off from a verbatim which is present in the 2nd line onwards of the field code side. In this state, apply change to <4J> of the link 3 (the 4th line) of the field code side, create drop-off of the next new <4J>. At this time, it is intended to replenish with <3C> according to 9.18.01. In this case, minus 1 of the 4th line is created from the 3rd line of FIG. 44.

FIG. 39C is a diagram for illustrating the third replacement. After change as per FIG. 38C, a name of an anchor becomes next <3C> according to the naming rule (9.07). On the other hand, <3C> which is the same as the name of this anchor is also present in an abstract link of the 1st line of FIG. 39B. This because these two <3C> suggest (7.51) the same languages of interest. Then, in the 1st line of FIG. 39B and FIG. 39C, it is intended to change these two to <4J>. In this case, the both become one. When this idea is represented by a figure using different representation method, it becomes a figure when FIG. 115C shifts to FIG. 115D. In short, the both are identical separate figures.

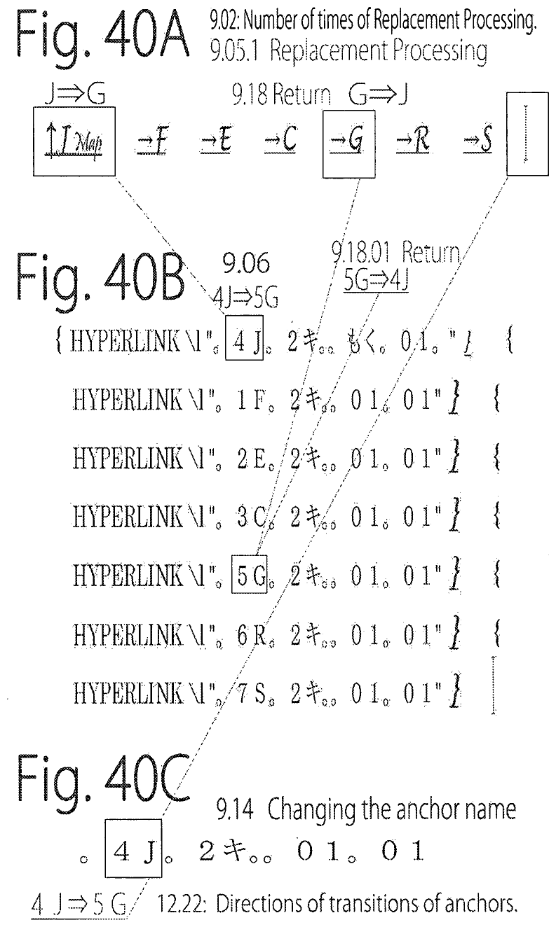

### 0.90.4: Drawings in FIGS. 40A to 40C

FIG. 40A is a diagram for illustrating the fourth replacement. In FIG. 40A, replacement of the link 4 is performed.

FIG. 40B is a diagram for illustrating the fourth replacement. In FIG. 40B, <4J> is dropped-off from a verbatim which is present from the 2nd line onwards of the field code side. In this state, apply change to <5G> of the link 4 (the 5th line) of the field code side, to create the drop-off of the next new <5G>. At this time, it is intended to replenish with <4J> according to 9.18.01. In this case, minus 1 of the 5th line will be created from the 4th line of FIG. 44.

FIG. 40C is a diagram for illustrating the fourth replacement portion. After change as per FIG. 39C, a name of an anchor becomes next <4J> according to the naming rule (9.07). On the other hand, <4J> which is the same as the name of this anchor is also present in an abstract link of the 1st line of FIG. 40B. This is because these two <4J> suggest (7.51). the same languages of interest. Then, it is intended to change these two to <5G> in the 1st line of FIG. 40B and FIG. 40C. In this case, the both becomes plus one (+1). When this idea is represented by a figure using different representation method, it becomes a figure when FIG. 115D shifts to FIG. 115E. In short, the both are identical separate figures.

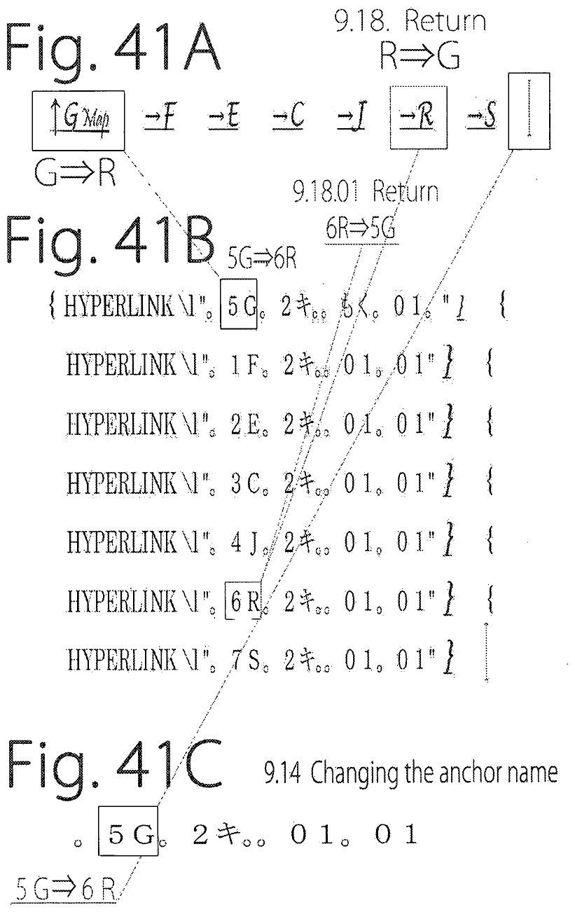

### 0.90.5: Drawings in FIGS. 41A to 41C

FIG. 41A is a diagram for illustrating the fifth replacement. In FIG. 41A, replacement of the link 5 is performed.

FIG. 41B is a diagram for illustrating the fifth replacement. In FIG. 41B, <5G> is dropped-off from a verbatim which is present in the 2nd line onwards of the field code side. In this state, apply change to <6R> of the link 5 (the 6th line) of the field code side, to create drop-off of the next new <6R>. At this time, it is intended to replenish with <5G> according to 9.18.01. In this case, minus 1 of the 6th line will be created from the 5th line of FIG. 44

FIG. 41C is a diagram for illustrating the fifth replacement portion. After change as per FIG. 40C, a name of an anchor becomes next <5G> according to the naming rule (9.07). On the other hand, <5G> which is the same as the name of this anchor is also present in an abstract link of the 1st line of FIG. 41B. This is because these two <5G> suggest (7.51) the same languages of interest. Then, in the 1st line of FIG. 41B and FIG. 41C, it is intended to change these two to <6R> together. In this case, the both becomes plus one (+1). When this idea is represented by a figure using different representation method, it becomes a figure when FIG. 115E shifts to FIG. 115F. In short, the both are identical separate figures.

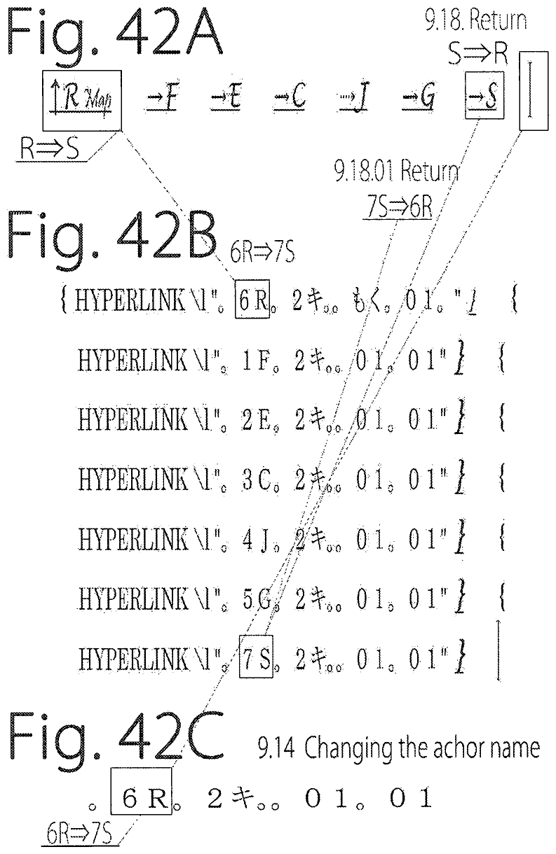

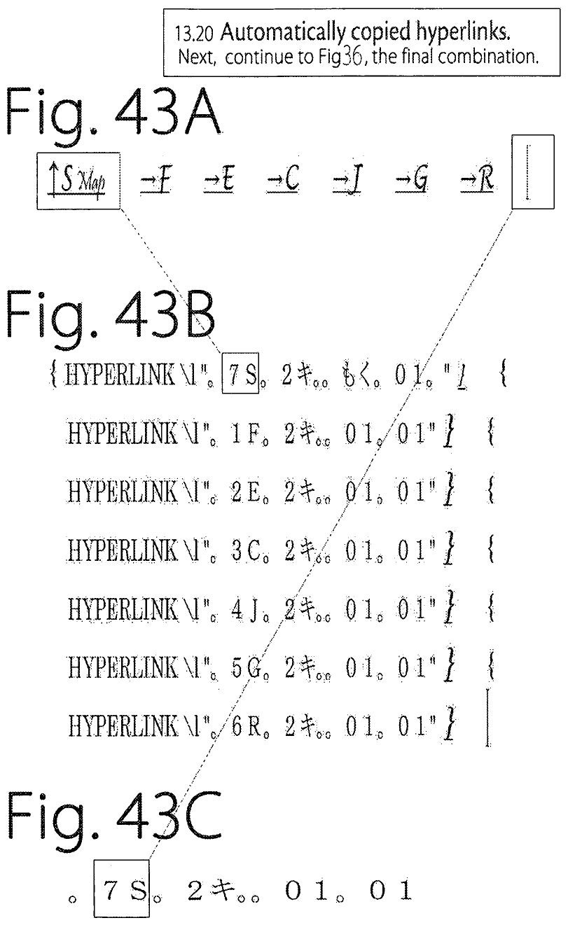

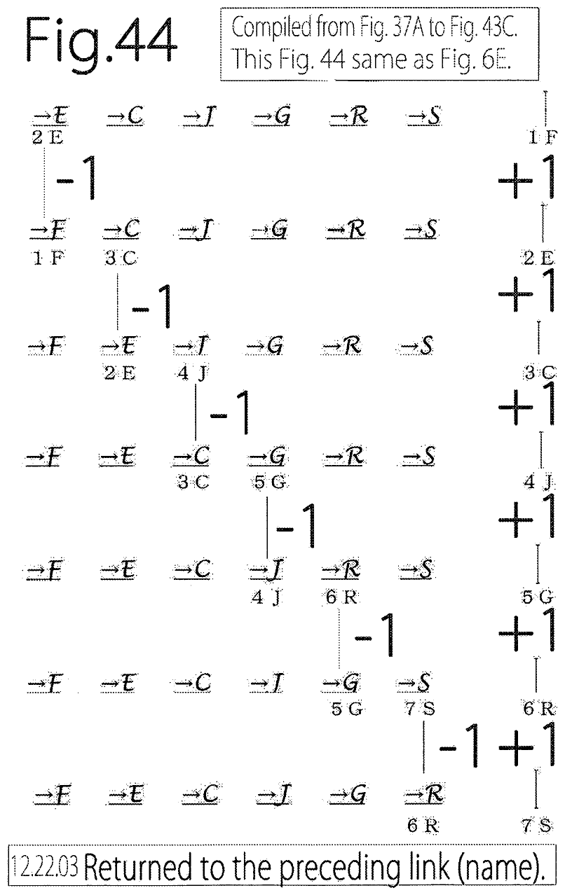

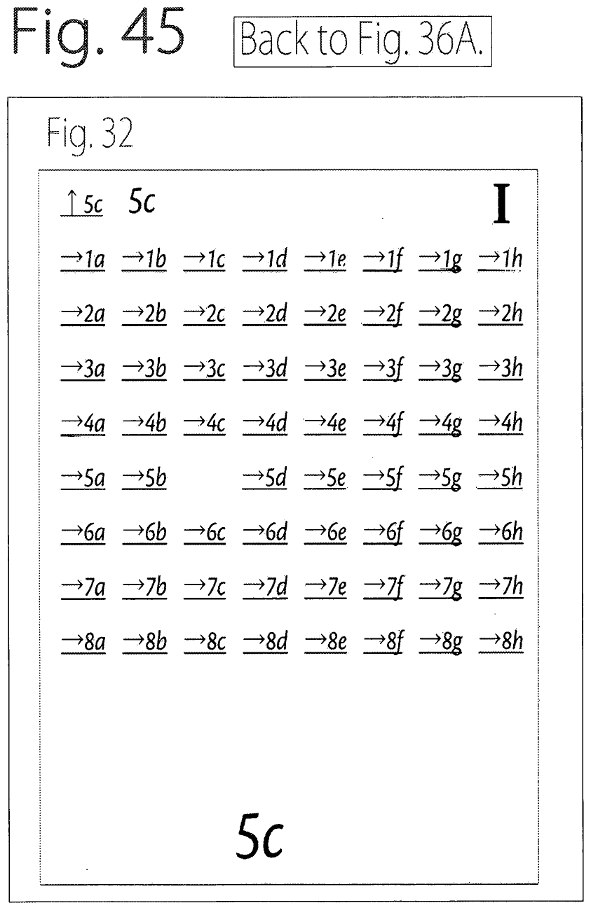

### 0.90.6: Drawings in FIGS. 42A to 42C

FIG. 42A is a diagram for illustrating the sixth replacement. In FIG. 42A, replacement of the link 6 is performed.

FIG. 42B is a diagram for illustrating the sixth replacement. In FIG. 42B, <6R> is dropped-off from a verbatim which is present in the 2nd line onward of the field code side. In this state, apply change to <7S> of the link 6 (the 7th line) of the field code side, to create the drop-off of the next new <7S>. At this time, it is intended to replenish with <6R> according to 9.18.01. In this case, minus 1 of the 7th line will be created from the 6th line of FIG. 44.

FIG. 42C is a diagram for illustrating the sixth replacement portion. After change as per FIG. 41C, a name of an anchor becomes next <6R> according to naming rule (9.07). On the other hand, <6R> which is the same as the name of this anchor is also present in an abstract link of the 1st line of FIG. 41B. This is because these two <6R> suggest (7.51), the same languages of interest. Then, in the 1st line of FIG. 42B and FIG. 42C, it is intended to change these two to <7S> together. In this case, the both become plus one (+1). When this idea is represented by a figure using different representation method, it becomes a figure when FIG. 115F shifts to FIG. 115G. In short, the both are identical separate figures.

### 0.90.7: Drawings in FIGS. 43A to 43C

FIG. 43A is a diagram for illustrating the completion of the seventh replacement. Then, in FIG. 43A, ->S is dropped-off from the end of the Order which configures a verbatim. At this time, it is in a state of the 7th line of FIG. 44 and FIG. 6E.

FIG. 43B is a diagram for illustrating the completion of the seventh replacement. At this time, the verbatim is arrayed in the Order. Consequently, in the verbatim which is present in the 2nd line onwards of the field code side, the largest number <7S> is dropped-off from the last 7th line.

FIG. 43C is a diagrams for illustrating the completion of the seventh replacement. After change as per FIG. 42C, a name of an anchor becomes next <7S> according to the naming rule (9.07). On the other hand, <7S> which is the same name of this anchor is also present in an abstract link of the 1st line of FIG. 42B. This is because these two <7S> suggest (7.51) the same languages of interest. When this scene is represented by a figure using different representation method, it becomes FIG. 115G. On the other hand, each from FIG. 37A to FIG. 43C is saved (9.09). Then, each of these replacements becomes a material used for final combination in FIG. 115H, like from FIG. 115A to FIG. 115G.

### 0.91: Drawings in FIGS. 44 to 45

FIG. 44 is a diagram for illustrating a state in which FIG. 37A to FIG. 43C are compiled. Then, it is a figure when the process “Covering all diagonal lines while moving through adjacent angles” explained in 12.25 is finished.

FIG. 45 is the reappearance of FIG. 32. Judging from the above FIG. 44, it is a figure to imagine how hyperlinks are increased.

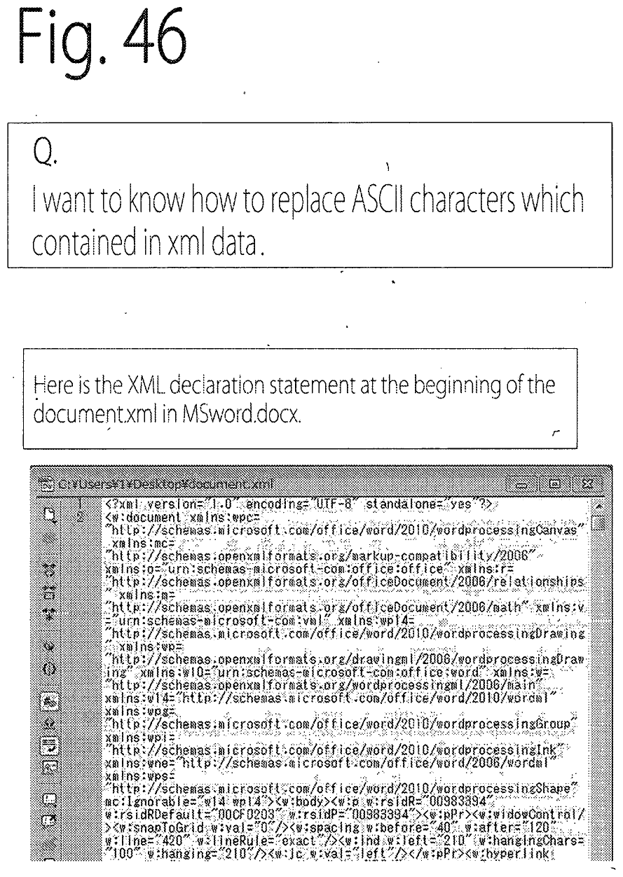

### 0.92: Drawings in FIGS. 46 to 51

FIG. 46 is a diagram for illustrating the beginning section of XML statement. FIG. 46 is an introduction for foreseeing the following operations to be performed in this XML statement.

FIG. 47 is a diagram for illustrating questions arising when FIGS. 37A, 37B, 37C are transitioned to FIGS. 38A, 38B, 38C. It is a figure for showing questions of replacement portions and replacement method.

FIG. 48 is a diagram for illustrating evacuation of hyperlinks. It is necessary to operate only anchors when replacement of anchors is performed. For this purpose, names of hyperlinks are evacuated temporarily.

FIG. 49 is a diagram for illustrating a procedure for a replacement method of anchor name. It is the replacement of anchors to be performed after evacuation in FIG. 48.

FIG. 50 is a diagram for illustrating a state when the names of anchors have been replaced.

FIG. 51 is a diagram for confirming that transitioning FIGS. 37A, 37B, 37C to FIGS. 38A, 38B, 38C has been completed. After replacement of names of anchors is completed, names of hyperlinks are changed to different names, while deleting <′> of evacuation. Change operation follows the Order described in 12.27. By executing the above FIG. 47 to FIG. 51, the transition from FIG. 115A to FIG. 115B is completed.

### 0.93: Drawings in FIGS. 52 to 56

FIG. 52 is a diagram for illustrating questions arising when transitioning FIGS. 38A, 38B, 38C to FIGS. 39A, 39B, 39C. The transition is performed by completing one-round in a manner as described in 12.23. Then, in this process, it suggests performing the process similar to FIG. 47.

FIG. 53 is a diagram for illustrating evacuation of hyperlinks. The transition is performed by completing one-round in a manner as described in 12.23. Then, in this process, it suggests performing the process similar to FIG. 48.

FIG. 54 is a diagram for explaining the procedure of replacement method of anchor name. The transition is performed by completing one-round in a manner as described in 12.23. Then, in this process, it suggests performing the process similar to FIG. 49.

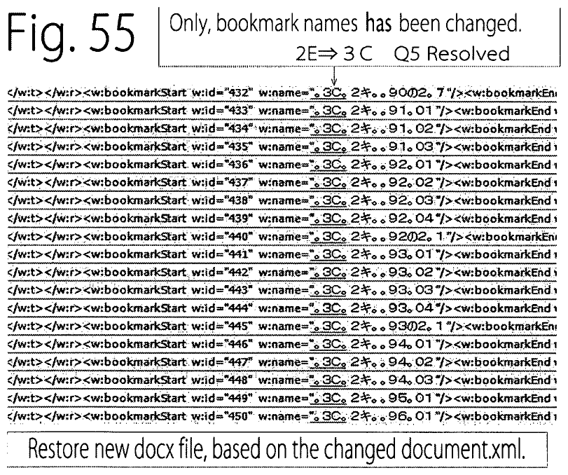

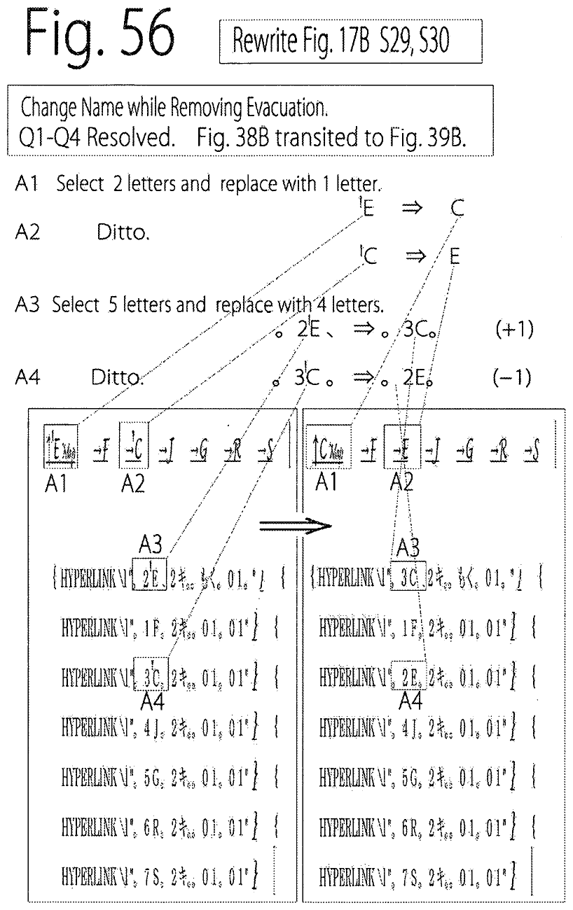

FIG. 55 is a diagram for explaining a state when the names of the anchors are replaced. The transition is performed by completing one-round in a manner as described in 12.23. Then, in this process, it suggests performing the process similar to FIG. 50.

FIG. 56 is a diagram for confirming that the transition has been completed when FIGS. 38A, 38B, 38C is transitioned to FIGS. 39A, 39B, 39C. The transition is performed by completing one-round in a manner as described in 12.23. Then, in this process, it suggests performing the process similar to FIG. 51. By executing the above FIG. 52 to FIG. 56, the transition from FIG. 115B to FIG. 115C is completed.

### 0.94: Drawings in FIGS. 57 to. 63

FIG. 57 is a diagram for explaining questions arising when FIGS. 39A, 39B, 39C is transitioned to FIGS. 40A, 40B, 40C. The transition is performed by completing one-round in a manner as described in 12.23. Then, in this process, it suggests performing the process similar to FIG. 52.

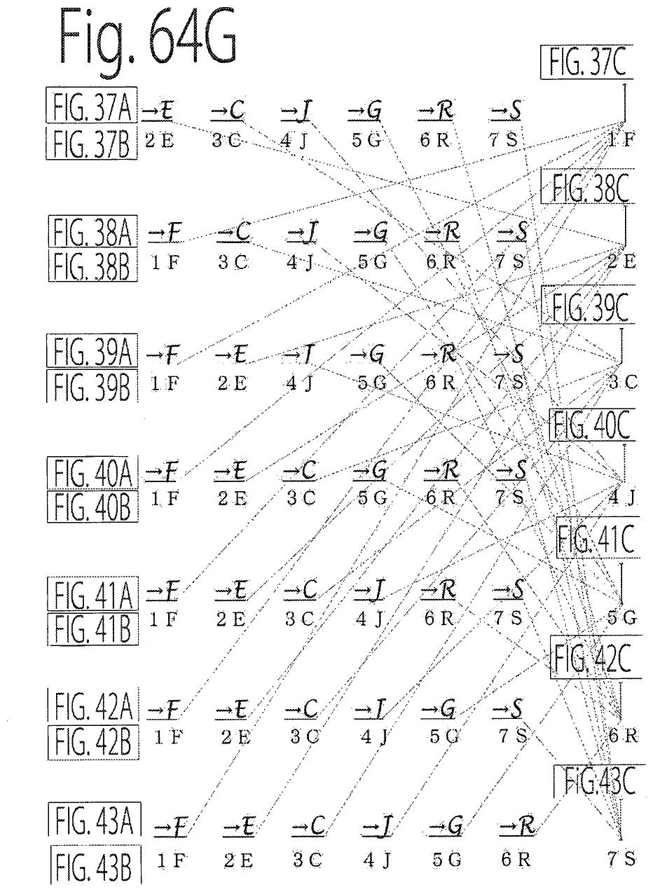

FIG. 58 is a diagram for illustrating evacuation of hyperlinks. The transition is performed by completing one-round in a manner as described in 12.23. Then, in this process, it suggests performing the process similar to FIG. 53.

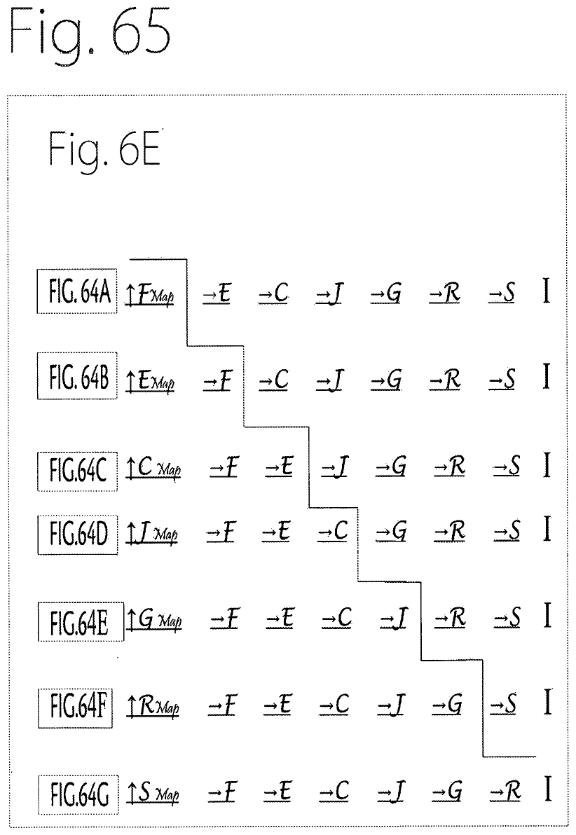

FIG. 59 is a diagram for explaining the procedure for a replacement method of anchor name. The transition is performed by completing one-round in a manner as described in 12.23. Then, in this process, it suggests performing the process similar to FIG. 54.

FIG. 60 is a diagram for explaining a state when names of anchors have been replaced. The transition is performed by completing one-round in a manner as described in 12.23. Then, in this process, it suggests performing the process similar to FIG. 55.

FIG. 61 is a diagram for confirming that the transition has been completed when FIGS. 39A, 39B, 39C is transitioned to FIGS. 40A, 40B, 40C The transition is performed by completing one-round in a manner as described in 12.23. Then, in this process, it suggests performing the process similar to FIG. 56. By executing the above FIG. 57 to FIG. 61, the transition from FIG. 115C to FIG. 115D is completed.

FIG. 62 is a diagram for explaining a state where intending to replace tags < > that are present in the complex XML statement. The transition is performed by completing one-round in a manner as described in 12.23. Then, in this process, it suggests performing the process similar to FIG. 57.

FIG. 63 is a diagram for explaining a state where hidden names of hyperlinks are changed, after replacement of anchors. The above from FIG. 47 to FIG. 61 suggests that replacement of lower level regions having different names has been performed by replace-all method (9.14 onwards).

### 0.95: Drawings in FIGS. 64A to 64G and FIG. 65

FIG. 64A is a diagram for explaining that the jump is not established since names are not common.

FIG. 64B is a diagram for explaining that the number of jumps which follows N(N−1) is two.

FIG. 64C is a diagram for explaining that the number of jumps which follows N(N−1) is six.

FIG. 64D is a diagram for explaining that the number of jumps which follows N(N−1) is 12.

FIG. 64E is a diagram for explaining that the number of jumps which follows N(N−1) is 20.

FIG. 64F is a diagram for explaining that the number of jumps which follows N(N−1) is 30.

FIG. 64G is a diagram for explaining that the number of jumps which follows N(N−1) is 42.

FIG. 65 is a diagram for explaining how the replacement portions of verbatim in FIG. 64A to FIG. 64G are transitioned.

### 0.96.01: Drawings in FIGS. 66A to 66C

FIG. 66A is a configuration diagram illustrating the apparent side of science. By the way. Regarding each A, B, C from FIG. 66A to FIG. 114C, each A is viewed from the apparent face of the configuration of science. Regarding each A, B, C from FIG. 66A to FIG. 114C, each B is viewed from hyperlink side of configuration. Regarding each A, B, C from FIG. 66A to FIG. 114C, each C is a name of an anchor arranged at the end of each A. Furthermore, respective names of each A, B, C constitute each other as one science by being integrated. At the time, each FIG. 66A to FIG. 114C corresponds to replacement performed from the state of FIG. 47 to the state of FIG. 51. Further, it corresponds to the state of FIG. 115B after FIG. 115A Therefore, the figures from FIG. 67A to FIG. 114C are included in FIG. 115B. And, FIG. 115I and FIG. 115J suggests it.

FIG. 66B is a configuration diagram illustrating hyperlinks side of science. The name of the abstract link of the first line of FIG. 66B corresponds to column A of line 1 in FIG. 35A.

FIG. 66C is a configuration diagram illustrating anchor of science. The name thereof corresponds to column B of line 1 in FIG. 35A.

### 0.96.02: Drawings in FIGS. 67A to 67C

FIG. 67A is a configuration diagram illustrating the apparent side of science.

FIG. 67B is a configuration diagram illustrating hyperlinks side of science. The abstract link of the first line of FIG. 67B corresponds to column A of line 7 in FIG. 35A.

FIG. 67C is a configuration diagram illustrating anchor of science. The name thereof corresponds to column B of line 7 in FIG. 35A.

### 0.96.03: Drawings in FIGS. 68A to 68C

FIG. 68A is a configuration diagram illustrating the apparent side of science.

FIG. 68B is a configuration diagram illustrating hyperlinks side of science. The abstract link of the first line of FIG. 68B corresponds to column A of line 7 in FIG. 35A.

FIG. 68C is a configuration diagram illustrating anchor of science. The name thereof corresponds to column B of line 31 in FIG. 35B.

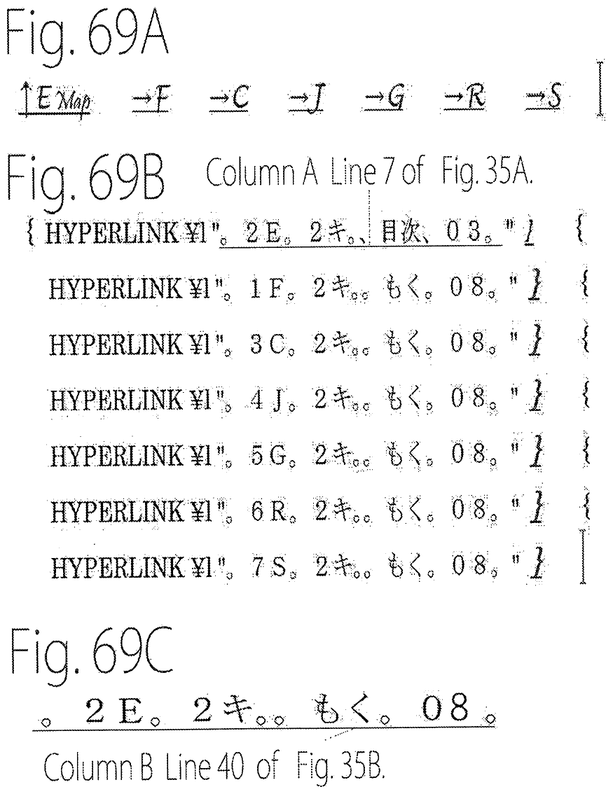

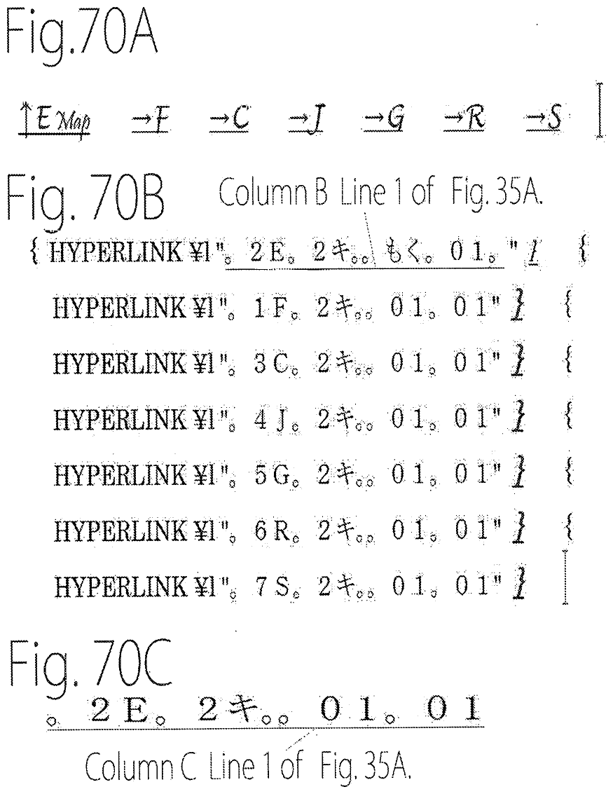

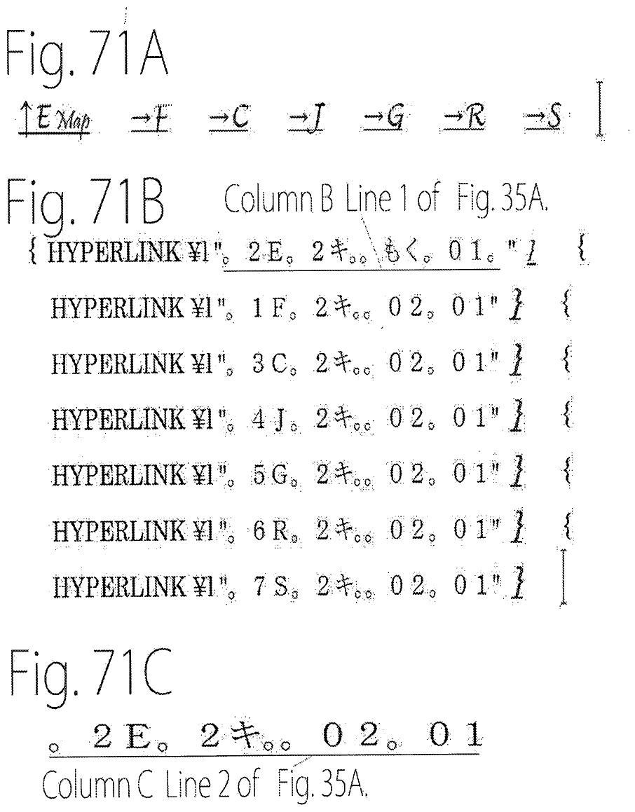

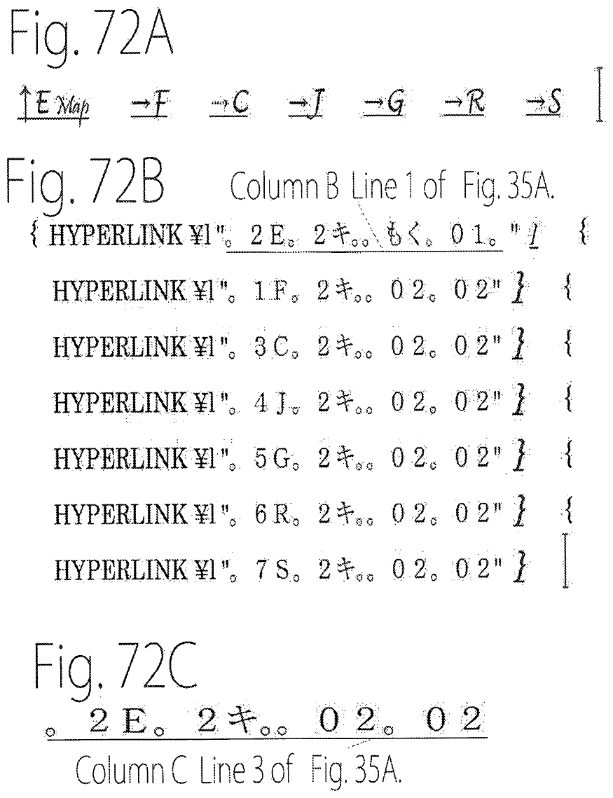

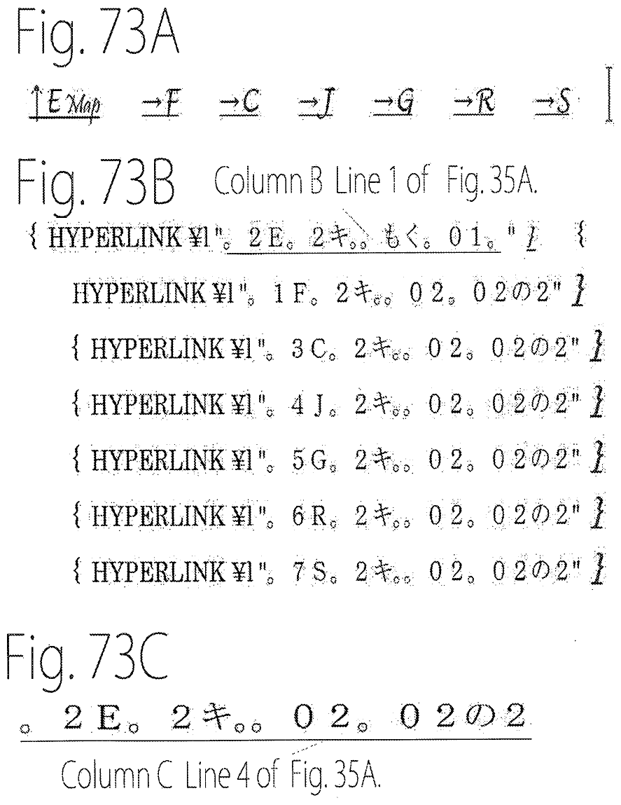

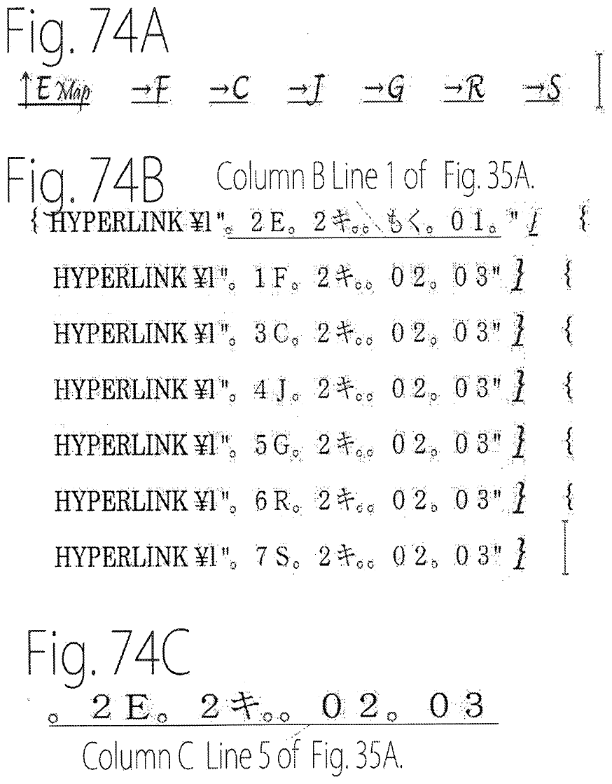

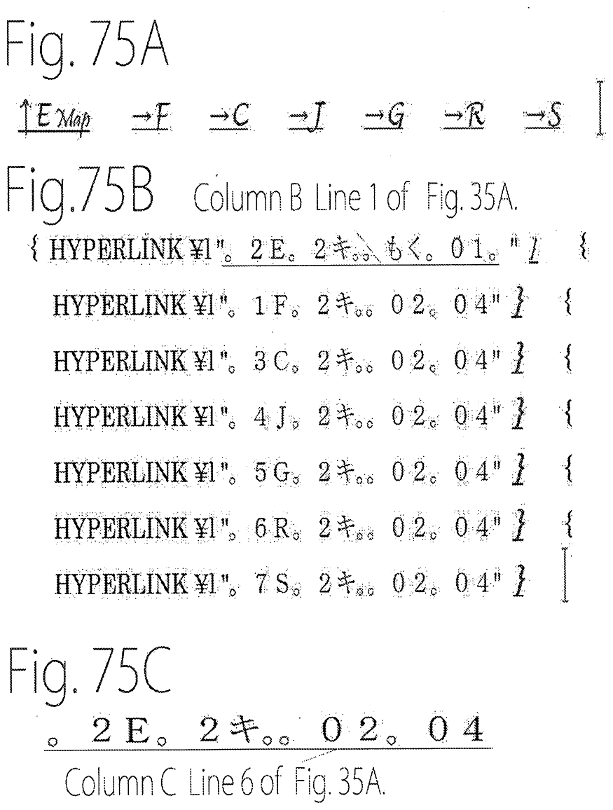

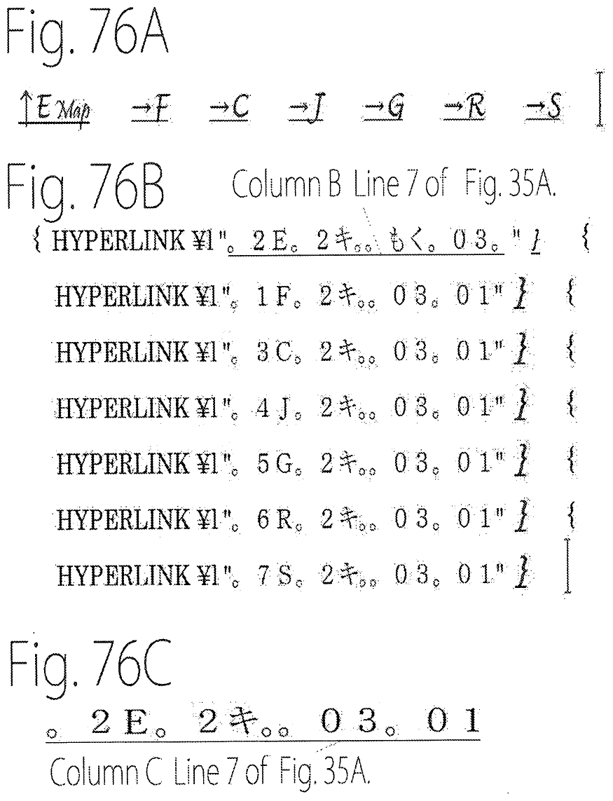

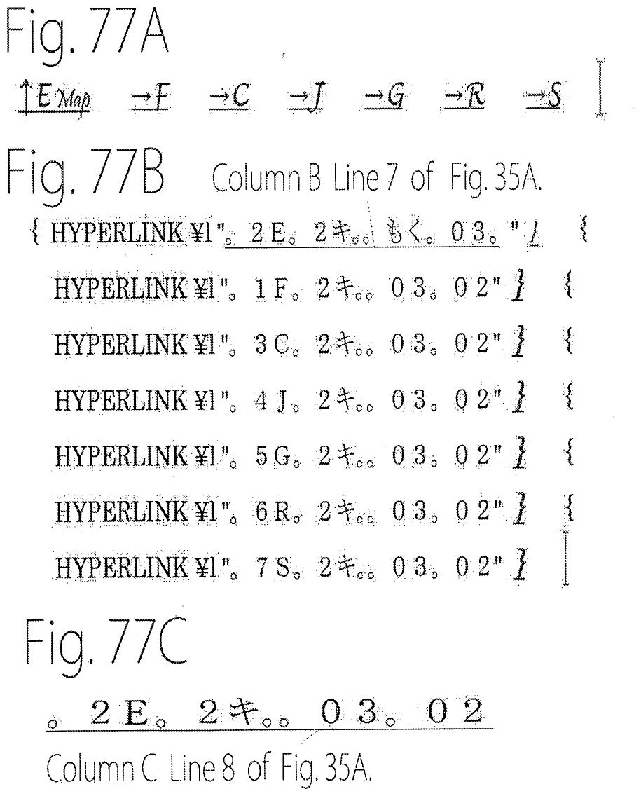

### 0.96.04: Drawings in FIGS. 69A to 69C

FIG. 69A is a configuration diagram illustrating the apparent side of science.

FIG. 69B is a configuration diagram illustrating hyperlinks side of science. The abstract link of the first line of FIG. 69B corresponds to column A of line 7 in FIG. 35A.

FIG. 69C is a configuration diagram illustrating anchor of science. The name thereof corresponds to column B of line 40 in FIG. 35B.

### 0.96.05: Drawings in FIGS. 70A to 70C

FIG. 70A is a configuration diagram illustrating the apparent side of science.

FIG. 70B is a configuration diagram illustrating hyperlinks side of science. The abstract link of the first line of FIG. 70B corresponds to column B of line 1 in FIG. 35A.

FIG. 70C is a configuration diagram illustrating anchor of science. The name thereof corresponds to column C of line 1 in FIG. 35A.

### 0.96.06: Drawings in FIGS. 71A to 71C

FIG. 71A is a configuration diagram illustrating the apparent side of science.

FIG. 71B is a configuration diagram illustrating hyperlinks side of science. The abstract link of the first line of FIG. 71B corresponds to column B of line 1 in FIG. 35A.

FIG. 71C is a configuration diagram illustrating anchor of science. The name thereof corresponds to column C of line 2 in FIG. 35A.

### 0.96.07: Drawings in FIGS. 72A to 72C

FIG. 72A is a configuration diagram illustrating the apparent side of science.

FIG. 72B is a configuration diagram illustrating hyperlinks side of science. The abstract link of the first line of FIG. 72B corresponds to column B of line 1 in FIG. 35A.

FIG. 72C is a configuration diagram illustrating anchor of science. The name thereof corresponds to column C of line 3 in FIG. 35A.

### 0.96.08: Drawings in FIGS. 73A to 73C

FIG. 73A is a configuration diagram illustrating the apparent side of science.

FIG. 73B is a configuration diagram illustrating hyperlinks side of science. The abstract link of the first line of FIG. 73B corresponds to column B of line 1 in FIG. 35A.

FIG. 73C is a configuration diagram illustrating anchor of science. The name thereof corresponds to column C of line 4 in FIG. 35A.

### 0.96.09: Drawings in FIGS. 74A to 74C

FIG. 74A is a configuration diagram illustrating the apparent side of science.

FIG. 74B is a configuration diagram illustrating hyperlinks side of science. The abstract link of the first line of FIG. 74B corresponds to column B of line 1 in FIG. 35A.

FIG. 74C is a configuration diagram illustrating anchor of science. The name thereof corresponds to column C of line 5 in FIG. 35A.

### 0.96.10: Drawings in FIGS. 75A to 75C

FIG. 75A is a configuration diagram illustrating the apparent side of science.

FIG. 75B is a configuration diagram illustrating hyperlinks side of science. The abstract link of the first line of FIG. 75B corresponds to column B of line 1 in FIG. 35A.

FIG. 75C is a configuration diagram illustrating anchor of science. The name thereof corresponds to column C of line 6 in FIG. 35A

### 0.96.11: Drawings in FIGS. 76A to 76C

FIG. 76A is a configuration diagram illustrating the apparent side of science.

FIG. 76B is a configuration diagram illustrating hyperlinks side of science. The abstract link of the first line of FIG. 76B corresponds to column B of line 7 in FIG. 35A.

FIG. 76C is a configuration diagram illustrating anchor of science. The name thereof corresponds to column C of line 7 in FIG. 35A.

### 0.96.12: Drawings in FIGS. 77A to 77C

FIG. 77A is a configuration diagram illustrating the apparent side of science.

FIG. 77B is a configuration diagram illustrating hyperlinks side of science. The abstract link of the first line of FIG. 77B corresponds to column B of line 7 in FIG. 35A.

FIG. 77C is a configuration diagram illustrating anchor of science. The name thereof corresponds to column C of line 8 in FIG. 35A.

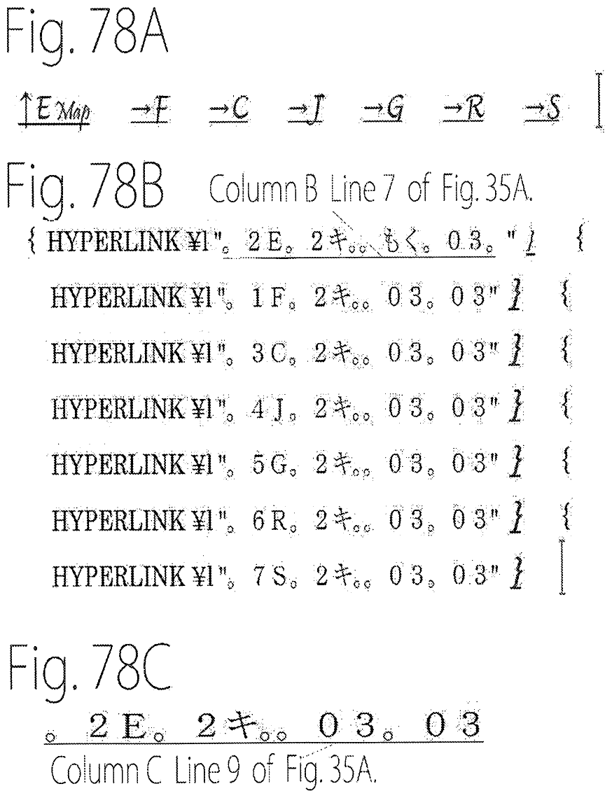

### 0.96.13: Drawings in FIGS. 78A to 78C

FIG. 78A is a configuration diagram illustrating the apparent side of science.

FIG. 78B is a configuration diagram illustrating hyperlinks side of science. The abstract link of the first line of FIG. 78B corresponds to column B of line 7 in FIG. 35A.

FIG. 78C is a configuration diagram illustrating anchor of science. The name thereof corresponds to column C of line 9 in FIG. 35A.

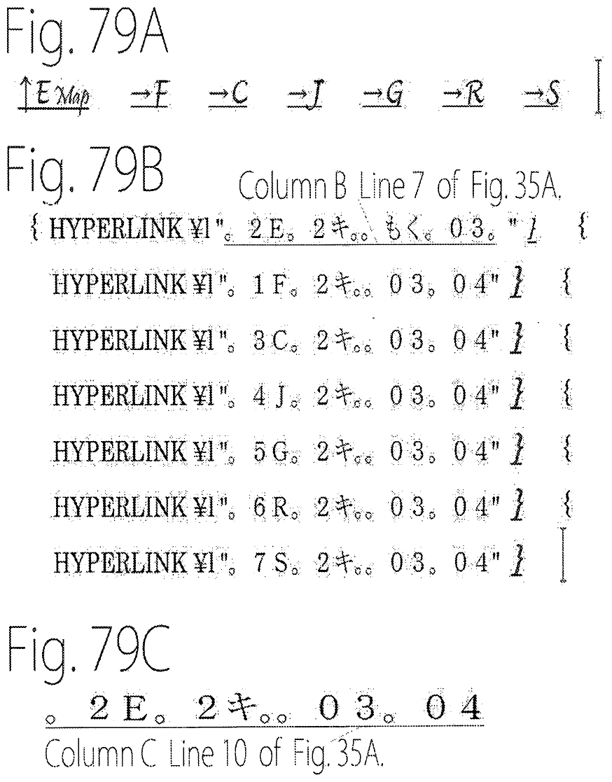

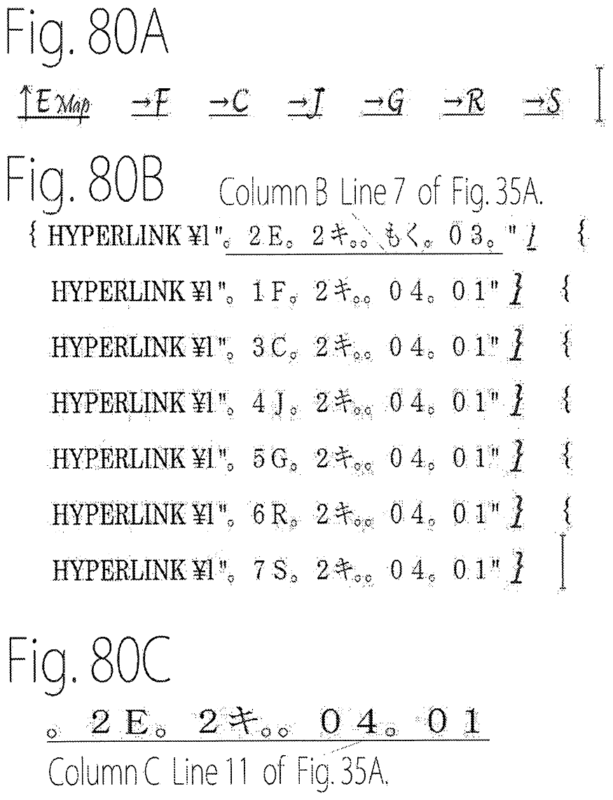

### 0.96.14: Drawings in FIGS. 79A to 79C

FIG. 79A is a configuration diagram illustrating the apparent side of science.

FIG. 79B is a configuration diagram illustrating hyperlinks side of science. The abstract link of the first line of FIG. 79B corresponds to column B of line 7 in FIG. 35A.

FIG. 79C is a configuration diagram illustrating anchor of science. The name thereof corresponds to column C of line 10 in FIG. 35A.

### 0.96.15: Drawings in FIGS. 80A to 80C

FIG. 80A is a configuration diagram illustrating the apparent side of science.

FIG. 80B is a configuration diagram illustrating hyperlinks side of science. The abstract link of the first line of FIG. 80B corresponds to column B of line 7 in FIG. 35A.

FIG. 80C is a configuration diagram illustrating anchor of science. The name thereof corresponds to column C of line 11 in FIG. 35A.

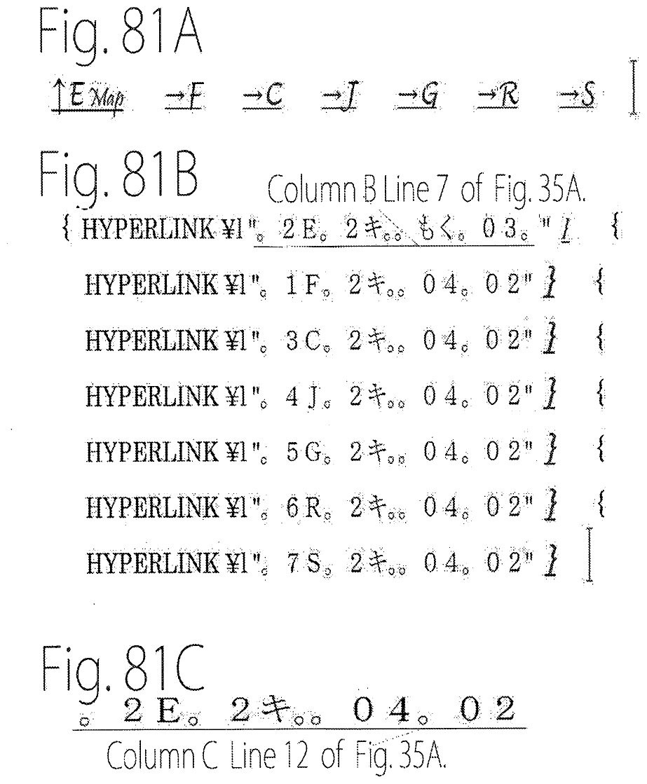

### 0.96.16: Drawings in FIGS. 81A to 81C

FIG. 81A is a configuration diagram illustrating the apparent side of science.

FIG. 81B is a configuration diagram illustrating hyperlinks side of science. The abstract link of the first line of FIG. 81B corresponds to column B of line 7 in FIG. 35A.

FIG. 81C is a configuration diagram illustrating anchor of science. The name thereof corresponds to column C of line 12 in FIG. 35A.

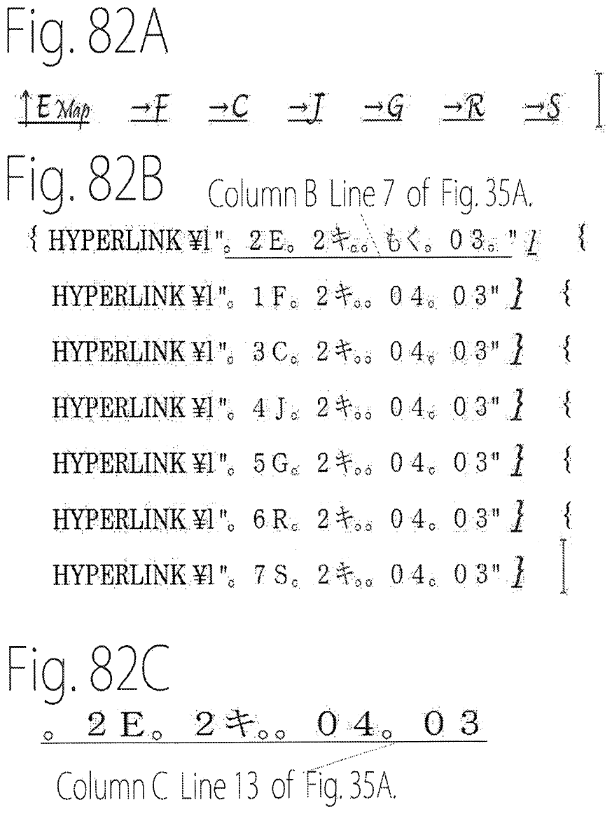

### 0.96.17: Drawings in FIGS. 82A to 82C

FIG. 82A is a configuration diagram illustrating the apparent side of science.

FIG. 82B is a configuration diagram illustrating hyperlinks side of science. The abstract link of the first line of FIG. 82B corresponds to column B of line 7 in FIG. 35A.

FIG. 82C is a configuration diagram illustrating anchor of science. The name thereof corresponds to column C of line 13 in FIG. 35A.

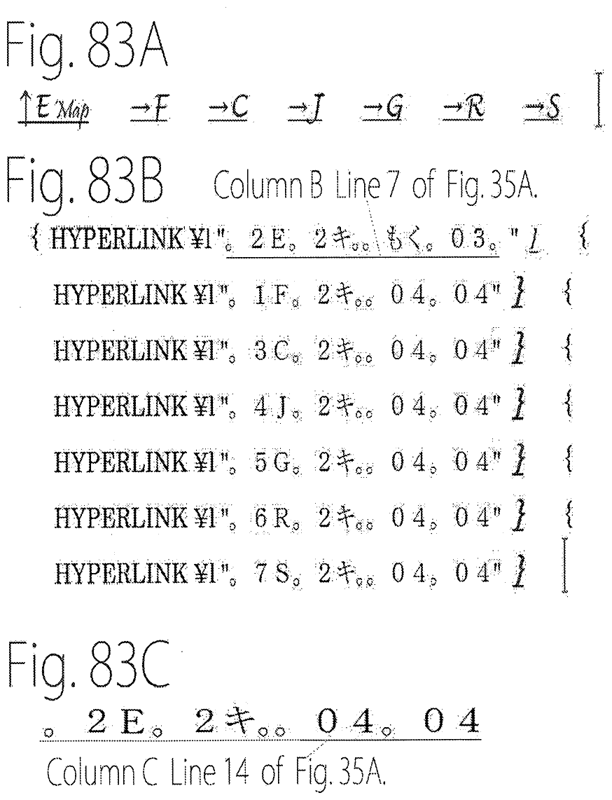

### 0.96.18: Drawings in FIGS. 83A to 83C

FIG. 83A is a configuration diagram illustrating the apparent side of science.

FIG. 83B is a configuration diagram illustrating hyperlinks side of science. The abstract link of the first line of FIG. 83B corresponds to column B of line 7 in FIG. 35A.

FIG. 83C is a configuration diagram illustrating anchor of science. The name thereof corresponds to column C of line 14 in FIG. 35A.

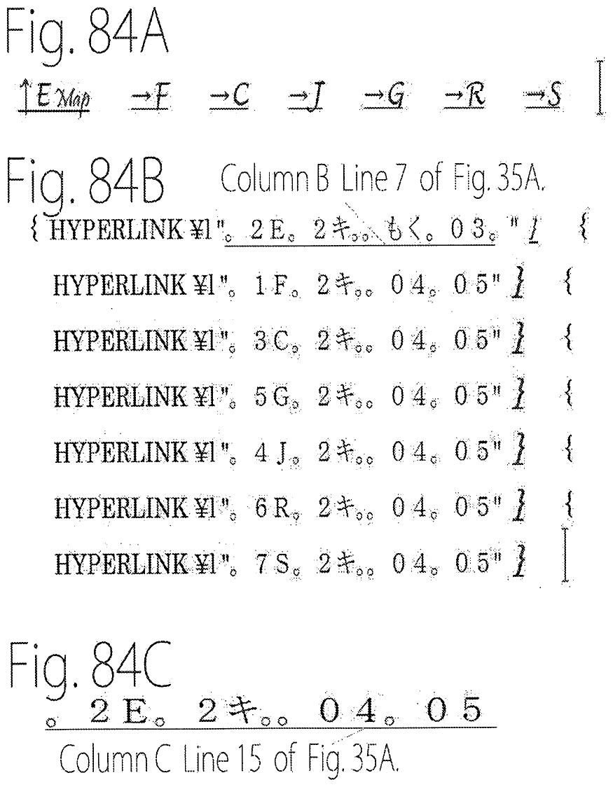

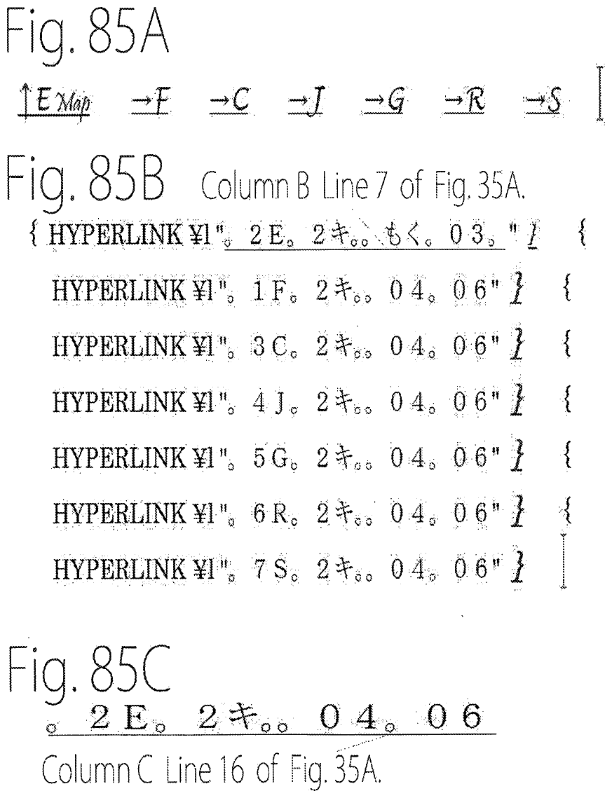

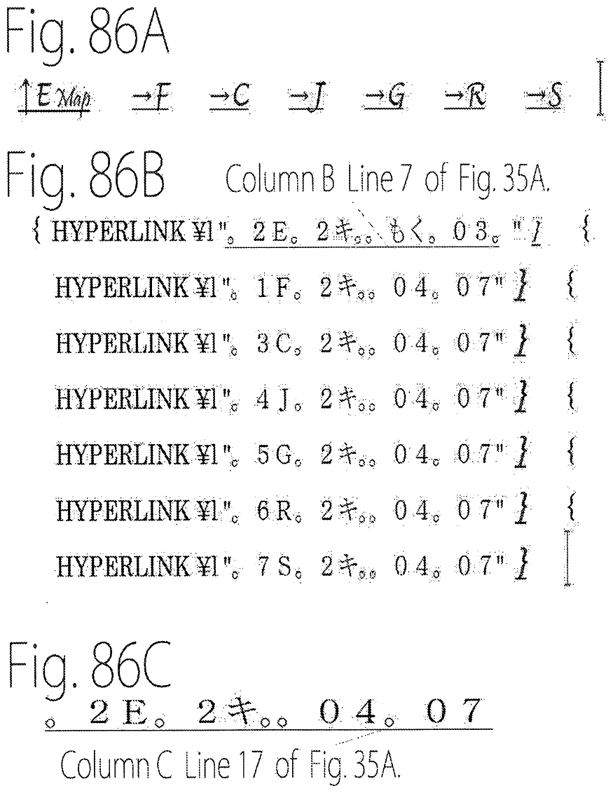

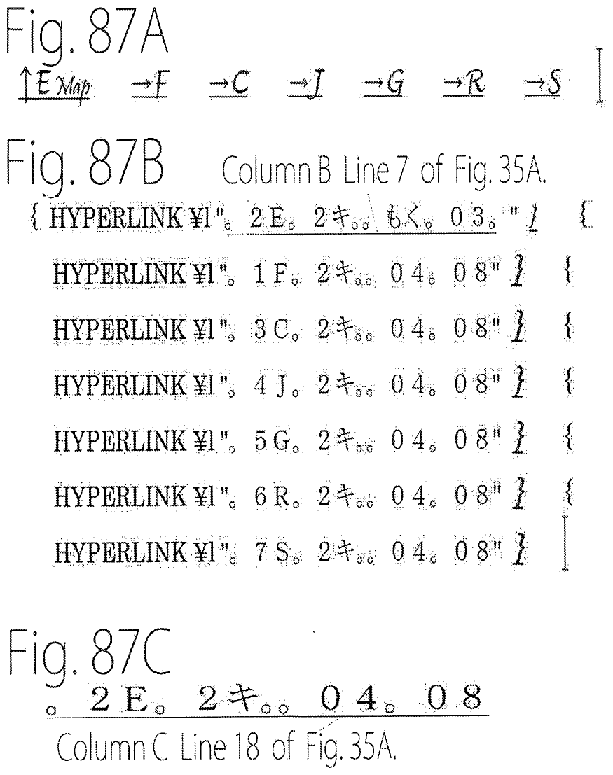

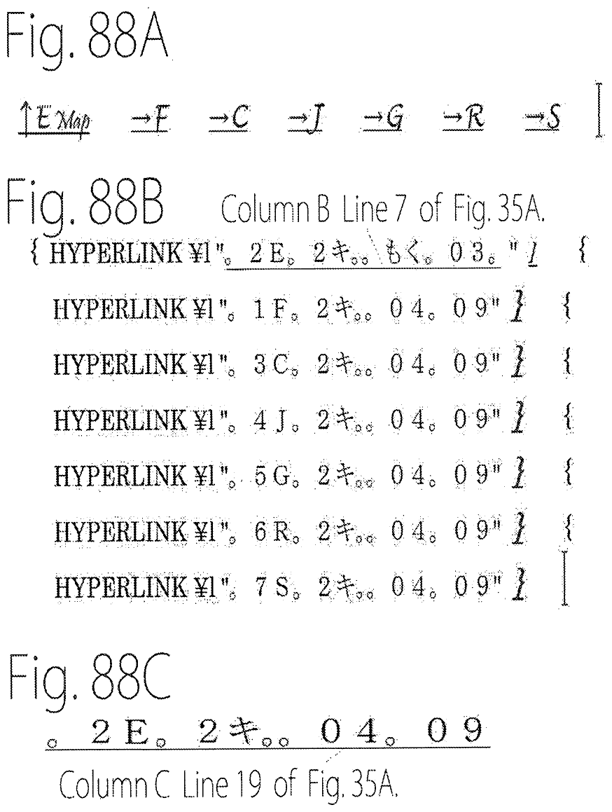

### 0.96.19: Drawings in FIGS. 84A to 84C

FIG. 84A is a configuration diagram illustrating the apparent side of science.

FIG. 84B is a configuration diagram illustrating hyperlinks side of science. The abstract link of the first line of FIG. 84B corresponds to column B of line 7 in FIG. 35A.

FIG. 84C is a configuration diagram illustrating anchor of science. The name thereof corresponds to column C of line 15 in FIG. 35A.

### 0.96.20: Drawings in FIGS. 85A to 85C

FIG. 85A is a configuration diagram illustrating the apparent side of science.

FIG. 85B is a configuration diagram illustrating hyperlinks side of science. The abstract link of the first line of FIG. 85B corresponds to column B of line 7 in FIG. 35A.

FIG. 85C is a configuration diagram illustrating anchor of science. The name thereof corresponds to column C of line 16 in FIG. 35A.

### 0.96.21: Drawings in FIGS. 86A to 86C

FIG. 86A is a configuration diagram illustrating the apparent side of science.

FIG. 86B is a configuration diagram illustrating hyperlinks side of science. The abstract link of the first line of FIG. 86B corresponds to column B of line 7 in FIG. 35A.

FIG. 86C is a configuration diagram illustrating anchor of science. The name thereof corresponds to column C of line 17 in FIG. 35A.

### 0.96.22: Drawings in FIGS. 87A to 87C

FIG. 87A is a configuration diagram illustrating the apparent side of science.

FIG. 87B is a configuration diagram illustrating hyperlinks side of science. The abstract link of the first line of FIG. 87B corresponds to column B of line 7 in FIG. 35A.

FIG. 87C is a configuration diagram illustrating anchor of science. The name thereof corresponds to column C of line 18 in FIG. 35A.

### 0.96.23: Drawings in FIGS. 88A to 88C

FIG. 88A is a configuration diagram illustrating the apparent side of science.

FIG. 88B is a configuration diagram illustrating hyperlinks side of science. The abstract link of the first line of FIG. 88B corresponds to column B of line 7 in FIG. 35A.

FIG. 88C is a configuration diagram illustrating anchor of science. The name thereof corresponds to column C of line 19 in FIG. 35A.

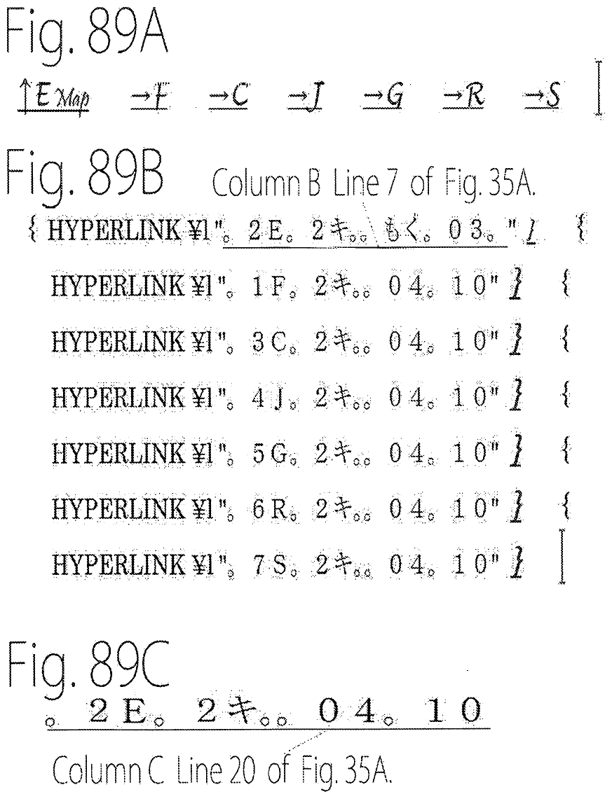

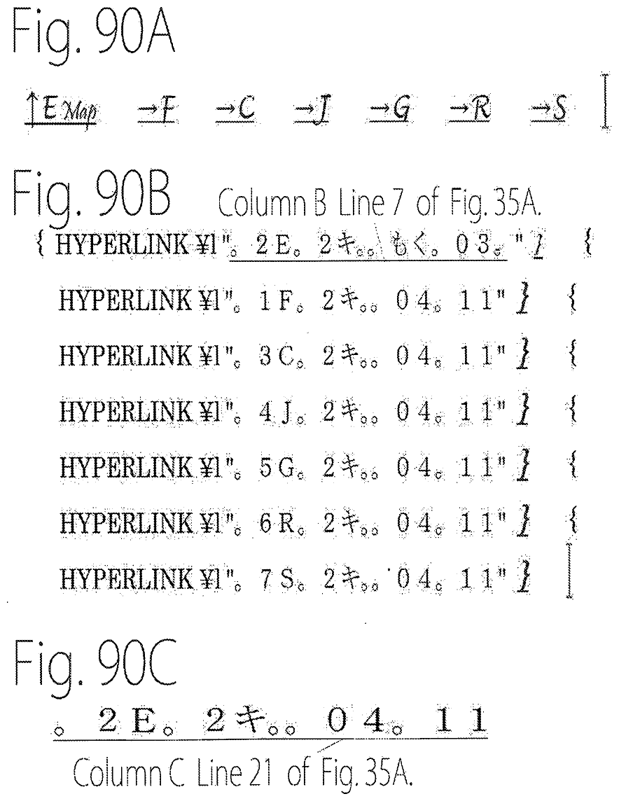

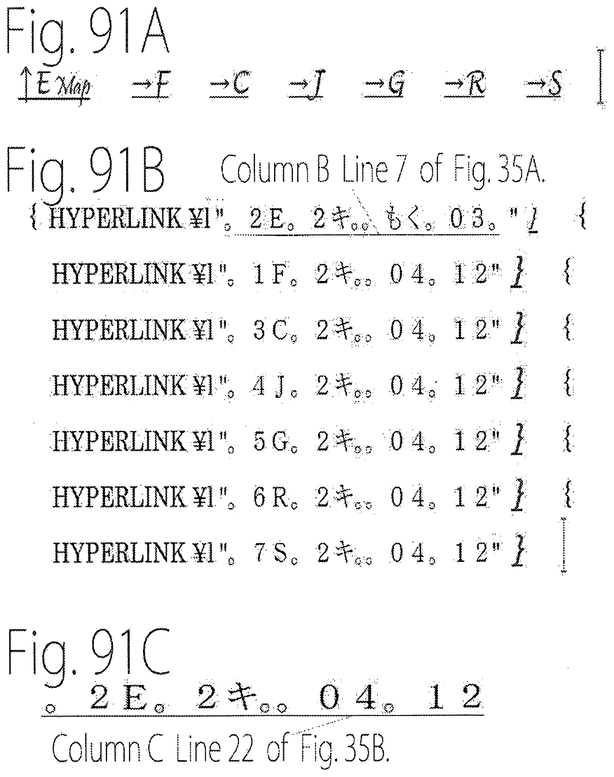

### 0.96.24: Drawings in FIGS. 89A to 89C

FIG. 89A is a configuration diagram illustrating the apparent side of science.

FIG. 89B is a configuration diagram illustrating hyperlinks side of science. The abstract link of the first line of FIG. 89B corresponds to column B of line 7 in FIG. 35A.

FIG. 89C is a configuration diagram illustrating anchor of science. The name thereof corresponds to column C of line 20 in FIG. 35A.

### 0.96.25: Drawings in FIGS. 90A to 90C

FIG. 90A is a configuration diagram illustrating the apparent side of science.

FIG. 90B is a configuration diagram illustrating hyperlinks side of science. The abstract link of the first line of FIG. 90B corresponds to column B of line 7 in FIG. 35A.

FIG. 90C is a configuration diagram illustrating anchor of science. The name thereof corresponds to column C of line 21 in FIG. 35A.

### 0.96.26: Drawings in FIGS. 91A to 91C

FIG. 91A is a configuration diagram illustrating the apparent side of science.

FIG. 91B is a configuration diagram illustrating hyperlinks side of science. The abstract link of the first line of FIG. 91B corresponds to column B of line 7 in FIG. 35A.

FIG. 91C is a configuration diagram illustrating anchor of science. The name thereof corresponds to column C of line 22 in FIG. 35B.

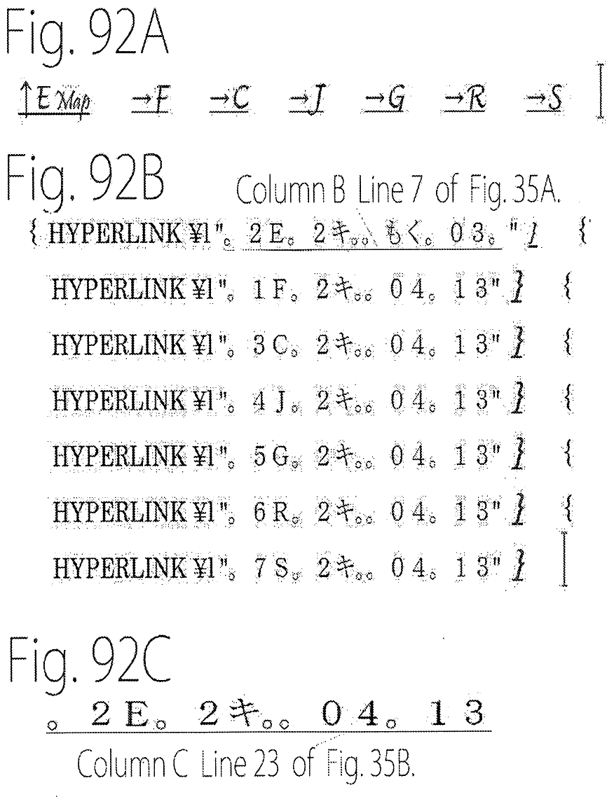

### 0.96.27: Drawings in FIGS. 92A to 92C

FIG. 92A is a configuration diagram illustrating the apparent side of science.

FIG. 92B is a configuration diagram illustrating hyperlinks side of science. The abstract link of the first line of FIG. 92B corresponds to column B of line 7 in FIG. 35A.

FIG. 92C is a configuration diagram illustrating anchor of science. The name thereof corresponds to column C of line 23 in FIG. 35B.

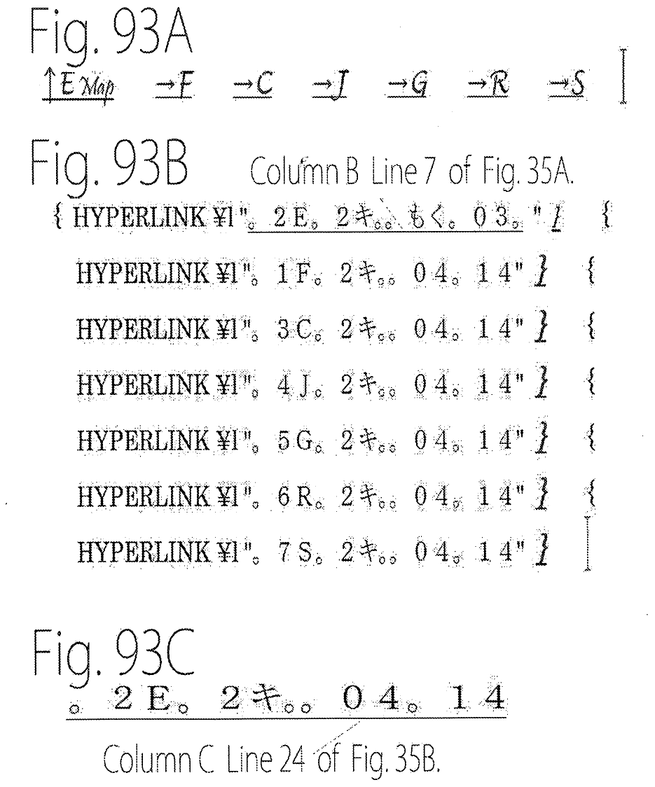

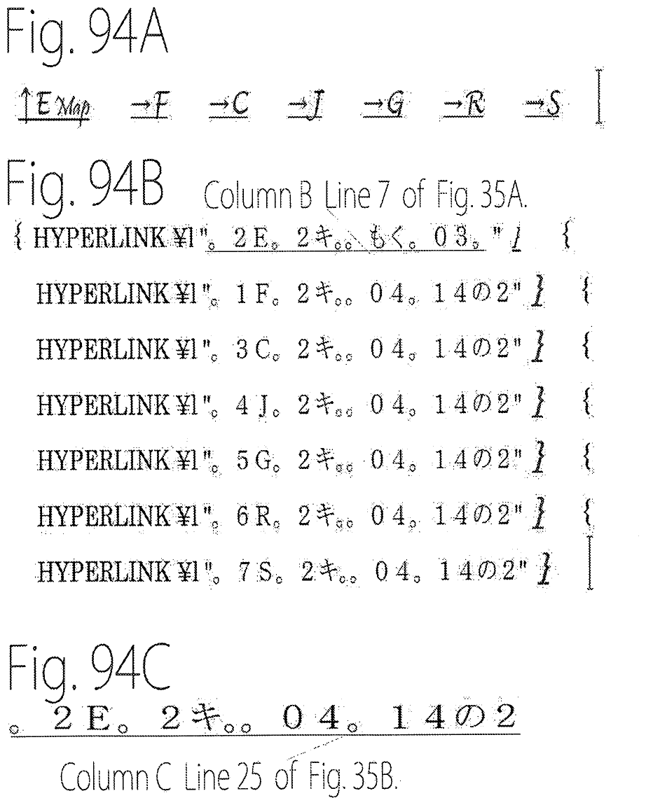

### 0.96.28: Drawings in FIGS. 93A to 93C

FIG. 93A is a configuration diagram illustrating the apparent side of science.

FIG. 93B is a configuration diagram illustrating hyperlinks side of science. The abstract link of the first line of FIG. 93B corresponds to column B of line 7 in FIG. 35A.

FIG. 93C is a configuration diagram illustrating anchor of science. The name thereof corresponds to column C of line 24 in FIG. 35B.

### 0.96.29: Drawings in FIGS. 94A to 94C

FIG. 94A is a configuration diagram illustrating the apparent side of science.

FIG. 94B is a configuration diagram illustrating hyperlinks side of science. The abstract link of the first line of FIG. 94B corresponds to column B of line 7 in FIG. 35A.

FIG. 94C is a configuration diagram illustrating anchor of science. The name thereof corresponds to column C of line 25 in FIG. 35B.

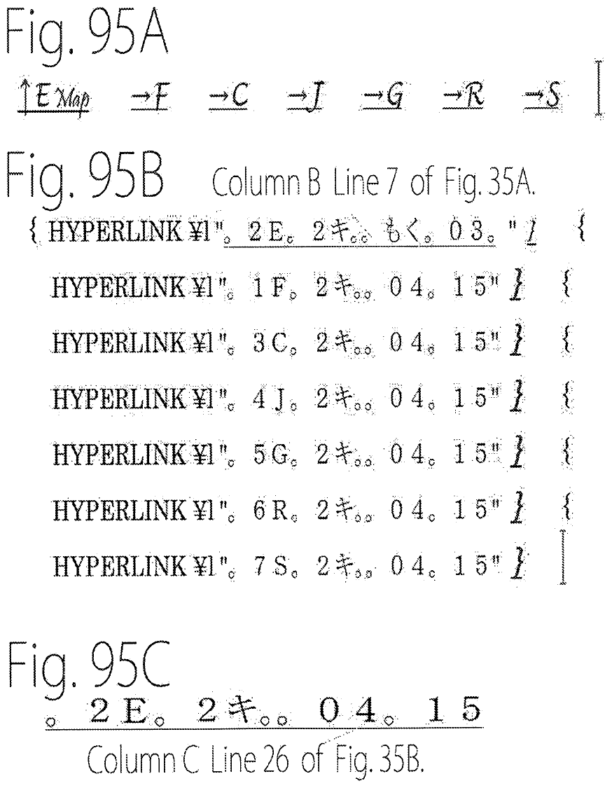

### 0.96.30: Drawings in FIGS. 95A to 95C

FIG. 95A is a configuration diagram illustrating the apparent side of science.

FIG. 95B is a configuration diagram illustrating hyperlinks side of science. The abstract link of the first line of FIG. 95B corresponds to column B of line 7 in FIG. 35A.

FIG. 95C is a configuration diagram illustrating anchor of science. The name thereof corresponds to column C of line 26 in FIG. 35B.

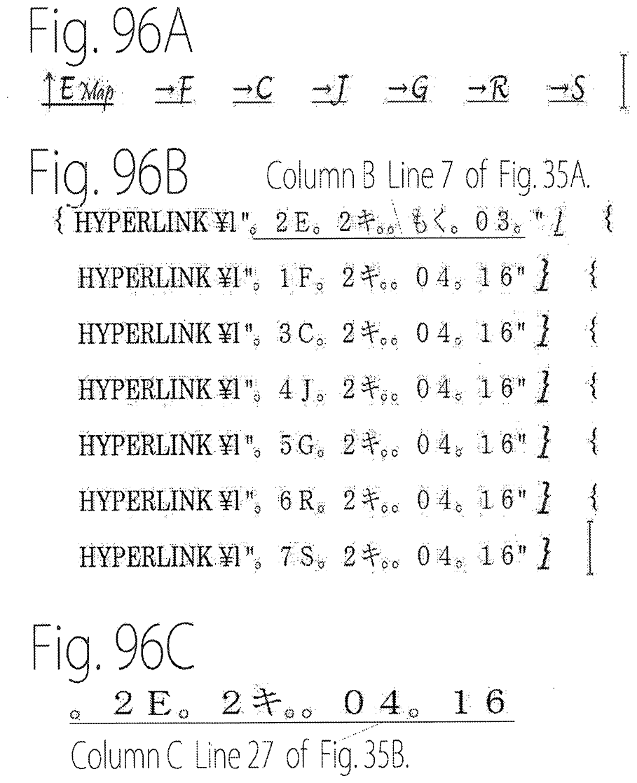

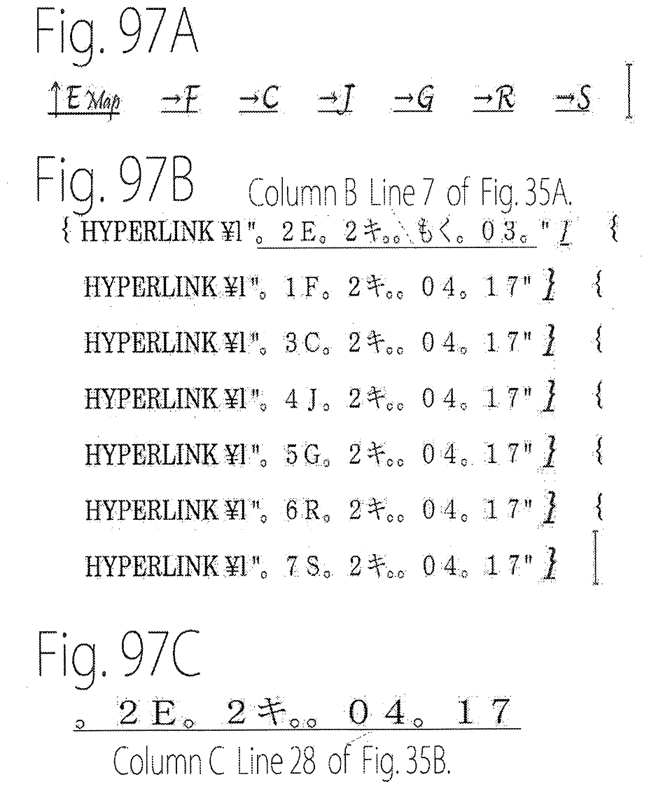

### 0.96.31: Drawings in FIGS. 96A to 96C

FIG. 96A is a configuration diagram illustrating the apparent side of science.

FIG. 96B is a configuration diagram illustrating hyperlinks side of science. The abstract link of the first line of FIG. 96B corresponds to column B of line 7 in FIG. 35A.

FIG. 96C is a configuration diagram illustrating anchor of science. The name thereof corresponds to column C of line 27 in FIG. 35B.

### 0.96.32: Drawings in FIGS. 97A to 97C

FIG. 97A is a configuration diagram illustrating the apparent side of science.

FIG. 97B is a configuration diagram illustrating hyperlinks side of science. The abstract link of the first line of FIG. 97B corresponds to column B of line 7 in FIG. 35A.

FIG. 97C is a configuration diagram illustrating anchor of science. The name thereof corresponds to column C of line 28 in FIG. 35B

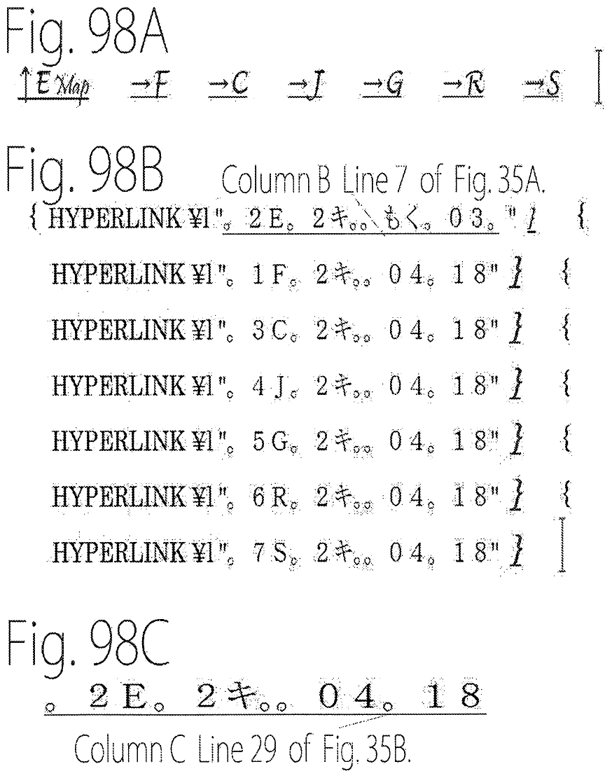

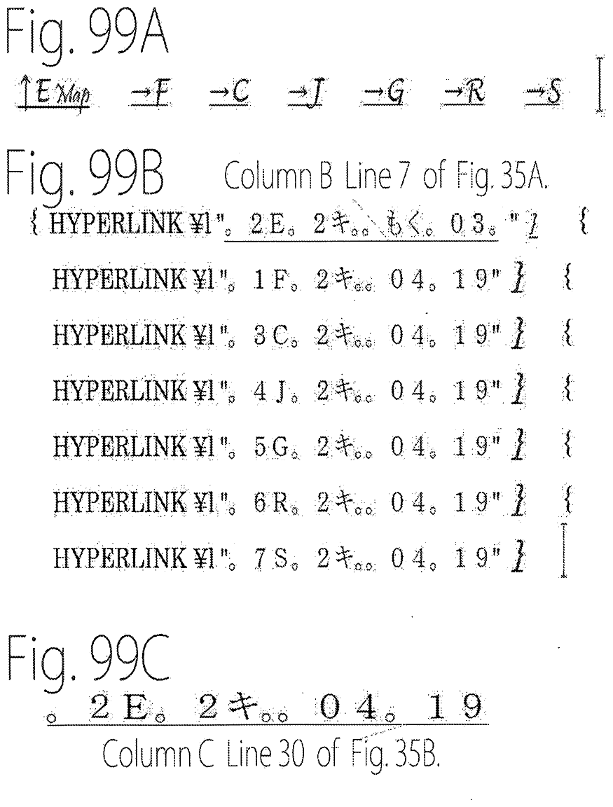

### 0.96.33: Drawings in FIGS. 98A to 98C

FIG. 98A is a configuration diagram illustrating the apparent side of science.

FIG. 98B is a configuration diagram illustrating hyperlinks side of science. The abstract link of the first line of FIG. 98B corresponds to column B of line 7 in FIG. 35A.

FIG. 98C is a configuration diagram illustrating anchor of science. The name thereof corresponds to column C of line 29 in FIG. 35B.

### 0.96.34: Drawings in FIGS. 99A to 99C

FIG. 99A is a configuration diagram illustrating the apparent side of science.

FIG. 99B is a configuration diagram illustrating hyperlinks side of science. The abstract link of the first line of FIG. 99B corresponds to column B of line 7 in FIG. 35A.

FIG. 99C is a configuration diagram illustrating anchor of science. The name thereof corresponds to column C of line 30 in FIG. 35B.

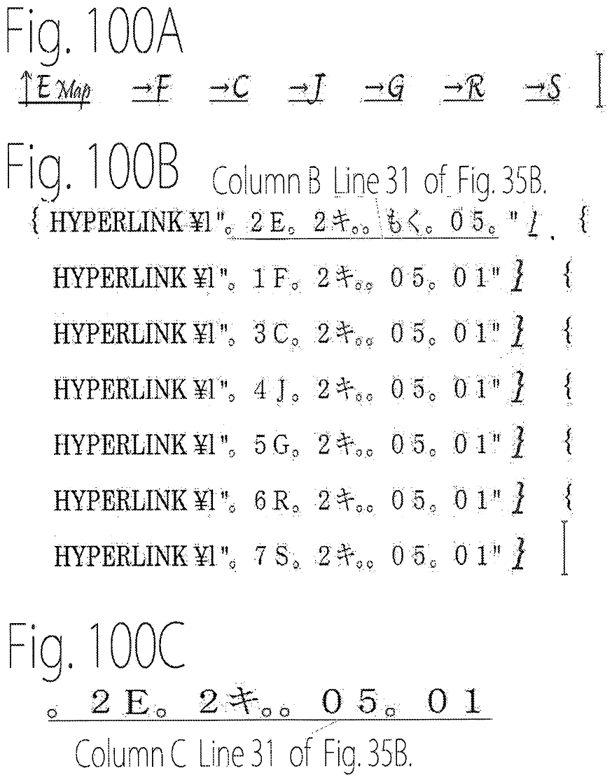

### 0.96.35: Drawings in FIGS. 100A to 100C

FIG. 100A is a configuration diagram illustrating the apparent side of science.

FIG. 100B is a configuration diagram illustrating hyperlinks side of science. The abstract link of the first line of FIG. 100B corresponds to column B of line 31 in FIG. 35B.

FIG. 100C is a configuration diagram illustrating anchor of science. The name thereof corresponds to column C of line 31 in FIG. 35B.

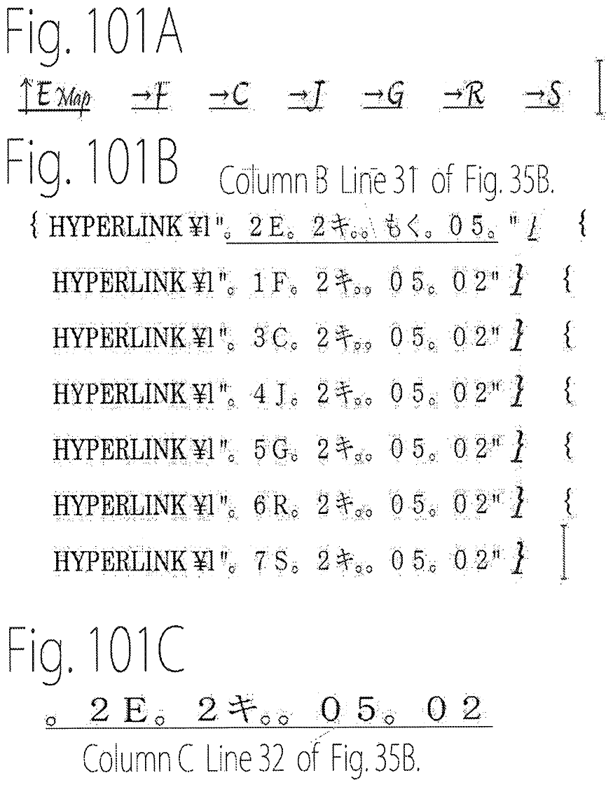

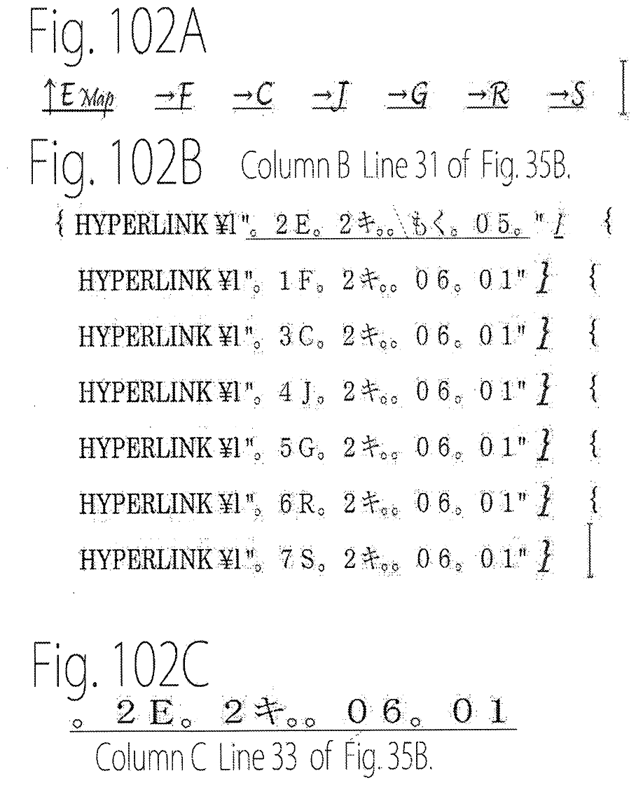

### 0.96.36: Drawings in FIGS. 101A to 101C

FIG. 101A is a configuration diagram illustrating the apparent side of science.

FIG. 101B is a configuration diagram illustrating hyperlinks side of science. The abstract link of the first line of FIG. 101B corresponds to column B of line 31 in FIG. 35B.

FIG. 101C is a configuration diagram illustrating anchor of science. The name thereof corresponds to column C of line 32 in FIG. 35B.

### 0.96.37: Drawings in FIGS. 102A to 102C

FIG. 102A is a configuration diagram illustrating the apparent side of science.

FIG. 102B is a configuration diagram illustrating hyperlinks side of science. The abstract link of the first line of FIG. 102B corresponds to column B of line 31 in FIG. 35B.

FIG. 102C is a configuration diagram illustrating anchor of science. The name thereof corresponds to column C of line 33 in FIG. 35B.

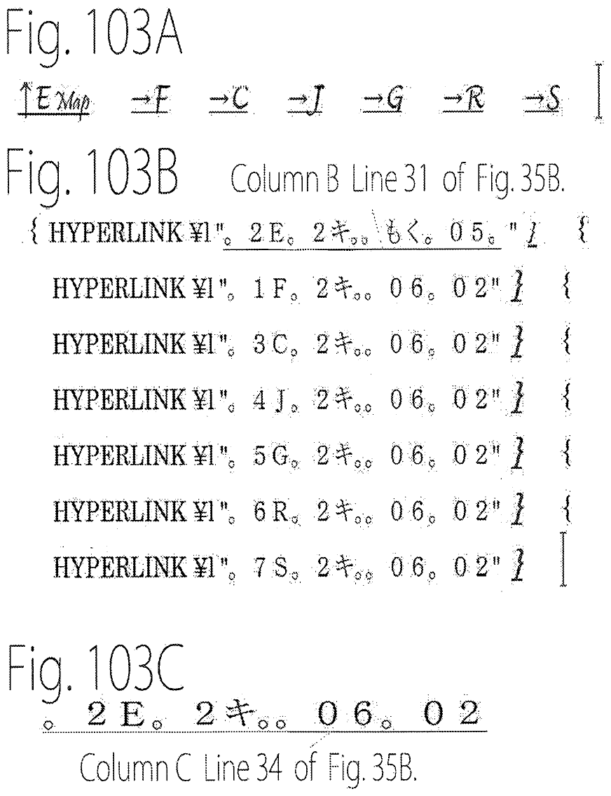

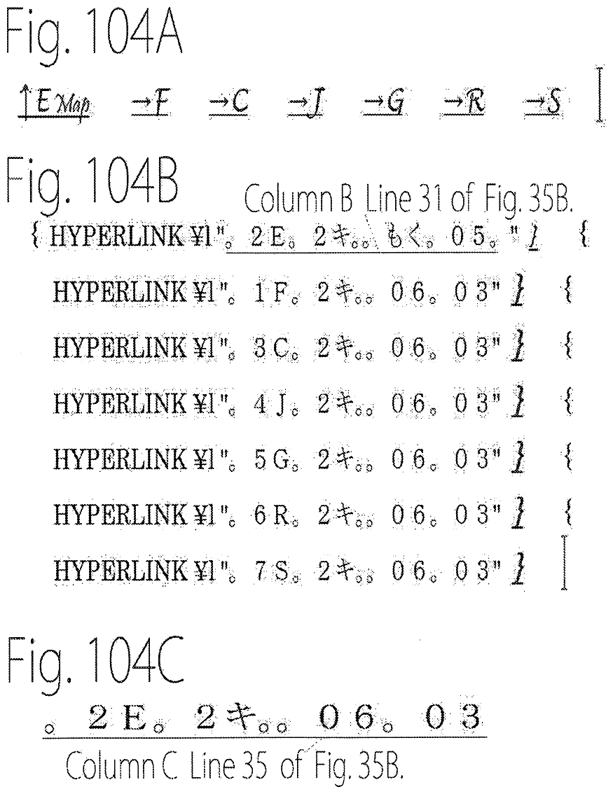

### 0.96.38: Drawings in FIGS. 103A to 103C

FIG. 103A is a configuration diagram illustrating the apparent side of science.

FIG. 103B is a configuration diagram illustrating hyperlinks side of science. The abstract link of the first line of FIG. 103B corresponds to column B of line 31 in FIG. 35B.

FIG. 103C is a configuration diagram illustrating anchor of science. The name thereof corresponds to column C of line 34 in FIG. 35B

### 0.96.39: Drawings in FIGS. 104A to 104C

FIG. 104A is a configuration diagram illustrating the apparent side of science.

FIG. 104B is a configuration diagram illustrating hyperlinks side of science. The abstract link of the first line of FIG. 104B corresponds to column B of line 31 in FIG. 35B.

FIG. 104C is a configuration diagram illustrating anchor of science. The name thereof corresponds to column C of line 35 in FIG. 35B

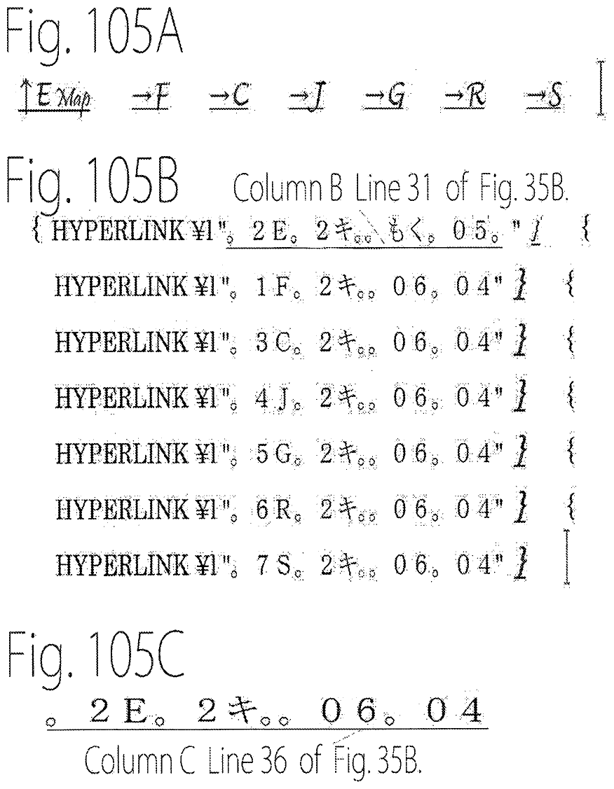

### 0.96.40: Drawings in FIGS. 105A to 105C

FIG. 105A is a configuration diagram illustrating the apparent side of science.

FIG. 105B is a configuration diagram illustrating hyperlinks side of science. The abstract link of the first line of FIG. 105B corresponds to column B of line 31 in FIG. 35B.

FIG. 105C is a configuration diagram illustrating anchor of science. The name thereof corresponds to column C of line 36 in FIG. 35B

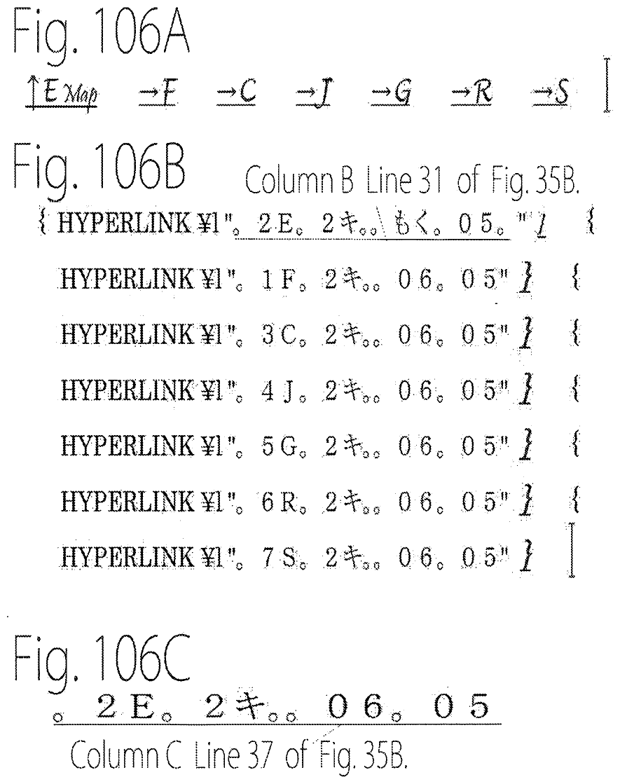

### 0.96.41: Drawings in FIGS. 106A to 106C

FIG. 106A is a configuration diagram illustrating the apparent side of science.

FIG. 106B is a configuration diagram illustrating hyperlinks side of science. The abstract link of the first line of FIG. 106B corresponds to column B of line 31 in FIG. 35B.

FIG. 106C is a configuration diagram illustrating anchor of science. The name thereof corresponds to column C of line 37 in FIG. 35B

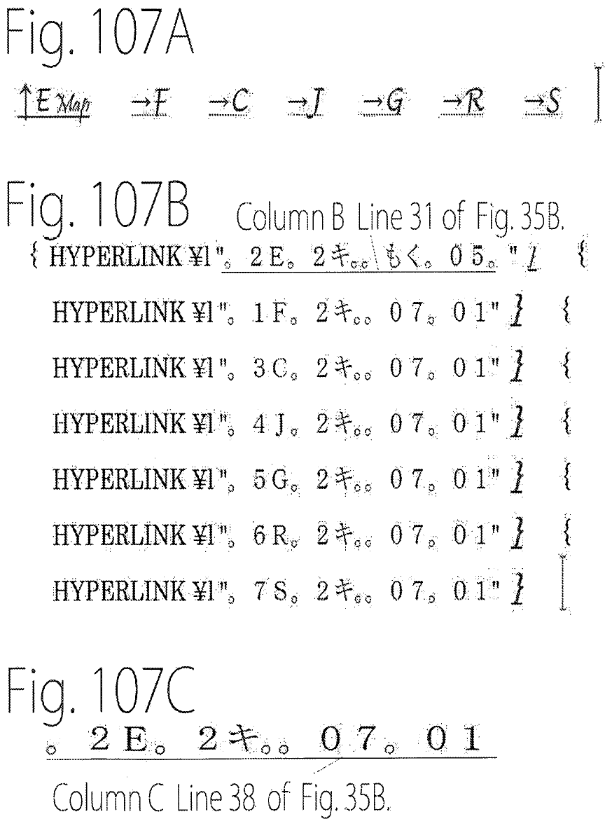

### 0.96.42: Drawings in FIGS. 107A to 107C

FIG. 107A is a configuration diagram illustrating the apparent side of science.

FIG. 107B is a configuration diagram illustrating hyperlinks side of science. The abstract link of the first line of FIG. 107B corresponds to column B of line 31 in FIG. 35B.

FIG. 107C is a configuration diagram illustrating anchor of science. The name thereof corresponds to column C of line 38 in FIG. 35B

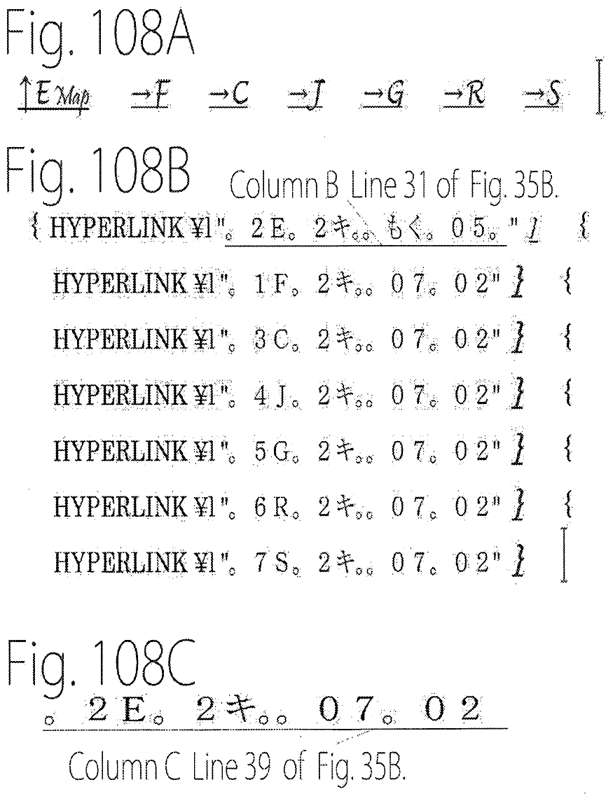

### 0.96.43: Drawings in FIGS. 108A to 108C

FIG. 108A is a configuration diagram illustrating the apparent side of science.

FIG. 108B is a configuration diagram illustrating hyperlinks side of science. The abstract link of the first line of FIG. 108B corresponds to column B of line 31 in FIG. 35B.

FIG. 108C is a configuration diagram illustrating anchor of science. The name thereof corresponds to column C of line 39 in FIG. 35B

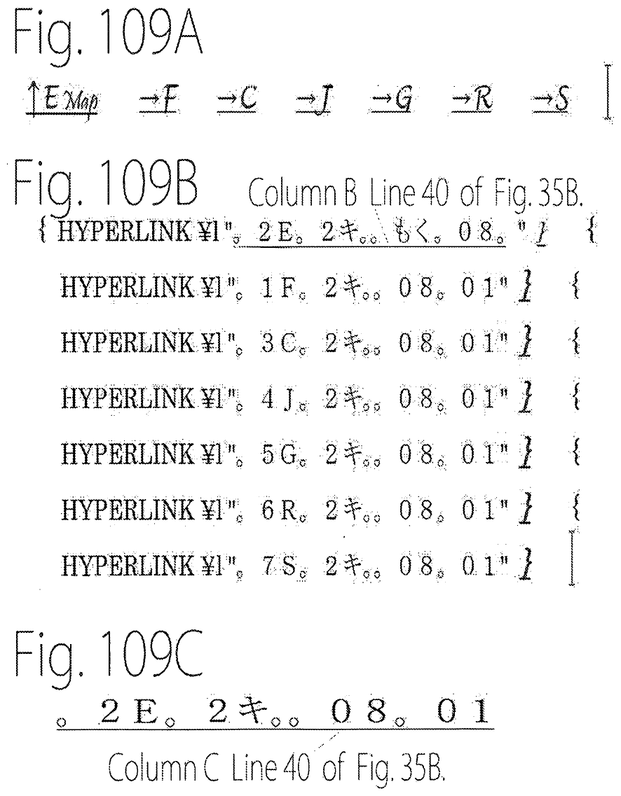

### 0.96.44: Drawings in FIGS. 109A to 109C

FIG. 109A is a configuration diagram illustrating the apparent side of science.

FIG. 109B is a configuration diagram illustrating hyperlinks side of science. The abstract link of the first line of FIG. 109B corresponds to column B of line 40 in FIG. 35B.

FIG. 109C is a configuration diagram illustrating anchor of science. The name thereof corresponds to column C of line 40 in FIG. 35B

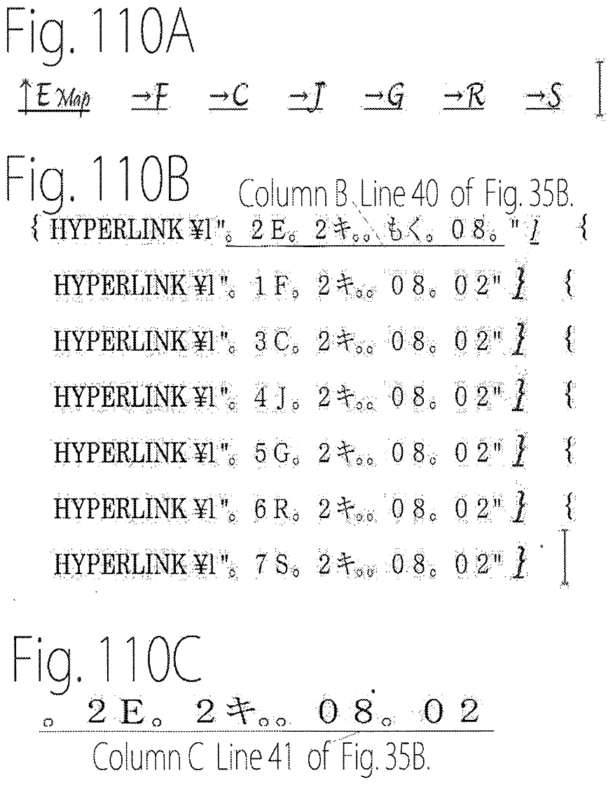

### 0.96.45: Drawings in FIGS. 110A to 110C

FIG. 110A is a configuration diagram illustrating the apparent side of science.

FIG. 110B is a configuration diagram illustrating hyperlinks side of science. The abstract link of the first line of FIG. 110B corresponds to column B of line 40 in FIG. 35B.

FIG. 110C is a configuration diagram illustrating anchor of science. The name thereof corresponds to column C of line 41 in FIG. 35B.

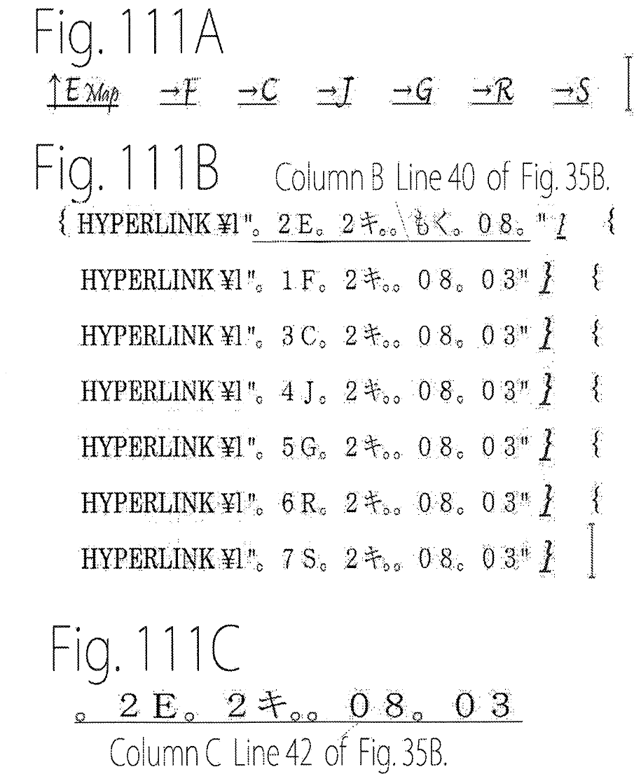

### 0.96.46: Drawings in FIGS. 111A to 111C

FIG. 111A is a configuration diagram illustrating the apparent side of science.

FIG. 111B is a configuration diagram illustrating hyperlinks side of science. The abstract link of the first line of FIG. 111B corresponds to column B of line 40 in FIG. 35B.

FIG. 111C is a configuration diagram illustrating anchor of science. The name thereof corresponds to column C of line 42 in FIG. 35B.

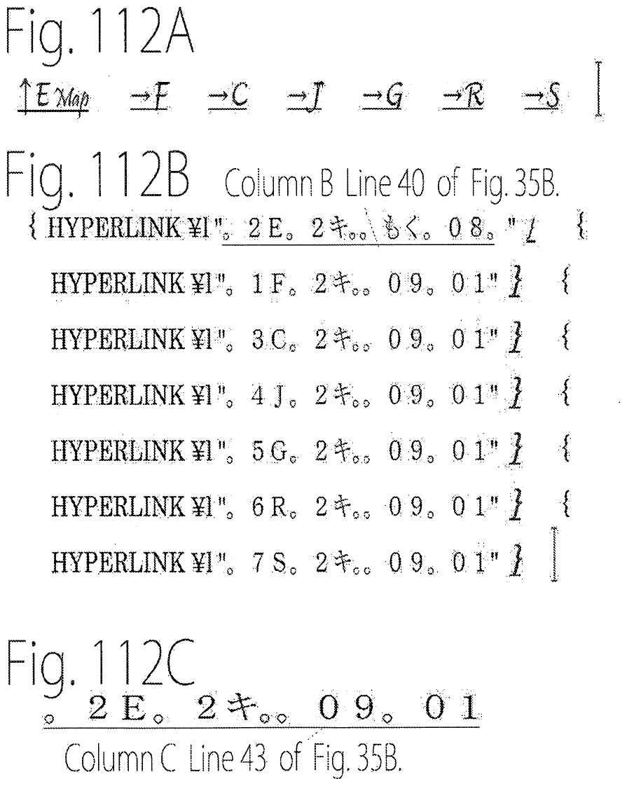

### 0.96.47: Drawings in FIGS. 112A to 112C

FIG. 112A is a configuration diagram illustrating the apparent side of science.

FIG. 112B is a configuration diagram illustrating hyperlinks side of science. The abstract link of the first line of FIG. 112B corresponds to column B of line 40 in FIG. 35B.

FIG. 112C is a configuration diagram illustrating anchor of science. The name thereof corresponds to column C of line 43 in FIG. 35B.

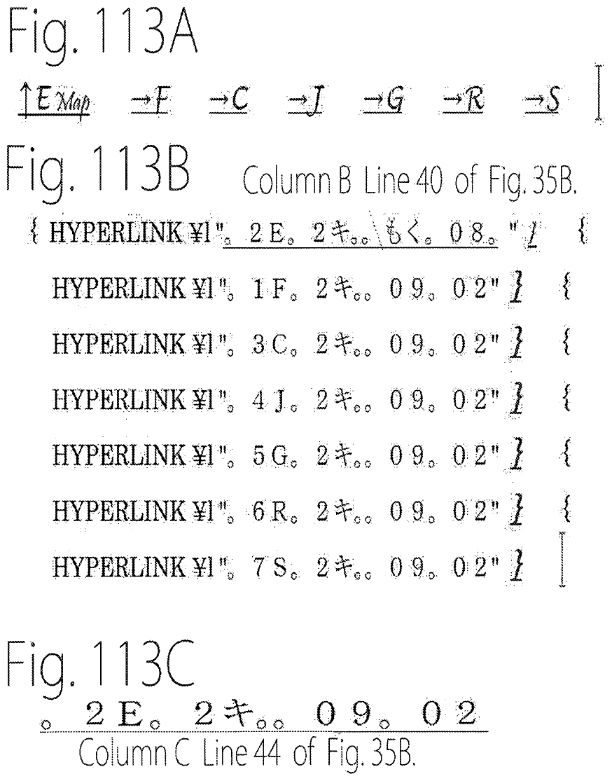

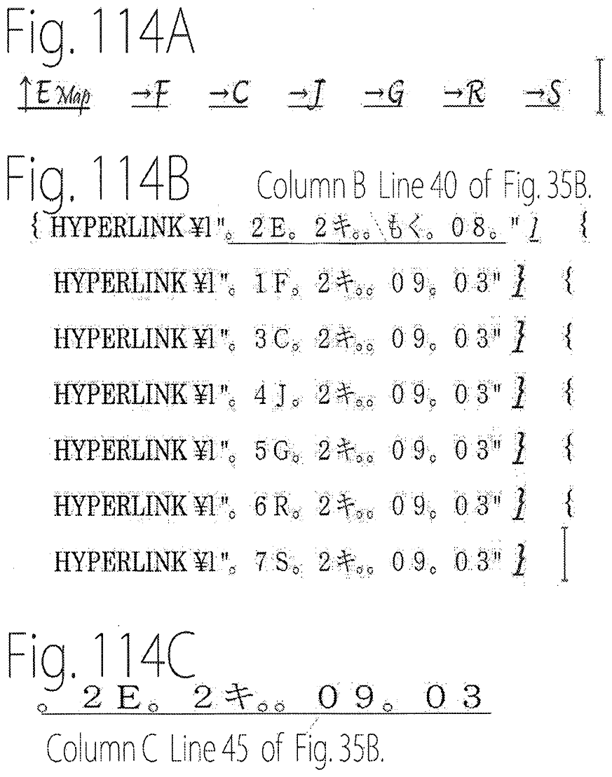

### 0.96.48: Drawings in FIGS. 113A to 113C

FIG. 113A is a configuration diagram illustrating the apparent side of science.

FIG. 113B is a configuration diagram illustrating hyperlinks side of science. The abstract link of the first line of FIG. 113B corresponds to column B of line 40 in FIG. 35B.

FIG. 113C is a configuration diagram illustrating anchor of science. The name thereof corresponds to column C of line 44 in FIG. 35B.

### 0.96.49: Drawings in FIGS. 114 to 114C

FIG. 114A is a configuration diagram illustrating the apparent side of science.

FIG. 114B is a configuration diagram illustrating hyperlinks side of science. The abstract link of the first line of FIG. 114B corresponds to column B of line 40 in FIG. 35B.

FIG. 114C is a configuration diagram illustrating anchor of science. The name thereof corresponds to column C of line 45 in FIG. 35B.

### 0.97: Drawings in FIGS. 115A to 115J

FIG. 115A is a diagram for illustrating that the first line of FIG. 6E refers to jumps to other separate files.

FIG. 115B is a diagram for illustrating jumps to seven separate files which correspond to the second line of FIG. 6E.

FIG. 115C is a diagram for illustrating jumps to seven separate files which correspond to the third line of FIG. 6E.

FIG. 115D is a diagram for illustrating jumps to seven separate files which correspond to the fourth line of FIG. 6E

FIG. 115E is a diagram for illustrating jumps to seven separate files which correspond to the fifth line of FIG. 6E

FIG. 115F is a diagram for illustrating jumps to seven separate files which correspond to the sixth line of FIG. 6E

FIG. 115G is a diagram for illustrating jumps to seven separate files which correspond to the seventh line of FIG. 6E

FIG. 115H is a diagram for illustrating that returnable jumps are established among all setting regions when FIG. 115A to FIG. 115G are combined.

FIG. 115I is a diagram for illustrating that when the lower level segments of names are the multiplicative increase, and returnable jumps can be executed among the verbatim in which respective lower level segments are the same.

FIG. 115J is a diagram for illustrating overall images when the applicant embedded about 40,000 hyperlinks in an electronic file with 7,200 pages, which are present at http//www.jpeg.jp/1.01.pdf. FIG. 1 was excerpted from this electronic file.

### 0.98: Drawings in FIGS. 116A to 116H, FIG. 117, FIG. 118, and FIG. 126

FIG. 116A is a diagram for re-posting the case where there are two anchors in the replacement of building drawings in FIG. 26. The anchors of the Old System and the New System are laid out in each of the setting region 97 on the same page. The left <,,1> is affixed to the Old System, and the right <,,2> is affixed to the New System.

FIG. 116B is a diagram for illustrating the case where names are in the location order, and then names intersect alternately.

FIG. 116C is a diagram for illustrating the case where anchors are sorted in the name order. In this case <,,1> is the Old System.

FIG. 116D is a diagram for illustrating the case where anchors are sorted in the naming order. In this case <,,2> is the New System.

FIG. 116E is a diagram for illustrating the case where anchors are arrayed in the naming order. The Old System. The New System. They are respectively, separated into two blocks in the naming order by sorting. But they are continuous as a straight line.

FIG. 116F is a diagram for illustrating the case where anchors are arrayed in the naming order. They are continuous like <0M,,1> <0M,,2> <1M,,1> <1M,,2> <2M,,1> <2M,,2>. It suggests that separation of names indicates that the table of contents can be reorganized according to different systems. From this view point, new invention will be written.

FIG. 116G is a diagram for illustrating the case where anchors are arrayed in the location order. It suggests that double names at the content receive jumping from the double systems.

FIG. 116H is a diagram for illustrating the fact that anchors in the setting region 97 are crossing when two systematically differ, each of them can be compared to each other. In that case, like DNA binding.

FIG. 117 is a diagram for illustrating that time is not affixed to apparent names of sciences in the second line and the third line of FIG. 117. However, hidden names are changed while the field codes are opened. Namely, the field codes are opened when executing one-round replacement through higher level segments of the names of the hyperlinks. In step 24 and step 29 in FIG. 16. In step 25 and step 30 in FIG. 16.

FIG. 118 is a photo of the observatory. Since a reflection mirror becomes deformed due to gravitational force, distortions are calculated by using the targets. When calculating errors, keeping a record of information in detail in sentence form, therefore writing of opinions will be more helpful for error calculation than only numerical values like CSV file style.

### 0.981: Drawings in FIGS. 119A to 119G

FIG. 119A shows a heptagon. In FIG. 119A, a hyperlink jump relationship is not yet established.

FIG. 119B hyperlinks are already set up to jumps among “1F” and “2E”.

In FIG. 119C hyperlinks are already set up to jumps among “1F”, “2E”, and “3C”. In this case, 3(3−1)=6 jumps are required to exchange information to go back and forth from each other.

In FIG. 119D hyperlinks are already set up to jumps among “1F”, “2E”, “3C” and “4J”. In this case, 4(4−1)=12 jumps are required to exchange information to go back and forth from each other.

In FIG. 119E hyperlinks are already set up jumps among “1F”, “2E” “3C”, “4J” and “5D”. In this case, 5(5−1)=20 jumps are required to exchange information to go back and forth from each other.

In FIG. 119F hyperlinks are already set up jumps among “1F”, “2E”, “3C”, “4J”, “5D” and “6R”. In this case, 6(6−1)=30 jumps are required to exchange information to go back and forth from each other.

In FIG. 119G hyperlinks are already set up to jump among “1F”, “2E”, “3C”, “4J”, “5D”, “6R” and “7S”. In this case, 7(7−1)=42 jumps are required to exchange information to go back and forth from each other.

### 0.982: Drawings FIGS. 120A to 120G

FIG. 120A looks at FIG. 119A from another perspective. FIG. 120A has two heptagonal shapes. But, as shown in FIG. 120A, each two heptagonal is before the jump is created.

FIG. 120B looks at FIG. 119B from another perspective. FIG. 120B has two heptagonal shapes. In FIG. 120B, hyperlinks are only set up to jumps within each “1F” and “2E” of each shape.

FIG. 120C looks at FIG. 119C from another perspective. FIG. 120C has two heptagonal shapes. Hyperlinks are already set up to jumps between each 1F, 2E, and 3C of each shape.

FIG. 120D looks at FIG. 119D from another perspective. FIG. 120D has two heptagonal shapes. Hyperlinks are already set up to jumps between each “1F”, “2E”, “3C”, and “4J” of each shape.

FIG. 120E looks at FIG. 119E from another perspective. FIG. 120E has two heptagonal shapes. Hyperlinks are already set up to jumps between each 1F, 2E, 3C, 4J and 5D of each shape.

FIG. 120F looks at FIG. 119E from another perspective. FIG. 120F has two heptagonal shapes. Hyperlinks are already set up to jumps between each “1F”, “2E”, “3C”, “4J”, “5D”, and “6R” of each shape.

FIG. 120G looks at FIG. 119G from another perspective. FIG. 120G has two heptagonal shapes. Hyperlinks are already set up to jumps perfectly between hyperlinks groups of each shape.

### 0.983: Drawings FIGS. 120A to 120G

FIG. 121A is another view of FIG. 119A and FIG. 120A. In FIG. 121A, two verbatim can be seen which have the same lower names of “˜.1” and “˜.2”. And at the right end of FIG. 121A, two anchors can be seen. These two are French Article 1 (.1F. 1) and French Article 2 (.1F. 2).

FIG. 121B is another view of FIG. 119B and FIG. 120B. In FIG. 121B, two verbatim are further added which have the same lower names of “˜.1” and “˜.2”. Two anchors added at that time are displayed at the right end of FIG. 122B. These two names are for English Article 1 (.2E. 1), and for English Article 2 (.2E. 2).

FIG. 121C is another view of FIG. 119C and FIG. 120C. In FIG. 121C, two verbatim are further added which have the same lower names of “˜.1” and “˜.2”. Two anchors added at that time are displayed at the right end of FIG. 121C. These two names are for Chinese Article 1 (.3C.1) and for Chinese Article 2(.3C.2).

FIG. 121D is another view of FIG. 119D and FIG. 120D. Samely, in FIG. 121D, two verbatim are further added which have the same lower names of “˜.1” and “˜.2”. Two anchors added at that time are displayed at the right end of FIG. 121D. These two names are for Japanese Article 1(.4J.1) and for Japanese Article 2(.4J.2).

FIG. 121E is another view of FIG. 119E and FIG. 120E. Samely, in FIG. 121E, two verbatim are further added which have the same lower names of “˜.1” and “˜.2”. Two anchors added at that time are displayed at the right end of FIG. 121E. These two names are for German Article 1(.5G.1) and for German Article 2(.5G.2).

FIG. 121F is another view of FIG. 119F and FIG. 120F. Samely, in FIG. 121F, two verbatim are further added which have the same lower names of “˜.1” and “˜.2”. Two anchors added at that time are displayed at the right end of FIG. 121F. These two names are for Russian Article 1(.6R.1) and for Russian Article 2(.6R.2).

FIG. 121G is another view of FIG. 119G and FIG. 120G. Samely, in FIG. 121G, two verbatim are further added which have the same lower names of “˜.1” and “˜.2”. Two anchors added at that time are displayed at the right end of FIG. 121G. These two names are for Spanish Article 1(.7S.1) and for Spanish Article 2(.7S.2).

### 0.984.1: Drawings from FIG. 122 to FIG. 126

FIG. 122 is a reproduction of FIG. 115J, which is a representative drawing of the parent application. And this is a figure which shows the conceptual whole shape of this invention.

FIG. 123 is the hidden side of FIG. 126. Here, it is required to generate a 64-sided jump zone.

FIG. 124 explains how to increase another setting regions while repeatedly performing drop offs and replenishment for hyperlinks.

FIG. 125 describes how to establish jumps when the hyperlink which suggest the content is not dropped off.

FIG. 126 is another figure of FIG. 32. In FIG. 32, 5C is missing, but in FIG. 126, there is no missing. When there is no drop off, the corresponding part jumps to an anchor arranged on the same page, so that screen transition is not performed. Therefore, as a feeling of gaze, it feels that there is no reaction even if the corresponding part is clicked.

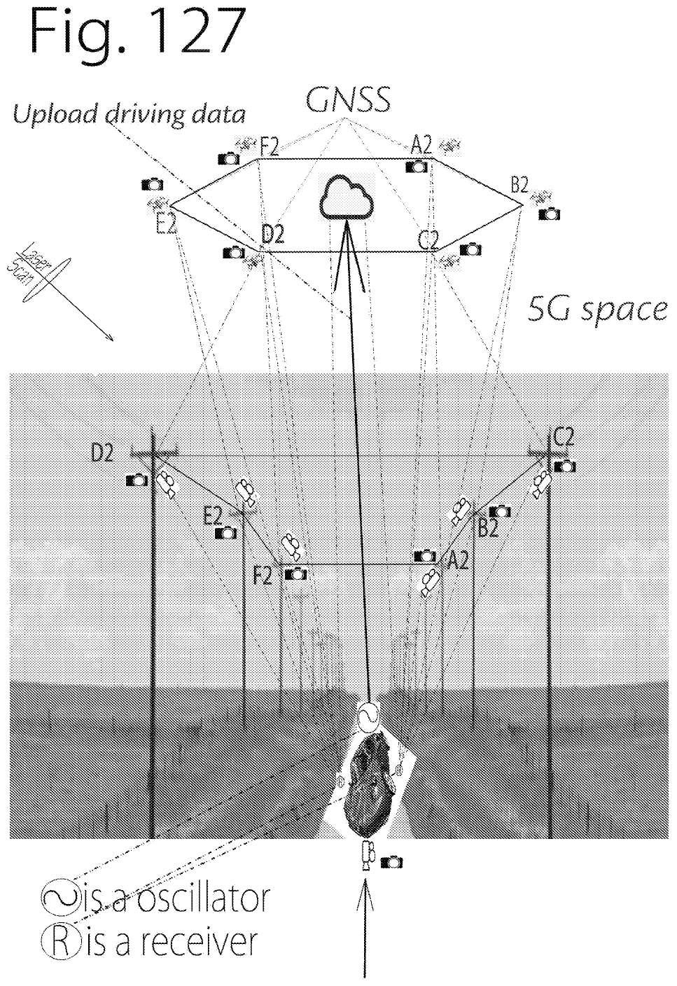

### 0.984.2: Drawings from FIG. 127 to FIG. 129

These drawings are an example, when the one-round database of the present invention is used in an automatic driving system of a car.

FIG. 127. Now, it is are popular to surveys to find the point of outgoing information based on the distance and position between artificial satellites. Also called GNSS. However, the distance measurement is too error-prone to accurately calculate the distance between vehicles in millimeters. Therefore, the accuracy can be improved by placing a camera on the utility pole, performing re-survey using a drone, and storing this data in a cross-referenceable database of one-round. By storing and describing separate information separately in each of the independent electronic files of the present invention, each description can be easily described and the artificial intelligence can understand things accurately. As a result, traffic accidents due to automated driving can be reduced.

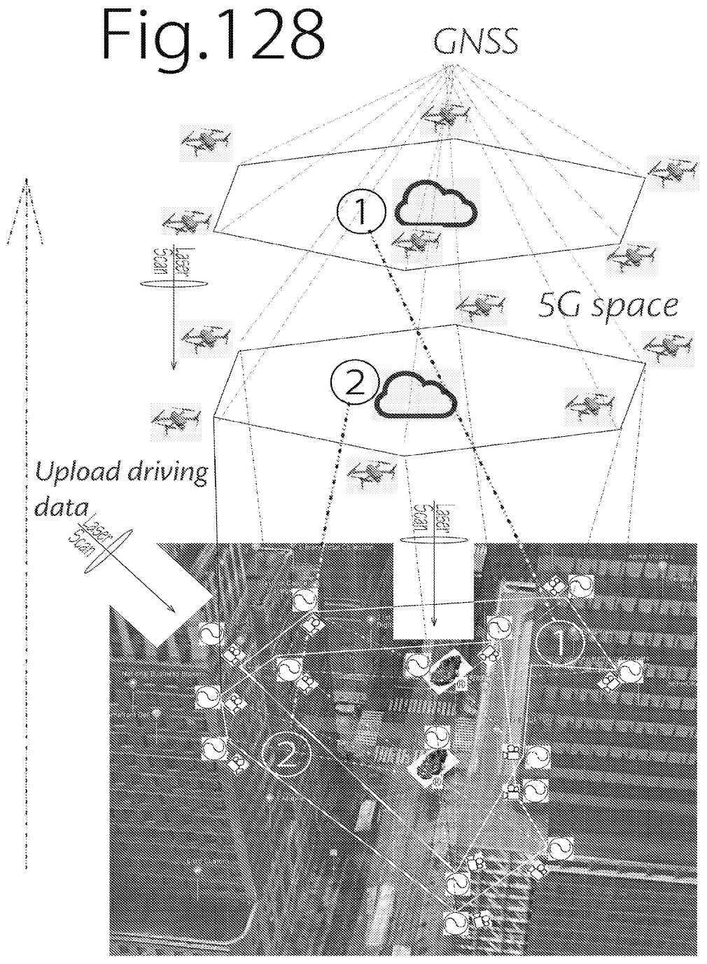

FIG. 128 is an example of location information collection surveys conducted in the city. The survey information is performed based on survey points lead in a drone or building linked with GPS (Global Positioning System). The information consists of photo and character information such as time, place, weather, and the like. The character information may be texts. These data are analyzed in advance by artificial intelligence and stored in a database. In addition, Circle 1 and Circle 2 are different information collection plates which consist of different data collection points.

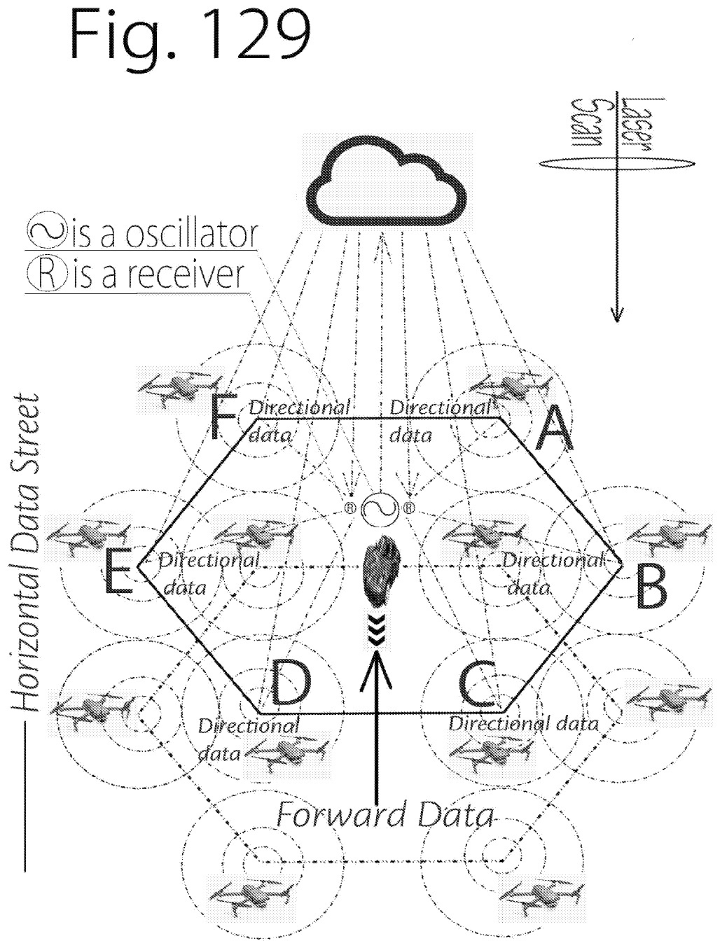

In FIG. 129, the data is configured in a multi-dimensional manner, and the position of the vehicle and the driving situation are analyzed as data in cooperation. Data of other vehicles traveling in the lane is also transmitted in the same way, and sharing of driving information is performed via the web system. Data is collected from multiple sources, but other vehicle data is stored in a common folder with multiple electronic files (each A, D, C, D, E, F) to reduce the obstacles to data analysis performed by artificial intelligence.

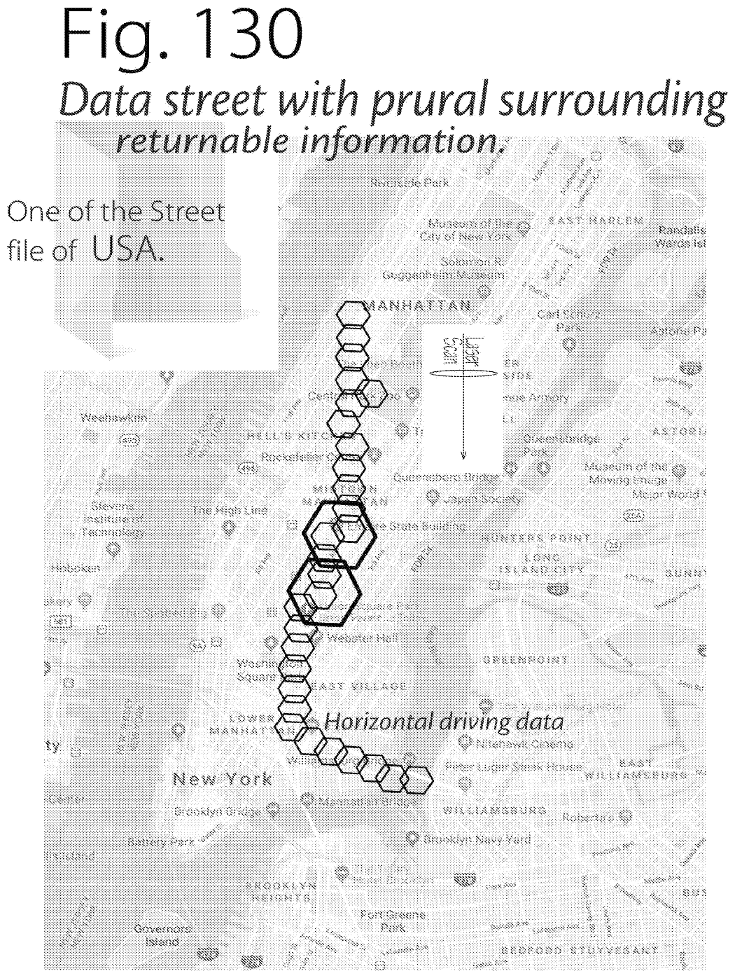

### 0.984.3: Drawings from FIG. 130 to FIG. 133D

In FIG. 130, when the destination is entered into the car, the car automatically downloads the road route from the Web cloud to the destination and saves it in the car. At that time, the information to the destination is stored in a single folder with multiple files (for example, each of the six corners of the diagram) per route.

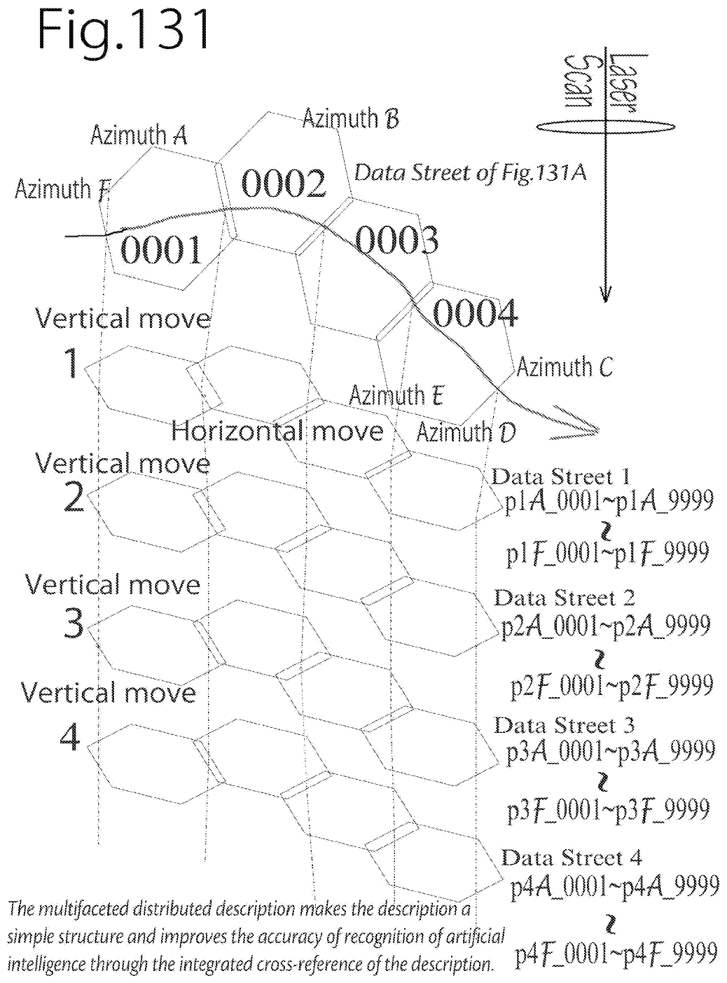

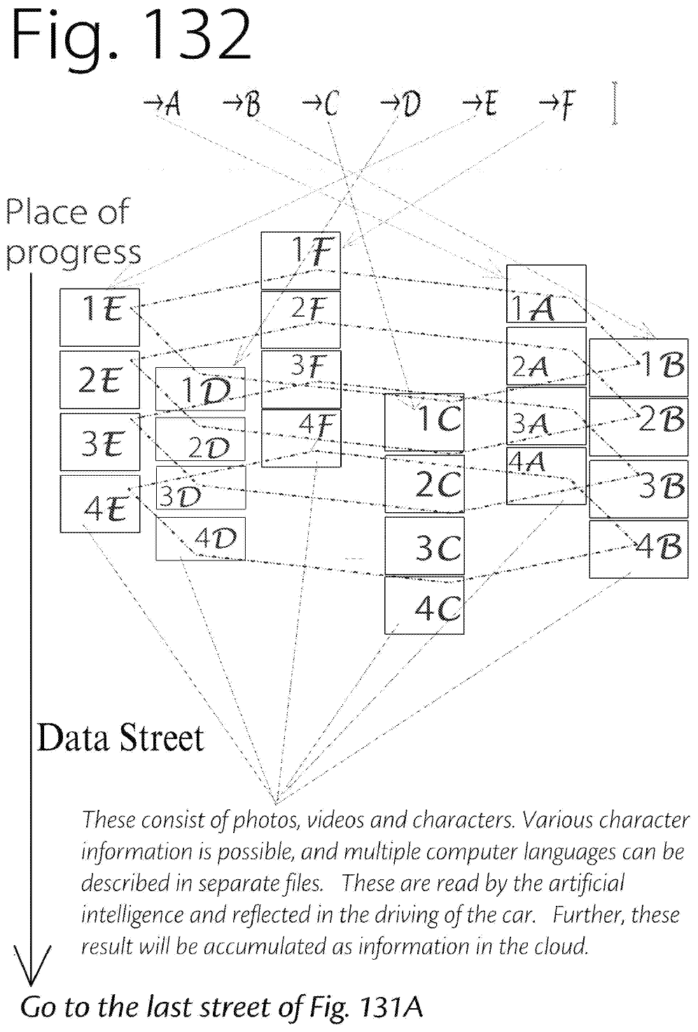

In FIG. 131, where azimuth is shown in the drawings, different data types may be used. In the case, then each of A, B, C, and D has a different analysis method because of different data types. By storing these separately and analyzing them with artificial intelligence, the difference between the vehicle whose information is collected in the database and the vehicle that is transmitting the current driving information is analyzed and used as automatic driving information.

FIG. 132 shows the arrangement of the setting region 4 when information is captured by altitude and angle at a specific time. At this time, the configuration as shown in FIG. 126 becomes one of the plates in FIG. 122.

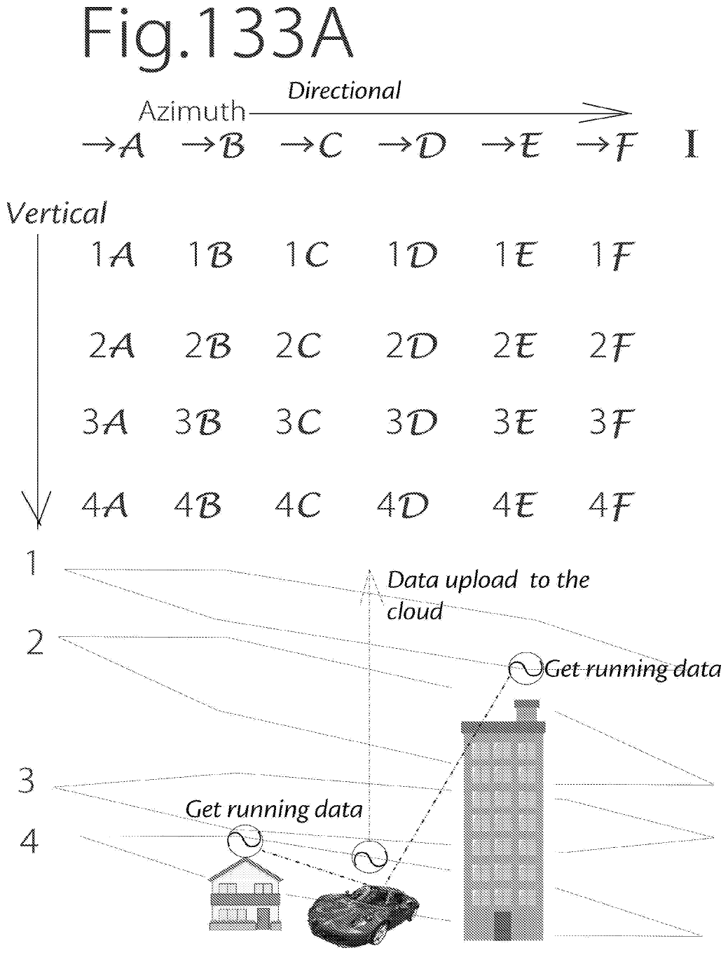

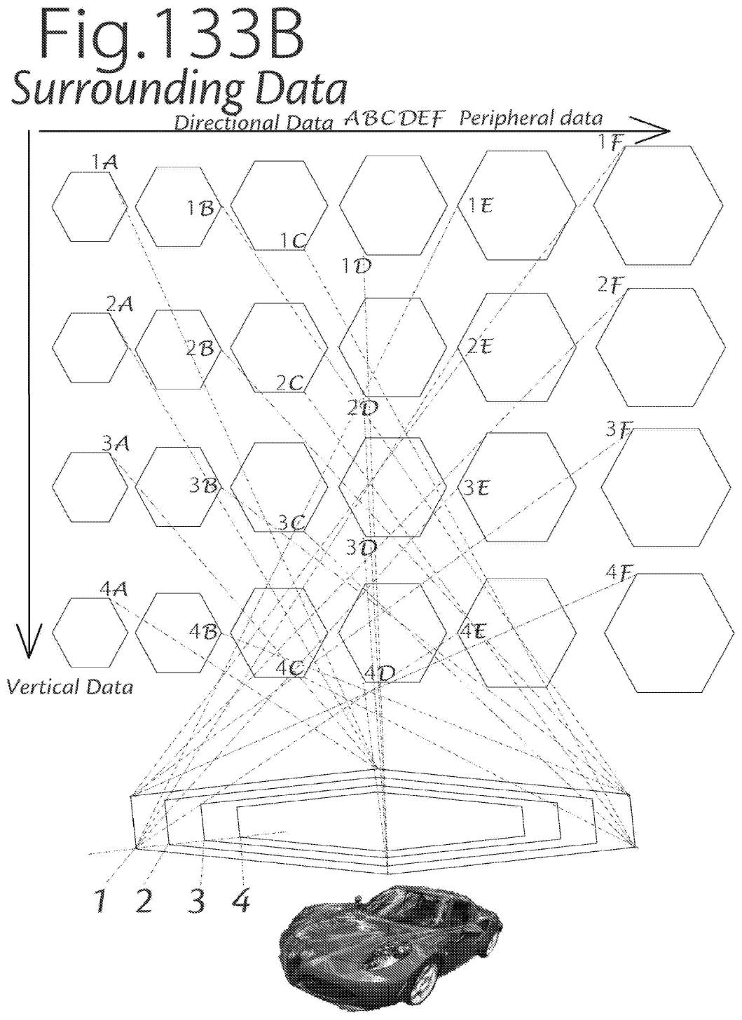

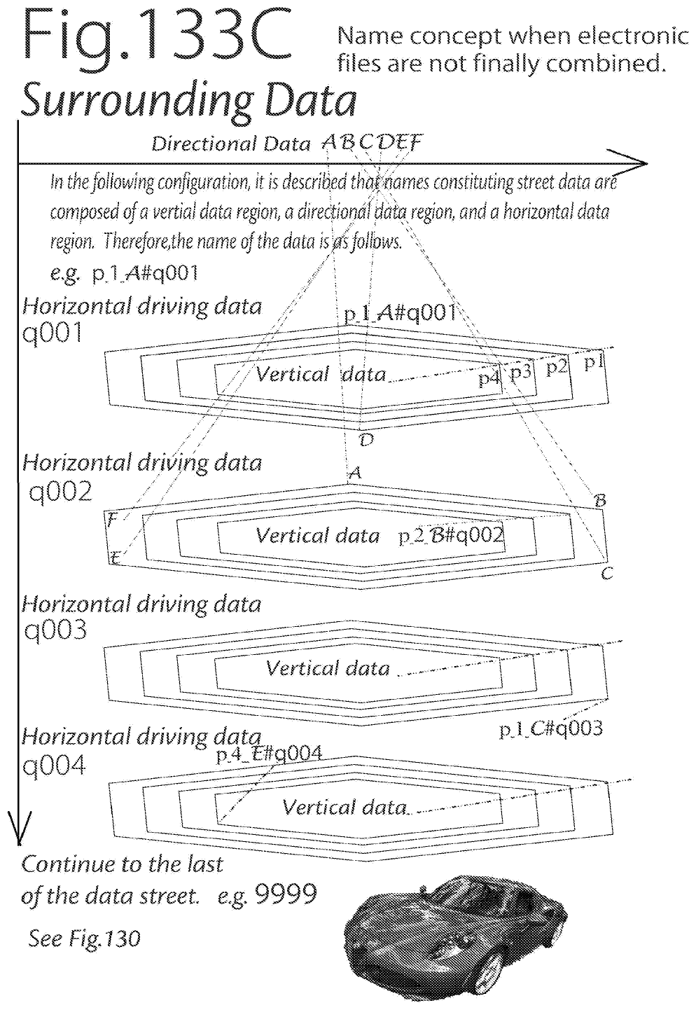

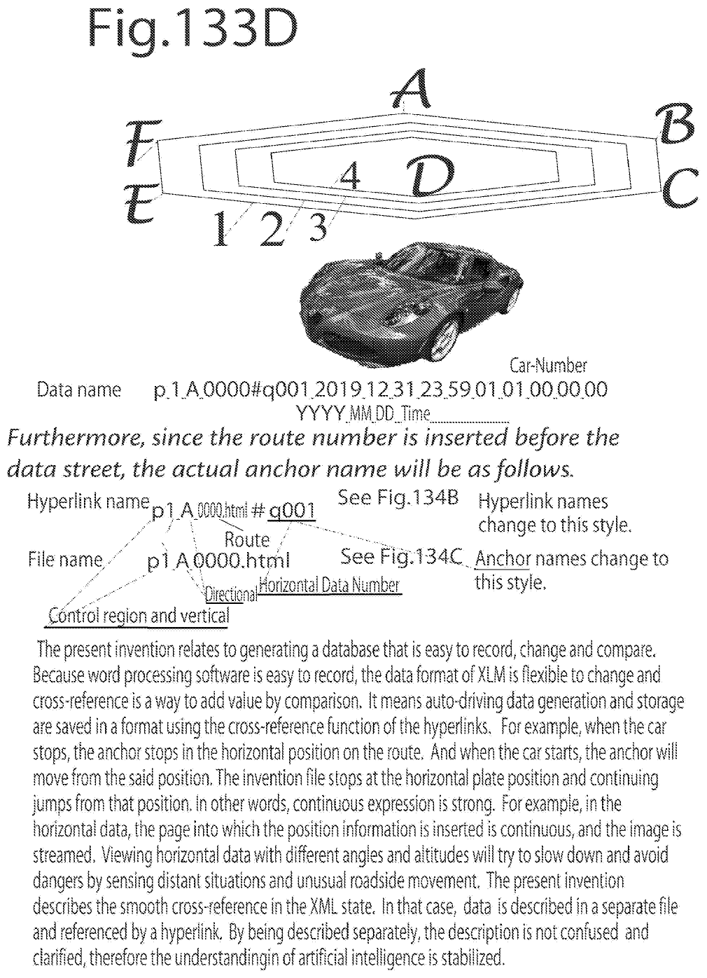

FIG. 133A shows the same setting area 4 as in FIG. 132 in a different format. The plate regions are arranged in parallel for easy observation, but in fact, direction and vertical are different from each other. This is because even if important information such as landmarks and dangerous spots is scattered in driving information, a hyperlink with emphasis on it is necessary.

FIG. 133B shows the information having an elevation angle and an azimuth angle. At the bottom of the drawing is a compressed form of the above drawing. Then, it becomes vertical as it goes to the center of the figure.

In FIG. 133C, information having the elevation and azimuth of FIG. 133B will be next arranged as horizontal driving data. The horizontally movement means the article 1 and article 2 in FIG. 115J. In other words, the each plate in FIG. 122.

FIG. 133D. What is worth mentioning here is that the example of the name of the hyperlink shown in the figure. And the structure of the name is shown. e.g. q1_A_0000.html#q001

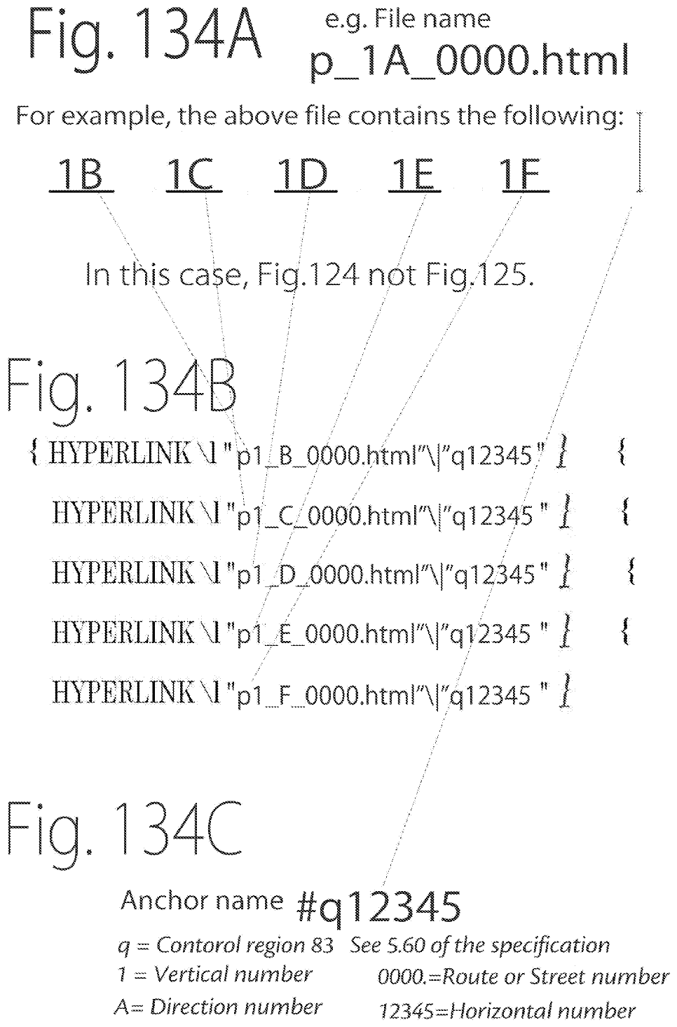

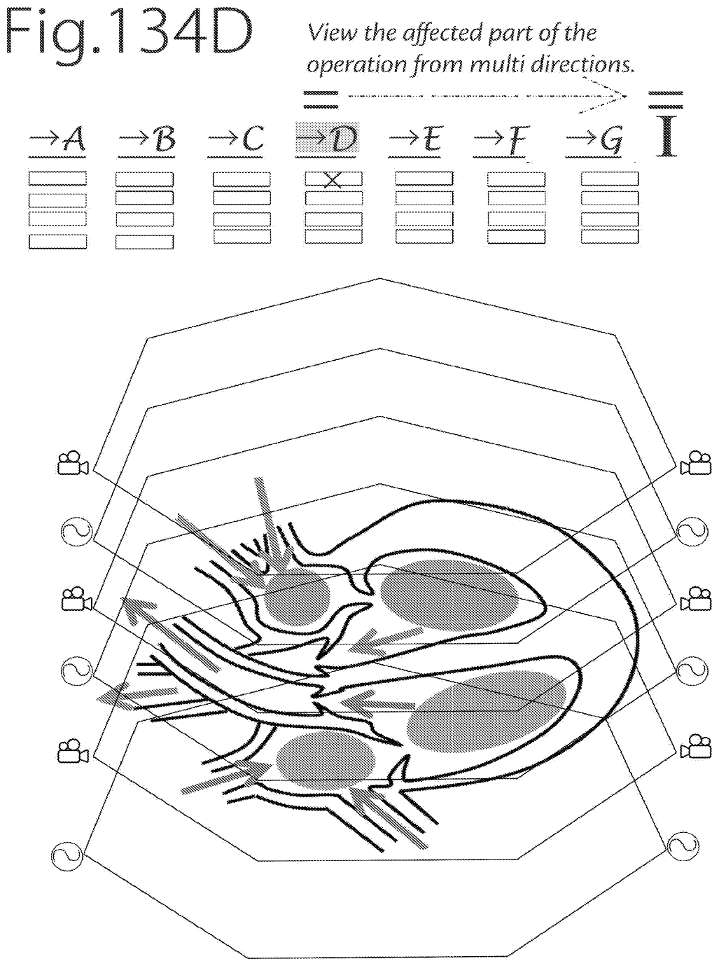

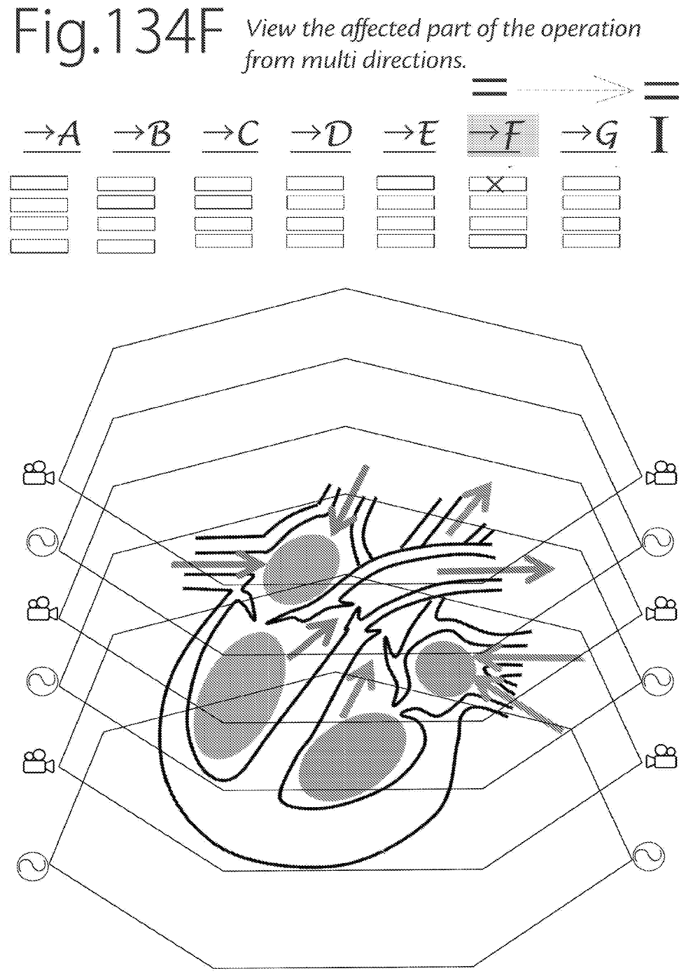

### 0.984.4: Drawings from FIG. 134A to FIG. 134C) MSWord

FIG. 134A to FIG. 134C shows file names of electronic files execute from MSword that are not finally combined. Those file names are target to be jumped from another electronic file created in one round. However, the parent application was not a jump to another file name. If the final combining is not performed, the file jumps to a different file name. This point is completely different from the jump when the final combination is performed.

FIG. 134A describes a case in which the apparent side of the electronic file has a dropout. That is, the case of FIG. 124, not of the case of FIG. 125.

FIG. 134B describes the hidden names of the hyperlink group described in FIG. 134A. In the FIG. 134B the name of the group indicating vertical in the first higher region and follow the direction in the second higher region of the html filename. Here,the direction data is changed so as to make one round.

FIG. 134C shows the names of the anchors described inside the electronic file. To be more precise, however, the anchor that receives the jump from the hyperlink in FIG. 134B that jumps to a different electronic file has two anchors: the file name and the description after “\|” or # indicating a specific location described therein. This can be confirmed by the presence of two double quotation marks in each of the hyperlinks described in FIG. 134B. In other words, two double quotation marks are created because the file is expanded using MS words, and if it is expanded using html processing software, it will be one continuous anchor name connected with #.

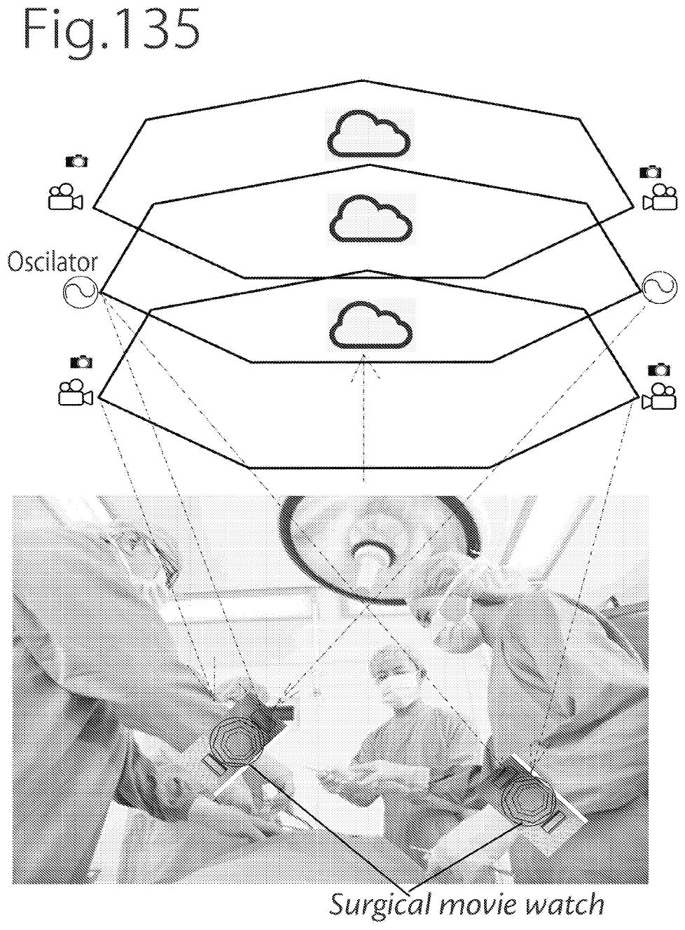

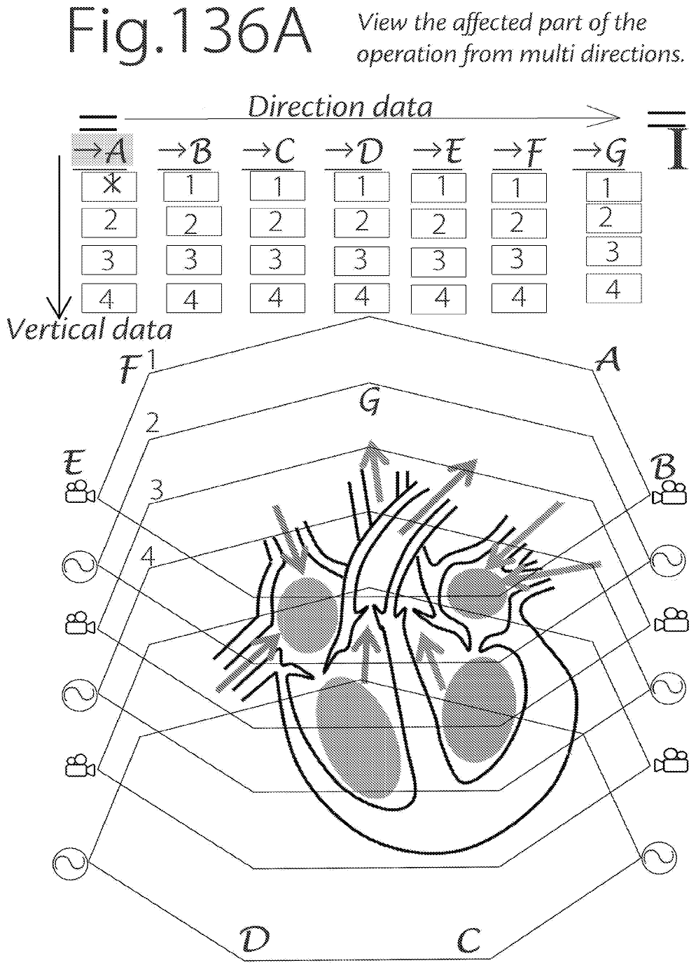

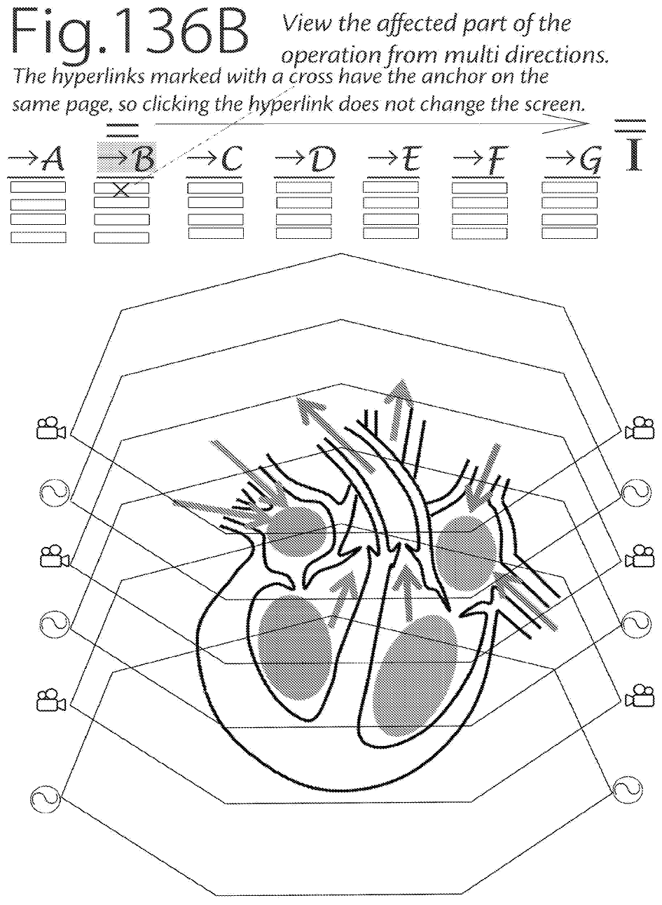

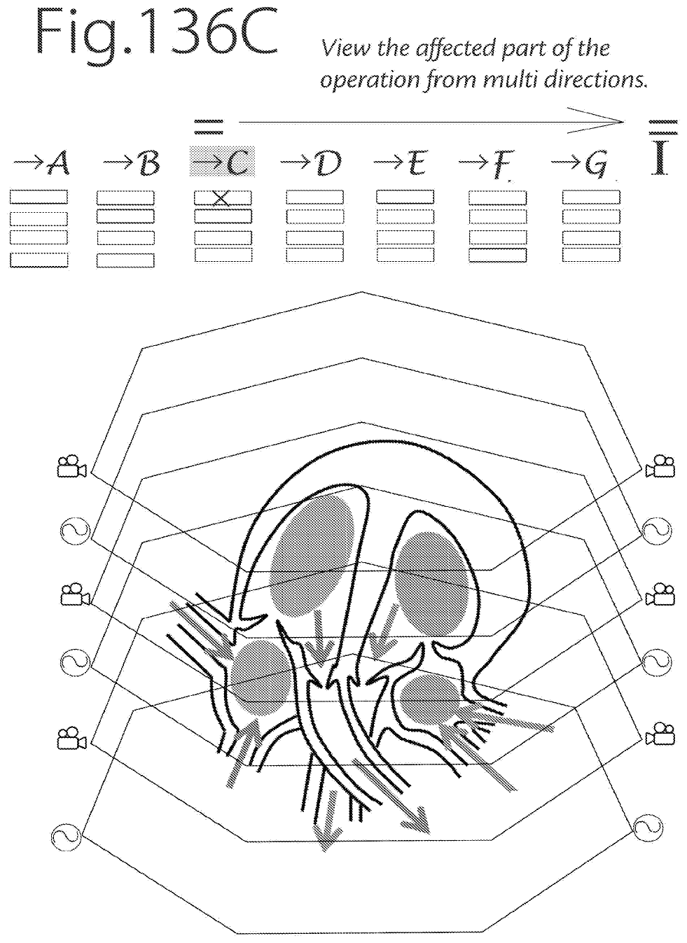

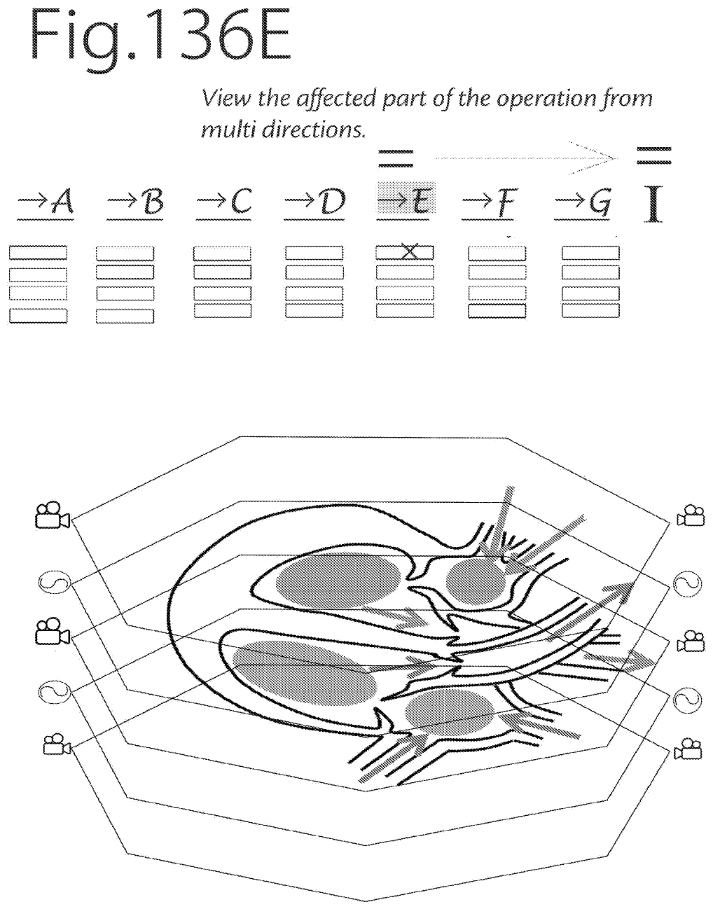

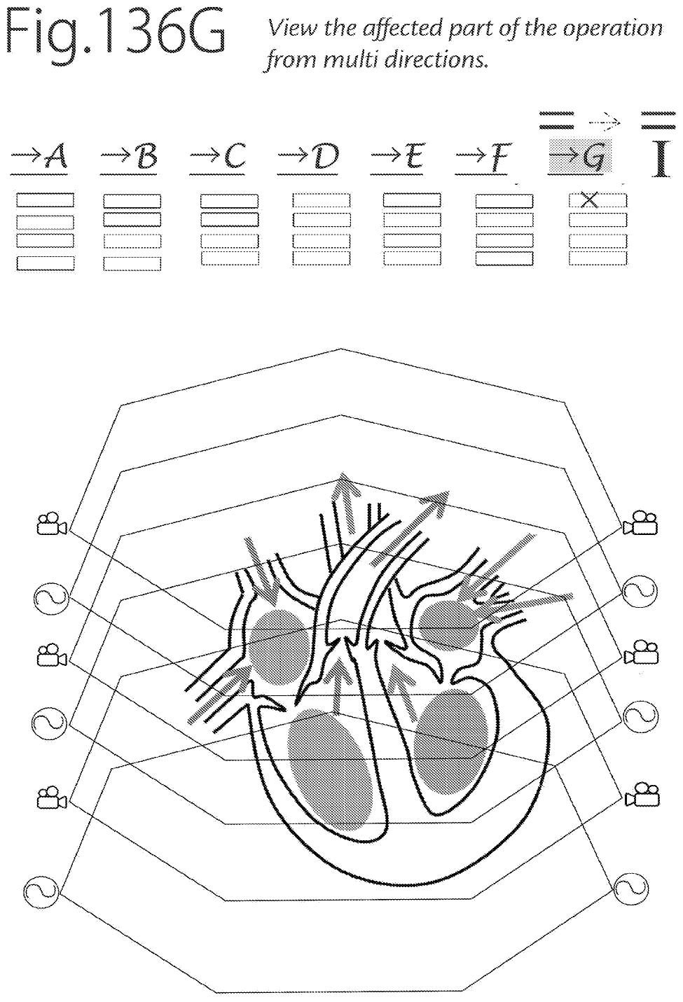

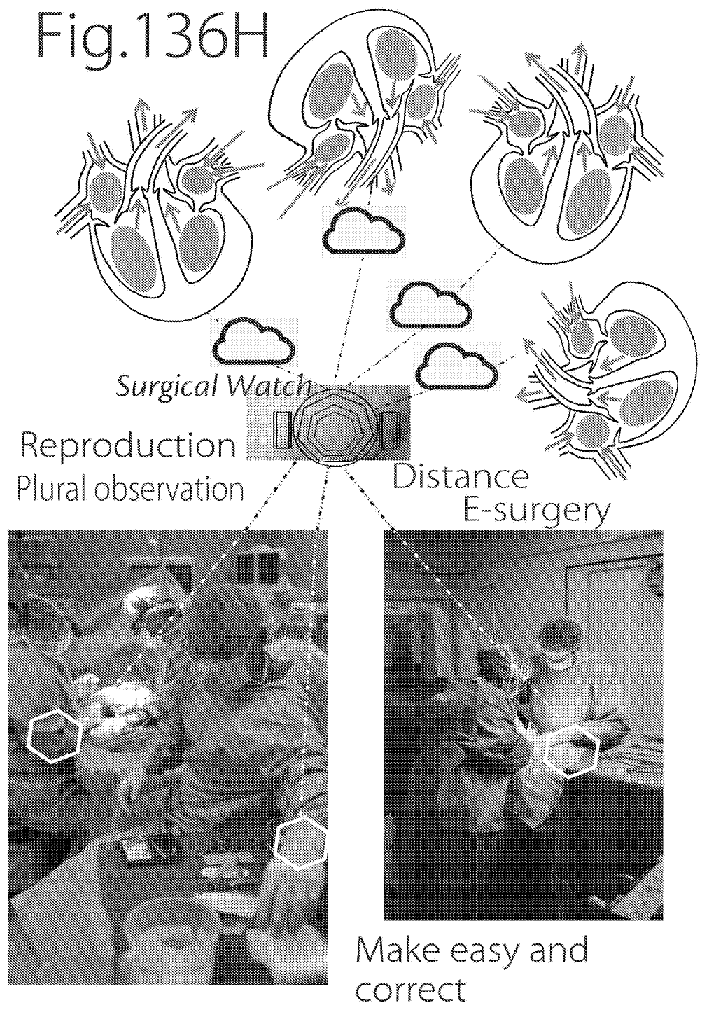

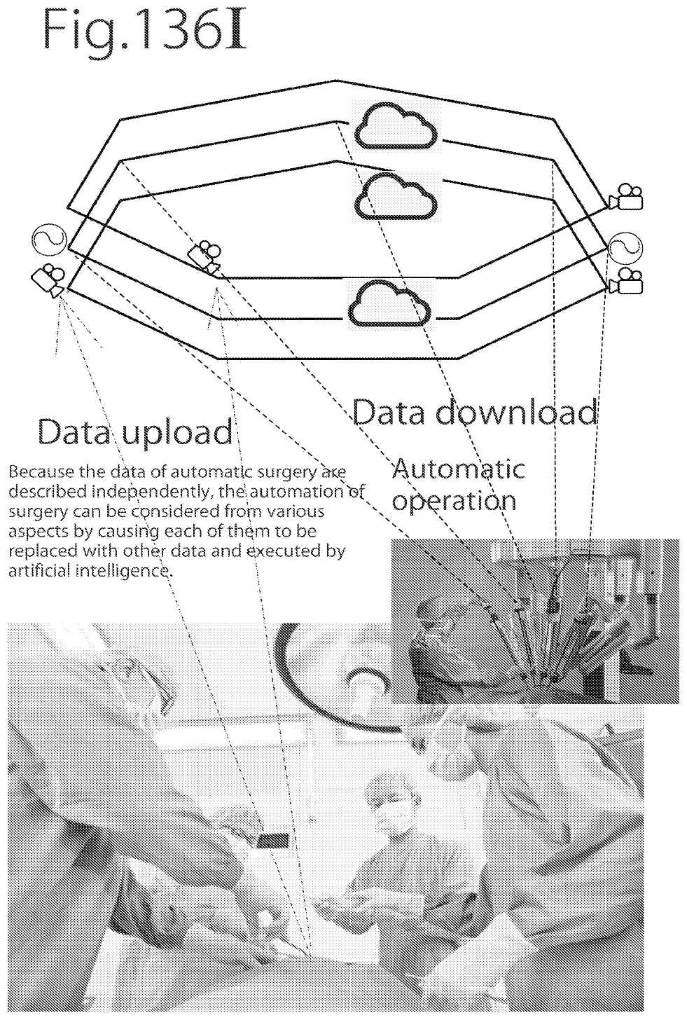

### 0.985: Drawings from FIG. 135 to FIG. 136I

In the following, the application of the present invention is considered by taking surgery as an example.

FIG. 135 Collect data on the current surgery at Azimuth angle and Zenith angle. At the same time, the team examines the existing Azimuth angle and Zenith angle surgical data while examining the current surgery.

FIG. 136A Heart movement as seen from a specific Zenith angle at a specific Azimuth angle. The imaging information can be browsed by arbitrarily changing the specific Azimuth angle or the specific Zenith angle. Images viewed from a specific Zenith angle of a specific Azimuth angle are displayed successively in time order. The equal part indicates that when a hyperlink is clicked, it only jumps to an anchor on the right side of the same page.

FIG. 136B is another figure of FIG. 136A. The specific Azimuth angle is moving to B. The equal part indicates that when a hyperlink is clicked, it only jumps to the anchor on the right side of the same page. The artificial intelligence analyzes the unmixed multifaceted data in the form of separate files separated for each viewpoint, and the artificial intelligence distributes the data to another medical site in a multifaceted arrangement that increases its value. The same applies hereafter, so the description is omitted.

FIG. 136C is another figure of FIG. 136A. The specific Azimuth angle is moving to C. The equal part indicates that when a hyperlink is clicked, it only jumps to the anchor on the right side of the same page.

FIG. 136D is another figure of FIG. 136A. The specific Azimuth angle is moving to D. The equal part indicates that when a hyperlink is clicked, it only jumps to the anchor on the right side of the same page.

FIG. 136E is another figure of FIG. 136A. The specific Azimuth angle is moving to E. The equal part indicates that when a hyperlink is clicked, it only jumps to the anchor on the right side of the same page.

FIG. 136F is another figure of FIG. 136A. The specific Azimuth angle is moving to F. The equal part indicates that when a hyperlink is clicked, it only jumps to the anchor on the right side of the same page.

FIG. 136G is another figure of FIG. 136A. The specific Azimuth angle is moving to G. The equal part indicates that when a hyperlink is clicked, it only jumps to the anchor on the right side of the same page.

FIG. 136H is an example of remote surgery. Another operation is performed remotely based on existing data sent from the cloud. Several people perform surgery while viewing the data from a wristwatch-type player. Data are linked by hyperlinks in the order of specific Zenith angles of specific Azimuth angles in time order.

FIG. 136I is an example of automatic surgery. The receiver operation is automated while delivering multiple files in chronological order. In each of them, images and data (blood pressure, heart rate, etc.) viewed from each Azimuth angle of the heptagon are recorded by them. The description is made in independent separate files, therefore improves the reading accuracy of artificial intelligence and enables safer automated surgery.

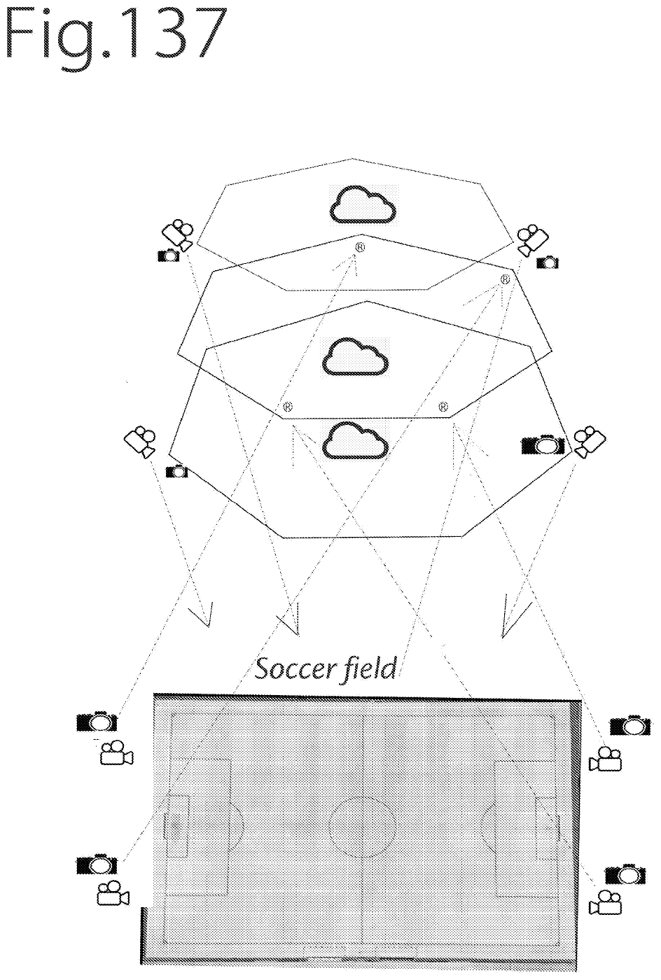

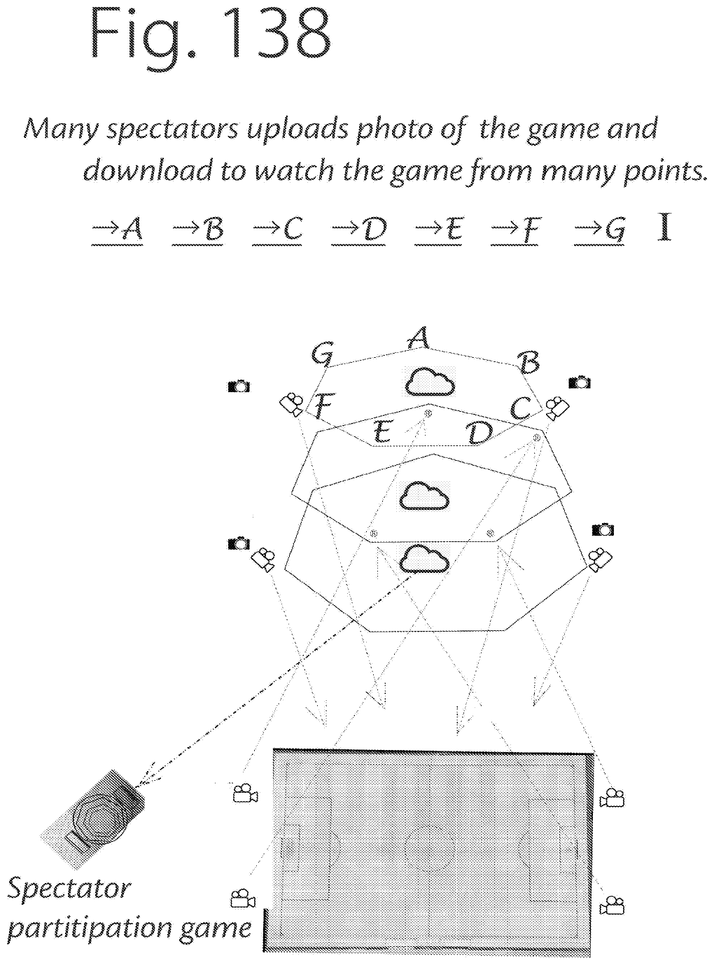

### 0.986: Drawings from FIG. 137 to FIG. 138

FIG. 137 is a drawing showing that information gathered from various points in a soccer stadium is collected and distributed to spectators in a stadium.

FIG. 138 further shows that, by simultaneously transmitting data taken by a spectator to other spectators, it is possible to know the movement of a player who cannot be seen from his/her own seat, so that he/she can participate in the game with a multifaceted presence.

### 0.987.1: Drawings from FIG. 139 to FIG. 141

FIG. 139 shows the file name replacement scene of which using MS word when multiple electronic files that will not be finally combined. e.g. Replace the file name that appears top of FIG. 139.

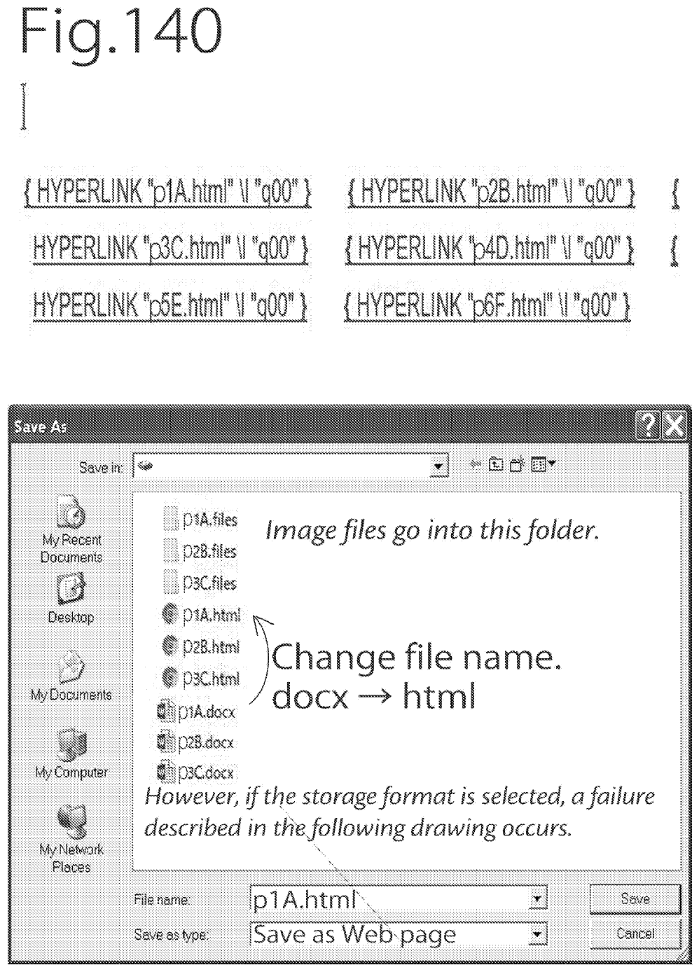

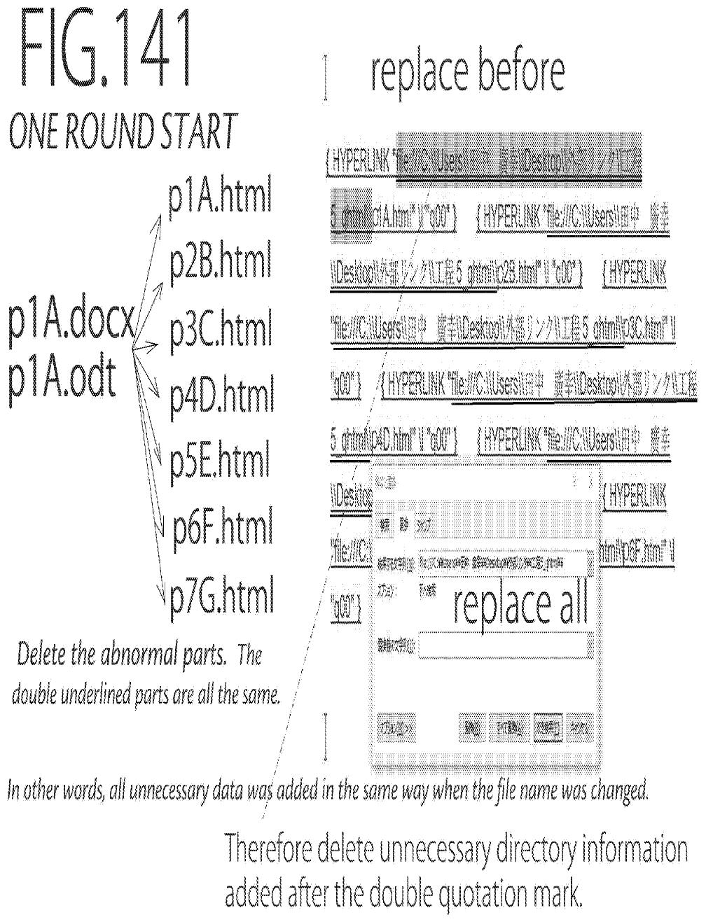

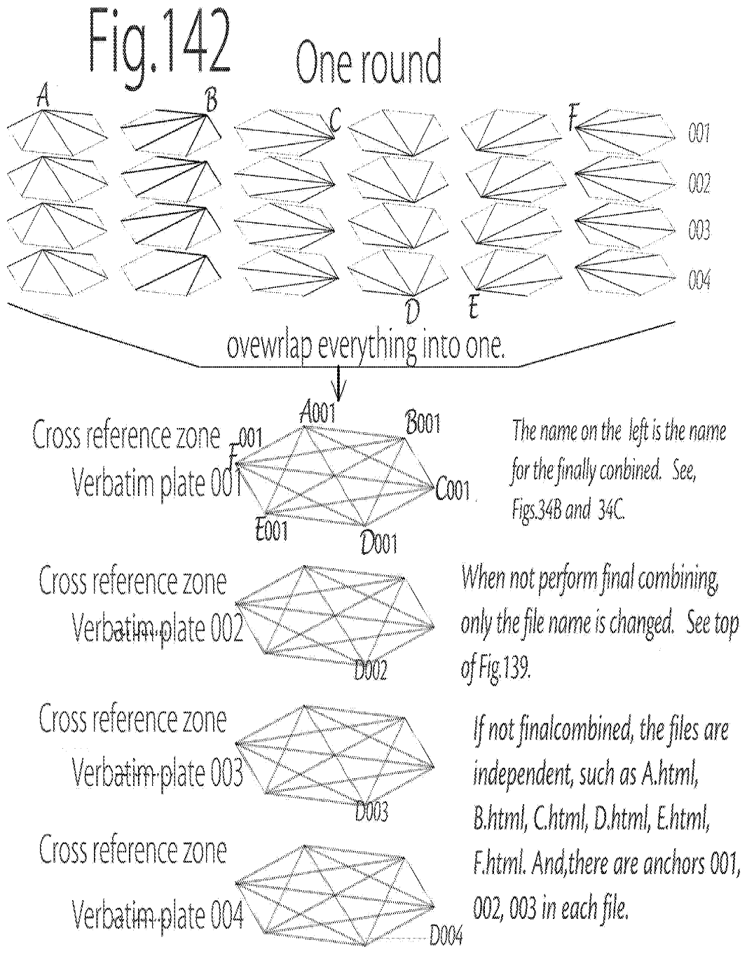

FIG. 140 is a replacement scene of the file name of which using MSword when generating a plurality of electronic files that are not finally combined. In that case, unlike FIG. 54, there are two double quotation marks. However, when the same file is developed by the html processing software as shown in FIG. 162A, the file name to be the jump destination and the specification of the specific place like will be combined # which replaced by a typical one type. e.g. “name.html # q01”.

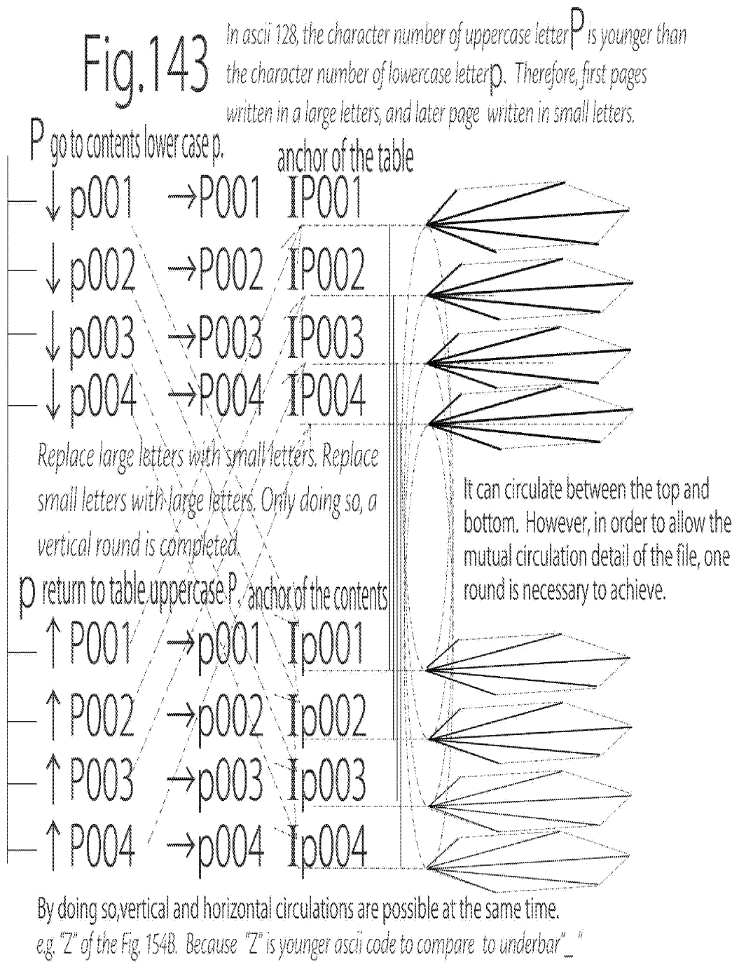

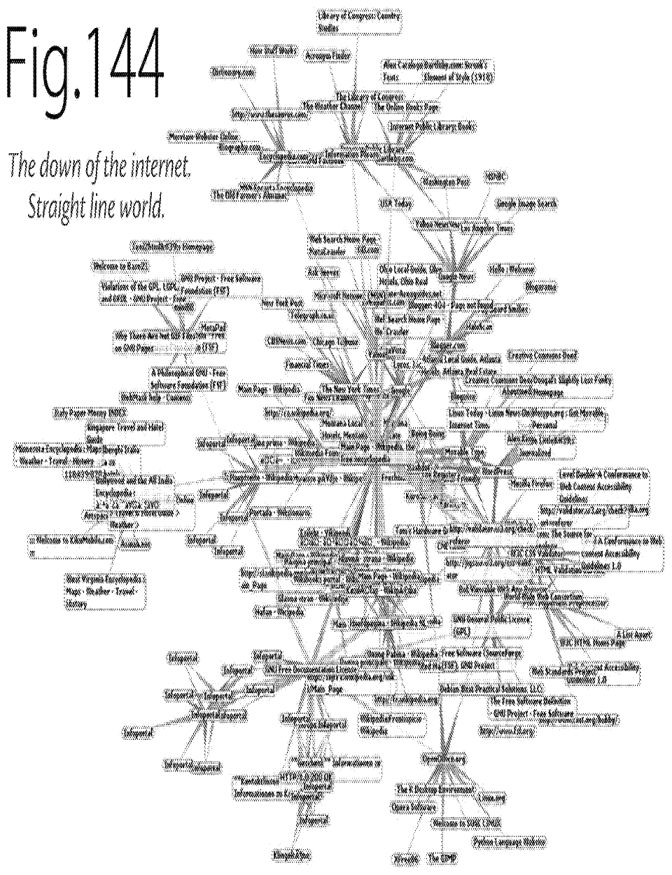

FIG. 141 illustrates a solution to a problem that occurs when an attempt is made to jump a hyperlink between different electronic files by creating another electronic file by replacing the name of the electronic file. The right side of FIG. 141 is a hyperlink that appears when the change in FIG. 140 is performed. With the change of the name, all the connection of directories up to the changed file is additionally described. Therefore, it is necessary to correct this absolute address to a relative address. That is, it is necessary to delete the added directory name. Calm down observations discover that all unnecessary additions are added equally. Therefore, jumping is possible by changing these to the relative addresses by deleting them at once from the name of the hyperlink.

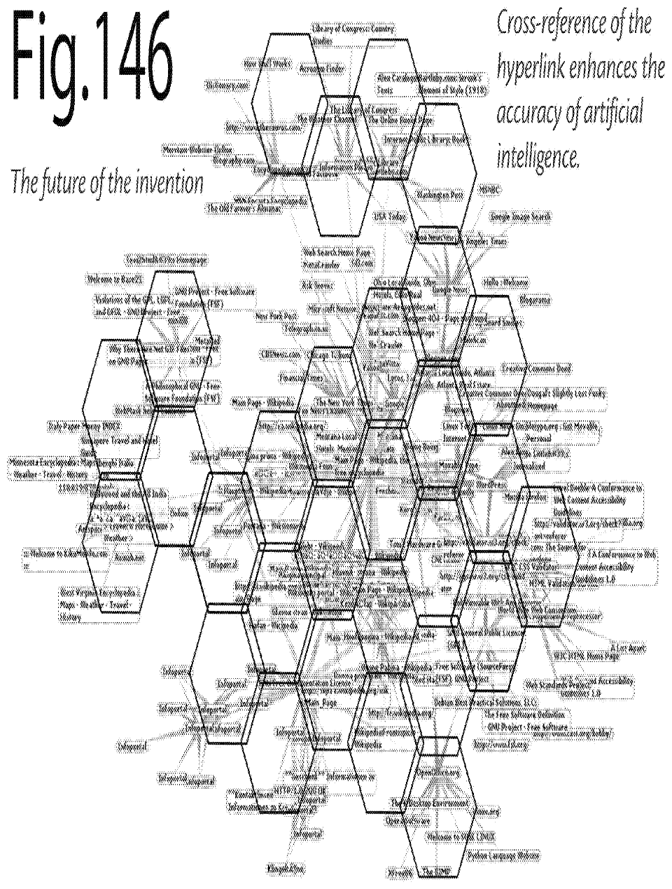

### 0.987.2: Drawings from FIG. 142 to FIG. 143

FIG. 142 is a representative drawing expressing the feature of one round which is the theme of the present invention. In the case of FIG. 126, N(N−1)=64*63=4032 jumps can be established by creating 64 different electronic files, as can be seen from horizontal direction 8 and vertical vertical 8. In addition, after replacement 63 different electronic files which has four lower-layer plates, then the same number of jumps will be generated for each plate. It seems too large for humans to use, but artificial intelligence can produce results from large reference areas that humans cannot.

FIG. 143 shows that, when a hyperlink functions between different setting areas having a downward arrow and an upward arrow, and a round is performed, the entirety constitutes an organic jump. In this case, since the circulation of A and a is also inherited, there is no isolated place in the entire electronic file, and all exist in the circulating flow. In this case, a setting area called science is used instead of verbatim. See, “science” setting region 3 of FIG. 1.

### 0.987.3: Drawings from FIG. 144 to FIG. 147

FIG. 144 is a work that stylizes an existing knowledge that the Internet is forming spider web. The design is by a person who is not the applicant.

FIG. 145 is a diagram showing that the present invention attempts to transform the Internet network into cross-referencing of information.

FIG. 146 schematically illustrates that in the future of the present invention, many of the Internet networks will be transformed into cross references in order to increase the accuracy of artificial intelligence.

FIG. 147 shows that the first and second processes placed the anchors in locations in character code order, and that the third process replaced the higher segment of the anchor's name with an order to character code, and thus replaced the anchor in order to the character-code. Therefore, it shows that it is possible to express as one line segment by connecting them in code order as an image diagram.

### 0.988.1: Drawings from FIG. 148A to FIG. 148D

FIG. 148A rewrite FIG. 6A of the 2-byte sample format into 1-byte sample format characters. In this case, the first area 83 is an area that circumvents the restriction because there is a rule that numbers must not be placed at the beginning of a hyperlink or anchor name. In other words, after “q”, numerical values can be arranged freely.

FIG. 148B rewrite FIG. 6B of the 2-byte sample forma into 1-byte sample format characters. The growth point “85” is filled with a character having two large blank portions so that the name can be easily replaced.

FIG. 148C is a sample which rewritten FIG. 6C into 1-byte format characters. The intermediate level region “88” indicates that there is a portion other than the highest level region 84 that serves as a one round. e.g. Replacements of the higher levels of names.

FIG. 148D is a sample when “084” which is the highest level region is replaced.

### 0.988.2: Drawings from FIG. 149 to FIG. 152C

FIG. 149 is a drawing in which FIG. 7 is rewritten in 1-byte notation. This is because it is easier to understand the invention if it is written in one byte that is familiar to Americans.

FIG. 150 is a drawing in which FIG. 8 is rewritten in one-byte notation. This is because it is easier to understand the invention if it is written in one byte that is familiar to Americans.

FIG. 151 is a drawing in which FIG. 16 is rewritten in 1-byte notation. This is because it is easier to understand the invention if it is written in one byte that is familiar to Americans.

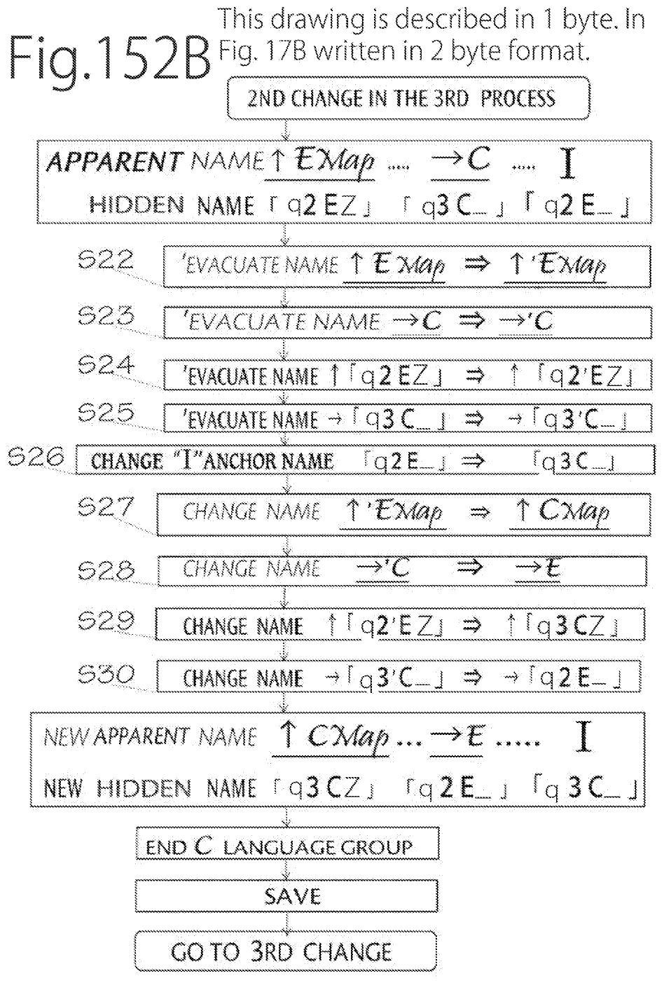

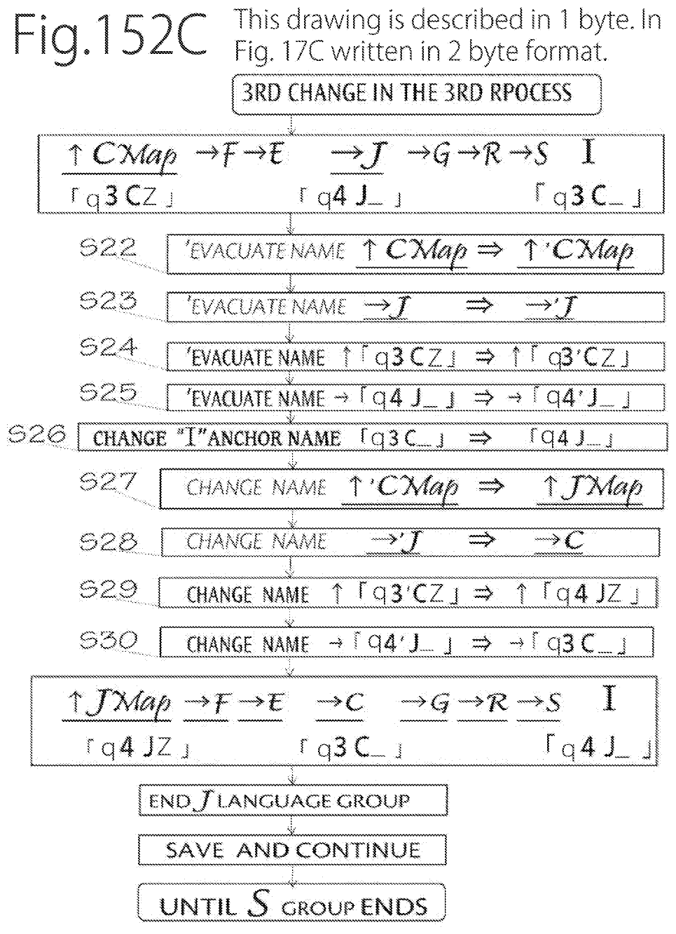

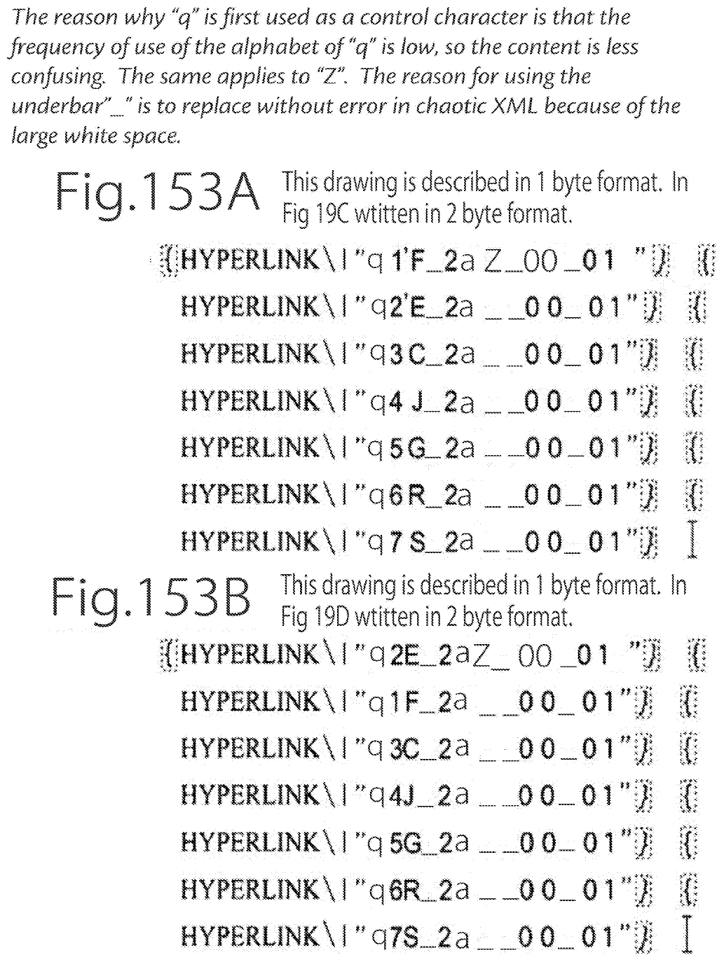

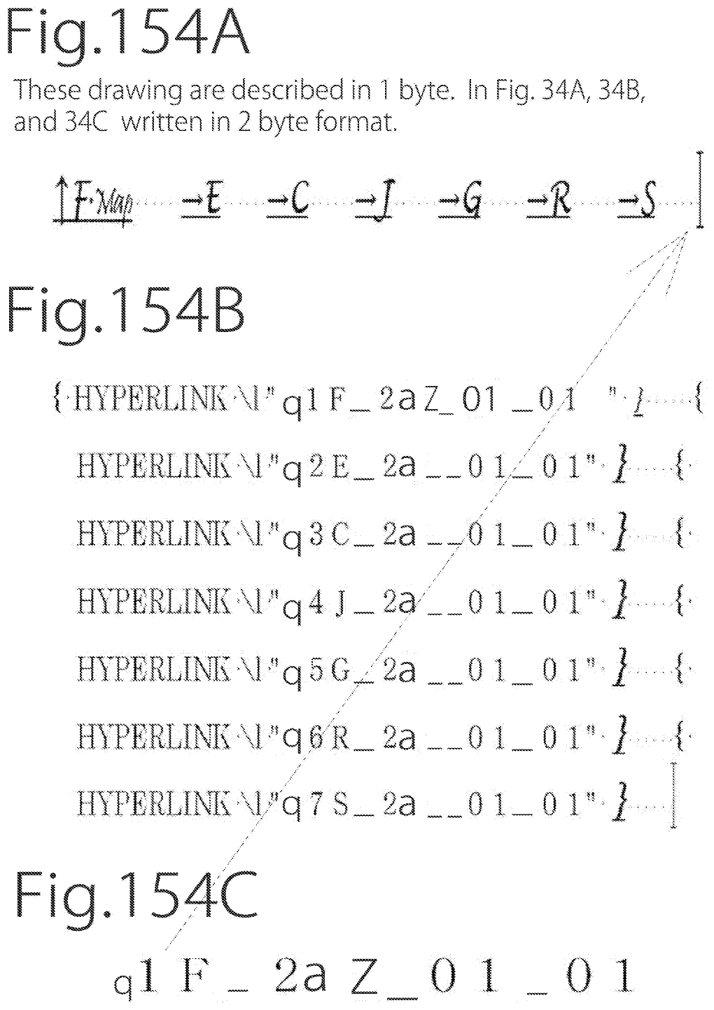

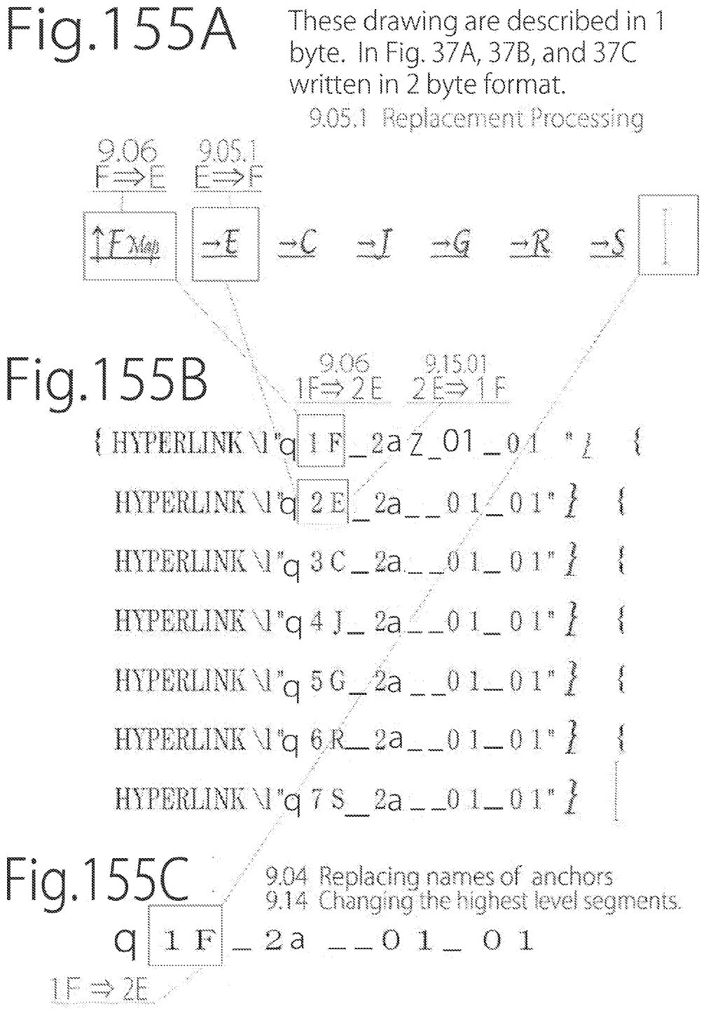

FIG. 152A is a drawing in which FIG. 17A is rewritten in 1-byte notation. This is because it is easier to understand the invention if it is written in one byte that is familiar to Americans.

FIG. 152B is a drawing in which FIG. 17B is rewritten in 1-byte notation. This is because it is easier to understand the invention if it is written in one byte that is familiar to Americans.

FIG. 152C is a drawing in which FIG. 17C is rewritten in 1-byte notation. This is because it is easier to understand the invention if it is written in one byte that is familiar to Americans.

### 0.988.3: Drawings from FIG. 153 A to FIG. 153B

FIG. 153A is a drawing in which FIG. 19C is rewritten in one-byte notation. This is because it is easier to understand the invention if it is written in one byte that is familiar to Americans.

FIG. 153B is a drawing in which FIG. 19D is rewritten in 1-byte notation. This is because it is easier to understand the invention if it is written in one byte that is familiar to Americans.

### 0.988.4: Drawings from FIG. 154 A to FIG. 154C

FIG. 154A is a drawing obtained by transcribing FIG. 34A.

FIG. 154B is a drawing in which the hyperlinks of FIG. 34B is rewritten in 1-byte notation. This is because it is easier to understand the invention if it is written in a familiar font.

FIG. 154C is a drawing in which the anchor of FIG. 34C is rewritten in 1-byte notation. This is because it is easier to understand the invention if it is written in a familiar font.

### 0.988.5: Drawings from FIG. 155 A to FIG. 155C

FIG. 155A is a drawing obtained by transcribing FIG. 37A.

FIG. 155B is a drawing in which the hyperlink of FIG. 37B is rewritten in 1-byte notation. This is because it is easier to understand the invention if it is written in a familiar font.

FIG. 155C is a drawing in which the anchor of FIG. 37C is rewritten in 1-byte notation. This is because it is easier to understand the invention if it is written in a familiar font.

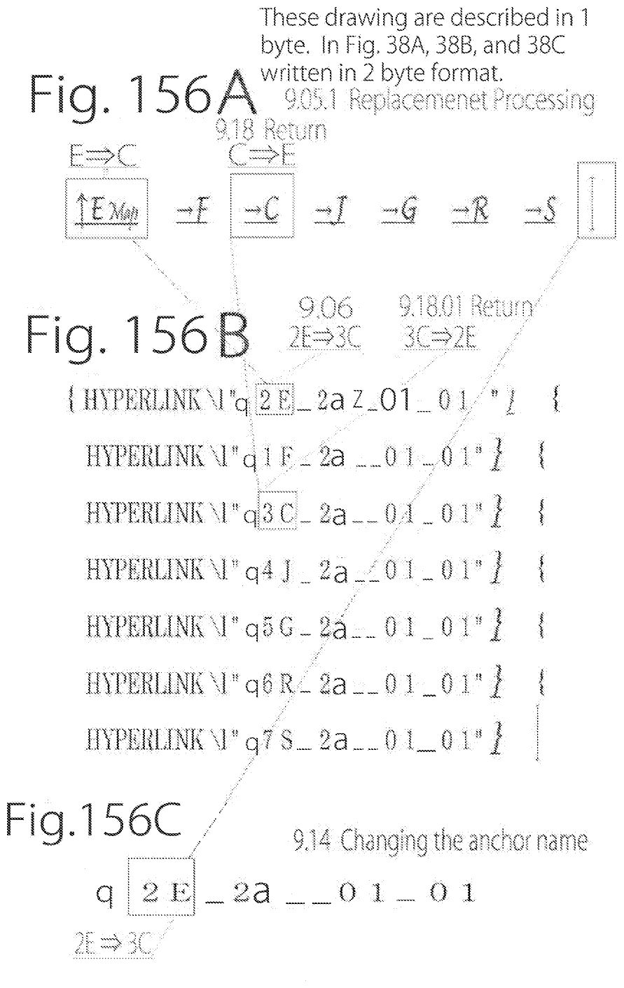

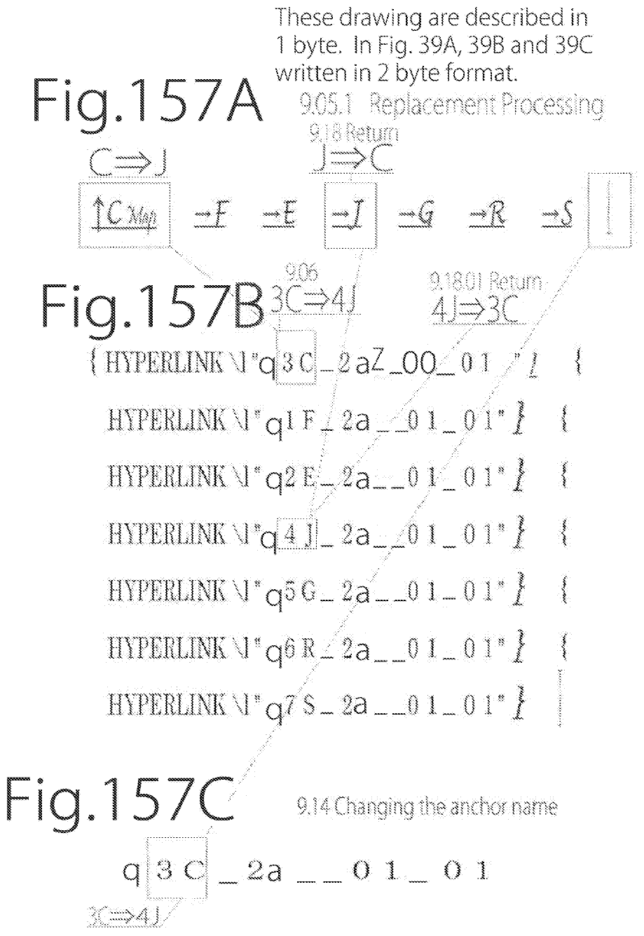

### 0.988.6: Drawings from FIG. 156A to FIG. 156C

FIG. 156A is a drawing obtained by transcribing FIG. 38A.

FIG. 156B is a drawing in which the hyperlink of FIG. 38B is rewritten in 1-byte notation. This is because it is easier to understand the invention if it is written in a familiar font.

FIG. 156C is a drawing in which the anchor of FIG. 38C is rewritten in 1-byte notation. This is because it is easier to understand the invention if it is written in a familiar font.

### 0.988.7: Drawings from FIG. 157A to FIG. 157C

FIG. 157A is a drawing obtained by transcribing FIG. 39A.

FIG. 157B is a drawing in which the hyperlink of FIG. 39B is rewritten in 1-byte notation. This is because it is easier to understand the invention if it is written in a familiar font.

FIG. 157C is a drawing in which the anchor of FIG. 39C is rewritten in 1-byte notation. This is because it is easier to understand the invention if it is written in a familiar font.

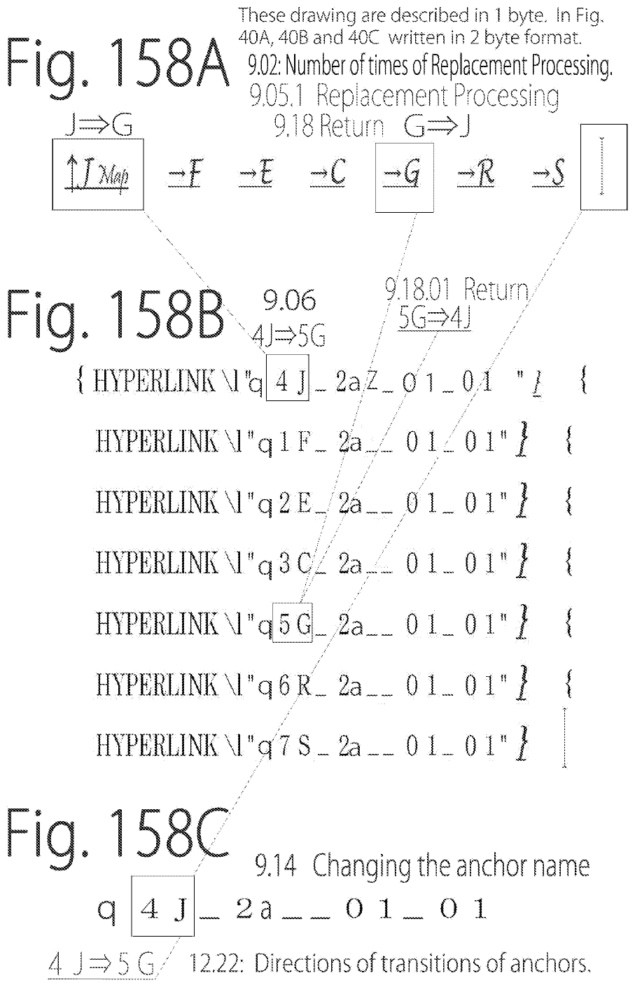

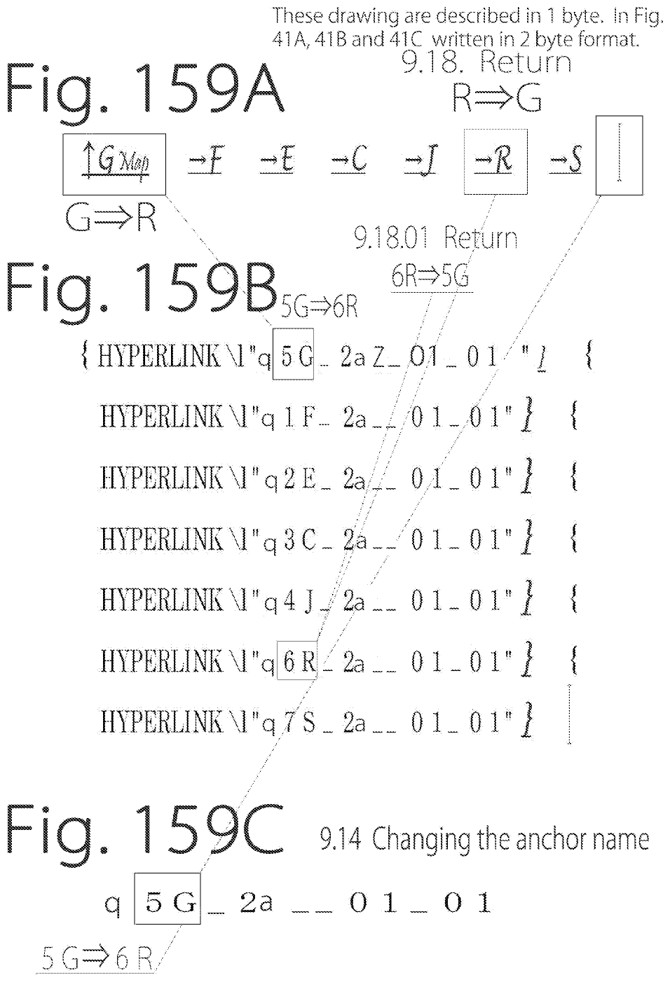

### 0.988.8: Drawings from FIG. 158A to FIG. 158C

FIG. 158A is a drawing obtained by transcribing FIG. 40A.

FIG. 158B is a drawing in which the hyperlink in FIG. 40B is rewritten in 1-byte notation. This is because it is easier to understand the invention if it is written in a familiar font.

FIG. 158C is a drawing in which the anchor of FIG. 40C is rewritten in 1-byte notation. This is because it is easier to understand the invention if it is written in a familiar font.

### 0.988.9: Drawings from FIG. 159A to FIG. 159C

FIG. 159A is a drawing obtained by transcribing FIG. 41A.

FIG. 159B is a drawing in which the hyperlink of FIG. 41B is rewritten in 1-byte notation. This is because it is easier to understand the invention if it is written in a familiar font.

FIG. 159C is a drawing in which the anchor of FIG. 41C is rewritten in 1-byte notation. This is because it is easier to understand the invention if it is written in a familiar font.

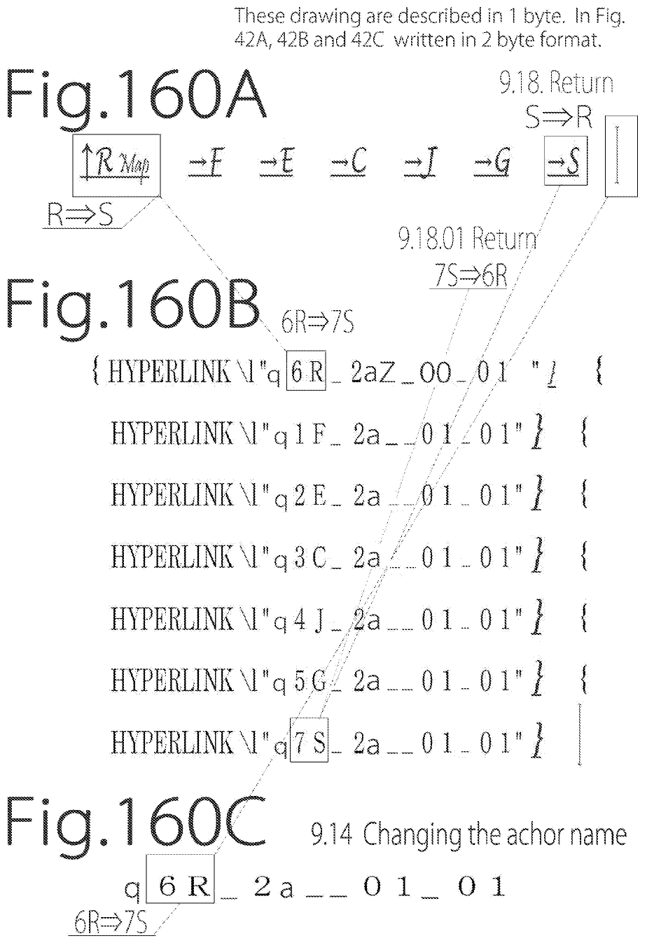

### 0.989.0: Drawings from FIG. 160A to FIG. 160C

FIG. 160A is a drawing obtained by transcribing FIG. 42A.

FIG. 160B is a drawing in which the hyperlink of FIG. 42B is rewritten in 1-byte notation. This is because it is easier to understand the invention if it is written in a familiar font.

FIG. 160C is a drawing in which the anchor of FIG. 42C is rewritten in 1-byte notation. This is because it is easier to understand the invention if it is written in a familiar font. Although the drawing has been omitted from the drawing, FIG. 43A to FIG. 43C need to replace in the same manner.

### 0.989.1: Drawings from FIG. 161A to FIG. 161G

FIGS. 161A to 161G and FIGS. 162A to 162G are drawings for explaining how jumps occur in the fourth process in which electronic files are not finally combined. FIG. 161A is very similar to FIG. 120A. Their names of hyperlinks and anchors consist of a higher segment and a lower segment. In each of the figures, the higher segment of the names of the anchors or hyperlinks is written in the vertical line portion, and the lower segment of the names of them are written on the plates appearing horizontally.

FIG. 161A shows a state of only A at the upper left in FIG. 142.

FIG. 161B describes that since the upper left A and B in FIG. 142 exist in one folder, jumps occurs between hyperlinks and anchors having the same name.

FIG. 161C describes that since A to Con the upper left in FIG. 142 exist in one folder, jumps occurs between hyperlinks and anchors having the same name.

FIG. 161D describes that since A to Don the upper left in FIG. 142 exist in one folder, jumps occurs between hyperlinks and anchors having the same name.

FIG. 161E describes that since A to Eon the upper left in FIG. 142 exist in one folder, jumps occurs between hyperlinks and anchors having the same name.

FIG. 161F describes that since A to F on the upper left in FIG. 142 exist in one folder, jumps occurs between hyperlinks and anchors having the same name.

FIG. 161G describes that since A to G on the upper in FIG. 142 exist in one folder, jumps occurs between hyperlinks and anchors having the same name.

### 0.989.2: Drawings from FIG. 162A to FIG. 162G

FIG. 162A is a diagram of FIG. 161A viewed from another viewpoint.

FIG. 162B is a diagram of the state of FIG. 161B viewed from another viewpoint. In the case of FIG. 162B, four additional verbatim which consist of six hyperlinks groups have been added to FIG. 162A.

FIG. 162C is a diagram of the state of FIG. 161C viewed from another viewpoint. In the case of FIG. 162C, four additional verbatim which consist of six hyperlinks groups have been added to FIG. 162B.

FIG. 162D is a diagram of the state of FIG. 161D viewed from another viewpoint. Hyperlinks that do not jump are marked with a cross. In the case of FIG. 162D, four additional verbatim which consist of six hyperlinks groups have been added to FIG. 162C.

FIG. 162E is a diagram of the state of FIG. 161E viewed from another viewpoint. Hyperlinks that do not jump are marked with a cross. In the case of FIG. 162E, four additional verbatim which consist of six hyperlinks groups have been added to FIG. 162D.

FIG. 162F is a diagram of the state of FIG. 161F viewed from another viewpoint. Hyperlinks that do not jump are marked with a cross. In the case of FIG. 162F, four additional verbatim which consist of six hyperlinks groups have been added to FIG. 162E.

FIG. 162G is a diagram of the state of FIG. 161G viewed from another viewpoint. All hyperlinks can jump. In the case of FIG. 162G, four additional verbatim which consist of six hyperlinks groups have been added to FIG. 162F.

### 0.989.3: Drawings from FIG. 163 to FIG. 166

FIG. 163 describes that all lower segments makes similar jumps within the each plate. This plate means the verbatim in the setting region 4 in FIG. 1.

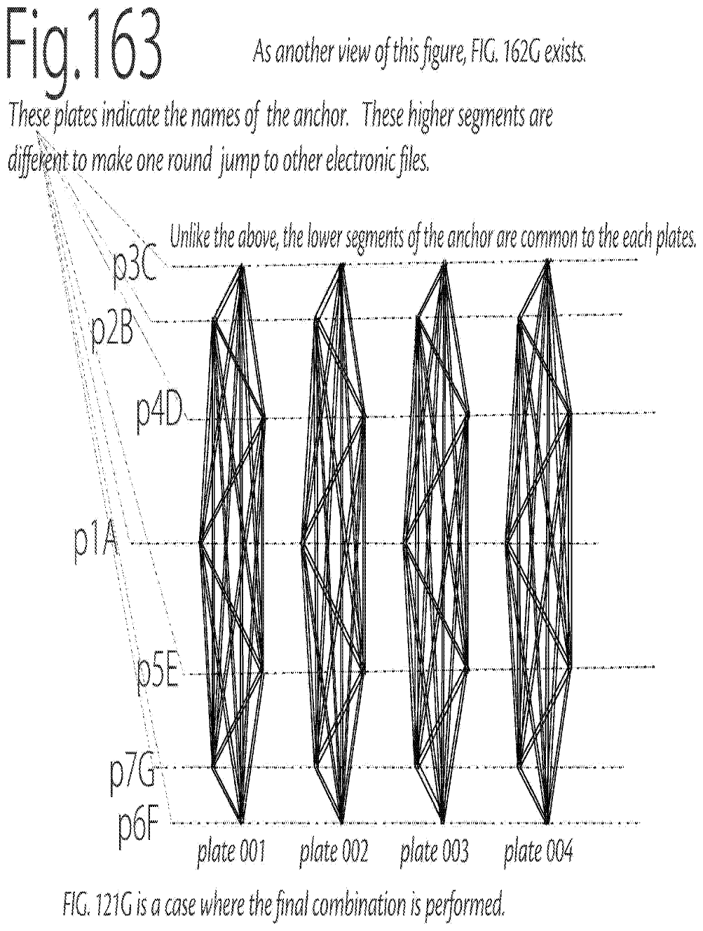

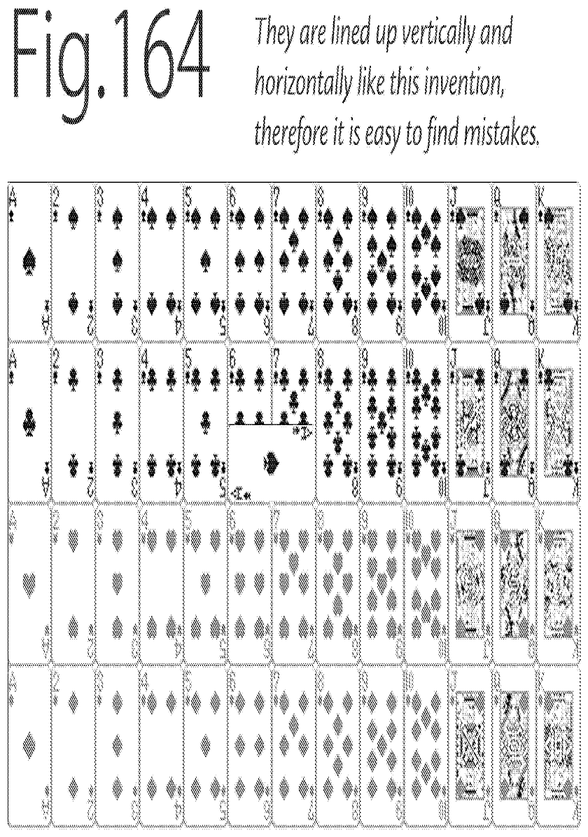

FIG. 164 shows that, in the case of a card game, if it is organized, human intelligence can easily find an error location. The same can be said for artificial intelligence if artificial intelligence is a product that imitates humans.

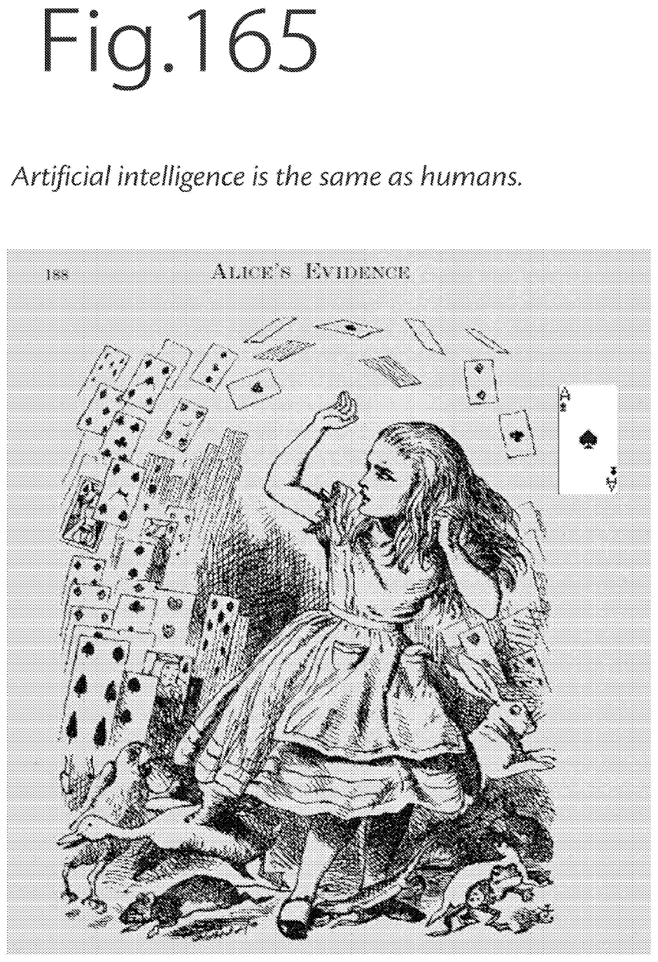

FIG. 165 shows that in an organized situation the decision is accurate and panic is reduced.

FIG. 166 is a table for abbreviation symbols in the specification. When the application is published by the USPTO, characters other than ASCII are forcibly transformed. Therefore, the value of publication will be decreased. To prevent this drawback, measures are taken to replace with the drawings. Because characters will not be replaced with another character when characters are changed to the drawings.

### DESCRIPTION OF THE EMBODIMENTS

### 0.99: Configuration of Specification

First, an example of electronic files in the present patent application, name rules, configuration of hardware, the configuration of an electronic file generation apparatus, conditions before entering production stage such as currently-being-prepared names will be described below. After that, a program control and a generation method composed of three processes will be described. Then, the different example of implementation from the first electronic files will be shown. Finally, points to note and image of large-volume production will be described.

### 1. One Example of Electronic Files

### 1.00: Embodiment Using Multilingual Treaties or Conventions

FIG. 1 is a diagram illustrating a part of an electronic file one according to one exemplary embodiment of the present invention. The electronic file one illustrated of FIG. 1 is an electronic file for comparing treaties translated into a plurality of languages. In other words, in the electronic file1 illustrated of FIG. 1, full texts of main patent treaties translated into seven languages (French, English, Chinese, Japanese, German, Russian, and Spanish) are contained in one MS Word file. And French version, English version, Chinese version, Japanese version, the German version, Russian version, Spanish version is described in this order.

### 1.10: Jumping Function of the Setting Regions of FIG. 1

Next, a relationship between individual hyperlinks of the hyperlinks group included in the verbatim and jump to the anchor A will be described. The link 1 (-->E of FIG. 1) illustrated in the setting region 6 of a verbatim of FIG. 1 jumps to other pages (the second line of FIG. 6E) in the identical file corresponding to the English version. The link 2 (-->C of FIG. 1) illustrated in the setting region 7 jumps to pages corresponding to the Chinese version (the third line of FIG. 6E). The link 3 (-->J of FIG. 1) illustrated in the setting region 8 jumps to pages corresponding to the Japanese version (the fourth line of FIG. 6E). The link 4 (-->G of FIG. 1) illustrated in the setting region 9 jumps to pages corresponding to the German version (the fifth line of FIG. 6E). The link 5 (-->R of FIG. 1) illustrated in the setting region 10 jumps to pages corresponding to the Russian version (the sixth line of FIG. 6E). The link 6 (-->S of FIG. 1) illustrated in the setting region 11 jumps to pages corresponding to the Spanish version (the seventh line of FIG. 6E). Further, the anchor A of FIG. 1 performs returning jump to a certain page of the setting region 4 being the French version, from other language pages. The anchor A of FIG. 1 will be in the same array as the anchors arranged at the end of FIG. 6E. The anchors are not usually displayed on a screen.

### 2: Description Relating to the Setting Region 4 (Verbatim Part) in an Electronic File

FIG. 2 is a diagram for briefly explaining a relationship between three anchors and six hyperlinks, unlike the hyperlinks group illustrated in FIG. 1. The content F13, the content E13, and the content C13 illustrated in FIG. 2 have similar content but differ in descriptive languages.

### 2.00: Apparent Names and Hidden Names in FIG. 2

In the location content F13, the location content E13, and the location content C13 in FIG. 2, hyperlinks are set up so as to content which respective displays suggest and are designed to jump in verbatim. For example, on a page of the location content F13, hyperlinks “-->E” and “-->C” and an anchor F13 are set up. On a page of the location content E13, hyperlinks “-->F” and “-->C” and an anchor E13 are set up. Further, on a page of the location content C13, the hyperlinks “-->F” and “-->E” and an anchor C13 are set up. Actually, these pages may be set up about several thousand pages apart from each other.

### 2.10: Jumping Function and Effect of F13 and -->E in FIG. 2

Jumping in verbatim is performed as follows. When selecting the hyperlink “-->E” on a page where the content F13 in FIG. 2 is described, the hyperlink jumps to the anchor E13 on a page where the content E13 is described. The jumping will enable what is displayed on a screen to be switched from the content F13 to the content E13. Next, when selecting the hyperlink “-->F” on the page where the content E13 is described, the hyperlink jumps in return to the anchor F13 set up on the page where the content F13 is described. The jumping will enable what is displayed on the screen to go back to the content F13 from the content E13. Though not illustrated, if the next page is the location content item F14 in multinational Conventions, a hyperlink E in content F14 jumps in verbatim to an anchor in E14, and jump in return is also similarly performed.

### 2.20: Order of the Setting Regions in FIG. 2

When a series of jump commands in FIG. 2 are performed with a smartphone, a position of the link “-->E”, present in the content F13, and a position of the link “-->F”, present in the content E13 for returning after the jumping are arranged. Using that they are located nearly at the same positions in the sciences even when arranged in association with each other by jumping. This is derived from the Order, the preceding and succeeding of the link 1 through the link 6 that constitute a hyperlinks group (the setting region 5 in FIG. 1) with six hyperlinks will never be reversed even in jump destination. Obeying the Order means that the preceding and succeeding in the setting region 5 in FIG. 1 is always maintained. The same applies to both jump destination and jump source. For example, the array in FIG. 6E, F:E:C:J:G:R:S. Further, at this time, a link for the content is dropped off from a hyperlinks group, which is hereinafter, simply referred to as “drop-off of interest”. Then, in the case of obeying the Order, the preceding and succeeding is not reversed when drop-off is performed. See, FIG. 124 (drop off) and compare FIG. 125 (not drop off).

### 2.30: Hidden Names of the Order

Then, the fact that jump of the hyperlinks becomes the Order means that this principle works without exception in the hidden names. The Order is to execute for hidden names. In other words, when hyperlinks are placed in locations, they are arrayed from the ascending order of the character codes in the verbatim. Also, even when a hyperlink of interest, where contents are arranged, is dropped off in verbatim, other hyperlinks will be arrayed in Order. Therefore, the character codes are placed in ascending order in the verbatim region, the same preceding-succeeding relation of the array will be maintained.

### 2.31: Effect of the Order

For this reason, a distance of nearly the same spacing is generated, between the positions of setting regions at jump source of hyperlinks and positions of setting regions at the jump destination of hyperlinks in science (the setting region 3) in FIG. 1. In such a case, it is easy for the user to notice that the interval is constant. Therefore, the user starts to wish to examine the contents iteratively by using this interval.

### 2.40: N(N−1)

On the other hand, the basic number of hyperlinks necessary for jumping for all content and causing them to function, it will be easily understood when users recollect hyperlinks of a Pentagon-like Star of David. See also from FIG. 115A to FIG. 115H. The basic number of straight lines must allow for double jumping so as to enabling going to and returning from each other by doubling the (N(N−1))/2. This is a formula for obtaining the sum of diagonal lines and neighboring sides in the polygon. In response to this, N−1, there is one drop-off of interest in the hyperlinks that jump in verbatim in the setting region 4 in FIG. 1. This is equivalent to the fact that straight lines that can be drawn from all the angles to any given angle are one less than the number of vertices of the polygon. For example, FIG. 115H. This is because straight lines cannot be drawn between the same angles where there is no distance. Thus, for example, one set of hyperlinks in the case of merging the content in seven languages at minimum into one electronic file is 6×7=42. The required a total number of hyperlinks based on this formula, in the setting region 4 in FIG. 1 that needs to operate as the verbatim. See also from FIG. 36A to FIG. 36G.

### 2.50: Construction of New Independent Lines of Sciences that are Independent of Contents

The verbatim of the setting region 4 set up in the electronic file 1, which contains full texts of treaties in seven languages illustrated in FIG. 1, is different from old type hyperlinks. The old type hyperlinks are embedded in the ground when arrives at the destination of the content. The destination having rich commentary to deepen a viewer's understanding, but it will finish its purpose and be buried. However, new types in the electronic file 1, a tool which configures jumping, which is named science, exists independently as one line, in a line different from the content. Therefore, new types are not only able to be described freely, independently, but also keeping similar arrangement style even before and after jumping and the contents are not affected by the science. Further, the fact that the science has become independent means that the science itself is always separated from the content and has become an independent structure. In other words, leading to independence in which addition or deletion can be performed by inserting or removing both hyperlinks and anchors in line unit of science. Then, usability and reusability of sciences at the time of large-volume production is enhanced by being independent on a space in this manner.

### 2.51: Lines on which Sciences are Placed

It is advisable not to arrange an anchor on a line beneath the hyperlink groups on the same page. This is because some viewer software may count a line number where an anchor is arranged and display the line stopped by the anchor at the top of a screen. Therefore, at that time after the jump, a viewer's line of sight will result in losing sight of the hyperlink groups for returning from the screen at the jump destination. When the position is unknown, the viewer will continue to look for it. In this case, by going back to continue one previous page, then the viewer will find a hyperlink to return by jumping. By the way, sciences do not always need to start from the first line of the page. For example, when Chapter, Parts or the like newly start, sciences may start following these items. The sciences do not need to be arranged on each page of an electronic file, but they need to be arranged at regular intervals so as not to cause degradation of the functions of verbatim.

### 3: Name Rules

### 3.00: Mechanism of Display of MSWord as an Editor of XML

In the electronic file (extension.docx) in FIG. 1, XMLfiles (e.g., “document.xml”) are included (FIG. 14). Further, information about anchors illustrated in FIG. 3A and FIG. 3B is managed by giving ID numbers within the document xml files (FIG. 18). In the “document xml” included in the MSWord, the ID numbers in the files are attached in order (w:id in FIG. 15 and w:id in FIG. 18), each time an anchor is created. Then, setting information of the anchor A in the setting region 4 of the electronic file 1 can be read at the dialogs in FIGS. 3A and 3B from a state of extension docx.

### 3.10: Hyperlink Edit Screen and Anchor Edit Screen

FIG. 3A and FIG. 3B are diagrams, each illustrating an example of an edit screen of the electronic file in FIG. 1. FIG. 3A is a diagram illustrating an example of a hyperlink edit screen. FIG. 3B is a diagram illustrating an example of an anchor edit screen.

### 3.11: Anchor Edit Screen

On the other hand, a screen 34 illustrated in FIG. 3B includes thereon a screen 36 that is displayed when selecting an icon 35 named “bookmark” (Bookmark) located on the screen top of MS Word. A bookmark refers to an anchor on MSWord. On the screen 36, a list of bookmark names is displayed in a region 37. Further, bookmarks can be added by an add button 38, and already-created bookmarks can be deleted with a delete button 39. Furthermore, when a jump (go to) button 40 is selected, while a particular bookmark is selected in the region 37, clicking on the button 40 allows users to jump to the point of the content where the bookmark has been placed. As for sorting order of the list of bookmark names shown on the screen 36, the bookmark names can be rearranged by designating either a name button 41 for name order or a location button 42 for insert order. In other words, the bookmark edit screen illustrated in FIG. 3B is designed so that, when selecting a location order (the button 42 in FIG. 3B), anchors are arrayed in the location order. And when selecting the name order (the button 41 in FIG. 3B), information of the anchors is sorted and displayed in the order of character codes separated from the locations.

### 3.12: Hyperlink Edit Screen

A screen 31 illustrated in FIG. 3A is a screen displayed when selecting an item named Edit Hyperlink in a context menu that appears when right-clicking of a mouse on a hyperlink (-->E) illustrated in FIG. 1. In FIG. 3A, when selecting a display 32 named “Place in this document”, names of a plurality of anchors set up within the electronic file are displayed in a list, in a region 33 named “Select a Place in this document”. On the screen in FIG. 3A, setting up of a hyperlink can be performed by selecting an anchor name being displayed in the region 33. Clicking on the hyperlink allows users to jump to a predetermined place in the electronic file.

### 3.20: Anchor Names are Displayed in the Order of Character Codes

However, an appearance order of names on the hyperlink edits screen (the display 32 in FIG. 3A) is only displayed in the same order as the name order (the button 41 in FIG. 3B) since the location order (the button 42 in FIG. 3B) cannot be selected. And, it is the specification of MSWord, which edit hyperlinks only in the order of character code of the names of the anchors. Not accept the location order. However, since the ASCII characters of Western fonts have only 128 characters, before-and-after relationship of the character codes becomes clear. Therefore, until now, it was not necessary to relate ASCII characters in the location order.

### 3.30: Purpose; the Naming Rules and Verbatim

The anchor A in the setting region 4 in FIG. 1 is created according to the naming rule. This is because automatically create next circumstances. On the one hand, the anchors are described one after another in the location order of a particular language. And on the other hand, verbatim described one after another in the location order of other languages. It aims to sequentially jump between the particular language and other languages in the location of the content orderly.

### 3.40: Names that Cannot be Produced in a Large-Volume

However, in the region 33 in FIG. 3A, only anchor names are collected from the locations. And they are arranged in order of sorting in an entirely different character order. For this reason, in the case where anchor names are increasingly produced at random, even if information that suggests the locations is available, the anchor names cannot be sorted based on the information. As a result, combining with hyperlinks becomes impossible.

### 3.50: Names that can be Produced in a Large-Volume

However, whichever arraying method may be employed; the above problem can be solved if the names are arrayed in the same order in a manner easy to read and understand. In that case, if it can be solved by arranging the names that can read specific meanings of simple names, the names will be easy to operate. In this way, it is easy to combine the names sequentially in order. Furthermore, given large-volume production, it is logically convenient to create a variety of names using the numbers sequentially increasing in line with the locations. Normally, the names will be produced so as to be arranged in the ascending order of younger names. Mass production is the same too. The names are created to be arranged from the beginning. Accordingly, the naming rule in a narrow (0.10) sense is preferable than the naming rule in a broad sense.

### 3.51: Consider an Actual Example of Names by the Naming Rule in a Narrow Sense

As described above, the currently prepared name 72 A of FIG. 5 is usually created by the narrow meaning naming rule described above. For example, if there are large document contents such as the PCT rule, it is desirable that the abstract link is created so that it is displayed not only in one layer but also in two layers. Again, anchor names given in the order of their places are generated according to narrowly defined naming rule. And even if the name of the anchor is separately stored from the table of contents and the content, it is possible to restore the table of contents and the order of the content by changing the alignment method to the name order. This is because the naming rule in a narrow sense is that the names of the anchors placed at the locations were arranged from small character numbers to large character numbers. Therefore, in the case of the PCT rule, it is always arranged in order of table, TABLE, Article (FIG. 35A and FIG. 35B).

### 3.60: Consider an Actual Example of Names by the Naming Rules in a Broader Sense

Meanwhile, there is another naming rule. The rule is the naming rule in a broader sense. The broad rule is established simply by having a name that indicates the content is placed in the location. But even so, the generation apparatus can restore the suggested position from the name. For example, in the case of Japanese, the order of One (“Ichi”), Two (“Ni”), Three (“San”) is natural numbers aligning in the ascending order. For example, MSWord can connect hyperlinks only according to the name order. However, suppose that different manufacturer's XML editor is used, which can combine hyperlinks One (“Ichi”), Two (“Ni”), Three (“San”) in the location order. In this case, this different company's word processing software enables jumping.

### 3.70: The Best Naming Rule

Since the files concerned created according to the naming rule are also reserved within the same folder, it is preferable to array the files according to the criterion under which the files can be aligned in a unified manner. In this way, when jumping to another file in the same folder, it is recalled that the files are arranged in the name's order, in the extension type order, in the size order, in the creation date order, and the likes. When we think this way, what is described the name order becomes the best arrangement order universally. This is because so far as what is called the location order does not exist in arrays in common with many other files in a folder. Thus, from now on, the description according to the naming rule in a narrow sense will be provided. However, so long as the naming rule in a broad sense is convenient, it is not necessary to deny the use of the naming rule depending on a certain situation.

### 4: Description of Hardware Configuration

Next, the generation apparatus for generating the electronic file 1 will be described.

### 4.00: Generation Apparatus 50

FIG. 4 is a block diagram illustrating hardware configuration example of the generation apparatus 50 for generating the electronic file 1 described from FIG. 1 to FIG. 3B. The generation apparatus 50 is an information processing apparatus such as, for example, a notebook PC, a desktop PC, a tablet terminal, and a smartphone. The generation apparatus 50 is loaded with applications, OS (Operating System) and the like for creating electronic files, tables, presentation documents, etc. Users can create electronic files by activating, for example, electronic file creation software such as MSWord.

### 4.10: Description of 50 in FIG. 4

As illustrated in FIG. 4, the generating apparatus 50 comprises a central processing unit (CPU) 51, a read-only memory (ROM) 52, a random-access memory (RAM) 53, a hard disk (HD) 55, a hard disk drive (HDD) 56, a media drive 57, a display 58, a network interface (I/F) 59, a keyboard 60, a mouse 61. A DVD-ROM drive 62, an external device I/F 63, and a bus line 64.

### 4.20: CPU 51 in FIG. 4

The CPU 51 is a device used to integrate control respective devices and controllers connected to the bus line 64. The CPU 51 loads necessary programs or the like on the RAM 53 when executing processes, and realizes various types of operations by executing.

### 4.30: ROM 52 in FIG. 4

The ROM 52 is a device configured to store therein various types of programs and the like necessary for realizing a function of executing a basic input/output system (BIOS) or operating system (OS) serving as a control program of the CPU 51. The RAM 53 is a device that functions as a main memory, a work area, and the like of the CPU 51.

### 4.40: HD 55 in FIG. 4

The HD 55 is a device that stores an electronic file 55A, the electronic file creation software 55B, a dedicated program 55C and the like. Among them, the electronic file 55 A is a file that can display XML data composed of a document or a numerical value and is, for example, an extension docx file, created by MSWord. Further, the electronic file creation software 55B is software that can create anchors and hyperlinks and be capable of operating documents and numeric values of XML. The electronic file creation software 55B may be, for example, MSWord, Apache OpenOffice Writer, or LibreOffice. The dedicated program 55C is a program for enabling documents and numeric values of XML to be operated, but it may be a unitary configuration or may be a program incorporated into MSWord. The dedicated program 55C can execute a part or all of processing based on various types of instructions from users described below.

### 4.50: HDD 56 in FIG. 4

The HDD 56 is a device that controls read or write about various types of data and the like concerning the HD 55 by the control of the CPU 51.

### 4.60: Media Drive 57 in FIG. 4

The media drive 57 is a device that controls read or write data concerning a recording medium such as a flash memory. The display 58 is a device that displays various types of information such as cursors, menus, windows, characters, images, videos, etc. A touch panel function may be incorporated into the display 58. The network I/F 59 is a device that performs data transmission by utilizing a communication network.

### 4.70: Keyboard and Storage Medium in FIG. 4

The keyboard 60 is a device provided with a plurality of keys for inputting characters, numeric values, various types of instructions, and the like. The mouse 61 is a device for performing selection or execution of various types of instructions, selection of processing targets, movement of the cursor, and the likes. The DVD-ROM drive 62 is a device that controls read or write data concerning DVD-ROM as an example of an attachable and detachable recording medium. From now on, a computer-readable storage medium for storing a computer program is referred to as a computer-readable storage medium or solely a storage medium.

### 4.80: External Equipment 63 in FIG. 4

The external equipment I/F 63 is a device that transmits and receives data to and from external equipment. The bus line 64 is a grouping of signal lines each electrically connecting various types of hardware described above with each other.

### 4.90: Supplemental Description in FIG. 4

The recording medium may be a computer-readable recording medium such as DVD-R, DVD-RW, DVD-RAM, compact disk (CD)-R, CD-ROM, CD-RW, blue ray disk, or may be provided with a drive which the generation apparatus 50 can use. Herein, the recording medium is constituted to include the HD 55 and the HDD 56, but in addition to or in place of these, a flash memory and an SSD (Solid State Drive) may be provided.

### 5: The Electronic File Generation Apparatus 50

From now on, a functional configuration of the electronic file generation apparatus 50 and currently-being-prepared names will be described.

### 5.00: Currently-being-Prepared Names

Now, functions when the electronic file generation apparatus 50 operates and eligibility requirements of name data will be described. However, names, as used in Chapter 5 refer solely to hidden names as viewed from field code side.

### 5.01: Components of the Electronic File Generation Apparatus 50 of FIG. 5

FIG. 5 is a diagram illustrating the functional configuration when electronic file creation, processing is performed in the electronic file generation apparatus 50 according to an exemplary embodiment of the present invention. As illustrated in FIG. 5, the electronic file generation apparatus 50 comprises a name control unit 71, a storage unit 72, an instruction information receiving unit 73, a name generation unit 74, a name incrementing unit 75A, a name multiplicating unit 75B, and a name changing unit 76, a name evacuation unit 77, a name combining unit 78, and a final combining unit 79.

### 5.02: Software for the Generation Apparatus 50 in FIG. 5

Functions of the components illustrated in FIG. 5 will be described below. The present invention is realized by the CPU 51 illustrated in FIG. 4 deployed on the RAM 53, the electronic file creation software 55B such as MS Word stored in the HD 55, and the dedicated program 55C such as a macro. From now on, respective functions of the generation apparatus 50 that constitutes the entire configuration will be described.

### 5.03: The Name Control Unit 71 in FIG. 5

The name control unit 71 controls the entire name generation processing of the electronic file generation apparatus 50 integrally. Specifically, the name control unit 71 causes the above respective instructions input by the instruction information receiving unit 73 to be output to the display 58 or to be stored in the HD 55 via the HDD 56. As described in FIG. 5, the name control unit 71 is constituted to include all of the following units, but it may be constituted not to include the name evacuation setting unit 77. Further, unlike FIG. 5, the name control unit 71 may be provided independently of the following units: the name generation unit 74, the name incrementing unit 75A, the name multiplicating unit 75B, the name changing unit 76, the name evacuation unit 77, the name combining unit 78, and the final combining unit 79.

### 5.10: An Electronic File 72A in FIG. 5; General Remarks

The electronic file 72 is a storing or saving destination when names are created, multiplicatively increased, and combined. In other words, in the electronic file 72A, some of the names, which become the origin of hidden names incorporated into anchors in future, or hidden names that should be generated and incorporated into hyperlinks in future are saved as they are naked. Hereinafter, the electronic file 72A may be referred to as currently-being-prepared names 72A or names 72A as appropriate.

### 5.11: An Electronic File 72B of FIG. 5; General Remarks

Further, in the electronic file 72B. If names (MSWord calls it, “a bookmark.”) in the process of large-volume production are anchors, the “names” are surrounded by double quotation marks as displayed in the seventh line of FIG. 15. In their tags containing the words of the bookmark are seen ahead. Anchor names in the English style, are “NAME” names in a state of being surrounded by the definite article “bookmark”. It exists in the form of <w:bookmark Start w:id number w:name “name”/>. And if the names are hyperlinks, they are in a state where “names” of FIG. 15. Double quotation marks have surrounded them, and the tags contain words of hyperlinks are seen ahead. Hyperlink name in English style is saved in a state of science in the setting region 3 or a state of verbatim in the setting region 4. The NAME is in a state of being surrounded by the definite article “hyperlink”. <w:hyperlink w:anchor=Name w: history=2“number”/>. From now on, the electronic file 72B is referred to as currently-being-prepared names 72B or names 72B as appropriate. In each processing step of the name control unit 71, changes are further applied individually to forms when the names are saved.

### 5.12: An Electronic File 72C in FIG. 5; General Remarks

Further, the electronic file 72C is a file in a state with a jumping function of the setting region 3 or 4. Hereinbelow, the electronic file 72C is referred to as an already-combined name 72C or a name 72C as appropriate. Names used in 5.00 through 5.99 refer to hidden names as seen from field codes or XML side. Not from the apparent side. It should be noted that the electronic file 72C is also an electronic document created based on the electronic file. Hereinbelow, the electronic document will be described as the electronic file 72C or simply electronic file.

### 5.13: The Storage Unit 72 in FIG. 5; Copy and Save

Furthermore, the electronic file currently-being-created names 72B can save data temporarily copied by the name generation unit 74, the name multiplicating unit 75, and the name evacuation unit 77. Also, the electronic file currently-being-created names 72B can save data newly created. Furthermore, the storage unit 72 can supply the above-described data to the CPU 51 according to the instructions from the name control unit 71.

### 5.20: The Currently-being-Prepared Names 72A; Sample of Names

On the other hand, the currently-being-prepared names 72A in FIG. 5 are names that exist before the electronic file generation apparatus 50 operates. The names are incorporated into production step according to the instructions of the name control unit 71 and become anchor names, then become hyperlink names. FIG. 6A and FIG. 6C are diagrams for explaining a configuration of the currently-being-prepared names 72A in FIG. 5 as an example. Of these, the name illustrated in FIG. 6A is a sample of the name corresponding to contents items in Japanese, in the case where multilingual treaties in different languages are related to each other. This sample corresponds to the content that has a mutual relationship with treaties and their rules.

### 5.21: Eligibility Requirements of the Currently-being-Prepared Names

When the currently-being-prepared names 72A are created, there are several rules to be followed. First, the names 72A obey the naming rule. In other words, even when names of anchors arranged in the location order have been extracted into another file, there is no change in the front-and-back relation of the order. The order can be confirmed by sorting the names in advance on spreadsheet software. Also, after inputting characters into MS Word and then selecting characters to be converted, the order can be confirmed by simultaneously pressing ALT key and X key and confirm their character codes. Furthermore, the names need not be the ones that suggest what their entities are. It is to the extent that it is preferable to suggest their entities if possible. However, matching of hidden names of hyperlinks and anchors are requirements of jumping. Therefore, the hyperlink names need always to match the anchor names. Subsequently, the eligibility requirements of the currently-being-prepared names 72A will be described below.

### 5.30: <.> in the Control Region 83, Notes FIG. 126

The head part of the first column in FIG. 6A, FIG. 6C, and FIG. 6D (hereinafter, this part is referred to as a control region 83) is <.>. Since it was confirmed that MS Word does not accept the name of an anchor starting from a number regardless of whether it is 1 byte or 2 bytes, this starting specification of <.> must be avoided. Hereinafter, an area requiring this control is referred to as the control region. The control region 83 is represented as <.> to avoid the phenomenon. On this occasion, it is preferable in some cases to use <,> besides <.>. The reason, as mentioned in 7.51.07, is that <,> is younger than <.> when arranging them in the name order. If the character <,> consists of character numbers that are younger than <.>, then it is possible to create an abstract link. Using this method, the table of contents will come first, and the next article will be written.

### 5.31: Using Commas <,> and Full Marks <.> for a Part of Segments of the Name

In this regard, characters such as <.> <,> are characters to be used for hyphenation processing. When writing sentences, there are other characters to be used for hyphenation processing, but the reason for using <.><,> here is that it is meaningful to select and change in a unit of segments free of mistakes when performing the processing in FIG. 15 and FIG. 18. By making blank parts of characters large and making the names conspicuous in the unit of segments thereby making clear the apparent and hidden names in the list of mingled characters such as document xml. Therefore, it is not limited to <.> and <,>.

### 5.40: Dividable into Segments

Next, the names 72A each must be composed of several segments and each segment including character data having a great space. This is because the segments are required to include <.> or the like to make sure any change or replacement of a segment can be performed without errors. Therefore, in dividing into segments, a question arises whether <.> is considered to be placed on the front segment or back segment. Regarding this point, it can be considered that in the theme region 81 of FIG. 6C, reading point <.> may be considered to be included in the highest level region 84. Or the reading point <.> may be considered to be included in the intermediate level region 88. Similarly, regarding the double reading point <..> is shown in FIG. 6A, FIG. 6C, which may be considered to be included in the theme region 81. Alternatively, it may belong to region 82. In other words, where these control symbols are included in what region is only a matter of style.

### 5.41: Divide into Short Segments

However, when a large number of characters are present in a segment, the CPU is heavily loaded during automatic replacement processing. In order to avoid the burden from increasing, it is necessary to select as small in the number of characters as possible, regarding selection range of replacements. Here, the number means the number or the character which will be converted into another data. For example, FIG. 49. For this reason, respective segments will be composed of a small number of characters.

### 5.50: Theme Region

Next, it will be explained that dividing a name into a plurality of segments makes it easier to exchange segments from outside. The highest level region 84 in FIG. 6A or FIG. 6C is a segment that constitutes a part of a theme region 81. In the theme region 81 according to the present exemplary embodiment, the last (rightmost) digit of the highest level region 84, is differently expressed depending on languages mainly used for contents. For example, in the electronic file in FIG. 1, characters such as <F> for French, <E> for English, <J> for Japanese are used. In FIG. 6C, the highest level region 84 is present at the part of the leading segment that constitutes the theme region 81. Then, following the segment of the highest level, an intermediate region 88 is present. At this time, the theme region 81 is similar to the region 84 in FIG. 6D.

### 5.51: Leading (Leftmost) Digit of Theme Region

In contrast, numbers are entered into respective leading digit parts of the highest level region 84 in FIG. 6A and FIG. 6C, and the intermediate level region 88 in FIG. 6C. This is because by entering the numbers, it is desired that the preceding-succeeding relation of <F:E:C:J:G:R:S> is not reversed when creating the links from 1 to 6 of FIG. 1. This is because if numbers sorting is not present, respective languages can only be arrayed in alphabetical order like <C:E:F:J:G:R:S>. In other words, the alignment of the names order cannot be created in the order of contents which a user wants to describe. Therefore, the user can control constantly the order of the themes discussed in this relational way, it will be possible to describe the contents in the order the user wants to discuss. Accordingly, to align respective seven languages in order, the highest level regions 84 in FIG. 6A and FIG. 6C are assigned numbers in front of characters. <1F>: <2E>: <3C>: <4J>: <5G>: <6R>: <7S>. Thereby achieving the control of hyperlinks based on the numbers.

### 5.52: Simple Sorting Region of the Intermediate Level Region

Of course, when patent-related famous treaties have been organized in one file, the last digit part of the intermediate level region 88 in FIG. 6C suggests what treaty name corresponds to what character. If the sequential order of the themes can be controlled to be always kept constant in this manner, the content can be described in the order of desire to discuss. As for <00> of the intermediate level region 88 in FIG. 6C, suppose that the Title of the Rule is marked with <#> like FIG. 9G. In this case, if Paris Convention is 0, the PCT is 1, and Regulations under the PCT is 2. Then, representation as <2#> can suggest that the second content of an electronic file is Regulations under the PCT (# suggests K in Japanese of PCT RULE. It means a rule. From now on the same applies. Symbols # replaced are shown in FIG. 126). Thereafter, when the number sorting is performed using the highest level and the same configuration as the highest level in this manner, each leading digit part is characterized and named as a simple sorting region.

### 5.60: <.> and <,> Used for Other Parts

On the other hand, the character <.> in FIG. 6A to FIG. 6D, which is used in the control region 83, is used for a purpose other than the control at other segments. For example, if indicated as <.1F.> by using this character, even in continuous XML sentences without line breaks which make sentences easier to read, the character strings being not line fed, preceding and succeeding of characters can be made conspicuous. Thereby, characters in the center can be made conspicuous and made easy to read. If the characters can be made conspicuous in this way, the operation performed after selecting the central character strings will become easy. See FIG. 48. Also, the mistakes also decreased. Then, the reliability of replacement processing is enhanced. However, the type of characters is not one. For example, there are two types of symbols <.><..> in FIG. 18. Furthermore, in FIG. 18, <.,> is used in addition to the two symbols. This is because, if <,> is used at portions that become the same number of columns counting from the head of names, it can be arranged forward since character codes are younger than the case where the same column begins with <.>. By using this principle, it is desired to create a table of contents forward of contents.

### 5.70: Lower Level Region

Finally, the Article/Clause region 82 of the name will be described. The Article/Clause region 82 is a region into which individual Articles/Clauses of treaties or conventions are entered. The Article/Clause region 82 is a part consisting of numbers of the regions 86, 87 in FIG. 6A and FIG. 6C, and is composed of the lower level region 86 and the lowest level region 87. Then, the lower level region 86 and the lowest level region 87 in the present exemplary embodiment directly suggest contents in the names, as illustrated in 72A, 72B, and 72C in FIG. 5. For example, in the case of Rule 1.1 of Regulations under the PCT, <.01.01> or the like is used. Then, even though the Article/Clause region 82 has different language name in a segment at the highest level, Rule 1.1 is created commonly without exception as <.01.01> regardless of any language. This is one of the absolute requirements.

### 5.71: Control in the Lower Level Region

Then, the lower level region 82 is a composite control region that is equipped with both a meaning control region and a number sorting region. The names of Articles/Clauses are locations of the names of Articles/Clauses where the contents are located. The use of respective two digits has two purposes. First, Articles often have more than 10 Clauses. At this time, though it is desired to describe Clause 10 next to Clause 9, always Clause 10 will be arranged forward of Clause 2. This is because upper digit 1 is still alive. The first purpose is to prevent this occurrence in advance. In other words, when starting from 01, then 10 can be arrayed next to 09. The second purpose is to keep a stable line of sight with other Articles/Clauses on many name creations (In FIG. 9G and FIG. 15, FIG. 18, FIG. 19C, and FIG. 19D). When ending with Clause 02 and ending with Clause 11, the number of digits is stable together like Clause 02, Clause 11, which leads to the stable line of sight. Because they consist of the same place values. Two-digit display.

### 5.80: Mapping Out Turning Points and Hierarchical Order

Next, consider the case where science is created for title and table of contents. An attempt will be made to use growth points (the region 85 of FIG. 6C) of segments at portions that come to the same vertical positions counted from the control region (the region 83 of FIG. 6D). The hidden names with growth points can be diversified. In this case, the names arrayed in the following order style: 1 <,,> style for the title of the treaty, 2 <,.> style for the table of contents or overview table, 3 <.,> style for the Tables of Contents i.e., the detailed tables, and 4 <..> style for content. If the first growth points style and continuous the Article/Clause are finished, then the next growth points style and continuous Articles/Clauses will begin. As a result, the names of the Articles/Clauses can be controlled using different style segments. In short, by causing the segments to have hierarchical control of names, even when numbers that should begin with the same number 1 are used in any of titles, Parts, Articles, Clauses, respectively, it becomes possible to define which hierarchy they belong to.

### 5.90: 2 Byte Characters

By the way, in the case of English language, documents are written with the single byte characters. And single byte users do not write double-byte characters. Therefore, even if the contents are increased due to revisions in the future, the modification is easy when double-byte characters are used. Because the font style of single-byte characters has diversity. Therefore, the diversity of the contents introduces troubles into the field code. However, if creating a name with only double-byte characters, it reduces the diversity of the font style. Therefore, it is easy to control the characters. Here, the diversity means the font style which makes the difference in size and shape of the zone of the characters. Also, even if the clause of the content will increase due to revisions in the future, it is unlikely to overlap the content's wording, and thus double-byte characters are easy to deal with or to modify. Suppose, English sentences consist of one-byte and only jumping names consist of two-byte. Then, the two-byte characters are changed and increased. Select the two-byte characters and similarly change them to the same two-byte characters. Therefore, they will not hurt English which is written in one-byte. And two-byte is always background, not the content side where English is written. They coexist and help each other and develop.

### 5.91: Cautions on Input of Two-Byte Characters

In the case of MSword of MS Inc, the icon of “Aa” (Change Case) is on the home screen, so from this location, a user can select Full-Width. At this time, it is easy to become one byte when an input of alphabet letters, so it is necessary to pay particular attention. It is rare in word processors that alphabets in two-byte notation are displayed. Furthermore, even if alphabets in two-byte notation are displayed, autocorrect works, and the two-byte alphabet shall be modified to one byte. This is because the default specification of MS Word worked. At this time, when determining whether the input character is two-byte or one-byte, it can be judged concerning the fact that if the font style name is an alphabetic expression, it is often one-byte character.

### 5.92: Characters in which More than Half of the Character Area is a Blank Space

Even if more than half of the character zone like <.> is used as the red line of FIG. 18 in the tightly packed in the tagged document XML, it is easy to specify the change range. It is preferable to use characters that have a large blank space. Then, furthermore, it is preferable to perform replacements containing <.> in front and back of replacement characters. Whatever the chaotic sentences in the succession line, it is possible to specify the change range easily. The part in the red line in FIG. 18 has been changed in this manner. In this method, for the part of NAME of an anchor wrapped and surrounded by double quotation marks like a style “bookmark” in XML tag directly changed from the XML sentence. At this time, the interior of the <w: bookmark Start w: id number w: name/> is specified. It makes it easier to correct the range. There is also an idea that it is expected that identifying the range of change will be easier if the XML tag is expanded. The meaning of expanding tags is each line feed. However, it consumes PC resources for deployment. Therefore, it is often the case that you cannot replace names after deployment.

### 5.93: Discussion of Currently-being-Created Name 72 A; Preservation Format

On the other hand, the currently-being-created name 72A shown in FIG. 5 can be saved, for example, as an Excel file or a CSV file. However, it may be stored as an electronic file other than these files. It may be directly incorporated in the above-mentioned dedicated program 55 C. The creation rule may be included in the dedicated program 55 C. The name may be generated each time the currently-being-created name 72 A is required.

### 6. Description of the Processing of Names in the Name Control Unit

### 6.00: Introduction

Next, description will be provided below focusing on functional aspects of program creation in the name control unit 71 in FIG. 5. The description is also directed to general remarks about respective processes as particular remarks discussed in the next Chapter 7. Names in Chapter 6 refer to both apparent and hidden names, unlike the names in the above-described Chapter 5. Further, when science is referenced in the setting region 3 in FIG. 1 in Chapter 6 onwards, the science shall include, as an example, a verbatim which is only the setting region 4 in FIG. 1 without an abstract link in the setting region B in FIG. 1.

### 6.10: The Instruction Information Receiving Unit 73 in FIG. 5: General Remarks

The instruction information receiving unit 73, receives any of the following instructions concerning the setting region 3 and the setting region 4 in FIG. 1 from a user. These instructions regarding names of science or verbatim include a region generation instruction, a name saving instruction, a name incrementing instruction, a name multiplicating instruction, a name changing instruction (which may include an evacuation instruction and a setting information changing instruction), a combining instruction, and a final combining instruction. Further, the user can perform the above-described instructions from a displayed UI screen (not illustrated) by the dedicated program 55C. These instructions are inputted to a CPU 51 by the user directly operating, for example, a keyboard 60 or a mouse 61, and thereby the processing can be received, and after that, these instructions can be processed in a batch in a file. The reason why the name control unit 71 in FIG. 5 is not configured to have the name saving function is that the name storage unit 72 is provided separately, and the save instruction is described in the name incrementing unit 75A.

### 6.11: N−1 of Arrangement in the Setting Regions

In a verbatim of the setting region 4 at page 2 of the electronic file one illustrated in FIG. 1, jumping can be executed for the multinational treaties in seven languages in correspondence with Article-to-Article. In that case, six links: link 1 through link 6 that constitute a hyperlinks group in the setting region 5 are created in the setting regions 6:7:8:9:10:and 11 respectively. For example, “-->E:-->C:-->J:-->G:-->R:-->S” correspond to the apparent names of the hyperlinks group. Finally, the anchor A is arranged at the end. At this time, in spite of seven languages, an arrangement through the link 1 to the link 6 is less by one. This is because the description in the language of content is given immediately below, and thus there is no need to jump to this content. In short, the reason why “-->F” is excluded from FIG. 1 is that the content placed immediately below the science is French language.

### 6.12: Order Rule of Arrangement in Structured Setting Regions

Further, the array of seven languages is the order of “-->F, -->E, -->C, -->J, -->G, -->R, -->S”. Even if one link for one language arranged in the content is excluded from a hyperlinks group to become the abstract link in the setting region B in FIG. 1, the array of each line of FIG. 6E is an array according to the order rule that the front-and-back relationship among the links does not change. At this time, since the abstract link at the head returns to the table of contents of the contents of interest, the abstract link is always the same language as that of the content. Thus, at the abstract link at the head part, there is displayed the table of contents that suggests the language of interest excluded from the setting regions 6, 7, 8, 9, 10, and 11. When including the abstract link B, the apparent names of the seven links are similarly displayed in the setting region 4 in a verbatim, as illustrated in FIG. 34A. Further, on the hidden side, the names that suggest the contents as illustrated in FIG. 34B are described. Also, in the above-discussed example, \hat{ }|F is described at the head. Also, though the anchor arranged at the end cannot be read from the apparent surface, the hidden name suggesting the language of the content is displayed as illustrated in FIG. 34C. The array in this order is called the order rule.

### 6.13: Designating the Starting Line of the Setting Region

Some of the viewer products calculate exactly an arrival line after jumping. In this case, an anchor is located at the top of the arrival line, like the starting line in a new page. For example, MS Internet Explorer. Therefore, it may sometimes happen to scroll back to the one line before the jumped page to find a returnable hyperlink. This is because the anchor in the science is placed on a line afterward lines of hyperlinks. In this case, after jumping is executed, user's judgment ability of visual sense will be lost at a jumping destination. After a while, the hyperlink of interest will be found. Therefore, sometimes the user scrolls to the previous line, and then a returnable hyperlink will be found. As a result, the user becomes difficult to perform stable understanding to compare contents. Particularly in a case in which many hyperlinks are displayed as shown in FIG. 32, it is necessary to pay attention. That is why the anchor is placed on the first line among the lines of the hyperlinks in FIG. 29 and FIG. 30. However, software programming integral with iPhone intentionally does not perform this exact jumping. This specification effectively utilizes CPU source, but as a result, it is not affected by the designation of the starting line.

### 6.14: Generation Instruction of Setting Regions

The name generation unit 74 generates the setting area 4. The setting area 4 is composed of hyperlinks and an anchor. These hyperlinks in the setting region 4 jump to the anchor, which is set up in the verbatim at the setting region 4, which is set up at the predetermined positions of the pages included in other electronic files. The anchor of the setting region 4 returns from other hyperlinks, which is set up in the verbatim at the setting region 4, which is set up at the predetermined position of the pages included in the other electronic files. Further, the name generation unit 74 generates a part thereof.

### 6.15: Name Multiplicating Instructions in Setting Regions

The name generation unit 74 can create a large number of different hidden names at the time of multiplicative production of names to be arranged at the positions of sciences or verbatims, where there are only several kinds of apparent names. The example is illustrated in the electronic file in FIG. 32. And, the name generation unit 74 executes processing of increased production when arraying sciences or verbatim at a predetermined page in the electronic file 72 according to a signal from the information receiving unit 73 that receives generation instruction from a user.

### 6.16: Instruction of Hidden Names in Setting Regions

Hidden names have also been discussed in detail elsewhere, and therefore an overview will be given here. It is preferable that generation instruction of the hidden names performs generation instruction of a name that corresponds to an apparent name. Also, it is preferable to perform generation instruction in a unit of the segment that constitutes the hierarchical level. For example, respective segments are divided by punctuations such as <..> <.> <,,> <,> so that forward and backward of the segmentation are easily distinguished even by human eyes. Furthermore, errors can be prevented by simplifying the rules in advance when creating complex jump structures. Furthermore, the anchor names can be arrayed only in the order of character codes in the hyperlink dialogue box. If so, if the anchor names have been arranged in advance in the order of character codes in the location order, the anchors displayed in the combination dialog box will be arranged in the location order. When the names are arranged in the order of character codes to the location order, the both appear so that they coincide with each other, and the names are arranged in simple and stabilized order. This is the basis of all of the present invention. And until now, nobody has noticed that.

### 6.17: Anchor Names in the Same File

Further, when two separate files are combined into a single file, if there are the same anchor names in the both files, the anchors that intend to be added at the end, but the added anchors will be automatically deleted. Accordingly, it is necessary to assign different hidden names to the respective anchors. Whereas, in the processing by the name generation unit 74, “the name of the hyperlink” can create a plurality of hyperlinks having the same hidden names. This is because, even when two separate files are combined into the single file, the hyperlinks having the same names present in one file are not excluded.

### 6.20: Saving Instruction

The name multiplicating unit 75B can create copies of Sciences or verbatim created by the name generation unit 74 and can cause the copied data to be stored in the storage unit 72. The purpose of copying the names is that it is desired to keep the data for multiplicative-production are copied and saved before the change. And then combine the before data and the data after the change to create one file which has doubled capacity. Note that duplication is a kind of production activities. However, it is an obscure term to operation for the program. About what to copy for what purpose is not included. Therefore, to make documents accurate, the term of multiplication will be used in the present specification.

### 6.30: Name Multiplicating Instruction

The name multiplicating unit 75B is adapted to perform, in another electronic file, multiplicative production of the setting region 3 or the setting region 4 generated by the name generation unit 74. The name incrementing unit 75A can also perform increment of not only the setting region 3 or the setting region 4 but also individual hyperlinks and anchors in other electronic files, which are not to be finally combined. In this case, to execute verbatim jumping to a plurality of locations of a particular file on WEB, the hidden name of the first hyperlink (the link 1) belonging to the verbatim in the setting region 5 of FIG. 1 is set up as <http//:www.uspto/01.htm#NAME>. And the hidden name of the second hyperlink (link 2) is set up as <http//:www.uspto/02.htm#NAME>, and the similar processing continues up to the last hidden name of the last hyperlink. In this case, the file name of itself is <http//: www.uspto/00.htm> and jumping to the above-discussed different file will be performed. Therefore, the above-discussed <#NAME> between different files will follow the naming rules, orders. In this case, concerning the name change in each file, the increasing method by recycling (8.20) will be used for the portion of <.NAME>, while referring to the change in the lower level region. And a changing method for the highest level region will be used for the portions of 00, 01, 02.

### 6.40: Name Changing Instruction

The name changing unit 76 performs multiplicative production. At this time, the name changing unit 76 processes the setting region 3 multiplicatively increased by the name multiplicating unit 75B. In short, the names of hyperlinks at jump destination are changed. The anchor name that receives the return jumping from the hyperlink in another page is changed. The change is performed according to the prescribed naming rule. There is a case in which the already-combined names 72C are wanted to be reused in another electronic file having a content of another multilingual treaty. At this time, the name changing unit 76 performs a change of segments. For example, a hidden name <1#..00.00> will be described. At this time, only a segment <1#..> is selected as a change target. Then, it is replaced with <7#.0>. In this manner, <0> is added besides <7#>. The resultant segment becomes <7#.000.00>. This kind of replacement processing is used for the case in which name data composed of the three-digit number of Articles is required to be generated, based on the already-combined names 72C. Therefore the Patent Cooperation Treaty (PCT) will be reused in The European Patent Convention (EPC).

### 6.50: Combining Instruction

The name combining unit 78 is adapted to combine sciences produced by the name incrementing unit 75A and the name multiplicating unit 75B into one electronic file. The “combine” means digital processing of copying sciences set up in other electronic files, onto a particular electronic file. However, it has a little wider sense regarding nuance, including the process of moving and adding a science.

### 6.51: Example of Name Multiplicating Instruction

For example, as shown in FIG. 12A, the combining unit 78 joins two files into one file. That apparent names are both equal “-->E -->C” but have different hidden names like <1.01.> and <.1.02>. Be careful to describe these names more accurately. There is one file with “-->E -->C” on the first page, where it is written as the hidden name <0.01.> of each of the lower segments. The file has the same “-->E -->C” displayed on the second page, where it is written as the hidden name <.1.02> of each of the lower segments of the names. The name multiplicating instruction instructs the multiplicative creations from the lower segments of names to the higher segments and instructs the scale to move to the higher digit.

### 6.60: Evacuation Instruction

The name changing unit 76 changes all sciences each beginning with an abstract link in the setting regions 3, and apparent names and hidden names of links and a hidden name of an anchor belongs to each science. While changing is going to be performed, the name evacuation unit 77 evacuates portions of names unwanted to be changed by temporarily changing them to other names so that they are not changed inherently. This means that the name evacuation unit 77 is adapted to evacuate both apparent names (for example, step S23 in FIG. 16) and hidden names (for example, step S25 in FIG. 16). See FIG. 48, FIG. 53, FIG. 58. After that, several setting information change instructions are issued, so that intended names of the anchors are all changed. See FIG. 49, FIG. 54, FIG. 59.

### 6.61: Apparent Name Evacuation Instruction and Setting Information Changing Instruction

For example, the name evacuation unit 77 performs changing operation from “\hat{ }|F-->E” to “\hat{ }|E-->F”. This can be divided into several processes. That is, the name evacuation unit 77 selects the “\hat{ }|F” portion and sets up and add an apostrophe like “\hat{ }|'F” to the file. Add dot. Also, the name evacuation unit 77 selects the “-->E” part and sets up and add the apostrophe like “-->'E” to the file. Add dot. After completing the process described in the next paragraph, the name evacuation unit 77 selects the “'F” two letter part of “\hat{ }|'F” and replaces it with one letter of “E”. Add dot. See A1 of FIG. 51, A1 of FIG. 56, A1 of FIG. 61. Also, select two letter part of the “E’ from “-->'E” and replace it with one letter of ‘F’. Delete dot at the same time. In this way, the sequence of “\hat{ }|E-->F” is completed. At this time, an apostrophe is to support this change. In actual replacement, for the sake of the safety of change, it contains certain letters before and after the changed parts. Additional description using FIG. 16 is provided in 9.10.

### 6.62: Hidden Name Evacuation Instruction and Setting Information Changing Instruction.)(Note. Abbreviation FIG. 166.)

For example, the name evacuation unit 77 replaces French setting information with English setting information. This can be divided into several processes. Change the <.1F.> to <.1'F.> by attaching an apostrophe to the hyperlink like <.1'F.> in advance. Add dot. This is the reason why, even if the anchor's name in document xml is changed to <.1F>, the apostrophe is added in advance by the name evacuation unit 77 so as to give no influence to the hyperlink. This is performed so that the hyperlink does not have the same segment as the anchor name. The hidden name of the anchor <.1F.> is converted to <.2E.>. See FIG. 49, FIG. 54, FIG. 59. The actual change of the combination of apparent name and hidden name, in this case, is explained in 9.10 concerning FIG. 16.

### 6.70: Final Combining

The final combining unit 7 combines the anchor names in the order of character codes when combining the sciences or verbatim created by the name changing unit 76 in one electronic file. The leading sort key is the first letter of the highest level segment 84 in FIG. 6A and FIG. 6C, which is a number from 1 to 7. Therefore, the combination is performed in the ascending order of numbers, and <1F>:<2E>:<3C> and so on are obtained. After being combined, the names are saved and become already-combined names 72C. In the case of the Fourth Process described below, it is only after the combination of respective files that the verbatim can refer to the destination anchors, and come to have a function as hyperlinks. In the case of FIG. 2, the final combining unit 79 performs combining in the order of the content file. The content file In French having “-->E -->C”. The content file in English having “-->F -->C”. And the content file in Chinese having “-->F -->E”. Respective destination anchors are provided from the setting regions arranged in another file after the final combining, thereby enabling the hyperlinks to jump to the respective anchors.

### 7.00: General Remarks of the Three Processes

Subsequently, the processing performed when the generation apparatus 50 generates the electronic file 1 will be described in detail. The generation processing is composed of three processes when broadly classified. Namely, the generation apparatus 50 performs the First Process, the Second Process, and the Third Process. In the First Process, processing for generating one set of science is performed, as illustrated in FIG. 7, FIG. 8. In the Second Process, processing for repeatedly creating one set of science up to the necessary number of sets of sciences for one language is performed, as illustrated in FIG. 11, FIG. 12A through FIG. 12C. In the Third Process, processing for changing apparent names and hidden names of hyperlinks and anchors respectively set up for the sciences is performed. At this time, processing for replacing various languages is performed, based on the order rule. The replacement processing is described in FIG. 16, FIG. 17A through FIG. 17C. Then, the final combining unit 79 finally combines these files for different languages into one electronic file to create the electronic file 1. It should be noted that the electronic file described here is also an electronic document as discussed in 5.12.

### 7.01: Definition of the Order Rule

The order rule is a rule for arraying order of hyperlinks as seen on a monitor. For example, the arraying order of -->F, -->E in FIG. 2. For example, the arraying order of each line in FIG. 6E. The arrangement of the apparent names of the hyperlinks in the monitor needs to be always stable. A user needs to be easily aware of their arrangement on the monitor and to be able to recognize their distance and spacing. Thereby, repeatable jumps including return at jump source and jump destination on the monitor can be executed. For this reason, the array in which the setting regions are reversed like -->E -->F in the back-and-forth relationship in the jump destination is contrary to the order rule. The order is also a rule for the arrangement of the hidden names of the hyperlinks. The arrangement is created in the setting regions according to the order rule so as to correspond to the processing of the above-mentioned apparent names. When the field codes from the setting region 6 to the setting region 11 are opened, the hyperlinks are arrayed from smaller numbers to bigger numbers. In other words, the leading digits of the higher level segments 84 in from FIG. 6A to FIG. 6D are arrayed from smaller number to bigger number.

### 7.02: Example of the Order Rule

Regarding the ascending order, description will be provided taking each line of FIG. 6E as an example. This ascending order means the way of arraying in which six hyperlinks are arrayed from the setting region 6 to the setting region 11 in FIG. 1. The way of arraying in the ascending order is to change the hidden names of the hyperlinks in the order from smaller numbers to bigger numbers. Setting up the numbers of the leading digit in a similar manner to the above. The setting regions 84 indicated in FIG. 6A to FIG. 6D are created according to the order rule. When taking FIG. 9G as an example, the hidden names of the hyperlinks are arrayed in the setting region 6 to the setting region 11 in the ascending order of the numbers. For example, the array in the following order: <2E>:<3C>:<4J>:<5G>:<6R>:<7S>. It is important to array the apparent names and the hidden names of the same links in correspondence to each other. From now on, each processing will be described in detail. From now on, the processing method will be described taking MS Word, which is typical Word processor software, as an example. In the case of other company's products, this example is made as a reference for creation.

### 7.03: Completion of the Currently-being-Prepared Names 72A

Links for seven languages may be created in a science currently-being-created, as illustrated in FIG. 7 and FIG. 8. In this case, N−1 hyperlinks are arranged from the link 1 to the link 6, where N=7. Then, preparation will be made for enabling jumping to other languages. Thus, three setting regions are prepared for the science. The link 1 to the link 6 that constitute a verbatim is arranged in the setting region 5 in FIG. 1. The abstract link is arranged in the setting region B in FIG. 1. The anchor is arranged in the setting region A at the end of FIG. 1. The process until the completion of the setting regions in the first one line in FIG. 1 is the First Process. In short, the process until the creation of one science in the first line of FIG. 6E is the First Process. The sciences from the second line to the final line in FIG. 6E are created in the Third Process as will be explained below. In the Third Process, an explanation from the second line to the final line in FIG. 6E will be provided.

### 7.10: The First Process, Up to the Completion of Single Science

FIG. 7 and FIG. 8 are flowcharts illustrating one example of generation processing up to the completion of one science. The creation processing is executed by the generation apparatus 50 shown in FIG. 4. Then, FIG. 9A through FIG. 9E are diagrams illustrating an on-going stage of creation in each processing in FIG. 7. FIG. 9E displays the setting region 5 in FIG. 1. In FIG. 9F and FIG. 34A, the abstract links are placed at the head. Namely, this is a state in which the First Process has been already completed. Further, FIG. 9G and FIG. 34B illustrate the hidden names in FIG. 9F and FIG. 34A. At this time, in FIG. 9G, the segments of the names of the second line to the seventh line are <.2#..01.01>, identical to one another except for the highest level region. The name of the anchor in FIG. 9F is not written in FIG. 9G too. However, the name of the anchor is <.1F.2#..01.01> written in FIG. 34C.

### 7.11: Identical Lower Level Segments of Names

As described above, the verbatim in the setting region 4 in FIG. 1 governs the movement of the verbatim. To this end, the segments of names are all identical to <.2#..01.01> in the second lowest level segments and the lowest level segments. Regarding the hyperlinks in the verbatim, examples of their apparent names are given from the setting region 6 to the setting region 11 of FIG. 1. Examples of their hidden names are given in FIG. 34B. Regarding the anchor in the verbatim, an example of its apparent name is given in the setting region A of FIG. 1, and example of its hidden name is given in FIG. 34C. Furthermore, <ABSTRACT> in the abstract link suggests a table of contents arranged in the setting region B in FIG. 1. Examples of respective first lines in FIG. 9G and FIG. 34B include <ABSTRACT>. The <ABSTRACT> suggests returning to a table of contents of the attention language. To this end, the hidden name is created by using the <ABSTRACT> having smaller character code and starts earlier than the full-width characters <01> arranged in the same column. The <ABSTRACT> is created by using younger character code at a location corresponding to <01> in the second line and beyond in FIG. 9G. Namely, in the identical column counted from the head of the name, the <ABSTRACT>, which is younger character code than that of <01>, is used. From now on, description will be made concerning FIG. 7. However, a flowchart illustrating the First Process is also shown in FIG. 8 by using the same step numbers. Therefore, users can be expected to understand the process by replacing FIG. 7 with FIG. 8, as needed. For the abstract link notation in Japanese, see the top of column B in FIG. 35A.

### 7.20: One Symbol

In step S1 in FIG. 7, the name generation unit 74 creates one symbol in the electronic file 1. When taking FIG. 1 as an example, one symbol is generated at a position of the link 1 in the setting region 6. FIG. 9A illustrates “-->E” thus created.

### 7.21: Creating a Hyperlink Out of the Symbol

In step S2 of FIG. 7, the name generation unit 74 sets up a hidden name of the hyperlink to the symbol created in step S1. The creation is performed by the name generation unit 74 in FIG. 5. The hyperlink is set up like <.2E.2#..00.01>, for example, as shown in the second line of FIG. 9G. At this time, when setting up the hyperlink to the symbol, insert one byte <#> at the head, and subsequently input the above name. The reason why <#> is inserted at the head is that an anchor which is jump destination to the current file of interest is not yet set up. At this time, an input screen of an edition dialogue of the hyperlink in FIG. 10 is used. But, if this situation remains as it is, jumping will not be established. This is because the name of an anchor that indicates a predetermined location and the name of a hyperlink that refers to the above-mentioned anchor is not present in the identical file. However, at a later stage, names that establish jumping will be scheduled to be created in a different file. When transitions are executed in the final Third Process, the names that jump at this time will be created. Finally, when these different files are combined, all of the hyperlinks are enabled to jump to respective anchors. Thus, the above-described name will be inputted after one byte <#> has been inputted at the head, as described in the First Process. Then, a hyperlink becomes as illustrated in FIG. 9A. Namely, the hyperlink is set up to the symbol “-->E” and changed to an underlined “-->E”. If the field codes of this part are opened, hidden hyperlinks become as illustrated in FIG. 9G. Namely, they are changed to the names enclosed in double quotations. It is found that the hyperlinks are created. Note: The <#> mark here is not a symbol be replaced in FIG. 126, but a symbol <#> which can usually be inputted on the keyboard.

### 7.30: The Second Duplication

In step S3 in FIG. 7, one hyperlink is duplicated. The creation is performed by the name generation unit 74. For example, an underlined “-->E” is duplicated at a position of the link 2 of the setting region 7 in FIG. 1. Then, it becomes as illustrated in FIG. 9B. However, at this stage, it is mere a duplication of the link 1.

### 7.31: The Second Creation of Apparent Name

In step S4 in FIG. 7, change the apparent name of the hyperlink duplicated in step S3. The creation is performed by the name changing unit 76. For example, “E” which has been duplicated in step S3 is selected and turned gray. Then it is duplicated as illustrated in FIG. 9D. After that, select “E” of the apparent name “-->E”. Then, press “C” and an enter key to change the apparent name to “-->C”. Then, the state becomes as illustrated in FIG. 9D. At this time, in the case of MS Word, the apparent name “C” that has succeeded the same font style that has been set up for E will be automatically created.

### 7.32: The Second Creation of Hidden Name

In step S5 in FIG. 7, the hidden name of the hyperlink which has been created in step S4 is changed. The creation is performed by the name changing unit 76. Again explained in step S5 in FIG. 8. Here, select the part <.2E.> which is included in the hidden name of the hyperlink. Then change <.2E.> to <.3C.> in step S5 in FIG. 8. Alternatively, one byte <#> is placed at the head from Insert Hyperlink dialog in FIG. 10. Further, for example, the entire name is inserted like <.3C.2#..00.01>. Note: The symbol <#> as used here is not a symbol to be replaced in FIG. 126, but a symbol <#> which can usually be inputted on the keyboard.

### 7.40: Creating Links of Verbatim

The step S6 in FIG. 7 will be explained. The name changing unit 76 performs the similar processing on the link 3 in the setting region 8 in FIG. 1. At this time, setting processing is carried out as explained in steps S3, S4 and S5 of FIG. 7. After that, hyperlinks of the verbatim are arranged as illustrated in FIG. 9E. This means that the hyperlinks are set up from the setting region 6 to the setting region region 11. In this manner, the following is completed. “-->E”:“-->C”:“-->J”:“-->G”:“-->R”:“-->S”. These correspond to the link 1 through the link 6 that constitute the verbatim of the setting region 4. At this time, the segment of the name written in step 6 in FIG. 8 serves as a useful standard. <.4J.> <.5G.> <.6R.> <.7S.>.

### 7.50: Creating the Apparent Name of Abstract Link

In step S7 in FIG. 7, the apparent name of the abstract link is created in the setting region B in FIG. 1. The creation is performed by the name generation unit 74 in FIG. 5. The creation is performed at the head of the setting region. Therefore, the head of the setting region is followed by a plurality of links from the link 1 to the link 6 created in step S6 in FIG. 7. Then, the apparent name of the ABSTRACT link becomes “\hat{ }|FMap”, as illustrated in FIG. 9E, for example.

### 7.51: Creating the Hidden Name of ABSTRACT Link

In step S8 in FIG. 7, a hyperlink is set up for the hidden name of the ABSTRACT link created in step S6. The creation is performed by the name generation unit 74. The relationship between the ABSTRACT link in the first line in FIG. 9G and the subsequent names of the anchors A has a strong relevancy. In other words, the both will use names that suggest the same languages. This is because as can be seen in the region A in FIG. 1, both the hyperlink in the ABSTRACT link and the anchor in the verbatim correspond to the attention language. For this reason, as long as the anchor in the region A of FIG. 1 follows the naming rule, the ABSTRACT link will also be affected by the naming rule. And, the both will use the names that suggest the same language. For example, the attention language in FIG. 9G is the French language suggested by <.1F.> which is a segment of the name of the anchor. Then, the leading segment of the name of the ABSTRACT link becomes also identical to the name of the anchor by being affected by the attention language. It becomes <.1F.> as illustrated in the first line in FIG. 34B.

### 7.51.01: Fore-and-Aft Relationship with Name of Content in the Attention Language

The ABSTRACT link in the same science jumps to the anchor on a table of contents page which appears earlier. Thus, the ABSTRACT link will be created by assigning smaller or younger character code than the anchor which is present in the science to which the ABSTRACT link belongs. The ABSTRACT link will be created by assigning smaller or younger character code, to a column backward of the leading highest level region that constitutes a name. For example, a segment of the hidden name is created as <ABSTRACT> to the ABSTRACT link corresponding to a column position where the Article/Clause region 82 starts. If so, a character code of <ABSTRACT> is earlier to start or younger than a character code of <00.00> that includes the full-width character <00>, thereby always satisfying the requirement. For this reason, even if any given character code number is used for columns behind the <ABSTRACT> counting from the head of the name, this can become an ABSTRACT of contents. For example, even if the ABSTRACT is varied as <abstract.99.> or the like, the <ABSTRACT.99.> is always younger or earlier than <00.00> which includes the full-width character <00>. Note: Abstract and ABSTRACT are abbreviations written in FIG. 35A. And the 0 is double-byte 0.

### 7.51.02: Sequence of Arrays of Multilingual Contents and Multilingual Abstract Link

Usually, tables of contents of respective languages are arrayed in sequence as a continuous formation with their content. If so, this array processing must be performed to prevent any content of any language from entering into the middle of the both of the tables of contents of the respective languages and the contents of the respective languages. This sequence of the arrays is required for creating the currently-being-prepared names.

### 7.51.03: Actual Example of Abstract Link

For this purpose, the relationship between the name of the abstract link and the name of the anchor within the same science that constitutes the same line is such that the names are required to be created as identical to each other. This is because the segment parts of the theme region 81 of the names in FIG. 6A and FIG. 6C both suggest the identical convention. However, the abstract link within the same science is required to be smaller in character code than the anchor. Please compare each name of FIG. 66B to FIG. 114B to those name of FIG. 66C to FIG. 114C.

### 7.51.04: Position where an Anchor for a Table of Contents is Arranged

The reason is that the abstract link is required to be created to return to the anchor for the table of contents for the same language.

### 7.51.05: Characters in Abstract Link

At this time, there are two methods for the abstract links to be created within the above-mentioned same science. One method is to use a character code smaller than the full-width character <00> similarly to the above. Another method is to use the fact that <,> is younger in character code than <.>. This is a method to use <,> for either digit of two digits of the respective segment regions 85 in FIG. 6A and FIG. 6C one just before starting the above-mentioned Article/Clause region 82. If processed in this manner, and then the abstract link can be kept to appear always jump forwardly of the name of the anchor in the same language. Thereby, the abstract link “\hat{ }|FMap” is completed.

### 7.51.06: Character Codes of Abstract Link

In this regard, “names are the same” also means that numbers thereof are equal to each other even though the names are converted to character codes. PC employs a technique designed to replace numbers with characters and then display the characters. If a technique for replacing characters with numbers in a reverse manner, and then user's understanding will be deepened. By using this method, let's consider again the relationship between names before change and names after change based on the character codes. This means that <.> is also displayed after converting the number to the character. Although there are various ways of grasping the character codes at this time, description will be provided by taking the simplest example.

### 7.51.07: Simultaneously Pressing ALT Key and X Key

Upon selecting <.> on MS Word, simultaneously press ALT key and X key. By doing so, <.> turns into a number 00B0. Similarly, <,> turns into a number 00AA. By the same token, upon looking into the segment regions 85 of the FIG. 6A and FIG. 6C, <..> turns into <00B000B0>. When <,> is used for a part of <..> as described above, it turns into <.,> or <,.>. If they are converted to character codes, they turn to <00B000AA> or <00AA00B0 >, respectively. Therefore, each of <.,>, <,.> has a character code smaller than <00B000B0> of <..>. Thus, when <.,>, <,.> are arrayed after sorting via spreadsheet software, they will be arrayed forward of <,.>.

### 7.52: Table of Contents Having Systematic Uniformity

Even in the case where the number of hierarchies increases, it becomes necessary to retain their systematic uniformity for respective content. For example, assume a desire to organize into one file containing respective languages versions of the PCT and Regulations under the PCT in combination, which are multilingual international treaties. In that case, firstly, names should be divided into respective languages by using the highest level segment 84 in FIG. 6C. Secondly, names should be divided into respective content to correspond to respective treaties, using the second highest level segment 88 of name. For example, <.1P> (not shown) is used as PCT, and as illustrated in FIG. 9G, <.2#> is used as contents for the Regulations under the PCT. Thirdly, at a position in the middle between the end of the Patent Cooperation Treaty <.1P> and the start of Rules of the Regulations under the Patent Cooperation Treaty, an abstract for Rules is created. This means the middle between <.1P> and <.2#..01.01>. Refer to Amendment drawings of FIG. 65 onwards.

### 7.60: Setting-Up of Anchor

In step S9 in FIG. 7, the processing is completed by setting up an anchor at a predetermined position on the right side of a line where the links 1 to 6 are arrayed, as illustrated in FIG. 9F, for example. End the processing in FIG. 7. The name generation unit 74 is used for this processing. The name affixed to the anchor cannot be seen from FIG. 9F. However, numbers other than those of the highest level segments of the names should be equal in the second line onwards as shown in FIG. 9G. Likewise, segments other than the highest level segments of the anchors should also be equal. This is because the anchor is also a part of the component to jump in verbatim.

### 7.61: Names in Verbatim State) (Note: Abbreviations in FIG. 166)

Therefore, <.1F.2#..01.01> is the hidden name of the anchor in FIG. 9G. If the name is decomposed, all the highest level segments that belong to the corresponding science in the setting region 3 in FIG. 1 have personality names in the highest level segment 84 such as <1F>, <2E> and the like. In contrast, the hidden names other than all the highest level segments 84 which belong to the corresponding verbatim are identical to one another, like <..01.01> in FIG. 9G. At this time, it is easy to understand when comparing between the apparent names in the setting region 4 in FIG. 1 and the hidden names in the second line onwards in FIG. 9G. The fact that the lower level segments of the respective names of these anchors and the hyperlinks are set up to be common has a special meaning. Namely, at the time of transition in the Third Process as described below, the lower level segments can be copied and completed incrementally and automatically, which is the core idea of the present invention. The anchor is shown in FIG. 34C. Also, for comparison, FIG. 9F is shown again in FIG. 34A, and the hyperlinks in FIG. 9G have been shown again in FIG. 34B.

### 7.62: Position of Anchor

Although the anchor is arranged at the end of the verbatim in the setting region A in FIG. 1, the position of the anchor is not particularly limited to the end. However, an anchor is a stop symbol for jumping. A hyperlink is a start symbol for jumping. Therefore, it is necessary to arrange both so as not to overlap at one place.

### 8.00: The Second Process; Up to the Completion of a Sciences Group in One Language

Subsequently, the processing up to the completion of a sciences group in one language, which is the Second Process, will be described. In the Second Process, one science generated in FIG. 7 and FIG. 8 is incremented one by one. FIG. 11 and FIG. 12A to FIG. 12C are flowcharts illustrating one example of the processing. The steps in FIG. 11 can be replaced with the steps in FIG. 12A, FIG. 12B and FIG. 12C for incrementing one science generated in FIG. 7 and FIG. 8 one by one. The procedure for the creation will be described below. At this time, FIG. 12A illustrates the processing up to the combination of two files consisting of 01 and 02. FIG. 12B illustrates the processing up to the combination of two files consisting of 01+02 and 03+04. FIG. 12C illustrates the processing up to the combination of two files consisting of 01+02+03+04 and 05+06+07+08.

### 8.10: Incrementing

In step S11 in FIG. 11, increments a science created in step S1 to step S9 in FIG. 7 one by one. The increment processing is performed by the name incrementing unit 75A in FIG. 5. The sciences before incrementing are temporarily saved for the purpose of name combining. The sciences before incrementing will be separately saved from the sciences after incrementing.

### 8.11: Changing .docx to .zip

In step S12 in FIG. 11, changes the extension of the file incremented in step S11, from docx to zip file, for example. The name changing unit 76 performs the processing. A specific example of changing to the zip files will be described below concerning to FIG. 13.

### 8.12: zip--> document xml

In step S13 in FIG. 11, unpack “document xml” compacted in the zip file of step S12 to the outside of the file. The name changing unit 76 performs the processing. More specifically, copies “document xml” inside the zip file to a place in the outside. The name incrementing unit 75A performs the processing. Step S13 will be described below more specifically concerning FIG. 14.

### 8.13: Replace all Names

The name changing unit 76 performs replace-all processing of segments of names of hyperlinks and anchors contained in “document xml”. As described in step S14 in FIG. 11. For example, the name changing unit 76 changes the names notated with <..01.01> to the names notated with <..01.02>. When executing the replacement processing, it is desirable to decide the target range by containing punctuation <.> ahead and behind the names in order to avoid change errors.

### 8.14: FIG. 15 as Photograph Substituted for Drawing

FIG. 15 is a photograph substituted for drawing. The processing of the photograph is executed in step S14 in FIG. 11. The photograph is a screen shot while the document xml file is opened. This figure is an image when the names of the hyperlinks and the bookmarks are batch-changed. In FIG. 15, Rule 1 through Rule 9 of the Regulations under the PCT is changed to Rule 11 through Rule 19. The purpose is to reuse the names. In FIG. 15 at this time, the names in column C of FIG. 35A, FIG. 35B are changed. The goal is to replace 0 with 1. In this invention, goal differs from selection range. The goal is the range that appears as a result. The selection range is a practical area for actually carrying out the goal range. In order to achieve reliable replacement, the goal was replaced by adding characters, which have large blank space so as to be easily visible, in front and behind. In FIG. 15, punctuations were used in front and behind. For that reason, in FIG. 15 the selection range <..0> was changed to <..1>. Once more. The goal is to replace 0 with 1. Then, <..0> is selected and changed to <..1>. In this case, the goal range is <1>, while the selection range is <..0>. Namely, the goal is one part of the processed range. In this way, the existing name becomes the new name. FIG. 15 shows the state after the processing has been performed and conversion has been completed. The total number of replacements is 45, written on the last line in FIG. 35B. In FIG. 15, portions underlined in red are the changed names. The whole figures of these 45 pre-change states are described from FIG. 70A to FIG. 114C. Then, <..0> is selected and changed to <..1>. In this case, the state before the goal is <0> and the state after the goal is <1>.

### 8.14.01: Observation of FIG. 15

When observing the replacement shown in FIG. 15, two patterns can be recognized. The first pattern is written in the first line from the top including

</w:t></w:r><w:hyperlink w:anchor=“0.2E.2#..11.01”w:history=“1”.

Another pattern is written in the seventh line from the top. The seventh line is written as follows.

w:id=“0”w:name=“1F.2#..11.01”/><w:bookmarkEnd w:id=“0”/>.

From the description, the following can be found. Names of bookmarks, which mean anchors, have changed. If so, the first line from the top can be considered as a location where the hyperlinks have been replaced. Furthermore, since the number of “w:id” on left and right sides of the seventh line is equal to “0”, it can be determined that change has taken place at this location. On every seventh lines, the similar patterns are repeated. The seventh anchor placed on the 49th line from the top shown in FIG. 15 which is written as follows.

w:id=“6” w:name=“1F.2#..13.01”/><w:bookmarkEnd w:id=“6”/>.

The above 6 means that 7 anchors partly changed are shown in FIG. 15. Because it started from 0, so 6 means 7th. The result report message is automatically created by the software, and the displayed indicating “Completed: 315 items from among 315 items have been replaced by the present documents” at the bottom of the screen shot of FIG. 15.

### 8.14.02: How to Read FIG. 15

As described above, as can be seen from FIG. 15, the same replacement patterns appear at every seventh lines. The total number of changes is 315. Considering from the points, it will be found that divide 315 by 7. As a result, 45 anchors have been replaced. The total number of lines in the spaces C in FIG. 35A and FIG. 35B is 45 as shown in the last line of FIG. 35B. Therefore, there is no error in replacement conversions. The every seventh line corresponds to the number of the names appearing in the verbatim which is constituted by a combination of six hyperlinks and one anchor A in the setting region 4 in FIG. 1. The same pattern is repeated every seventh row. This is the answer for that one set constituted by seven combinations of six links in the setting region 4 in FIG. 1 and the anchor A are all replaced continuingly. However, if the entire setting region 3 is replaced from XML and if the seven links including the abstract link and the setting region A in FIG. 1 are replaced, the changes should occur at every eight links. A question arises as to why this difference has occurred.

### 8.14.03: How to Read FIG. 15

The reason is that if a segment of name is <..0>, and then a replacement of <..1> was obtained. However, already at that time, the corresponding part of the abstract link in the setting region B in FIG. 1 was already another name. In short, the abstract link was like <.1F.2#..ABSTRACT.01>. Then, there was not a part corresponding to <..0> in the same position counting from the head. Accordingly, the replacement was not performed. Therefore, it was seven instead of eight. Note: Here the difference between abstract and ABSTRACT is the abbreviation and written in FIG. 35A.

### 8.15: Changing Document xml to zip

In step S15 in FIG. 11, replacement of step S14 is ended. Return the “document.xml” to a place inside the original zip file. The name changing unit 76 performs this operation.

### 8.16: Changing zip to docx

In step S16 in FIG. 11, changes the extension of the .zip file, which has been changed in step S15, to docx. Hereby the outcome of the replacement is obtained. The name combining unit 78 performs this operation. Thereby, files including a plurality of sciences, having the names <..01.01> and <..01.02> are associated with one another.

### 8.20: Changing Through Recycling

In step S17 in FIG. 11, repeat the processing from step S11 to step S16. This processing is performed by the name incrementing unit 75A, the name multiplicating unit 75B, the name changing unit 76, and the name combining unit 78. Then, the processing ends when the necessary number of sets of sciences is produced (END). The combination in the Second Process is performed by the name combining unit 78 that combines the electronic files. The combination the electronic files will be as follows. The name multiplicating unit 75B increase names from that have been just before the changes and saved. The name incrementing unit 75A change and increase names which are missing parts in a multiplicating manner. Accordingly, each time the combination of the electronic files occurs, the names are increased two-fold, four-fold, eight-fold, and so on in the multiplicating unit 75B. At this occasion, by acquiring data together, and pasting them, only one XML declarative statement is left at the head of a passive file on which the data is pasted. Also in the final combination, as will be described below, the same will apply.

### 8.21: Increased Portions are Combined

At the first time, a file has hidden names of <..01.01> for an existing portion and a file has hidden names of <..01.02> for an increased portion. The newly increased portion at the second time has hidden names <..01.03> and <..01.04> obtained by performing name change processing on the above-hidden names. At this time, <..01.03> and <..01.04> are combined with <..01.01> and <..01.02>, thereby one file having four-line sciences from <..01.01> to <..01.04> is created. Furthermore, similarly, the third time processing will be performed by the name changing unit to create one file having eight-line sciences from <..01.01> to <..01.08>. In this manner, when parts that correspond to Clauses have been completed, similar processing is performed on the parts that correspond to 1-digit Article, and then the parts of 2-digit Articles at the higher level will be similarly performed. Those tasks are performed by the name multiplicating unit 75B. If Clause 9 is needed, a new name is created in the following manner at the end of <..01.08>. The task is performed by the name incrementing unit 75A. Create a new name by changing a file having <1.01> before the change to a file having <1.09> after the change. Combine a file in step S14 in FIG. 12A with the combined file having <..01.01> to <..01.08> in FIG. 12C.

### 8.22: Features of Processing from the Lowest Level Segment

In general, unlike clauses, articles typically include both Article 9 and Article 10. It is necessary to starting with the creation of Article 0. Because add 1 to the front of 0, it will be 10. Therefore, Article 0 has a value. The processing is gradually transitioned from a lower level of a name to an intermediate or higher level of the name. Then, it is characterized in that when change processing of the higher level of names is performed, the names processed at the lower level will be recycled. The higher the level of the names is concerned, the increased number of the names of the lower level are recycled, and as a result, the number of the processing will be increased. In the case where the Article/Clause regions are represented by numbers in this manner, it will make the processing quicker by the name incrementing unit 75A. This is because incrementing the names is enabled in accordance with a scheme of changing through recycling.

### 8.23: Features of Changing by Recycling Names at Lower Level

In FIG. 15, the XML text was obtained by selecting <..0> and changing from <..0> to <..1>. For this reason, the changed portions are indicated by <..1> underlined in red. This part consists of the Article/Clause region 86 in FIG. 6C. Therefore, when referring to a digit position, these replaced portions are related to top part of the double-digit. This means top part of Rule 11 through Rule 19 have been automatically generated by directly recycling the names from Rule 01 to Rule 09 as they are. FIG. 15 is a photograph substituted for drawing of this scene.

### 8.30: Hidden Names Aligned in One Vertical Array

Regarding the hidden names in the field codes, it is desirable to align the string length of each line in the identical vertical array, as illustrated in FIG. 9G and FIG. 34B. The example illustrated in FIG. 6C represents a page having a width of 320 points, a height of 480 points, and a narrow margin of 17 points on its left-right sides created by a word processor. When the page is viewed on a narrow screen of a Smartphone, the number of characters becomes less, and line feed becomes more, and therefore auto-loop back/wrap-around function will work frequently.

### 8.31: A Hanging Indent

At this time, a hanging indent has been kept set up at one character. Only this condition is not always the case where the names in the field codes are aligned in the identical vertical array. This is because, for example, if the number of characters is made small, the names can be aligned in the identical vertical array in a similar manner by increasing the number of the hanging indents. In that case, the second line through the seventh line can be adjusted so as to be aligned in one vertical array. The first line and the second line are affected by the increased number of the hanging indents, and thus blanks are formed at the left side.

### 8.32: It is Possible to Read the Replacing Processing Performed

If the names are replaced by the names aligned straightly in the vertical array in the field codes, the names will be replaced orderly as shown in FIG. 15 or FIG. 18, and it is possible to read the replacing processing performed on software.

### 8.40: Creation of a Large Volume

Sciences will be created by the same creation method as the one described in the above processing. For example, create 8 sciences first, and add 2 sciences to the 8 sciences previously created, then 10 sciences can be created, and furthermore, 20, 40, 80 sciences can be created. In this manner, sciences can be created efficiently in a large volume. Hyperlinks in the sciences may not be necessarily aligned on the same single line and may be aligned on two or three or more lines. FIG. 25 consists of three sciences. FIG. 12A through FIG. 12C illustrate the processing examples similar to the processing described in FIG. 11. The step numbers in FIG. 12A through FIG. 12C correspond to the step numbers in FIG. 11.

### 8.50: Precautions in Step 2 (Warning of .docx)

FIG. 13 is an example of a screen shot displayed when the extension of the electronic file 55A is replaced from “docx” to “zip”. Although a warning message is displayed as shown in FIG. 13 when changing the extension, the extension should be changed by ignoring the warning message. Please, do not use software when replacing extension. Manually change four letter docx to three letter zip.

### 8.60: Operation on Document xml in zip Archive

FIG. 14 is a diagram illustrating document xml contained in the folder in the electronic file 55A after the extension has been changed to “zip”. As illustrated in FIG. 14, document xml is always present in the folder of the zip archive. The document xml needs to be copied to any given folder outside the zip archive. If conversion of the names is performed while the document xml remains to be present in zip archive folder, PC will be frozen. And the extension of the document xml is “XML”. It means they can be processed by using a web page editor. In order to prevent the content of other parts from being modified, batch conversion is performed surely on the name parts containing punctuations in front and behind added. Like <.0.>. Then, these are directly saved as they are. Then, the “document.xml” is returned into the file in which the extension is “zip”. Finally, the extension of the folder, of which the extension is “zip” is returned to the original “docx”. In this manner, the product of the multiplicative-production is completed.

### 8.70: Exact Replacement

When the multiplicative production is performed through the replacement of the names, select <..> inclusive of even a part of <.> or <..> to be described subsequent to <.> and its notation. By this selection method, it is possible to surely identify the portions that users really want to change. It is desirable to perform batch conversion of all corresponding portions in the file into desired notation.

### 8.71: Example of Change Using Growth Point

For example, 2 spaces <..> in the segment region 85 in FIG. 6A is selected and replaced with 5 spaces <.00..>. Thereby, an intermediate segment like the second highest level segment 88 in FIG. 6C can be created between the highest level segment 84 and the second lowest level segment 86. Furthermore, without evacuating the document xml contained in a finally combined complete file, 5-character part <.2#..> of the names such as <.4J.2#..01.01> is selected as a portion to be changed. A final combined means that verbatim jumping is returnable between the different structured setting regions. Then, the processing is to perform batch changing five character string of <.2#..> part to a six character string of <.9#..0> part. If performed in this manner, then the names can also be changed to <.4J.9#..001.01> or the like. For this purpose, the method in FIG. 15 is used in which the same processing is performed to increases both the hyperlinks and the anchors. In this way, a segment after change <001> can be used for hidden names suitable for 3-digit Articles of EPC Rules, for example.

### 8.71.1: Advantages and Disadvantages of Growth Point Scheme

A replacement method using the above growth points, replacement after opening document xml is described in 9.61, as a simultaneous replacement. This method has an advantage that both hyperlinks and anchors are replaced by one-time processing, and therefore it is it is straightforward. For this purpose, it is required to select the changing portions including <..> or the like of which the use is improbable in grammatical structure, and safely and reliably replace them. However, since the processing is performed by opening document xml, hidden information of word processor functions such as font style or line feed will be all open. A PC will search the entire document xml, thus leading to a big burden on PC and taking much processing time.

### 8.71.2: Evacuation Scheme

When replacing segments of names by PC, to achieve time-saving, it is preferable to divide the Second Process into three stages. Then, in the second stage which is the middle stage of three stages, the above changing processing is performed on only the names of anchors. For example, step S26 in FIG. 17A, FIG. 17B and FIG. 17C.

### 8.71.3: Embodiment of Evacuation

In the first stage, in this case, the names of the hyperlinks and the anchors are made to be non-common each other. In the present application, the operation to be performed in advance for the purpose of preparation is called evacuation. For example, the field codes are opened and the part of five characters <.2#..> containing <..> of a growth point of the names of all hyperlinks is selected and changed to seven characters. Like <.9#.'.0>. If evacuation is performed in this manner, and then processing waiting time of PC can be shortened. Thereafter, in the second stage, performed only the anchors from document xml. Additionally, the second stage, there is no evacuation and directly change five characters into six characters. It means <.2#..> to <.9#..0>. The third stage after that will become only recovery processing opposite to the first stage. In short, <.9#.'.0> regarding the hyperlinks is selected and changed to <.9#..0> and an apostrophe is deleted. In this way, both the hyperlink and the anchor are replaced with new names and jumps to each other as before.

### 8.71.4: Choice Between Growth Point Scheme and Evacuation Scheme

Choice of either growth point scheme or evacuation scheme is dependent upon the balance between operational skill and time required for replacement. The reason why two implementation methods have been written in the above description for examples of changes using growth points is that users wanted to know those choices.

### 8.72: Changes of Names that Will not Give Influence on Content

If a character string containing <..>, which is impossible in the grammar, is selected, and then new hierarchies can be created and added while conversion error in the content can be prevented.

### 8.80: Definition and Significance of the Currently-being-Created Name 72B

The currently-being-created name currently-being-created names 72B in FIG. 5 receive an instruction from the name control unit 71. Then they are saved as a sciences group in the setting region 3 or a verbatims group in the setting region 4. However, similarly to the names 72A, the names 72B may be composed of functionless hyperlinks in a broad sense that does not have jump destinations, although there is a description of hyperlinks on the hidden names.

### 8.81: Creation Timing of Abstract Link

The creation of the TABLE links, in this case, should be preferably processed before the start of the Third Process, after the Second Process before the next final combination is completed.

### 8.90: Advantage of Removing the Diversity

As also seen in the case of MS Word, even when apparent names are continuous, XML side in hidden names may be partitioned. Even when apparent names are continuous, they may be segmented in some cases by <tag>, <tag>, <tag>. When converted into PDF, its defects may appear even in apparent names that are segmented. In order to successfully avoid such a phenomenon, Articles/Clauses consisting of one-byte characters in content are converted into two-byte character notation. After that, the two-byte character notation is pasted to a file with the extension of text. By pasting to txt, the variety of font styles or the like as seen in Western sentences is temporarily removed. After that, if batch replacement is performed on the font styles or the like equal to those of the content, and batch conversion into XML is again performed, segmentation of characters/numbers or the like by tags in XML syntax can be decreased.

### 8.92: Various Production Methods in the Second Process

Various methods of multiplicative production can be considered for the Second Process. 1. Increase manually as shown in FIGS. 20A, 20B, 20C. 2. Increase from aligned field codes automatically. 3. Combine with the file generated previously to multiplicate two-fold, four-fold, eight-fold. The above three methods are newly disclosed in this application. Also, various methods of multiplicative production can be considered for the Second Process, but not limited to it. Therefore, the multiplicative production is merely an example. Furthermore, since this Second Process is a simple multiplicative production process, it is a place where many people can introduce different ideas.

### 9. Explanation of the Third Process of Generation Processing

Coupling in the electronic file will be described below. The word “coupling” indicates that the names of the hyperlinks and the anchors coincide with each other. To put it briefly, the following Chapter 9 describes a magical technique, which corresponds to the core part of the present invention. As for the coupling, hereinafter referred to as “final coupling”. However, besides this final coupling, the word “name combining” or “name combining unit 78” may be used. But this name combining has no meaning of the coupling. In other words, in the above Chapter 8, a method for increasing the lower level segments of names is described. And in that case, the same word combining is used, but there is no meaning of the coupling. Again, the following is a description how to derive the coupling. Then, the replacement of the highest level segments of names will be explained. An electronic file described in the following is also an electronic document as mentioned in 5.12.

### 9.00: Until the Completion of Science Groups of all Languages

Next, the summary of the Third Process which is a process up to the completion of the science groups of all languages will be described. The previous process aims at increasing production of only one language science. However, the Third Process is the final process for creating other languages. In the Third Process, the processing of changing the language regions is performed. It should be noted that the electronic file described below is also an electronic document as discussed in 5.12.

### 9.01: Figures Illustrating the Processing

The Third Process is for executing replacements of the highest level segments of the hidden names. The highest level segments of the hidden names shown in the regions 84 of FIG. 6A to FIG. 6D. FIG. 16, FIG. 17A to FIG. 17C illustrate the key points of replacements of names in hyperlinks and anchors. Among the replacements performed in these figures, the replacement of the setting region 6 in FIG. 1 is illustrated in FIG. 19A to FIG. 19D. At this time, FIG. 19A and FIG. 19B illustrate the apparent names, and FIG. 19C and FIG. 19D represent an actual example of the processing of the hidden names. FIG. 19A and FIG. 19C illustrate the state in the middle of the replacements, while FIG. 19B and FIG. 19D illustrate the state after replacements.

### 9.02: Number of Times of Replacement Processing

Replacement belongs to a science of the setting region 3 in FIG. 1. That is, (1) the anchor A in the setting region 4, (2) one of the hyperlinks from the setting region 6 to the setting region 11, (3) the abstract link B. Replacement is performed for the above three portions in total. The science will be preserved when these three replacements are completed. Then, the processing is transitioned to the creation of sciences for the next different languages. This orderly execution of replacements and changes is illustrated in each line of FIG. 6E. Since FIG. 6E has seven lines, it means sciences for seven languages.

### 9.03: Relationship Between FIG. 16 and FIG. 17A to FIG. 17C

Then the processing for replacing the names of hyperlinks and anchors for French with those for English, based on FIG. 16, is described in the following step 22 to step 30. FIG. 17A is a rewrite of FIG. 16. The replacement processing for creating sciences of languages other than French has been described in FIG. 17B and FIG. 17C using the same step numbers as in FIG. 16 and FIG. 17A. Therefore, when creating another science of another language, the explanation from step 22 to step 30 of FIG. 16 can be referred to by replacing with FIG. 17B and FIG. 17C. It should be noted that the processing for a total of three portions described below does not include the temporally preceding and succeeding relationship. After that, descriptions including a viewpoint of the temporally preceding and succeeding relationship will be provided.

### 9.04: Replacing Names of Anchors

Firstly, description about an anchor in FIG. 1 will be given. The Third Process replaces the name of the anchor located in the setting region A of FIG. 1 based on the naming rule. Starting from the anchor F that suggests French language and constitutes the highest level segment of the anchor, the hidden names of the anchors will be sequentially replaced for other languages in the following order. <.1F.>:<.2E.>:<.3C.>:<.4J.>:<.5G.>:<.6R.>:<.7S.>. The above processing is performed on the XML file. All pieces of XML data containing all hyperlinks in newly created files are searched, and all the names of the anchors having the concerned characters are replaced in sequence. In this case, all names including hyperlinks and anchors are replaced by the replace-all method.

### 9.05: Replacing Names of Hyperlinks

Next, hyperlinks in the region 5 in FIG. 1 will be described. Here the explanation is required for accuracy, and then FIG. 6E is used. In the First Process and the Second Process, “F” exclusions have been created from the setting region 6 to the setting region 11, as illustrated in the first line of FIG. 6E. And the same applies to FIG. 1 too. In the Third Process, the second line onwards will be created. At this time, the style of the first line of FIG. 6E is used as a basis. The creation follows the order. That is, the hyperlinks will be replaced in the order of the respective regions 6:7:8:9:10:11. At that time, the names of all the hyperlinks in the file are searched. Then, all names having the corresponding characters in the names will be replaced in a sequential manner.

### 9.05.1: Corresponding Replacement of the Hyperlink Names

Apparent names will be described. The apparent name “-->E” located in the second column of the first line of FIG. 6E is replaced. It is replaced with “-->F” located in the second column of the second line of FIG. 6E. The corresponding hidden name is also replaced. That is <.2E.> located in the second line of FIG. 34B is replaced with <.1F.> located in the second line of FIG. 19D. Open field codes. All hyperlinks in the corresponding file are searched. Then, the replacement method is a replace-all method. In short, all matched parts are replaced. “-->'E” at the second column in FIG. 19A is a part of the apparent name in the middle of replacement processing. <.2'E.> at the second line in FIG. 19C is a part of the hidden name in the middle of replacement processing. The apparent name corresponds to the hidden name.

### 9.05.2: Transition of Replacement Portions of Hyperlinks

Apparent sciences are arranged in one place after the completion of replacements. This is illustrated in each line of FIG. 6E. Then, there is the right downward line of each line in FIG. 6E. The left side of the line is a portion where sequential exclusion and replenishment have been made. For example, in the case where the processing is transitioned from the first line to the second line in FIG. 6E in the Third Process, the setting region 6 is changed from “-->E” to “-->F”. Likewise, upon transitioning from the second line to the third line of FIG. 6E, the setting region 7 is changed from “-->C” to “-->E”. Upon transitioning from the third line to the fourth line of FIG. 6E, the setting region 8 is changed from “-->J” to “-->C”. Upon transitioning from the fourth line to the fifth line of FIG. 6E, the setting region 9 is changed from “-->G” to “-->J”. Upon transitioning from the fifth line to the sixth line of FIG. 6E, the setting region 10 is changed from “-->R” to “-->G”. Upon transitioning from the sixth line to the seventh line of FIG. 6E, the setting region 11 is changed from “-->S” to “-->R”. This means that, in the Third Process, each time of transition, the name of interest is caused to be excluded from the setting region 5 in FIG. 1, and there is created a different file. This means that the name forward of the excluded name is to be replenished into the setting region 5. Hereinafter, the setting regions 6 to 11 are also referred to as the links 1 to 6. Hereinafter, the setting regions 6 to 11 are also referred to as the links 1 to 6.

### 9.06: Replacing the Name of the Abstract Link

Finally, the abstract link will be described. Replacement of abstract links is performed on the setting region B in FIG. 1. At that time, all hyperlinks in the same file are searched to find particular characters. The hyperlinks that contain the same characters are replaced with hyperlinks having different characters. The replace-all method is the same as the replace-all method for the above hyperlinks. In the First and Second Processes, there is already the link “\hat{ }|F” that suggests the French had been already created. In the Third Process, the operation of other attention languages according to the location order is performed. That is, all apparent names of all the setting regions B are sequentially replaced. Like “\hat{ }|E”:“\hat{ }|C”:“\hat{ }|J”:“\hat{ }|G”:“\hat{ }|R”:“\hat{ }|S”. At an intermediate point, different files are created. After that, the apparent name “\hat{ }|F” at the first column of the first line in FIG. 6E is replaced with “\hat{ }|E” at the first column of the second line in FIG. 6E. Correspondingly, <.1F.> at the first line of FIG. 34B which is the hidden name is replaced with <.2E.> at the first line of FIG. 19D.

### 9.07: Replacement in the Third Process

Anchor name suggests a language of interest. The segments of the names of the anchors are replaced in the ascending order of character codes in accordance with the naming rule, like <.1F.> to <.2E.>. Also, the hyperlinks arranged in the setting regions 6 to 11 are sequentially excluded from the setting regions. When a hyperlink is identical to the language of interest, it is excluded from the setting region. Hyperlinks having names different from the language of interest are added to the setting regions 6 to 11, resulting in creating the same six links. In other words, the exclusion processing is performed in the ascending order of character codes. The addition processing is also performed sequentially in the ascending order of character codes. FIG. 115A to FIG. 115G represents this transition.

### 9.08: Order of Replacement in the Third Process.) (Note; Abbreviation <.>FIG. 166)

For example, the hidden names in the region 5 in FIG. 1, in which the hyperlinks are gathered. Here, each time a different file is created, a file of interest is changed in sequence, as illustrated in the second line onwards in FIG. 6E. That is, the drop-off of interest is performed in the following order. :<.2E.>: <.3C.>:<.4J.>: <.5G.>: <.6R.>: <.7S.>. Then, in each file, replenishment is performed in the following order: <.1F.>:<.2E.>:<.3C.>:<.4J.>:<.5G.>:<.6R.>. The replenishment is performed so as to be arrayed according to the order rule. The apparent names and the hidden names correspond to alphabetic characters that suggest respective languages. In short, an apparent name is dropped-off from the setting region 5 respectively specified by the languages of interest, as illustrated in the second line onwards of FIG. 6E in the following order: E:C:J:G:R:S. In turn, other hyperlinks F:E:C:J:G:R are replenished in this order, as illustrated in the second line onwards of FIG. 6E. Description of the replacing process to the names of the abstract links will be omitted.

### 9.09: Up to Reaching the Already-Combined Names 72C

Each file in which replacement of name has been performed is saved each time transition has been completed. Saving is performed in the file 72B in FIG. 5. After that, transitions for all languages of interest are ended. Then the files are saved by the final combining unit 79 as the already-combined names 72C. See FIG. 115H. Therefore, the files have been saved in the Third Process in the following two styles. The one is a cluster composed of science groups of the setting regions 3. The other is a cluster of verbatim groups of the setting regions 4. At this time, the final combination has been completed. This is the state in which the hyperlinks have a function of jumping to the anchors. This means the hyperlinks in the narrow sense have been completed. Next, particular remarks of the Third Process will be specifically described, because of the temporal preceding-succeeding relationship.

### 9.10: Evacuation of Apparent Name; Abstract Link

In step S22 in FIG. 16, changing operation is performed. The name evacuation unit 77 is used for batch changing operation. The name evacuation unit 77 performs batch changing to replace one character “F” in the apparent names of hyperlinks with two characters affixing apostrophe like “'F” to obtain the abstract link. Add dot. The number of characters increases with changes. For example, as illustrated in FIG. 19A, the apparent name of the hyperlink is changed to “\hat{ }|'FMap”. Add dot. See FIG. 17A Step 22 of FIG. 48. FIG. 17B Step 22 of FIG. 53. FIG. 17C Step 22 of FIG. 58.

### 9.11: Evacuation of Apparent Name; Verbatim Link

In step S23 in FIG. 16, changing operation is performed. The name evacuation unit 77 is used for the operation. The name evacuation unit 77 performs batch changing the part in the link 1 in the setting region 6 of FIG. 1. Select one character “E” in the apparent name of the hyperlink -->E. Then, batch changing is performed to two characters affixing apostrophe like “'E”. The number of characters increases with changes. For example, as illustrated in FIG. 19A, the apparent name of the hyperlink is changed to “-->'E”. See FIG. 17A Step 23 of FIG. 48. FIG. 17B Step 23 of FIG. 53. FIG. 17C Step 23 of FIG. 58.

### 9.12: Evacuation of the Hidden Name; Abstract Link

In step S24 in FIG. 16, changing operation is performed. The name evacuation unit 77 is used for the operation. The name evacuation unit 77 changes the hidden name of the abstract link located in the setting region B in FIG. 1. That is, select <.1F.>. Then, change to <.1′F.> affixing apostrophe by the batch processing. The number of characters increases with changes. For example, as illustrated in FIG. 19C, the name is changed to {HYPERLINK\|“.1'F.2#.. ABSTRACT.01”}. See FIG. 17A Step 24 of FIG. 48. FIG. 17B Step 24 of FIG. 53. FIG. 17C Step 24 of FIG. 58.

### 9.13: Evacuation of Hidden Name; Verbatim Link

In step S25 in FIG. 16, changing operation is performed. The name evacuation unit 77 is used for the operation. The name evacuation unit 77 performs batch changing of the hidden names. That is, select the hidden name which is present in the link 1 in the setting region 6 of FIG. 1. Then, change to <.2'E.> by affixing apostrophe to <.2E.>. The number of characters increases with changes. For example, as illustrated in FIG. 19C, the name is changed to {HYPERLINK\|“.2'E.2#..00.01”}. See FIG. 17A Step 25 of FIG. 48. FIG. 17B Step 25 of FIG. 53. FIG. 17C Step 25 of FIG. 58.

### 9.14: Changing the Highest Level Segments

In step S26 in FIG. 16, changing operation is performed. The name changing unit 76 is used for the operation. The name changing unit 76 changes hidden names. The name changing unit 76 changes the electronic file docx in the state of step S25. Then, change the docx to zip extension. Further, the name changing unit 76 extracts document xml in the inside to the outside of the electronic file. Furthermore, the names of the anchors are changed. Refer to the example of the photograph shown in FIG. 18. The photograph is a screen shot acquired when <.1F.> in the highest level segments is changed to <.2E.>. The <.2E.> thus changed are all underlined in red and displayed as <.2E.>. In FIG. 18, the statements of w:bookmarkStart are described on all lines. Unlike FIG. 15, FIG. 18 shows conversion processing only on bookmarks. In FIG. 18, the names of the anchors surrounded by definite articles are replaced. FIG. 18 is a processing diagram after evacuation has been performed by affixing apostrophe to the names of the hyperlinks in advance. Therefore, unlike FIG. 15, the hyperlinks are not changed. Thus, in FIG. 18, the names of the hyperlinks are not described because of evacuation. To ensure this conversion, it is necessary to decide the selection range to execute replace-all. The range of change is selected by surrounding <4J> with <.> as shown in FIG. 6A or FIG. 6C. As a result, the accuracy of operation in the XML text can be improved.

### 9.14.01: Changing the Highest Level Segments in FIG. 18

In FIG. 18, the names at the top in FIG. 18 are <.2E.2#.,abstract>. However, the anchors are changed to <.2E.2#..ABSTRACT> from the line indicated by w:id=“16” in the middle. This is because the Regulations under the PCT has a large volume. Thus, the tables of contents are composed of two hierarchies. As will be seen from FIG. 18, one of two hierarchies is <.,>, and the other is <..>. When creating in two hierarchies, the difference of character codes on these portions is utilized. After the names are exchanged, document xml is returned to the zip folder. Thereafter, the extension is again returned to docx. The method of returning the extension from document xml to zip is performed in reversed manner to the previous explanation. Also, the method of changing the extension from zip to docx is performed in reversed manner to the previous explanation. In short, this is performed in reversed manner to the methods explained with reference to FIG. 13 and FIG. 14. Note; the abstract and ABSTRACT are words substitution shown in FIG. 35A.

### 9.14.02: Two Hierarchies of the Abstract Link

Hereinafter what is “Two hierarchies” will be described. In each of the diagrams B in FIG. 70B to FIG. 114B, the first line is the ABSTRACT link and the second and subsequent lines are verbatim. Each of the ABSTRACT links in FIG. 70B to FIG. 114B corresponds to the name in column B of FIG. 35A and FIG. 35B. Each C column in FIG. 70C to FIG. 114C corresponds to the name in column C of FIG. 35A and FIG. 35B. Further, in each of the diagrams B in FIG. 66B to FIG. 69B, the first line is the abstract link and the second and subsequent lines are verbatim consisting of the ABSTRACT. At the time, each first line corresponds to the name in column A of FIG. 35A and FIG. 35B as abstract. Therefore, the abstract link and the ABSTRACT link constituting the table of contents. And they are composed of two kinds of FIG. 66A to FIG. 69C and FIG. 70A to FIG. 114C. These two mentioned as “Two hierarchies.”

### 9.15: Changing Apparent Name of Abstract Link

In step 27 in FIG. 16, the name evacuation unit 77 performs batch changing to replace two characters affixing apostrophe to the apparent name “'F” with one character “E”. The number of characters decreases. For example, the apparent name of the abstract link is replaced with “\hat{ }|EMap” as shown in FIG. 19B.

### 9.16: Changing the Apparent Name of the Link Belonging to Verbatim

In step S28 in FIG. 16, the name evacuation unit 77 performs batch changing to replace two characters affixing apostrophe to the apparent name “'E” on MS Word with one character of “F”. The number of characters decreases. For example, the apparent hyperlink name is changed to “-->F”, as illustrated in FIG. 19B.

### 9.17: Changing the Hidden Name of Abstract Link

In step S29 in FIG. 16, the name changing unit 76 performs batch changing to replace the name affixing apostrophe <.1′F.> of the hyperlink inside the field code on MS Word with <.2E.>. For example, as illustrated in FIG. 19D, the hidden name of the abstract link is changed to {HYPERLINK\|“.2E.2#..ABSTRACT.01”}. See A3 of FIG. 51, A3 of FIG. 56, A3 of FIG. 61.

### 9.18: Replacing the Apparent Name of Link so as to be Returned to the Preceding Link

In step S30 in FIG. 16, the name changing unit 76 is adapted to replace the apparent names of the links with the apparent names of the preceding link one after another. This processing of causing to return to the preceding link is performed in the following manner. “-->E” to “-->F” for link 1 in the second line from the first line of FIG. 6E. “-->C” to “-->E” for link 2 in the third line from the second line of FIG. 6E. “-->J” to “-->C” for link 3 in the fourth line from the third line of FIG. 6E. “-->G” to “-->J” for link 4 in the fifth line from the fourth line of FIG. 6E. “-->R” to “-->G” for link 5 in the sixth line from the fifth line of FIG. 6E. “-->S” to “-->R” for link 6 in the seventh line from the sixth line of FIG. 6E. Therefore, it may be described as the resurrection of the name.

### 9.18.01: Replacing Hidden Names so as to be Returned to the Preceding Link

At this time, the name changing unit 76 is adapted to replace the hidden names of the links one after another in such a reversed manner. That is, <.2E.> is returned to <.1F.> for the link 1 in the second line from the first line of FIG. 6E. <.3C.> is returned to <.2E.> for the link 2 in the third line from the second line of FIG. 6E. <.4J.> is returned to <.3C.> for the link 3 in the fourth line from the third line of FIG. 6E. Hereinafter, though the hidden names are not shown, the names are replaced in the following reversed manner. <.5G.> is replaced with <.4J.> for the link 4 in the fifth line from the fourth line of FIG. 6E. <.6R.> is replaced with <.5G.> for the link 5 in the sixth line from the fifth line of FIG. 6E. <.7S.> is replaced with <.6R.> for the link 6 in the seventh line from the sixth line of FIG. 6E. This is described in S28 and S30 in FIG. 17A, FIG. 17B, and FIG. 17C respectively. The same also applies to FIG. 37A to FIG. 43C. See A4 of FIG. 51, A4 of FIG. 56, A4 of FIG. 61. Therefore, it may be described as the resurrection of the name.

### 9.18.02: Reason for Difference from Changing Direction of Anchor Names

The highest level segments of the anchor names are replaced in the following order: <1F>:<2E>:<3C>:<4D>:<5E>:<6R>:<7S>. The numbers of the highest level segments of the anchor names are increased as above. Then, replacement of the hidden names of the hyperlinks occurs in this order. This is because each time an anchor in the file is created, it matches the hidden name of the hyperlink. Even if this hyperlink jumps, it jumps to the anchor in the same setting region, so there is no value for jumping. On the other hand, a link that is wanted to add a jump to that part will be generated. That is, when the numbers of the names of the anchors become bigger as further going through matching, they will not match the hidden names of the hyperlinks, resulting in ceasing to jump to the anchors in the same setting regions. Thus, add the hyperlink. In FIG. 6E, symbols --> in downward arrows with two-dotted broken lines indicate that the link that jumps to the same page is excluded because the name is common to the anchor. Also, since the jump of the link previously excluded will function by the final combination, it indicates the addition of the link. Since the previously excluded links are restored, the names younger than the anchors will be restored. It can be seen that the relationship between combining the setting regions and jumping from FIG. 36A to FIG. 36G which are added to the Amendment.

### 9.20: Sequential Changes

When the above processing is performed, the abstract link is changed from “\hat{ }|FMap” to “\hat{ }|EMap”, and the processing ends (END). The name changing processing is performed such that the above step S22 through step S30 is performed. This processing is performed (N−1) times, which is a formula for finding the number of diagonal lines. Thereby, respective positions of links of the abstract links and verbatims are changed. Then, the setting region 3 and the setting region 4 in FIG. 1 are generated. This change is performed in the following manner on the setting region 6 through region 11. However, it is necessary to perform sequential changes in the order of the preceding and succeeding relationship of links. The setting regions 6 through 11 are not reversed. Namely, <F>:<E>:<C>:<J>:<G>:<R>:<S>. See each line shown in FIG. 6E. The processes described in FIG. 16, FIG. 17A to FIG. 17C, and FIG. 19A to FIG. 19D are the name changing examples for segments of the highest level segment 84 including alphabets. The highest level segment 84 is shown in FIG. 6A and FIG. 6C. Then, the names with the highest level segment 84 being changed are present in the currently-being-created names 72B. However, the currently-being-created names 72B are not limited to the highest level segment 84 in FIG. 6A, FIG. 6C depending on the configuration of contents. In short, this can be applied to the name changing processing for the intermediate level segment(s), for example, the second highest level segment 88. Therefore, the names with the second highest level segment 88 being changed may be present as the currently-being-created names 72B in FIG. 5.

### 9.21: Order of Final Combination

The final combination is the last step. The final combination is described in the Amendment using FIG. 36A to FIG. 36G. The final combination is a process of completing the generation processing. In the First Process, the hyperlinks are arrayed according to the order rule. The generation processing is started by arraying the anchors according to the naming rule. In the Second Process, the highest level segments of the anchors are not altered. The lower level segments of the names of the anchors are all identical to one another. In the Third Process, transition processing is executed in the ascending order of character codes in succession to the Second Process. Then, the last step is derived. For example, in the case of the multinational treaties or conventions in seven languages, the currently-being-prepared-names are combined in the following manner. <1F> denotes French:<2E> denotes English:<3C> denotes Chinese:<4J> denotes Japanese:<5G> denotes German:<6R> denotes Russian:<7S> denotes Spanish. The final combination is performed so that the files are combined in such a manner that the file having the anchor with the smallest character code of 1 is arrayed first. Then, the ascending order of character codes of the anchors simultaneously coincides with the location order.

### 9.22: Combination that Follows the Naming Rule and the Order Rule

The final combination combines the files based on the naming rule, in succession to the processing that has been executed so far. Each of the name generation unit, the name incrementing unit, the name changing unit, the name combining unit and the final combining unit strictly follows the naming rule and the order rule while creating the hidden names of the anchors and hyperlinks. Therefore, it is well considered that the electronic file generation method according to the present invention is quite simple, and the operation of the names thereof is easy to learn and understand.

### 9.30: Number of Times N of Changes

The processing shown in FIG. 17A to FIG. 17C is a partial detailed view of FIG. 16. FIG. 17A illustrates the above processing of replacement up to the region 6 in FIG. 1. FIG. 17B illustrates the above processing of replacement up the region 7 in FIG. 1. FIG. 17C illustrates the above processing of replacement up to the region 8 in FIG. 1. Furthermore, additional figures for the Amendment, FIG. 38A to FIG. 43C specifically illustrate this processing. At the start of the Third Process, since one attention language is already completed at the end of the Second Process. Therefore, next change to attention language <F>. In this manner, assuming that N is the number of languages, the Third Process is completed if the processing of replacements is performed N−1 times as previously described. This means that it can be regarded that the Second Process is performed N times in total. When these files are combined for the total N languages, the creation of the targeted single file is completed.

### 9.40: Effect 1 of the Generation Apparatus 50; Large-Volume Creation

As described from the beginning, the generation apparatus 50 has the name generation unit 74 in FIG. 5. The name generation unit 74 generates the setting region 3 of science including the abstract link or the setting region 4 of verbatim. The generation apparatus 50 has the name changing unit 76 that changes the names based on the prescribed naming rule. The name generation unit 74 changes the setting region 3 or the setting region 4 generated by the name generation unit 74. The generation apparatus 50 has a function of creating electronic files having the setting region 3 or the setting region 4 changed the name by changing unit 76. Furthermore, the generation apparatus 50 is configured to store one completed and organized electronic file by the final combining unit 79 in the electronic file 55A. Thereby, a creator of the setting region 3 or the setting region 4 needs not to repeat the combination of hyperlinks and anchors corresponding to contents from the beginning one after another. That is, the creator can create a large volume of electronic files by utilizing the data-link structure of the setting region 3 or the setting region 4 contained in the electronic files 1, 55A, or 72A.

### 9.50: Effect 2 of the Generation Apparatus 50; Executable Only by Algorithm

From another viewpoint, the generation apparatus 50 is configured to have the instruction information receiving unit 73 that receives any one of a setting region generation instruction, a name incrementing instruction, a name changing instruction, and a save instruction from a user. This configuration makes it possible for the user to construct the setting region 3 or the setting region 4 in the electronic files 1, 55A, or 72A, while directly reflecting the creator's intention. Consequently, even the creator who does not have programming skill or the like can create the setting regions. Especially when updating what the user does not want to show to people outside the company such as in-house manuals according to revision or abolition, they have excellent maintainability.

### 9.60: Significance of Storing Both the Names 72B and the Names 72C Separately

The storage unit 72 in FIG. 5 is convenient to store the currently-being-created names 72B and the already-combined names 72C separately. For example, there is an advantage that, based on jumping that is already established in the already-combined names 72C, it is very easy to change hyperlinks and anchors simultaneously by using a method of FIG. 15. In this case, the processing is executed in the Fifth Process, which comes subsequent to the final combination of the Fourth Process. In this case, it is possible to reuse by changing the region 88 of FIG. 6C. In contrast, there is an advantage that the currently-being-created names 72B are ready to be further changed in variety. For example, suppose that significant revision of a treaty has been made. In this case, assume that a relationship that particular provision or Article quotes or applies mutatis mutandis another provision or Article is greatly changed. At this time, it is necessary to correct jump reference so as to quote or apply mutatis mutandis only in the inside of contents of each particular language. This is because there is no such treaty revision that extends over another language. However, it is troublesome to create jumping in a relationship with a quotation, based on the final combined file. The targeted jumping destination requires not only selecting Article/Clause region but also to combine the hyperlinks carefully so that the language region be the same segments. In short, double attentiveness is sought. In addition, this setting mistake causes jumping to extend over another language, and there is a risk of critical error that confuses the thought. Contrary to this, in the case of creating jumping in a relationship with a quotation based on the file before the final combination, the higher level segments of names are of course the same. Therefore, the nerve should be focused only on the Article/Clause region. Consequently, it can be executed with half of attentiveness. Even if failed, it is only an error of the relationship between quotation and mutatis mutandis inside the same languages. In short, there is an advantage that is left off with a relatively minor mistake. Therefore, it is worthwhile to save the currently-being-created names 72B and the already-combined names 72C in the storage unit.

### 9.61: Disadvantage of the Already-Combined Names

Description will be again provided. The disadvantage of a method for extracting document xml from MS Word docx extension, and applying change through replace-all will be explained. This method is not intended to change a particular name but is intended to change all discriminately and uniformly if the names are the same. For this reason, after taking evacuation measures such as putting, for example, an apostrophe into parts which are not intended to be changed, measures for changing only necessary parts are required. However, the final combination is completed, and the names of the anchors are already diversified in one file. Also, after the final combination, the names of the hyperlinks are already diversified, and therefore evacuation operation is in an impossible state. Therefore, there is a disadvantage that it requires a lot of efforts and time to change the names.

### 9.62: Advantage of the Already-Combined Names

However, the already-combined names 72C are composed of the science of the structured setting region 3 and verbatim of the structured setting region 4, in which jumping function has been already demonstrated. Therefore, there is an advantage that reuses for further advanced jumping can be carried out with confidence by taking over a part of the structured setting region 4 from the currently-being-created names 72 B.

### 10. Description of Other Embodiments

From here, another configuration example other than an example of the electronic files described so far will be described.

### 10.00: Effect 3 of the Electronic File Generation Apparatus 50; Reusability as it is

The already-combined names 72C in the electronic files 1, 55A, 72A (e.g., a state of the science of the setting region 3, a state of the verbatim of the setting region 4 in FIG. 1) are copied to another electronic file. Then, the setting regions 3 or the setting regions 4 of the electronic files 1, 55A, 72A are also built as they are in another electronic file. Thereby, in the case of the electronic files, anchor information of the already-combined names 72C, the setting regions for setting up information (Add a Hyperlink) or the like is used as the setting regions 3 or the setting regions 4 as they are in other electronic files. New hyperlink configuration has a similar configuration to that of the existing electronic file 1, file 55A and file 72A. As a result, the need to generate the setting region 3 or the setting region 4 from zero is eliminated, and the reusability of data can be further enhanced. Specifically, it is conceivable to reuse the hyperlink structure of the Patent Cooperation Treaty (PCT) as it is, and the hyperlink structure of United Nations Convention on Contracts for the International Sale of Goods as it is. These treaties are characterized in that there are no new additional Articles/Clauses amendments in comparison with the Paris Convention.

### 10.20: Jumping Between Different Electronic Files

Hereinabove, an exemplary embodiment of the present invention has been described, but the present invention is not limited to the above-described exemplary embodiment, but various changes are possible. Hereinbelow, the changes will be described. For example, in the above-described exemplary embodiment, an example of the hyperlinks in the same electronic file (what is called internal link) is illustrated, but jump destinations of the hyperlinks may be set up in other electronic files. Further, the links in verbatim of the setting region 5 illustrated in FIG. 1 are generated one less than N sets (i.e., N−1 sets), which is the number of units of categories in the electronic file 72A. For example, in the case where a certain content has been already translated into seven languages, 6 links of the link 1 through the link 6 (the setting region 5 in FIG. 1) excluding the link of interest will be created.

### 10.20.01: Verbatim Region where the Link of Interest is not Dropped Off

Also, at the time of creation, it is preferable to set up the position of the hyperlinks of the verbatim jump destination page screen and the jump source page screen to be almost identical to each other. Then, the position allows a user to touch immediately. In this case, the language of the content of interest needs not necessarily to perform setting up of drop-off. In this case, in the setting region 5 of jump destination of any language, seven links of FECJGRS including one that does not jump in verbatim become apparent faces in the order as they in any language.

### 10.201: One Example of Replacement of Architectural Drawings

FIG. 21 through FIG. 28, unlike FIG. 1, those are one example of the reorganizing architectural drawings. The completion drawings of the building (FIG. 21) are stitched in the configuration order of architectural design, structure, and facility. Those are based on the results of discussions conducted by a constructor with a client or the results of discussions conducted by the building constructor with subcontractors by trade. They are reported as contract completion report of construction contract documents.

### 10.202: Necessity of Drawing Replacements

However, when a resident wants to reform after completion of a house, the resident considers how electricity, gas, water supply, drainage, wiring for the Internet and the like are laid out on a floor, and how the floor is constructed. For this purpose, the resident desires that a plan view, a front view, and a side view regarding own dwelling place are arranged in the order. Giving priority to the order of the plan view, the front view, and the side view of living space, and arranging them in this order may be easier to understand for the resident. When the drawings are arranged in this manner, it may be convenient, for example, to drive a nail into a wall. There is the need to determine from the surface drawing of the wall, whether the particular part of the wall has reinforcing steel, or the wall is a false wall in which no stuffing material is packed.

### 10.203: Replacement Method

Thus, first, the photographs of appearance concept drawings of buildings were taken with a digital camera (FIG. 21). Next, photographs of completion drawings were also taken with the digital camera. Then, the drawings were rearranged in classifications according to different projection methods, that is, plan projection method, front projection method, and side projection method. Each indicating the directions from the projection. Furthermore, a table of contents of the plan projection method (FIG. 22), a table of contents of the front projection method (FIG. 23), and a table of contents of the side projection method (FIG. 24) include the rearranged drawings in addition to the classifications according to different projection methods. Further, create jumping (the abstract links of the setting regions 99 from FIG. 25 to FIG. 28) to go and return between the Present table of contents (not illustrated) and the drawings. Further, jumping (New abstract links in the setting regions 100 from FIG. 25 to FIG. 28) to return from the drawings prepared by overlaying layers on the same projection method to the tables of contents of a new system was created. In this manner, the setting regions 99 and 100 reside on the identical pages of the drawings as illustrated from FIG. 25 to FIG. 28, and as a result, comparison of the drawings was enabled by jumping between both present and new tables of contents so as to discriminate one from another. In this manner, it is possible to compare the drawings by industry type of the subdivision, within the major division of the projection methods.

### 10.204: Effects

By using electronic files based on the new system thus completed, the drawings can be easily retrieved concerning each Floor, Street, and Avenue. Therefore, instead of the entire drawing collection, only drawings that contain necessary rooms can be lent to a resident in a mansion who is planning to repair interior construction, for example. This will be useful for protection of privacy of other residents. And it will bring about conveniences in that the resident can confirm areas that require work by referring to layout drawings of the new system based on the line of sight. And it is possible to make cost estimation based on the old system, when placing an order for the work such as remodeling. And it can confirm the work at the line of sight level of the resident based on the new system.

### 10.209: Stitching Order of Completion Drawings

As described above, the completion drawings handed over from an architectural contractor are laid out in the order of architectural design drawings, structure drawings, and drawings of equipment. The architectural design drawings consist of drawings themselves, and window drawings. The design drawings consist of floor design, front design, and side design. Then the floor design consists of first-floor plan view, second-floor plan view, third-floor plan view, and fourth-floor plan view. Next, joinery layout drawings being the window drawings are laid out, and individual joinery tables are described, and then shifted to front view, and side view of the architectural designs, then cross-sections taken along respective pillars and sectional details. In that, ABCDE, 1234 which suggest pillar positions are drawn. The architectural design drawings end in this way. Next, the structure drawings come, and finally, the drawings of equipment are laid out. And those all are sutured together.

### 10.210: Not Illustrated Disadvantage of Stitching Order of Completion Drawings

This layout of drawings is classified according to the naming of drawings by subcontractors, and thus users will become gradually accustomed to the order of the layout. However, respective drawings that utilize the first stage floor drawings (iFloor) in FIG. 22 respectively are stitched at far apart positions and users have difficulty in examining with one another. The above-mentioned respective drawings are as follows. :Structure Drawings (Structure), Steel Bar Arrangement Drawings (Bar Arrangement), Electrical Equipment Drawings (Electric Equipment), Gas Piping Drawings (Gas), Piping Drawings (Pipe), Sanitary Facility Drawings (Sanitary), and Ventilation Facility Drawings (Vent).

### 10.211: Replacement of Stitching Order of Plan Projection Method in FIG. 21

Then, a projection method is written in the highest level of the segment that constitutes name so that users can find first what projection method it is, only by seeing names of drawings. Next, the following names are given to sections at the lower level in the order of at what part the drawing is cut, finally for what purpose the drawing is drawn, and then the drawings were rearranged in the following order. For example, the drawings of the building in FIG. 21, in regards to apparent names are expressed as follows. The plan views for respective floors are expressed as i, ii, iii, iv. The front view Street pillar cross-sectional views are expressed as A, B, C, D. The side view Avenue pillar cross-sectional views are expressed by 1, 2, 3, 4. Next, the plus and minus symbols represent outside appearance of the building. :−:+: Street pillar cross-sectional view mean exterior of the building. Also, in this expression, the same also shall apply to the symbols −, + of the side view Avenue pillar lines.

### 10.211.01: A Replacement Example of the Stitching Order of the Planar Projection Method in FIG. 21

For example, <.1.1i.1Design> consists of multiple clauses. First, <.1.> means planar projection method to be described at the beginning. The next <1i.> means the first floor. The last <1Design> means that No. 1 is a design drawing. Similarly, <.2-.B2.Windows > consists of multiple sections. First, <.2-> means that the second projection method is the front projection method. The next <B> means the building pillar number B seen from the STREET. Lastly, <2.Windows> means the joinery figure placed second. Similarly, <.3/.23.Development> consists of multiple clauses. The first <.3/.> means the side projection for the third. The next <2> means the pillar number 2 of the building as seen from the AVENUE. The last <3.Development> means that the third is the exploded of inside view.

### 10.212: Lateral Ordering on Planar Projection Method in FIG. 22

Then, FIG. 22 arranges on the same line, the drawings that have used these same projection methods. Also, FIG. 22 illustrates a table of contents that jump to the drawings created to compare these drawings with a stable line of sight. For example, on a line of the setting region 91 in FIG. 22 (iFloor in FIG. 22), the above, various drawings represented by the planar projection method are placed as one lateral line. Then, the drawings using the plan projection method are compared in a short time. That is, the drawings using the first floor (iFloor) are arranged as follows: Design drawings (Design), Joinery drawings (Windows), Structure drawings (Structure), Bar arrangement drawings (Reinforcing Bar Arrangement), Electrical equipment drawings (Electric Equipment). Gas piping diagrams (Gas), Piping diagrams (Pipe), Sanitary facility drawings (Sanitary), and Venting facility drawings (Vent). These arrangements (the setting area 91) will become the source of creation of horizontal verbatim (the setting region 100 in FIG. 25 to FIG. 28) at the jump destination.

### 10.212.01: Two-Dimensional Table of Contents on Plan Projection Method in FIG. 22

Furthermore, four sheets of Design drawings are placed vertically (the setting region 92) in the order of a floor plan. A floor plan on the first floor (iFloor). A floor plan on the second floor (ii Floor). A floor plan on the third floor (iii Floor). A floor plan on the fourth floor (iv Floor). In this case, users are allowed to jump one after another and to compare them quickly. Especially in the recent drawing preparation method, layers are overlapped on the same basic drawings and the same kinds of drawings are used in sequence as plural kinds of drawings for the purpose of cutting down costs. Therefore, since it is created with the same line of sight as the basic drawing, it is possible to pay attention to different parts from each other without the confusion of the eyes before and after the jump. In this manner, FIG. 22 configures two-dimensional tables of contents having lateral and vertical tables of contents.

### 10.213: Lateral Ordering on Front Projection Method in FIG. 23

Therefore, the pillar cross-sectional views, though they cut streets, are classified based on at which of pillar portions of A, B, C, D the drawings are cut. For example, when the building is cut from above at D, the plotting of -->D is a plotting cut at D spot, and is viewed from C side with a light source from the pillar of C. On the contrary, the drawing of D<-- is a drawing viewed from the E side after being cut at the point D. Further, these layouts, that is, the setting region 93 are also the basis for the creation of lateral verbatim. And this will become the setting regions 100 from in verbatim FIG. 25 to FIG. 28, at the jump destinations.

### 10.213.01: Two-Dimensional Tables of Contents on Front Projection Method in FIG. 23

Furthermore, in FIG. 23, vertically arranged drawings cut in area D are arranged as follows: Design drawing, Design, Joinery drawing, Windows, Development drawing, Interior Development, Detail Figure, Sectional Detail, Pile Figure, Pile, Pillar Column, Column, Bar arrangement diagram, Bar. As described above, there are seven drawings. That is, in FIG. 23, in addition to verbatim regions arranged in the lateral direction, there is a verbatim setting region 94 arranged in the vertical direction. And it makes it easy to compare each other by jumping to each other. Thus, FIG. 23 is also a two-dimensional table of contents with the horizontal and the vertical table of contents.

### 10.214: Lateral Ordering on Side Projection Method in FIG. 24

Similarly, FIG. 24 is a table of contents created by giving priority to classification according to pillar cross-sectional views in FIG. 21. These Avenue pillars are present at positions of 1, 2, 3, 4. For example, when the cross-sectional view cuts the building by at a pillar 3 from above, a lower left oblique arrow “−/” is a light source from the pillar 4, and it is a plotting drawn at pillar 3 and viewed from pillar 4. On the contrary, an upper right oblique arrow “/\hat{ }”i is a drawing created by cutting at pillar 3 and by a light source from the pillar 2. In this case, those marked with + and − in the setting area 95 which is suggesting an external view as seen from the outside of the building. As described above, the arrangement of these drawings (the setting region 95) becomes lateral verbatim (the setting regions 100 from FIG. 25 to FIG. 28) at jump destinations. (Abbreviation arrow symbols are written in FIG. 166.)

### 10.214.01: Two-Dimensional Tables of Contents on Side Projection Method in FIG. 24

Furthermore, FIG. 24 indicates that the drawings, which are vertically cut at pillar position 3, include eight sheets as follows: 1—Design, 2—Joinery drawing (Windows), 3—Development view (Interior Development), 4—Detail drawing (Sectional Detail), 5—Pile drawing (Pile), 6—Pillar drawing (Column), 7—Bar arrangement drawing (Bar), and 8—Elevator drawing (Elevator). In short, the setting region 96 of FIG. 24 is configured such that these drawings cut at the same spot are vertical arranged, thereby allowing the user to jump one another and to easily compare them. In this manner, FIG. 24 is also configured as two-dimensional tables of contents having lateral and vertical tables of contents.

### 10.215: FIG. 25 Through FIG. 28

Next, four sheets in FIG. 25 to FIG. 28 are the same drawings that received jumping from C Elevator, present at the bottom of the setting region 101 in FIG. 23 (front view). Of these, FIG. 25 is a drawing in a state in which the content can be seen. Then, names of two anchors are assigned to this drawing. At this time, a left anchor of the two anchors present at right-top in FIG. 25 receives jumping from the present table of contents, and a right anchor receives jumping from the new table of contents. For this reason, as illustrated in FIG. 26, when the names of anchors (the setting region 97) present at right-top in FIG. 26 are placed in location order, the names of anchors of two types of the present system and the new system will be displayed alternately. On the other hand, in each sheet of FIG. 26 to FIG. 28, names begin with <.2>, but this is a character added to the head of the names. This indicates a situation after two minutes. Then time concept is brought and converted to 4D. However, hereinbelow, it is in the stage prior to the description of 4D (10.31), and the characters added to the heads of these names are not still present. Therefore, hereinbelow, in the stage prior to the description of 4D (10.31) starts, description will continue assuming that name begins with a growth point of <,,>.

### 10.216: FIG. 27

The following FIG. 27 is a diagram in which a left side anchor of two anchors (the setting region 97) located at right-top in FIG. 25 was selected. Thereby, the names were arranged in the order of tables of contents that reflect the stitching order of the Present completion drawings. At this time, a character of a section of the name of anchor for receiving jumping from the table of contents of the Present completion drawings was set as <,,1,>. Then, this is distinguished from <,,2.>. In this case, <,,2.> is for the names that are arranged in the order of tables of contents that intend to reflect the another stitching order by replacing the completion drawings. This order of 1 and 2 is used for the purpose of making character numbers of the names of the anchors given to the Present drawing arrangement to be always smaller than the anchor names given to the newly replaced drawings. In this manner, drawings of the buildings can be configured to have two system's name.

### 10.217: Figures from Anchor in FIG. 28

Finally, FIG. 28 is a drawing in which a right side anchor out of two anchors (the setting region 97) located at right-top is selected. In this way, anchor names are placed in the name order, so as to correspond to the layout of plotting order of the drawings after New replacements. At this time, the lower segment <2-> can be seen in the setting region 98. <2-.C8.ELEVATOR>. In this case, the symbol <-> is an abbreviation for a street. The symbol <2> is a control character of the front view being the second plotting method. For reference, a symbol <1> is assigned to the plan view <1> being the first plotting method. The next symbol <C> is a pillar number of the Street. The Elevator Drawing is arranged at the eighth place <8> of the front views at <C>. The setting region 101 in FIG. 23 indicates ELEVATOR that is present on the eighth line; then jumping is enabled to the Elevator drawing.

### 10.217.01: Description of the Second Lines in FIG. 25 Through FIG. 28

First, sciences on respective second lines (the setting regions 99) in FIG. 25 through FIG. 28 will be described. This is because, unlike conventional examples, sciences are separated into two lines. Namely, anchors in the sciences on the respective second lines are located at the left-hand side of the first lines of respective drawings, which are different lines. In other words, the anchor in the Present system is set at the position at the left side of the setting regions 97 on the first line.

### 10.217.02: Description of Jumping on the Second Lines in FIG. 25 Through FIG. 28

Next, jumping of the setting regions 99 arranged on the second lines of FIG. 25 through FIG. 28 will be described. \hat{ }|Present on the respective second lines of FIG. 25 through FIG. 28 jumps to the table of contents of the Present completion drawings (not illustrated). The next “S36-->B” belonging to the science means that it is a structure drawing (Structure). It is 36th of the total drawing numbers of the completion drawings. And plots a pillar present at “B” that jumps to the “>B” pillar cross-sectional view as a front view. At this time, --> is an abbreviation of the front view. The next “S37/\hat{ }2” means that it is a structure drawing (Structure), and is the 37th of the sum total drawing numbers of the completion drawings, and it jumps to “2” pillar cross-sectional “/\hat{ }” side view. The last “S39/\hat{ }3” means that it is a structure drawing (Structure), and is 39th of the sum total drawing numbers of the completion drawings, and it jumps to “3” pillar cross-sectional view of “/\hat{ }” side view. That is, the second line here are the setting regions that jump in accordance with the order of the drawing numbers of the structure drawing (Structure) of S36, S37, S37, S38 which is in the order of pages of the current tables of contents. Abbreviation symbols are written in FIG. 166.

### 10.217.03: Drop-Off of the Link of Interest

The reason why S38 is dropped off at this time is that the drawing of interest is located below. As described above, the layout of the second line is contiguous in present drawing numbers of 36, 37, 39. From this fact, it will be found that the setting region 99 is used for jumping when the user tries to look the drawings, in the order of the current array. In this case, when the drawing of interest is located below, the point that the drawing of interest is dropped off from science is the same as the case of International Treaties.

### 10.217.04: Returnable Jump

Also, at each jump destination though not illustrated, one line on which the science similar to the one in FIG. 25 or the like has been literally replaced is described on the second line. It is a matter, of course, that returnable jumping in between the drawings is enabled in FIG. 25 and the like being the same drawings.

### 10.218: Description of the Third Lines in FIG. 25 Through FIG. 28

Next, sciences on respective third lines (the setting regions 100) in FIG. 25, through FIG. 28 are the same drawings, will be described. However, anchors in the sciences on the respective third lines are located at the right side on the first lines of the respective drawings, which are different lines. In short, the anchor in the New system is region-set at right side position on the first line.

### 10.218.01: Relationship Between Vertical C Array and the Third Line in FIG. 23

Jumps on the third lines in FIG. 25 through FIG. 28 are executed to directly jump to respective jump destinations of vertical C array (the setting region 101) in FIG. 23 which is a table of contents, and allow the user to compare figures. That is, |\hat{ }New at the top of the respective third lines belonging to sciences in FIG. 25 through FIG. 28 is an abstract link for returning to the new table of contents. Therefore, it jumps to a table of content of the front view in FIG. 23. The next -->D directly jumps to a jump destination -->C in FIG. 23 without going through a table of contents. Similarly, the next -->W directly jumps to a jump destination -->C that is the joinery drawing (Windows) in FIG. 23 without going through a table of contents. Similarly, the next |<-- directly jumps to a jump destination -->C that is development view (Interior development) in FIG. 23 without going through a table of contents. Similarly, the next -->P directly jumps to a jumping destination -->C that is a pile drawing (Pile) in FIG. 23 without going through a table of contents. Similarly, the next -->C directly jumps to a jumping destination -->C that is a column drawing (Column) in FIG. 23 without going through a table of contents. Similarly, the next -->B directly jumps to a jumping destination -->C that is a bar arrangement drawing (Bar Arrangement) in FIG. 23 without going through a table of contents. Abbreviation symbols --> and <-- are written in FIG. 166.

### 10.218.02: Drop-Off of the Link of Interest

When the drawing of interest is laid out below, a drop-off of the link of interest from the science is the same as the case with international treaties or conventions. That is, -->C of FootStep and Elevator in the region 101 in FIG. 23 is dropped off from the region 100 in FIG. 25. Also, at each jump destination though not illustrated, one line on which science similar to the one in FIG. 25 or the like is laterally replaced, is described on the third line. It is a matter of course, that returnable jumping between drawings are enabled to FIG. 25 or the like being the same drawings.

### 10.31: Creating New Highest Level Forward of the Highest Level of Name

In respective drawings in FIG. 25 through FIG. 28, a verbatim structure of the present patent application is used in the setting regions 102 of new first lines. In the previous description, anchors belonging to FIG. 21 through FIG. 24 were placed only in the first line different from the above two lines. In short, in FIG. 25 through FIG. 28, two anchors corresponding to hyperlinks on the second line and the third line were only located on the first line which is different from the above two lines. On the contrary, on the lines of the first verbatim in FIG. 25 through FIG. 28, hyperlinks for the verbatim of the first line were not present. However, when performing conversion to 4D, hyperlinks bringing a concept of time into the first lines in all figures from FIG. 21 to FIG. 28, are located to form a verbatim (the setting region 4 in FIG. 1). Thus, a creation method thereof will be described below.

### 10.32: Features of New Names

When describing new first line, apparent names are described by bringing the concept of time such as 0M, 1M, 2M (the setting regions 102 in FIG. 21 through FIG. 28). Further, sections indicating a lapse of time (e.g., <.2> after 2 minutes) are merged and added (FIG. 26 through FIG. 28) as the highest level regions of hidden names. In that occasion, the hidden names are added, in the new highest level regions of the hidden names on the field code side. For example, <.2,,2.2-.C8.ELEVATOR> in FIG. 26 is the addition of <.2> before <,,2.2-.C8.ELEVATOR>. This means after two minutes. Prior to bringing the concept of time, growth points of <,,> are present (<,,> in FIG. 26 through FIG. 28) in the control regions at the head of the hidden names of anchors.

### 10.33: Advance Processing on Existing Second and Third Lines

At the time of creation, measures should be taken so that erroneous selection of the range of character string replacement is not made. Thus, a growth point with double continuous punctuations <,,> is selected. Then, while the growth point remains attached, for example, <,,> is replaced with <0,,> in this manner, <0> minute is added forward of the names. Through this addition, as described below, in the existing system and the new system, the highest level segments of the hidden names are changed. In the existing system, a hyperlinks group on the second line and an anchor at the left side on the first line that constitute the system are added. In the new system, a hyperlinks group on the third line and an anchor at the right side on the first line that constitute the system are changed to add The highest level segments of the hidden names are added. In other words, <0> is added to the names of all hyperlinks and anchors in files of FIG. 25 through FIG. 28. Speak collectively, the effect spreads over all the files, and furthermore, changes are similarly performed to the hyperlinks and the anchors on the first lines from FIG. 21 to FIG. 24 including the existing table of contents parts. This is because, while changing and adding those field codes, all the field codes are opened in step 25 and step 30 of FIG. 16. All the field codes including not only the table of contents parts, but also the second lines and the third lines. See FIG. 117.

### 10.34: A Method of Changing Names which do not Put a Burden on PC

Certainly, batch changing can be performed from XML to the names of all the hyperlinks and the anchors in the file. See FIG. 15. But in order to reduce the burden on PC and to shorten the time for processing, dividing the procedure for the processing into several steps may make the processing quicker in some cases. This is because even in the case of the processing of the same hidden names, the burden on PC is less, in the processing performed while field code side is opened.

### 10.35: A Method of Changing Names Using Growth Points

As shown below, the procedure for the processing is divided into several steps. <.0> is added to the new highest level regions of the hidden names of the hyperlinks, after opening the field codes by simultaneous pressing ALT+F9. At this time, a check mark “ambiguous search” is removed. However, MSWord's specification is different in language. And, MSWord in English has no fuzzy search function. Then, growth points are used in order to perform reliable changes. Furthermore, an apostrophe is added to <,,> before replacement like <0,',> after replacement. By this adding processing of single quotation mark, evacuations of the hyperlinks on the second line and the third line are carried out. After finishing the evacuations, since two anchors for sciences of the second line and third line are located in the first line, only the name of the anchor on the first line is changed. In that select <,,> and replace with <.0,,>. Then by this processing, <.0> is added to new highest level regions of the names of two anchors, respectively. In this manner, in FIG. 25 through FIG. 28, replacements of two anchors are performed at the same time. At this time, replacements of the two anchors will be performed from docx--> zip--> document xml.

### 10.36: A Method of Changing Names by Using Evacuations

Hidden names of hyperlinks are replaced by adding a single quotation <'> like <.0,',>. The feature of the changes from document xml is that, when same names are included in XML statements no matter whether they are hyperlinks or anchors, all names are replaced. This is because the portions to which changes are applied in XML sentences are performed through replace-all method. Therefore, the portions to which changes are going to be applied have been evacuated in advance so that the same portions as conversion target from XML are not present. Then, after changes for the names of only the anchors have been finished, the operation returns to the restoration processing of the hyperlinks this time. At that time, similar to the previous processing, the field codes are opened by simultaneous pressing ALT+F9. After that, exclude the apostrophe from <.0,',> before replacement like <.0,,> after replacement. In this manner, <.0> is merged and added forward, as the new highest level regions of the second line and the third line, and jump is established similarly to before merged and added.

### 10.37: Merging of Names in the New Verbatim on the First Line

By the above-described processing, the addition of <.0> to anchor parts (two in the setting regions 97) as the new highest level regions is finished. Next, a hyperlinks group is created. For example, in the case of <0M>, an apparent name at this time is created like “-->1M” to “-->7M”. Refer to the first lines in FIG. 21 to FIG. 28. At the head of the hidden names, segments of the new highest level regions that suggest different times of <.1> to <.7> are added. This is because <.0> is already added to the anchor. In this case, it has been previously described (10.32) that it is only necessary to create the merged name added with new time ahead.

### 10.37.01.1: Method of Creating a Synthesized Name

Now, the way how to create the above-mentioned synthesized name of hidden names will be described. This is largely divided into two stages.

The one stage is to separate the names between the present system and the new system. And they can be compared alternately. For example, in the segment 97 of FIG. 116A, the different names of <1> and <2> are arranged. See FIG. 116B. This is because of the old system of <1,> and new system <,,2> were expressed in the segments. Therefore, if the names are sorted in order of location, the placement order of the setting region 97 in FIG. 116A will be alternated. However, if the names are sorted by name, the old system <1,> and the new system <,,2> are separated. See FIG. 116C and FIG. 116D. See FIG. 116E and FIG. 116F. Therefore, it suggests that, if different names <1> <2> are able to receive jumps from different hyperlinks, then different names receive multiple information of the systems.

The other stage is to generate the setting region of the new first line which becomes the verbatim for the new system.

### 10.37.01.2: Identification of the Name of the Present System and the Name of the New System

Separate names by the present system and the new system, and clearly distinguish them so that they can be identified by just looking at the name as belonging to either system. For example, <,,1> is for a old name, <,,2> is a new name. Add these to the front of the name of the present system and the name of the new system. By doing in this way, the names will cross in the order of the location as shown in FIG. 28. Then, when sorted in the order of names, they are separated as shown in FIG. 27 and FIG. 28. Then, they are not mixed. Crossing implies that mutual comparison is possible. Separation implies that each can be combined with other configuration individually.

### 10.37. 02: Addition of Time

Then, segments that newly mean time are added to the front of those names. In FIG. 27, <.2,,> is added to the head of the present system name. In FIG. 28, <.2,,> is added to the head of the name of the new system. However, initially, <.0,,> is generated. It is because the time needs to complete one round as verbatim regions. In this way, <.0,,> is added initially to all the names of all the hyperlinks and anchors.

### 10.37.03: Generate Verbatim in the First New Line

The verbatim is created in accordance with the Order. Therefore, the following measures are taken on all the anchors of which existence can be confirmed in the state in which the right side of the region 97 of FIG. 28 is opened. <,,2> which is the location order of the new system is added to the name of the region 98. Further, <.0> is added forward of <,,2>. Next, in order to create a verbatim, change is applied to a portion of <.0>. For example, obtain continuous numbers by dragging on the spreadsheet. Continuous numbers of 01234567 are created. Then, it is only necessary to arrange those names created in the regions 102 of FIG. 21 to FIG. 28 on the hidden names --> 1M to --> 7M. Also, for all anchors that can confirm their existence for the old system while the left side of the region 97 of FIG. 27 is opened, also add <.0> before <,,1>. When converting the new system into verbatim, we also want to convert the current systems mutually into verbatim and want to prepare so as to compare and refer to each other.

### 10.38.01: Completing One File for 0-Minute State after Fire Broke Out

In this manner, first, one file for 0-minute state after the fire broke out is completed. At this time, the Order of which the highest level segments are different from each other is generated in verbatim as follows. In the file, names are arranged, names representing 1 to 7 minutes are arranged in verbatim on hidden names of respective links composed of, for example <.1,,2.2-.C8.ELEVATOR> through <.7,,2.2-.C8.ELEVATOR>. Then, these hidden names are arranged in the Order in verbatim on the new first line. Verbatim which has two anchors will be better to refer to science in a narrow sense. However, the new first line thus created does not yet have jump destination.

### 10.39: The Effect of the Scheme for Completing One Round Through the Highest Levels of Names Spreads to the Second Line and the Third Line

Two anchors of interest are arranged. There is completed one file with and having verbatim regions in a narrow sense in which after 0-minute is basic. Then, based on this file, it is possible to perform transitions in sequence from 0-minute to 7-minute. In this case, the scheme for completing one round through the highest level segments of names (9.18 and 12.25) being the Third Process is used. Namely, evacuations are performed by using the scheme for completing one round through the highest level segments of names. (described at 12.20). Then, new verbatim is automatically generated.

### 10.40: Why the Effect Spreads

Therefore, it should be noted that the influence was concurrently exerted on respective second lines (the setting regions 99) and respective third lines in FIG. 25 through FIG. 28, owing to replacement processing scheme to open the field codes. Since time indication is not represented in apparent names of hyperlinks, users are not aware of it. Certainly, unlike on the apparent names of the respective first lines in FIG. 22 through FIG. 28, 0M or 1M indicating the time is not described in the apparent names of the respective second lines (the setting regions 99) and the respective third lines (the setting regions 99) in FIG. 25 through FIG. 28. However, when creating different files by the scheme for completing one round through highest level segments of names (described below 12.25), changes in the highest level segments of the hidden names of each one are such that simply not only the first lines. And the respective second lines and the respective third lines are present in the same file. But also both the respective second lines and the respective third lines have growth points <,,> of the names. For this reason, simultaneously with opening the field codes, and selecting <.0,,>, and replacing it with <.1,,>, they are influenced by the changes. All jump destinations of the names when the field code is opened are subject to change of time. Evacuations of the names will be performed on the halfway, but the description will be omitted. The same description as above is repeatedly described below. The effect of this one cycle scheme also has an effect on the science of the second and third lines. The reason was that the field codes were opened and the new highest level segments were added to the names. To open the field code, press ALT key and F9 key at the same time. However, this operation method is an act of changing all field code areas. Therefore, open field codes other than the first line to execute the scheme for completing one round. So, without intention, substitution of names extends not only to the verbatim of the first line but also to the whole.

### 10.41: Features of Jumps by Creating New First Lines

As described above, even if the first row -->1 M is jumped, the layout is copied without change. Even when different files are created, the apparent layout of the second line and the third line is the same. For this reason, there is no change in the setting area before and after the jump. Similarly, before and after jumping of hyperlinks of the respective second lines and the respective third lines, there are no changes on apparent names before and after jumping by creations of the new first lines. This is because time is not described on the apparent names. Furthermore, segments of the hidden names which are the same as the first lines are added to even the second lines and third lines. Therefore, even when hyperlinks of the second lines and the third lines are caused to jump, an elapsed time --> 1M or -->2M on the apparent names arranged on the same first lines is not changed. In order to make the jumping in different elapsed time state, it will be performed by changing a verbatim link on the first lines to links other than the link of interest. That is, the sciences in the 2nd and 3rd lines execute a small jump within the range described in the 1st line. Therefore, when it is desired to set the jump to a different elapsed time state, the link of the verbatim in the first line is changed to a link of another attention. This is the difference between a jump in a range that does not change the highest level segment of the name and a jump that changes the highest level segment of the name. Therefore, if respective names are crossed in the state before generation, similarly to the jump of the state after generation, the property of crossed is taken over. This means <0> <1> described above. But, the 2nd and 3rd lines have the same top segments on the same page. This is the reason, why those jumps are small jumps.

### 10.42: Converting Non-Science into Science

FIG. 21 through FIG. 28 will become an example in which setting regions of sciences can be created, if a given replacement is performed to a field other than a field such as multi-language International Convention. Unlike the case of International Convention, in the case of architectural drawings, it would be a reality that it may be more often the case where the lower levels of names are not numerals, the number of characters is also not uniform, and increase by the Second Process is difficult. However, it suggests verbatim can also be created without Articles/Clauses. Even if it is difficult to increase the names by the Second Process, executing the Third Process by using the scheme for completing the highest level regions of names has a large effect on shortening of time taken to create hyperlinks.

### 10.50: One Example of Electronic File Having Story Line

The electronic files having data link structure generated by the above-described electronic file generation apparatus 50 can change description configuration of not only language books but also books of other fields. Therefore, the electronic files of the present invention also enable implementing electronic drawings other than electronic documents and electronic books. Then, in the present invention, embodiments through these various electronic files will be described solely as electronic documents.

FIG. 29 and FIG. 30 are different from FIG. 1, FIG. 29 and FIG. 30 are other files having content of a storyline. In the electronic files illustrated in FIG. 29 and FIG. 30, respective sciences are the ones in which translations for each language can be compared. Files different from FIG. 29 and FIG. 30 are considered. For example, a plurality of sciences are provided separately, one more time. In that case, anchors are further increased. Then, consider a story of an old science. Then, a plurality of new stories. Then, they jump each other.

### 10.51: Reedition of Tables of Contents of Books

Furthermore, it is convenient to organize travel guide books in respective languages into a single volume, and further to cause them to jump as they are. It is also convenient for conversations of information exchange during travel. Travelers whose everyday languages are different meet on a trip. When foreign language travelers meet on the oversea trip, the necessity of exchanging information each other on the travel destination is highly required. In that case, the layout of verbatim in new first lines in FIG. 21 through FIG. 28 will be used. Editors add tables of contents in the order of timing and seasons of various purposes of travels such as SPA hot spring, fishing, and events, in addition to tables of contents that are edited only in the order of geographical names of travel destinations. Travelers change languages sequentially and directly jump from different tables of contents to respective content. It is also possible that current books create a number of different stories in respective languages and jump each other (FIG. 29, FIG. 30). It is also possible to relate different systems to each other by using two different anchors on the new first lines in FIG. 25 through FIG. 28. By using a technique on the second lines or the third lines in FIG. 25 through FIG. 28 each time the purpose of edition differs, sciences by purpose and planning are also created separately at respective pages and related to each other by jumping. If there are differences between a request from a client and the programmer's own planning, the programmer tries to explain to the client by jumping the content and comparing them. Then, the programmer tries to explain the client by replacing the whole edition of the desire of the client and proposal of planning paper. At this time, it is convenient if there are two anchors. Furthermore, hands over the file to the client so that the client can operate on the client's hand. Thereby, the programmer will give substantial satisfaction to the client.

### 10.52: Replacing Basically Arrangement Order of Content of Books

In a case of a law textbook, definitions, requirements, purposes, effects can be separated from each other, and hyperlinks are used to combine these texts with each other. Therefore, the description can be provided by dividing into a collection of definitions, a collection of requirements, a collection of purposes, and a collection of effects. These are linked with each other. And, the collection of definitions describing only definitions is used for memorization. Further, from the collection of requirements containing only the requirements, necessary and sufficient characteristics of the requirements can be compared and examined. Further, in explaining the purposes, only the collection of the purposes is described sequentially one after another. By using these, similarity and singularity on the different explanations of the purposes can be checked each other. In explanation of the collection of effects, only the effectiveness portions are described over several ten pages sequentially in an unbroken line. For this reason, attempts will be easily made to further think commonness and difference with and from other systems having similar effects. In this way, learning from varied viewpoints becomes easy. For this reason, the layout order of content items of almost all law books will be replaced. Regarding comparisons between the amendment law and the before amendment law, instead of only two times, further many amendments can be compared to each other. The comparative law needs to make the difference clear. The history of law needs to make the difference clear.

### 10.53: Save Style Having a High Effect Per Processing Time

In the case of company manuals, if descriptions are changed to DB method of the present scheme capable of performing cross-reference like the above-described law books, users can easily consult the related descriptions at positions distant from each other. Then, report documents to a customer can be created in a short time by copying and pasting the parts. Also, the basic type of program obtained from xmIDB collected in advance is assembled to compare and circulate the related contents so that the basic type can be extracted early. If parts tool of a tool box of such programming software is used, it is possible to expedite the completion of a toolbox of the programming software.

### 10.60: Hyperlinks for Prevention of Falsification

It may be possible to directly make changes from document xml without evacuating all data link structures comprised of a combination of hyperlinks and anchors included in the already-combined names 72C in FIG. 18. In that case also, the electronic file generation apparatus 50 has executed the processing shown in FIG. 5. For example, if the hyperlink structure can be created by converting two-byte names into one-byte from document xml. In the case, willfully use characters dots or dashes. Those are often used for hyphenation processing. But, that cannot be created, for example, from MS Word as a word processor. When such names are replaced, then files that prevent the links from being altered by other people can be created. The reason why the names in FIG. 31 described with characters such as dots or dashes are used is because it is difficult to insert them from the state in which extension is docx, and this will prevent addition or correction of the anchor names.

### 10.61: Embodiment of Prevention of Falsification; UVOP

For example, the electronic file illustrated in FIG. 31 contains UPOV Convention (The International Union for the Protection of New Varieties of Plants) as content, and anchor names included in this electronic file are the ones that have been operated from xml. The operation has converted the extension of docx into zip, and extracted document xml from a folder to the outside, and performed conversion using web page creation software. A dot as used hereinafter refers to a dot which is usually input from the keyboard, unlike a dot to be replaced in FIG. 126.

### 10.61.01: The Effects of Prevention of Falsification

In this case, it becomes possible to input names, for example, names beginning with the half-width numeral, which cannot be input as an anchor name in the operation of ordinary MS Word. Then, even when the names abruptly begin with the numeral, there is a phenomenon that MS Word which has a document viewer function can display the names. In this case, word processor function of MS Word is not useful. In this case, regarding input of dots, when the input of dots to other than the leading control region 83 (in FIG. 6A through FIG. 6D), then jumping function is enabled to work. Then, even in such a state, a jumping function can be confirmed by MS Word as the viewer software. Also, in the case of PDF, jumping is established. Then, in this manner, the head of the beginning of the hyperlinks and anchors which are controlling symbol is prohibited to use by World Wide Web Consortium, and as a result, falsification of hyperlinks of documents will become difficult. Since <0.> in FIG. 31 is full-width unlike half-width <0.>, they are displayed at the end if arrayed in the name order. In FIG. 31, intentionally, it is created so that it is recognized that one-byte characters are lined up in the previous line because the anchor of <0> of double-byte character <0.> exists at the end. By the way, in the world, it is said to be 1 byte or 2 bytes. But it is exactly, one byte and UNICODE.

### 10.62: Modification Against the Naming Rule or the Name Eligibility

The electronic file 1 that has become one file by the final joining unit (79 in FIG. 5). And the file is able to add another operation to xml. For example, it is possible to remodel. 1 with Japanese1. 2 with Japanese2. 3 with Japanese 3. After sorting the order of one, two, three of Japanese by a spreadsheet software will line up as 132, but the jumping will be established. Also, the segment such as <.> is used in Japanese sentences. There is a use of a punctuation mark of <.>. So it is not possible to delete it <.> from XML. However, in Western sentences, <.> is not used in contents. Therefore, <.> can be deleted from all the contents. But this deletion not including the control segment at the beginning of the name. Of course, even if you change two-byte characters to one-byte characters (FIG. 31), jumping is established. In other words, it is possible to change a verbatim contrary to the naming rule. However, since it is difficult to return to the previous state after modification, it is irreversible change, so it helps to prevent tampering. Anyway, Mark <.> existing at the control segment at the beginning of the name cannot be deleted.

### 10.70: One Example of an Electronic File for Comparing Many People's Opinions

FIG. 32 is one example of another electronic file for comparing many people's opinions. And, FIG. 32 is for comparing images in respective faces of a diamond. As illustrated in FIG. 32, those hyperlinks can be made to employ an assessment technique for reflecting many people's opinions on administration, and to describe opinions of respective people at respective pages, and to compare the opinions of other people. Further, for example, since the number of faces of a brilliant-cut diamond is 58, images in respective faces can be located at respective pages. This will enable satisfaction of clients to be enhanced, if diamonds are sold, by describing reflections, colors, flaws, the cutting technique from the respective faces of the diamond, in a file with their images, and besides assigning grades. In the case where such an electronic file is created, if 64 sets of hyperlinks are created first, and after that, decreased to 58 sets of hyperlinks, then the setting regions having the same hyperlinks as respective surfaces of the diamond will be completed, and will become suitable when comparing images on the respective surfaces.

### 11. Precautions for Creating Electronic Files

Precautions for creating electronic files will be described below.

### 11.00: About Edition Processing Via Field Codes

FIG. 33 is a display example when edition processing is performed via field codes. If ALT+F9 button is pressed simultaneously on MS Word, the field codes are expanded, and hyperlink names can be edited. When replacement is performed using a fuzzy search, even if dots <.> and commas <,> are included before replacing, these portions are not counted as the number of characters before replacement. However, after replacement, correctly replace the counted characters. This is a replacement method that uses the fuzzy search. For that reason, for example, supposing <. 1.> before replacement and <. 2.> after replacement, the processing will be replacement by increasing the single character part <1> to 3 characters <.2.>. Therefore, the result is 5 characters <.. 2..>. Therefore, the fuzzy search needs to be stopped. Then, why the work is performed from the field code side? If changing processing of the hyperlink names included in the already-created names 72C is performed from the field codes, the burden on PC will be decreased. Therefore, it will become possible to perform changing in a batch of several thousand units of the hyperlink names.

### 11.10: Alignment and Display Method of Field Codes

However, in the display illustrated in FIG. 24, it is very hard to read due to a phenomenon that lines of sentences are word wrapped irregularly as shown in FIG. 33. Thus, make the number of characters of a hanging indent constant. Further, make the number of characters constantly. Thereby, maintainability, reusability of hyperlink information can be improved. When creating the electronic files 1, 55A, 72A, small-sized smartphone screen utilizes the auto-loop back/wrap-round function. In this case, a phenomenon that characters can be easily compared in a vertical direction can be utilized by the function. If this phenomenon is utilized, the field codes can be aligned in a vertical direction, and the distinction among the names can be displayed intelligibly. Thus, when checking whether the hyperlinks are generated properly in order, users can easily check if an ordering sequence is correct, only by directly and visually checking without using a technique of mouseover. Further, if this principle is used, the names of the hyperlinks can be confirmed in a short time using the entire display area in a wider range than the mouseover.

### 11.20: About an Aspect that is Preferably Used for Names

In the name generation, the burden of PC can be decreased by selecting a small number of characters and making the conversion on the names of the anchors and saving them using different names, and thus the considerable number of changes becomes possible. For example, changing processing from <.1F..> to <.2E..> is faster than changing processing from <.1F..01.01> to <.2E..01.01>. Further, the name multiplicating unit 75B is used for a method of multiplicatively increasing the names before conversion to 2-fold, 4-fold, 8-fold, and is also a creation method for time-saving. However, there is a possibility that both hyperlinks and anchors are uselessly produced. Regarding changes of the names using the field code, the character of HYPERLINK on the field code side is 1-byte, the name of HYPERLINK is likely to be influenced by font style when converting into 1 character with 1-byte character. Furthermore, XML declarative statement is located at the head of XML file. And, one-byte characters are used in XML declarative statement in <document.xml>. However, even when two-byte characters are replaced with two-byte names, conversion errors will not spread to the one-byte declarative statement. Thus, it is preferable to use two-byte characters when replacing the names.

### 11.21: Items to be Strictly Observed in Operation of Names

When deletion and changes of names from document xml, it is required to surely confirming that there are no characters to be used for evacuation setting in the content before performing changes. Especially after content has been inserted. This is because, when finally taking off apostrophes, users will have trouble with those being batch deleted instantaneously also from the content of the text. However, since it could be confirmed that 1-byte <′> is not present in declarative statements, in both MS Word 2010 and 2013, it was used for evacuation in this embodiment. However, double quotation mark of <″>, which is similar to <′>, shall never be used. This is because, as seen in FIG. 9G, apparent and hidden names are surrounded by double quotation marks, and accordingly, the use of the same characters will separate and destroy the names.

### 11.22: When Apostrophe is Already Used for Content

However, in the case of Western-style sentences, there is a problem that apostrophes are often used in the content in many cases. In that case, it is necessary to take measures so that “batch deletion” of apostrophes does not happen. In step 30 of FIG. 16, when the half-width angle apostrophe is deleted, the name is replaced. As the countermeasure, when changing the name, the segment plus another character is additionally selected. At this time, peculiar segments that do not exist in the content are to be selected. Since double quotation marks are used in field code side of the hyperlinks. And they are unable to be deleted. Therefore, in this application, the use of double quotation marks is prohibited, at the time of replacement of the names.

### 11.30: Conscious Input of Two Bytes is Needed

As a point to notice, when A B C are continually described following two bytes characters in MS Word, A, B, C are changed and described in one byte. Even if automatic change function is stopped, A, B, C are described in one byte. In other words, the input data is automatically converted into one byte. However, they are difficult to distinguish. Because they are similar fonts. Therefore, it is necessary to forcibly correct again to two-bytes. Because if those two types remain, the software determines that character codes are different. They do not jump. Other companies' products may have similar specifications, so attention is required.

### 11.40: Batch Change Processing of Names and Batch Change Processing Screen

When performing conversion by use of the replace-all method, then unconstrained transformations will be applied. This conversion replaces everything in XML. Hyperlinks and anchors are also subject to the conversion. This patent application uses this principle, namely, the replace-all method.

### 11.50: When to Create an Abstract Link

Usually, books have a table of contents. And for the current applications, French books become English books, English books turn into Chinese books. Therefore, the table of contents needs to be created before changing the language. In that case, it is desired to create an abstract link to return to the table of contents of each book before increasing the language. After that, it increases like 1+1+1. This is because it will be more reasonable to execute processing of taking over their features.

### 11.60: Relationship Between Abstract Link and Anchor

By the way, even after jumping from the abstract link to the table of contents, the language of the table of contents link does not change. For this reason, the abstract link is allocated segments of the same name meaning the same language as the content. However, since the table of contents is lined up forward of the content, it is necessary to assign a character with a smaller character number than that of the content. Thus, for example, if <.> is used for the content and <,> is used as the table of contents. However, the existence of anchors and abstract links in the same science with the same highest level regions gives influence on the evacuation of names. Therefore, the device renames the abstract links before changing the anchor from document xml. The name change is done in a way called evacuation. For the evacuation purpose, it is desired to add a single quotation mark. After that, only the name of the anchor is changed.

### 11.70: Changing Processing of Segments of the Names and Creation of New Segments

To begin with, even if it is a partial replacement of names, the computer recognizes them as different names from each other. Therefore, positively enabling partial conversion is more convenient than all replacements. Thus, as a result of considering, names are divided into several segments, and <.><..><,><,,> were provided. This result was such that, when a batch conversion is performed by using Webpage creation software for document xml, changes were quite clearly visible. So that they are distinctly arrayed in a line. Now, <..>, <,,><,,><,,> are its deformations, of the setting regions 85 in FIG. 6A through FIG. 6C. It like a growth point of the plant, and if <..> is replaced with <.00..>, then new segments can be additionally created. In short, if new sections are used for segments of names, names before adding segments and names after adding segments can be combined. As a result, users can combine names in various ways. It is because, notwithstanding a partial replacement of the names, the computer recognizes the names as different from each other.

### 11.80: Software as a Processing Tool of xml

Xml in MS Word is difficult to be identified with naked eyes since various data definitions are entered thereinto together with content. Though there is dedicated software available to cope with this problem, it takes much processing time for rearranging XML in an easy-to-read state. Instead, there is web page creation software. The software is fast to change names. Also, when the names have a fixed length, auto-loop back/wrap-around function works as shown in FIG. 34B, and the names may be arranged in order. In that case, the web page creation software displays a screen at the time of name change so that the arrangement of xml can be read in order. Therefore, performing changes of the names by using the web page creation software significantly enhances the learning effect of XML (FIG. 15 and FIG. 18).

### 11.81: The Purpose of Substitute Photographs

The reason for attaching substitute photographs (FIG. 15, FIG. 18) in the present application is because the applicant wants many people to see how XML actually manages names of hyperlinks and anchors. Also, in the present application, it has become possible to simultaneously create both the hyperlinks and anchors (FIG. 15). Also, it has become possible to create only the anchors (FIG. 18). As a result, it will be found that when hyperlink operated from field codes, the names have become able to be automatically created almost completely.

### 11.90: Building Sciences by User's Manual Operation

In the above-described embodiment, names are to be generated by utilizing the dedicated program 55C being installed in the HD 55 of the electronic file generation apparatus 50 in FIG. 4 and the already-combined names 72C. However, names may be generated according to inputs from users, without using at all the dedicated program 55C and the already-combined names 72C. In this case, the procedure will be given as below.

### 11.91: Placement of all Anchors Before Process Begins

In the first place, as a precondition of work, an array of anchor names shall have been all performed in accordance with the naming rule. See from FIG. 151A to FIG. 151G. In the second place, description of apparent names of one science of the starting point of turning points of all languages file must be created, as illustrated in FIG. 6E. In the third place, the preceding-succeeding array of links in verbatim shall not be reversed during creation according to the order rule. See from FIG. 36A to FIG. 36G. In the fourth place, the attention dropped off from the portion coming downward line shall be created so as to be restored on the next line. See FIG. 6E and FIG. 44. The four points are necessary as described above. In addition to this, simple work is started by copying the beginning to the end of the one science, other than anchors, as one unit to the next location.

### 11.91.01: Replacement by Shifting, by Manually

When the copied science is changed into next science, the immediately preceding names are copied. Therefore, when respective hyperlinks are selected, the immediately preceding name is inverted to blue and displayed on the layout screen (FIG. 20A), and thus it is only necessary to shift respectively to the next succeeding name. This is because the anchors are arranged in the appearing name order. And this line up is the same location order in accordance with the naming rule. In this condition, an anchor for content residing at the next location appears in the next. Therefore it is only necessary to change the selection so as to shift to the next appearance directly. For example, PCT Article 4.12 for French in FIG. 20A. PCT Article 4.12 for Chinese in FIG. 20B. PCT Article 4.12 for Japanese in FIG. 20C. They are inverted to blue respectively. Therefore, it is only necessary to shift to the next appearance.

### 11.92: Temporal Advance Arrangement of Anchors

The processing is transitioned continuingly. From the setting region 6 (FIG. 20A), the setting region 7 (FIG. 20B), to the setting region 8 (FIG. 20C) in FIG. 1. This order is kept each time. The anchors for the Articles are positioning at the immediately preceding location of Article/Clause of verbatim where the user wants to replace from now. Therefore, even when the user may sometimes jump to an anchor where several hundred pages apart each time. Even when the user's level of consciousness falls, and any mistake occurs, it is easy to copy to the next line altogether, as described above. And It is easy to find a mistake. Because immediately preceding names are copied into next page as one science. Since copy after has same names of the hyperlink names of copy before. Because if the lowest level regions 87 (FIG. 6C) of names of the link are unprocessed, only the portions are not corresponding. A number of the segment is different from other segments. Therefore, mistakes can be found quite clearly. This is because, for unprocessed portions, numbers of the lower level regions of the segments are not equal.

### 11.93: Supplementary of Creation by Manual Operation

This invention is to automatically create hyperlinks and anchors. However, there are still several demands for the manual operation. For example, at the start, an interval of jumping for cross-reference between verbatims was determined initially to match short sentences of Chinese or Japanese. After the completion of the file, the time has come to trying to compare with each other. Then compare those languages of long sentences of German, Russian or the like. In that case, there are cases where the user wants to insert a cross-reference. This is because the longer the sentence, the wider the space between the pages where the verbatims are placed, and movement between the verbatims value is reduced, and as a result, the value of mutual reference will decay. Scroll after jumping means the loss to the merit of cross-referencing. In that case, the instruction information receiving unit (the setting region 73 in FIG. 5) receives any of a setting region generation instruction, a name incrementing instruction, a name changing instruction, a save instruction, a final combination instruction from users, which will be used for supplementary.

### 12. Overall Image on Large-Volume Production

A comprehensive image of large-volume production of electronic file creation is described below. However, when describing as electronic documents, electronic drawings will be included. In short, it should be noted that the electronic documents in the present application as discussed in 5.12 and 10.50 will include electronic drawings.

### 12.00: About Processing by the Name Changing Unit 76

The changing processing of names by the name changing unit 76 is largely Divided into Two Parts: Processing on the Higher-Level Regions of Respective segments that compose names, and processing to replace the lower level regions.

### 12.01: About Processing of the Lowest Level Region 87

The lowest region 87 is for an Article/Clause. The method of increasing this part will be accelerated by manual operations like in FIG. 20A to FIG. 20C. In this case, hyperlinks are created according to the explanation of FIG. 20A to FIG. 20C, and the method of FIG. 3B adds an anchor. At the time, the number of files does not increase.

### 12.10: About Processing of the Lower Level Region 86

The processing by the name multiplicating unit 75B is started with the processing on the lower level region 87. The processing characteristics of the setting region at the lower level are as follows. In the lower level region, change 1 to 2. After that, join into one file. One combined file consists of 1 and 2. Then, next, changes one file consisting of 1 and 2 to 3 and 4, and then combines one file. After diversifying the numerical expression of the lower level region, it shifts to the processing of the upper level while copying the already changed part of the lower level. At this time, increasing processing of the upper-level regions will be performed while automatically copying the already changed part of the lower-level regions. So to speak, the increased processing by the name changing unit 76 will be multiplicatively increased like 10-fold, 20-fold (double of 10-fold), 40-fold, 80-fold, and beyond. This is because the processing by the name changing unit 76 can subdue the name incrementing unit 75A. However, this is one feature of the name changing unit 76. Because the name changing unit 76 performs more important processing than the name incrementing unit 75A. The process does not constitute the name incrementing unit 75A. For example, it generates over 80 supplements.

### 12.11: About Features of Processing of the Lower Level Regions of Names

A processing technique of the lower level regions 82 performed by the name changing unit 76 can be divided into three steps. Firstly, a step corresponding to a Clause level that does not reach Article level, for example, the setting region 87 in FIG. 6A and the setting region 87 in FIG. 6C. Secondly, a level of one-digit Article, for example, one-digit part of the region 86 in FIG. 6A and one-digit part of the setting region 86 in FIG. 6C. Thirdly, a level of two-digit Article, for example, two-digit part of the setting region 86 in FIG. 6A and two-digit part of the setting region 86 in FIG. 6C. In the following order, the processing rises from lower level to higher level.

### 12.12: Processing at a Level of the Lowest Level Regions of Names

First, in the processing on Clauses at the lowest level, those that exceed 10 Clauses are found, and therefore it is preferable to keep always two-digit frames to be prepared. However, when thoughtlessly multiplicatively increasing the names that are not actually used, much time will also be wasted for their deletion. Thus, in the processing on Clauses at the lowest level, it is recommendable to create up to about 8 Clauses which is typically necessary range.

### 12.13: About Features of Processing at an Article Level

For example, in the case of creating a one-digit level of Article, the necessity is high to create all names from 0 to 9 for the first digit. Create all names means creating Article 00 Clause 01. In the previous case, 9 means Article 09 Clause 08. This is because Article 9 exists almost in all Treaties. And it is better to create up to 8 Clauses. In this instance, 08 is as described in the previous paragraph. For this reason, it is better to further additionally perform multiplicative processing after having executed 80-fold multiplicative processing, and to prepare all the variety from 00 to 98. In this case, 98 means Article 09 Clause 08. Further, regarding the contents of laws such as Treaties, Article 0 itself may be considered unnecessary. However, if Article 00 exists, it can be transformed easily into both Article 10 and 20. Therefore it is necessary to create Article 00.

### 12.14: About Image of Processing of the Lower Level Parts of Names

Assume that names which have been changed and created in the above lower level parts are all expressed as 1. Then, it becomes as follows. (1+1) for the first time (step S14 in FIG. 12A). (1+1)+(1+1) for the second time (step S14 in FIG. 12B). ((1+1)+(1+1)+(1+1)+(1+1)) for the third time (step S14 in FIG. 12C). As described above, when expressed in addition formulas, the second part of the bracket is copied taking along the former parts of the parentheses, thereby to double the number of names for each incrementation (See FIG. 114A to 114C).

### 12.20: About Processing of the Highest Level Regions of Names

Finally, the top segment will be described below. The applicant, before having knowledge of the process of the document xml, created the links of the multilingual treaty as follows. In short, the seven languages are created by repeating creations in such a manner. When finishing the Second Process in French, and then again starting from the First Process in English. However, this processing takes much time and effort, and it will become processing of repeating very similar processes. Because in the case where international Treaties are codified, the final number of Articles or the final number of Clauses of respective Articles are the same, even when languages are different from each other. As a result, if the science of a certain language can be created. And if it can be handed over directly to other languages, then it will be present to the human who needs the idea. And it is natural, and it is more convenient. In other words, there is a way to reduce the number of iterations of the same process, and it is desired to discover a further process that the First Process and the Second Process can be used as they are. Thus, as an idea, the applicant comes to consider that respective Treaties only differ in the part which suggests languages in the highest level region. And the same design is used in the way of arraying the content configurations of Article/Clause regions in the lower level regions. Therefore, each Treaty differs only in the part that implies the language in the highest level region, and the applicant came up with a way to replace them.

### 12.20.01: Omitting the Processing of Complicated Lower Level Regions

The Third Process has the advantage to cope with the Paris Convention that contains many additional provisions due to the amendments. This is because the Paris Convention is diverse in its intermediate level segments, and therefore care must be taken when repeating the Second Process to create different sciences as in FIG. 6E. The intermediate level segment means the segment 88 of FIG. 6C. For example, the Paris Convention has additional provisions: 4-2 to 4-4, 5-2 to 5-4, 6-2 to 6-7, 7-2, 10-2. Because the above-mentioned portions, behind hyphens, become the intermediate level segments. However, the Third Process is a process for changing only the segments of the language. And the segment of the language exists at the top segment of the name. Because the above-mentioned portion in front of hyphens becomes the highest level segment. Therefore, the Third Process changes only the setting region 84 of FIG. 6C. Therefore, whatever the intermediate level segments have the variety such as <bis> <ter>, they are not included in the top segment which is generated in the Third Process.

### 12.20.02: Copying the Lower Level Regions of Names

This is a result of making changes to the parts of the highest level regions only. (the setting regions 84 in FIG. 6C.) :<1F>: <2E>: <3C>: <4J>: <5G>: <6R>: <7S>: The intermediate level regions (the setting regions 88 in FIG. 6C) where there are segments containing bis, ter, quarter, and so forth subsequent to Articles receive their outcomes of intermediate products as copied in another file. Here, the intermediate product refers to each row of FIG. 6E. That is, each verbatim generated in the Third Process is considered as an intermediate product. This is because, at the head of names, there is the highest level regions, and one-round through those highest level regions is completed and their outcomes are similarly copied onto each of the lower level regions including the intermediate level regions. As a result, the variety at the time of starting one-round has been directly reproduced. The reproducing processing includes the variety, such as <bis> <ter>. The scheme for completing one round through the highest levels of names (12.25) as will be described below has this effect. In the case of architectural drawings in FIG. 28, distinctive names like kinds of drawings are entered into the lower level regions (the setting regions 82 in FIG. 6A and FIG. 6C), instead of numbers. Accordingly, in this case, multiplicative production of 2-fold, 4-fold, and 8-fold in the Second Process cannot be performed. However, in any case, if the highest levels of the names are composed of numbers and symbols (e.g, <1F>: <2E>: <3C>: <4J>: <5G>: <6R>: <7S>), measures can be taken by using the scheme for completing one-round through the highest level segments of the names.

### 12.20.03: Scheme for Completing One-Round Through the Intermediate Levels of Names

Therefore, further, the applicant would like to consider again, the scheme for completing one-round through the highest level region. In other words, why completing one-round through the regions must be executed at the highest level? Because a scheme for completing one-round, through the intermediate region of the name, seems to be acceptable. After rearrangement of architectural drawings, an embodiment to further add new highest levels to the forward was employed. If so, a method for completing one-round through the intermediate levels (the setting region 88 in FIG. 6C) may be employed. In this case, at first, completing one-round only through the intermediate levels (the setting region 88 in FIG. 6C). Next, at last, complete one-round through the highest levels (the setting region 84 in FIG. 6C) while retaining the segments of the names via the intermediate level.

### 12.20.04: Scheme for Completing One Round Through Names

In that case, completing the first one-round through the intermediate levels will be the same in terms of effect as completing one-round through the highest levels in terms of effect. In other words, when completing one-round through the lower level regions (the setting region 86 and the setting region 87 in FIG. 6C), these files are generated. Next, these files are further combined into one file, then completing one-round through the highest level regions. This combination creates double jumping in the one file. The double jumping in large and small scales is enabled. Thus, it could be called a scheme for completing one-round through the higher level segments of names. This time, the setting region 88 in FIG. 34B will be used. Like <2#>. Then, the intermediate level segment will be used to classify specific Treaties from a certain point of view and make them be interlinked with each other by jumping. In the case of a legal text, it is possible to classify into the content, for example: Definition, Requirement, Purpose, Effect, and so on. Thereby, readers can go to and back from various contents by virtue of hyperlinks.

### 12.20.05: Setting Regions that are all Identically Arranged

In another case, completing one-round through names will be considered again. Hyperlinks in a verbatim of the setting region 4 in FIG. 1 are automatically created. When one-round through names is completed, all names are enabled to jump. At this time, as illustrated in FIG. 8, one-round through names are written. Then, the apparent names become like FIG. 6E. However, is it required to drop-off the hyperlink of interest in order to establish jumping? The apparent names could be identically arranged without deleting the hyperlinks that do not jump? This is because there is the need to display always the apparent names of the hyperlinks, and it is better to identically arrange the apparent names even when the hyperlinks do not jump.

### 12.20.06: To be Identical to Substantially Completing One-Round

However, if separate files are created without evacuations, then when the names of anchors are replaced, the hidden names of the hyperlinks become identical to the names of the anchors one after another. In other words, each time of transition, the highest level regions of the names are replaced one after another, and all becomes identical to each other. In the hyperlinks group of FIG. 1, the last line of FIG. 6E will all become like -->S -->S -->S -->S -->S -->S, and such jumping that covers all diagonal lines becomes unable to be generated. In this case, -->S -->S -->S -->S -->S -->S are apparent looks, but here, it is desired to regard them as an image that concisely represents the hidden names by the apparent names.

### 12.20.07: To be Identical to Substantially Completing One-Round

Thus, even when replacing the names of anchors from XML, then replacing the only names of the anchors, it is also similarly required to evacuate the hidden names of the hyperlinks in the setting regions in advance. Furthermore, regarding the apparent names that do not jump, some display to confirm jumping that does not work will be needed.

### 12.21: Significance of Names of Anchors being Different from Each Other

FIG. 6E illustrates a collection of replacements of apparent names to be performed through the Third Process with respect to the international multi-language convention. When arrayed at one region in this manner, users will be aware that hyperlinks with several similar forms are present on different lines in multiple ways. However, respective hyperlinks are sciences having different anchors. At this time, anchors (right end in FIG. 6E) are tools to be placed in content which is end-points. Therefore, changing the names of the anchors in the Third Process results in that they have been adapted to the changes of the content. By these changes, it is possible to cope with the changes of the destination content.

### 12.21.01: Significance of the Lower Level Regions of Names being Common with Each Other

Furthermore, in the Third Process, only the highest level regions (the setting regions 81 in FIG. 6A and FIG. 6C) of the names of both hyperlinks and anchors have been replaced. From FIG. 46 through FIG. 61 which are detailed drawings for replacement, replacement of segments can be seen. By this replacement, the regions lower than the intermediate level regions (the setting region 82 in FIG. 6A, the setting region 82 and the setting region 88 in FIG. 6C) of the names lower than columns to be replaced are created by copying. Therefore, <.2#..01.01> and the like on the second line onwards in FIG. 34B are saved all identically in different files to be created each time of transition. Further, although the names of the anchors cannot be read from FIG. 34B, the names are <.1F.2#..01.01> (FIG. 34C). In short, all the names belonging to verbatim (the setting region 5 in FIG. 1 and the anchor A) are all identical names in their lower level regions. These are combined, finally. In other words, replacements of the highest level regions of names in the Third Process is a method for replacing and creating the names of the anchors and hyperlinks so as to correspond to each other, in order to replenish the missing parts of jumps. Then, finally, jumping is established by combining the anchors and hyperlinks. Because combining means draw diagonal lines of those different mounts (See FIG. 115H).

### 12.21.02: Functions of Hyperlinks

In brief, when the starting points of jumping sources are mounted of another file, hyperlinks will perform other works. Even if the names of the hyperlinks are the same. In other words, the traveling directions of dynamical vectors are the same. However, the hyperlinks act as other hyperlinks, as in each FIG. 115A to FIG. 115G. Those distributed figures have the same name but being mounts of another file. There figure suggests, those hyperlinks have another address. It is the address of the anchor. Therefore, different lines can draw. In this case, the starting points of travel differ from each other in every FIG. 115A. Thus, respective hyperlink groups in FIG. 6E will be understandable. And those final combinations make cross references real (See FIG. 115H). But it might be difficult to understand since the position of the anchor A in FIG. 1 is written at the right end. It might be easier to understand when imagining that the anchor A in FIG. 1 is positioned further left of the abstract link. This is because it might be easier to call in mind the figure of the hyperlink that jumps from the position. And FIG. 6E and FIG. 115A to 115I will be certification of cross reference for this invention.

### 12.22: Directions of Transitions of Anchors.) (Note. Abbreviation FIG. 166)

Again, call in memory of David's star. At this time point, consider that there are content in the languages of interest at all angles. Consider that one angle is taken as self-angle, and angles other than self-angle be taken as other-angles. You may remember that a task for changing an anchor name of self-angle of the language of interest to an anchor name of adjacent another angle (hereinafter, referred to as “adjacent angle”) will be the changes of positions of the Stars of David. When moving to the adjacent angle, anchors will move by increasing the numbers. Like: <.1F.>: <.2E>: <.3C.>: <.4J.>: <.5G.>: <.6R.>: <.7S.>: in accordance with the naming rule.

### 12.22.01: Directions of Replacements of Hyperlinks

When writing separately in several ways, it will be like the next style. When an anchor moves to a new adjacent angle, a task to delete the hyperlink occurs. Because the hyperlink jumps to the same corner on the same page. In this case, delete the name which will become the name of this adjacent angle, because it will be no worthwhile jumping to the same page. In FIG. 17A, segments are shown in step 25 as added with a single quotation mark, but the same segments disappeared in the step S30. In other words, since there is no meaning even when jumping to an anchor on the same page, the same segment will be deleted. Secondly, there comes a task for additionally writing a hyperlink name of which the adjacent angle must perform a jumping function in that portion. For this purpose, at the right side of an arrow in steps 30 in FIG. 17A, a segment part was changed. In other words, it was replaced with the segment that must perform the jumping function. The task needs to be broken down into the above two parts. For example, in (9.01 Drawings illustrating processing), replacements of the apparent names have been described. When replacing the highest level regions of the hidden names in that occasion, description in (9.18.01 Replace hidden names of links to return), will become as follows: the link 1 (<.2E.> --> <.1F.>): the link 2 (<.3C.> --> <.2E.>): the link 3 (<.4J.> --> <.3C.>): the link 4 (<.5G.> --> <.4J.>): the link 5 (<.6R.> --> <.5G.>): the link 6 (<.7S.> --> <.6R.>) (see FIG. 6E).

### 12.22.02: Directions of Rearrangement of the Both Become Opposite to Each Other

The highest level regions of the hidden names of anchors obtain new names with increasing numbers like: <2>:<3>:<4>:<5>:<6>:<7>:. In that case, jumping from the hyperlinks into the same mount will be worthless. Because those hyperlinks jump to the same verbatim zone. It means jumping to the same page. Delete unnecessary jumps. However, those hyperlinks are restored when the hidden names of the anchors obtain new names. They appear one after another on the same lines of the same page. Regarding this, the above-described hyperlinks will be excluded from the hyperlinks. However, it could be considered that, if the numbers affixed to the anchor's increase, then causing the hyperlinks previously excluded to be restored in order to work at the time of final combination at a later stage. Accordingly, in this case, the names will be replenished with names one younger than the increased anchor names. The names may be considered to be: <1>:<2>:<3>:<4>:<5>:<6>. (See FIG. 115A to FIG. 115H.)

### 12.22.03: Deletion and Restoration of Hyperlinks

In short, as anchors are transitioned in such a manner that their character numbers are increased in increments by one, the names of hyperlinks perform replenishment to return to one preceding to the names of the anchors. That is, both the apparent names and the hidden names are performed similarly. For this reason, restoration may be better than wording (See FIG. 44).

### 12.22.04: Reconstruction of Hyperlinks as Seen from FIG. 6E

This may be read as below. The names of the anchors at right end in FIG. 6E increase from the first line to the seventh line as follow. <1>:<2>:<3>:<4>:<5>:<6>:<7>. Hyperlinks with the same names that can not execute a valid jumping function will be generated. Thereafter, the hyperlinks will be deleted from verbatim from the same lines. And as the line of going down stair shifts to the right one by one, hyperlinks which have become able to perform jumping function will be additionally written (reconstructed) on the left side thereof.

### 12.23: Covering all Diagonal Lines

Then, the above-described excluding and adding tasks are performed continuously. Transitions will be performed so as to cover two times of the number of all diagonal lines and two times of the number of outer circumferential sides. Repeating the changes until just before completing one-round through the angles of a star one after another. At this time, when FIG. 19C is changed to FIG. 19D, the processing is not only removing apostrophes but also “'F” in FIG. 19A of the apparent name of the abstract link is replaced with “E” in FIG. 19B. Also,“'E” in FIG. 19A of the apparent name of the link 6 is replaced with “F”. Furthermore, <'F> in FIG. 19C of the hidden name of the abstract link is replaced with <E> of FIG. 19D. Also, <'E> in FIG. 19C of the hidden name of the link 6 is replaced with <F> in FIG. 19D (See FIG. 63). If this processing is performed in sequence, the number of links and anchors belonging to verbatim other than the abstract link present in FIG. 6E remains to be seven in each line and remains to be seven lines. Therefore, FIG. 6E indicates covering all diagonal lines (a total of 42 of N(N−1)) and all self-angles (a total number of 7 of anchors). (See FIG. 115H)

### 12.24.01: Final Combination on Different Mounts

By the way, what will happen if different files are combined in the order from the top line to the bottom line of FIG. 6E? Diagrams from FIG. 36A to FIG. 36G show the addition of each line of FIG. 6E. Then, the last FIG. 36G shows that jumping can be executed between all the setting regions.

### 12.24.02: Printing and Publication Division of the United Nations

Why could we not create a returnable jump covering the setting regions like the present invention? One of the reasons was a problem with the multilingual site side which becomes a foundation for the application. For example, the United Nations' printing and publishing division states that it has copyrights of the International Treaties that are deposited contents and furthermore states that the UN's permission is required for the use of the contents.

### 12.24.03: Name

It is assumed that a name is not a name unless there is personality. For example, there is a person named Ichiro among Japanese people. The meaning of Japanese Ichiro is a child who was born first. That is the meaning of his name. But, a name beginning with a number is not a name. A name that starts with a number is prohibited as the name of an anchor. This is the policy of W3C which created the Internet. And, the name which has no personality is called ID. On the other hand, since the ID is a numerical value, it can be used as very convenient XML DB that can be freely replaced and used. However, these ID did not jump. Because it was only sufficient that ID could be useful information as Database.

### 12.24.04: Default Setting of Conventional Software

MSWord is a representative basic software that dominates the world market. The inventor would like to explain the traditional software environment based on this product. In this MSWord, there are many default settings for the purpose of uses by many people. Those defaults are decided in order to sell the product to many people. For example, when Word's AutoCorrect function works, despite unintentional changes of the names of anchors or hyperlinks may be performed in some cases. In addition, Word has specifications that the automatic preservation function works within a certain time. Perhaps, it is 10 minutes by default. Under this situation, simultaneously with the moment when data is preserved manually, an operation of causing anchors to perform automatic preservation function occurs. In other words, two kinds of commands that should not be executed simultaneously may be executed simultaneously in some cases. At that time, it happens that the previously arranged anchors may sometimes be moved to and stored at an unintended position. In this case, lots of anchors move. For example, the DVD which the applicant submitted to the USPTO on Oct. 4, 2016 is a sample in which anchor positions were shifted by double save. In this case, it is impossible to restore the anchors to the previously placed position when considering its time and labor. Like this example, MS Word gives priority to finding mistakes or not losing written documents, rather than inserting the hyperlinks. Furthermore, as shown in FIG. 3B, the MS Word is a specification that cannot be associated with the hyperlinks in the order of the location as shown in FIG. 3A even though the anchors could be attached in the location order. If you try to change the extension of the docx as shown in FIG. 13 in order to avoid this Word specification, a warning will be displayed.

### 12.24.05: Proportional Increase of Hyperlinks and Anchors

Comparing the conventional technique to the human body. The prior art was only a technique to arrange hyperlinks corresponding to various nerves in the muscles. Also, the prior art merely joined specific parts of different muscles with hyperlinks. However, in the present application, it directly processed xml in the document state. In the present invention, the constant ratio between hyperlinks and anchors was always maintained so that the both are increased. As a result, the round trip of the jump is guaranteed. Thus, it became possible to increase the skeletons separately from the muscles. If names of the skeletons are replaced and combined, the content corresponding to the muscles are compared with each other for each unit. The prior art only enabled jumping in one direction to a part of the muscles. On the other hand, this application enables creating a link between the skeletons. If the names of hyperlinks and anchors are replaced with other ones as in this application, it is possible to create a link between the skeletons.

### 12.24.06: Rational Judgment on Increase of the Number of Diagonal Lines

Incidentally, the first line of FIG. 6E is specifically shown in FIG. 34A to FIG. 34C including a representative drawing in the present application. The representative drawing is not a selected drawing in the application disclosure by the USPTO. The representative drawings are FIG. 34A to FIG. 34C. These are selected by the applicant of this application. Based on this, respective lines of FIG. 6E are widely described in seven pages in total, from FIG. 37A to FIG. 43C. These diagrams also specifically show the generation method already embodied in FIG. 17A, FIG. 17B and FIG. 17C. However, as the number of diagonal lines increases as much as 42, it is difficult to figure out the image of the diagonal lines.

### 12.24.07: Unexpectedly Few Changed Parts. From FIG. 37A to FIG. 43C

But let's see the complexity again. Let's look at the diagrams in FIG. 37A to FIG. 43C. There are very few differences, among these diagrams. Only several segments are changed. In those figures, several segments are surrounded by squares. Perhaps those figures are helpful to understand the FIG. 17A. Those diagrams show the characteristics of the hyperlinks. It means that there is no need to draw straight lines for the hyperlinks to establish jumping. That is, if the hyperlinks with the same names are placed on different mounts, then it produces the start points. Differently mounting hyperlinks correspond to the starting points of the respective line segments. Also, the names of the anchors correspond to the endpoints of the line segments. And if those hyperlink names and anchor names are in the same file through the final combination, it is equal to the connection line drawn. In other words, hyperlinks are saved after copying them to a separate sheet. However, they are placed on different mounts. This means that respective hyperlinks having different starting places. Therefore, combining the electronic files is equal to make the state where the line is drawn by the ruler. Therefore, it functions as another line segment.

### 12.24.08: Replacement of Changed Parts

The diagrams from FIG. 47 to FIG. 63 show replacements of the changed parts. These diagrams help make users to easily understand FIG. 16 to FIG. 17C. Users can understand more easily the Third Process to the Fourth Process from the overview of these drawings. Further, FIG. 64A to FIG. 64G show how the addition of respective lines of FIG. 6E is related to other diagrams. In this case, FIG. 64A to FIG. 64G corresponds to FIG. 36A to FIG. 36G. If these are organized, then it becomes FIG. 65. FIG. 65 is almost the same as the FIG. 6E.

### 12.24.09: Change with Lower Level Regions

At the position of FIG. 34C, the name of the anchor is described. In the tables of FIG. 35A and FIG. 35B those names are written. At the position of the first line of FIG. 34B, the name of the abstract link to the table link is described. In the tables of FIG. 35A and FIG. 35B those names are written. However, even if you read these tables, it will be difficult to understand the composition as well. Although, when this is reproduced, the drawings of FIG. 66A to FIG. 114C are obtained. In FIG. 35A and FIG. 35B, the English name E is laid in the highest level region. And FIG. 37A is same as FIG. 34A. FIG. 37B is same as FIG. 34B. FIG. 37C is the same as FIG. 34C. These FIGS. 37A, 37B, 37C are modified and reproduced into FIGS. 38A, 38B, 38C. This FIG. 34C is only for 01.01 for French. FIG. 37A to FIG. 37C also have lower level segment regions as shown in FIG. 66A to FIG. 114C, and it is to be understood that these same lower level segment regions are copied while including these lower level segment regions. This is because these segments are lower level segments than “replace-all” segments. Replace segments are written in FIG. 49, FIG. 54, FIG. 58.

### 12.25: Covering all Diagonal Lines while Moving Through Adjacent Angles

Therefore, changes at that time will add the same number of names which have just previously changed, one after another, in such a way as 1 for the first time. 1+1 is the second time. 1+1+1 is the third time. 1+1+1+1 is the fourth time. Therefore, after the first line in FIG. 6E, the second line to the seventh line are added increasingly. So to speak, numbers will increase in such a way as 1+1+1+1+1+1+1. At this time, links for seven languages will be completed by performing six times of repetitions of changes on initial completed portion (From now on, changes of the names performed through the Third Process will be referred to as “Scheme for completing one-round through the highest levels of names”). These are shown in FIG. 115A to 115H.

### 12.26: Setting Regions which can be Comprehensively Referred to

Until now, international treaties among multiple countries in multiple languages have been conventionally handled by displaying on screens divided into left and right parts. However, transitions through the scheme for completing one-round through the highest levels of names which the name changing unit performs to create, the setting regions of independent sciences, which can make comprehensive reference, can be automatically generated. That is, in this case, jumping for comprehensive reference from any given content of interest to all other given content can be executed, and jumping from any given content at jump destinations, which has been compared, to reference source content can be returned. For this reason, from now on, international treaties among multiple countries in multiple languages can be handled by going to and from content in other languages with one screen as it is, by comprehensive references by the help of hyperlinks and anchors. In particular, in the case of smartphones in recent year, the need will be increased since display area of their screens is very small.

### 12.27: Setting Regions that Allow for Stable Line of Sight

At that time, the new science is automatically generated in the setting region while transitioning to change the anchor in the science region according to the naming rule, the hyperlinks in the science region according to the order rule. Changing wrote from FIG. 46 to FIG. 61. Therefore, the scheme will have the effect that the setting regions of the hyperlinks and anchors that allow for stable line of sight for comparing the content can be created.

### 12.30: Hardware Operation Suitable for Huge Electronic Files

With the above First to Third Processes, it becomes possible to create complicated hyperlinks than manual operation more dramatically quickly. However, when it comes to organizing multinational treaties or conventions regarding almost all patents in multi-languages as they are in one file. Then, in such a manner that the Regulations under the PCT are assigned to <2#> present just below the highest level, and EPC Rules are assigned like <7#>, tens of thousands of anchors and hundreds of thousands of hyperlinks must be provided in one file. However, when the layouts of hyperlinks and anchors are already combined in one file from the beginning, then the hyperlinks jump to Articles as usual. In this case, the PC attempts to manage the hyperlinks and anchors sequentially by attaching ID numbers. Therefore, data expansion to the RAM will be slow. PC side has become unable to follow a speed of manual operation. What should be done to avoid such a situation, and to create a large-scale organic structured electronic file?

### 12.31: Value of Later Placement of Anchors

Again, it would be necessary to consider once again that if the names of the hyperlinks match the names of the anchors, the hyperlinks jump. Since the anchors are laid first, the movement of the PC becomes dull. If that is the case, add the same names of anchors later. In that case, word processor software like MS Word never carefully gives any advice on the wording “What combine with”. When the anchors are few, it is polite, but as the anchors are too many, each one advice becomes rather annoyances.

### 12.40: Merits of Final Combining Scheme

Prior to the final combination, complete hyperlinks such as inside links for each language. After that, combine with other languages files. Moreover, the files are required to be joined at one time. Once the seven files become one, then hyperlinks jump to the destinations. In this final combination method, even if mistaken the setting of the hyperlink to anchor during its creation, it will not cause to jump to the another language file. Such mistake is a fatal mistake. This fatal mistake means that jumping causes confusion of thought. That is, in the final combining method, it is possible to generate a link to be applied without affecting mutually different languages. Also, by combining the files at the end, it is possible to considerably reduce the time for the PC to delay the processing of the generation of the electronic files.

### 12.50: Unique Names

Conventionally, when performing changes of names, operations for changing the designated positions of column counted from the head of a page, head of a line, or head of target character were the mainstream. However, in the present patent application, a method of operation differs. There is no designation of the column of changing portions. To attain the object, unique names were devised. The operation of the names was enabled by use of 2-byte characters, or by use of growth points, or by being composed of short segments. In this case, replace the names by “replace-all” operation. The effects include the ability to get around the congested XML syntax without troubles or difficulties. The algorithm itself to get around XML and to bring about the birth of new names is original and novel too.

### 12.60: Replacements of the Higher Levels of Names

In the specification so far, description has been provided entirely as replacements of the highest level regions of names. However, an embodiment (5.52) of replacing the intermediate level regions of names is described, by way of an example (12.21.04, 12.30 in a basic application that serves as a basis for a priority right, FIG. 6C in drawings) of combining different treaties or conventions. That is, a file is created that uses the highest level namespaces to generate one round and uses one of the intermediate level namespaces to generate all the treaties or rules for different patents. In this case, each treaty is hyperlinked, subdivided like a definition, requirement, purpose, and effect. This is because, when finally combining different names respectively in which segments of the higher levels of respective names have been replaced. Then, the names when combined coincide with each other and jumping is performed, by use of the principle of combining the names in which segments of the names are identically copied respectively onto the lower level. Therefore, it is not a requirement to be always the highest level. Thus, this will be newly referred to as a “scheme for completing one-round through the higher level of names”.

### 13.00: The Fourth Process

In the present application, description has been provided by dividing the processing into three processes. However, there is an additional process of combining different files into one file upon the completion of the above-discussed three processes. This process is called the “Fourth Process”. The feature of the Fourth Process is that each time files are combined in the ascending order of the character codes of names of anchors in accordance with the naming rule, the number of jump destinations increases. For example, when two different files are combined, two jump destinations are established, and the total number of jump targets can be calculated by 2(2−1). This means that assuming that N stands for the number of files, and N files are combined, the total number of jump destinations, which one science or one verbatim provides, can be calculated based on the formula of N(N−1). Respective FIG. 64A to FIG. 64G and FIG. 115A to FIG. 115G show N(N−1) in detail. Thus, when 64 files are combined, for example, in a case shown in FIG. 32, the total number of the jump destinations, which one science or one verbatim provides, can be calculated by 64(64−1). This means that 4032 jump destinations will be established as a result of combining the 64 files for each science or verbatim. According to the present embodiment, as shown in FIG. 32, an enormous number of 4032 links can be established among 64 files (See FIG. 118).

### 13.00.10: Starting Vertex and Ending Vertex of Diagonal Line to be Automatically Copied

However, in the world of hyperlinks, there is one characteristic that, if the names are the same, jumping is established without forcibly drawing a line segment. Also, there is another characteristic that the replacements of the names in the Third Process shown by the dotted lines in the drawing of FIG. 6E is performed only on a verbatim or a part of science. Details of replacement parts are shown in FIG. 37A to FIG. 43C. And every replacement ideas are combined into one sheet; it becomes the image of FIG. 44.

### 13.00.20: Automatically Copied Hyperlinks

That is, in FIG. 6E, after the first one science has been created, six transitions are conducted. FIG. 115A to FIG. 115J describes its transition and effects to all the lower replaced segments are combined. Therefore, once the first one of 64 sciences has been created, jumps that correspond to all diagonal lines including two neighboring sides on every vertex will be covered by simply performing 63 times, the Third Process. See FIG. 45 and FIG. 118.

### 13.00.30: Diagonal Line Example Including a Large Number of Adjacent Edges

A line segment is drawn by connecting the coordinates between two points. Therefore, when the coordinates between two points are present on different mounts, the line segment cannot be formed only by merging these different mounts. In order to establish the line segment, further action of drawing a straight line is required. But, in the hyperlinked world, if the hyperlink coordinate value and the anchor coordinate value match as the name, it jumps automatically. If so, even when merging the mounts at the end, jumping will occur automatically if the names coincide with each other. If that is the case, further move the vertex to make one-round as it goes around the vertex of the diagonal line including one adjacent side. Finally, by combining all the figures, the coordinates covering all vertices of the polygon are created. In that case, if the coordinates covering all vertices are created, then all jumps of N (Z−1) will be possible (See FIG. 115A to FIG. 115G again).

### 13.40: Other Embodiments

The invention allows various kinds of embodiments to be implemented. According to the present invention, the user can easily review and compare the content in details while before and after of the jumping because the user's visual line is stable. For example, according to the present invention, error values transmitted from a specular reflection target for error measurement added to a prototype antenna of a telescope can be managed in unit of names with respect to names for each reflection target. In this case, higher level segments are assigned to specular targets and the lower level segments of the names are assigned to time axis where error measurements are stored or listed. In some cases, multiple targets, for example, 256 reflection targets can be managed. Even if the data of the reflection targets, is transferred to the relational DB and processed by the supercomputer, the data is simply divided for each target and the measurement results are saved by CSV (Comma Separated Value). On the other hand, according to the present invention, the measurement results are saved in an XML format in which the specular reflection targets and error measurement values can be compared with each other by looking into carefully. Therefore, comparative reference can be made from various points of view. Also, it can be recorded as character information consisting of long sentences.

### 13.50: Implementing onto Measuring Instruments

Furthermore, according to the present invention, regardless of applications, all measurement results can be preserved and referred to so as to cover all measurement results. At that time, since the principle is simply such that names are arrayed in the Order (character code order) in accordance with the naming rule, and a plurality of files are combined in the name order (character code order) of anchors, it is possible to produce software of new measuring instruments. Like examples of architectural drawings, the name system can be replaced by a plurality of anchors and can be also verified from a plurality of points of view.

### 13.53: Save Style with High Effect Per Time Processing

If a company's manual is also changed to the DB method of the present method which can cross-reference descriptions like the above-mentioned law books, it is easy to refer to relations which are far away from one another. In addition, customers can copy parts and prepare a report document in a short time. In addition, tools of programming software will accelerate the completion by arranging the data to the circulation. In the case, it becomes possible to extract and assemble the content of the basic type quickly as a toolbox of programming software.

### 13.60: Implementing on document.htm

Furthermore, the present specification has been described as document xml, but it is possible to implement hyperlinks and anchors on the whole regions where they are handled. Therefore it became possible to implement the hyperlinks and the anchors which consist of document.html.

### 13.70: About Hyperlinks Group that Indicates that there is a Hyperlink that Signifies Contents. A Hyperlink that Means Content Exists on the Surface. That Means, not Dropping Off. See, Equal Part of FIG. 125

As an Example of the present application, a commentary was mainly made in the case where there is a drop-off of interest or attention. However, there is no abstract link, there is no drop-off of interest or attention but the link may remain as it is in a verbatim. In this case, steps S22, S24, S27, and S29 for the table of contents link in the embodiments of FIG. 16, FIG. 17A, FIG. 17B, and FIG. 17C are unnecessary. And steps S23 and S28 of the apparent name processing to be performed for the drop-off of interest or attention are unnecessary. And it is necessary to perform the remaining three steps of S25, S26, and S30. The step S25 is in order to replace only the anchor's names. In other words, it is necessary to manage the environment so that only the anchor parts are subject to changes of the names of processing in the case of simultaneously knocking down every detail content including the hyperlinks and anchors from document xml in S26. Then, after changing the names of the anchors, it is sufficient to exclude <′> in the same manner as in S30. However, it is easier than S30 because there is no drop-off of interest or attention, and no restorations are necessary, and therefore it is only necessary to simply remove <′> from the hyperlinks. Thus, once the transitions of the anchors which have replaced their upper levels of the names have been completed in verbatim, it is only necessary to perform the final combination.

### 14.00: Diagonal Line Example Including a Large Number of Adjacent Edges

The invention is easy to understand the part that last combines generated electronic files. Therefore, in the following, the last combining part of the present invention will be explained using each of the three aspects in the seven combining drawings. That is, it is the fourth and final process of the present invention. If there is no final combining, explain how jump are established each time electronic files are uploaded to the web. If there is final combining, explain how jump are established as the bond increases in one electronic file. However, in that case, it need to remember to create that there are many line segments instead of two.

If the fourth process of effect is not described in Figures, it is difficult to understand what the first to third processes are for. Therefore the explanatory drawings for the combination of seven different anchors, so the number of drawings is seven each. So those becomes from FIG. 119A to FIG. 121G. It means 7*3=21 paper.

In a specification, there is an idea that only the generation method should be described, not the effect of the invention, and in response to this idea, those drawings had not been described. And the final combinings complete in a very short time.

### That is,

### 14.01: About formula

To explain using the formula for calculating the number of diagonal lines of a polygon:
1. The diagonal lines only occur in polygons exceeding triangles
2. Two hyperlinks that can go back and forth between the two information areas are condensed into one diagonal line and expressed.
3. One-way traffic does not exchange information.
4. Furthermore, since the diagonal line occur only in the polygons exceeding the triangle, therefore 3 was subtracted.
5. Therefore, the number of round trips of information is expressed by the following formula.

### Diagonal Lines of a Polygon

x=N(N−3)/2

Contrary to the above,
1. Information traffic divided into two, come and go, jumps of the hyperlinks.
2. Hyperlinks are counted by the number of jumps, therefore it does not divided by two.
3. If the hyperlink is captured for the purpose of performing information transition, it needs to remove jumping to the same file. So subtract one. See gray in FIG. 125. This is because a jump of the same file makes no information transition.
4. Therefore, the number to be subtracted is expressed by the following formula.

### Hyperlink Lines for Information Transition

x=N(N−1)

### 14.119A.1: about FIG. 119A

The reason of why the heptagon is described in FIG. 119A is that seven different electronic files have been created in the explanation of the third process in FIGS. 37A to 42C. However, there are two types of the fourth process. The first type make many jumps may be made within one electronic file by finally combining different electronic files into one. The second type jumps between different electronic files, such as drawings starting with FIG. 161A or FIG. 162A, without combining the electronic files. When not binding finally, it means jumping to each other separate html file. Here, as the order of explanation, the case of the final combining according to the flow up to now will be explained first with reference to FIGS. 119A to 121G.

### 14.119B about FIG. 119B

In FIG. 119B, a hyperlink is already set up to jumps between “1F” and “2E”. In this case, “F” that implies French is connected to “1” which has the youngest character code. Then, character code “2” comes next to “1” in ascending order, and “E” that implies English is connected to “2”. In this case, 2 (2−1)=2 jumps are required to exchange information to go back and forth from each other. This minus one is excludes jumping with respect to itself. For example, the equal jump of FIG. 125. This is because there is no information round trip.

It should be understood that in FIGS. 119B to 119G, when one line segment exists, information can be cross-reference so that it is mutually jumped. In the case of FIG. 119B, there is a line segment therefore there are two hyperlinks by which information reciprocates between 1F and 2E. In addition, it is necessary to consider that there are lower segments described numerically in the place. In FIG. 119B, the amount of information round trip is 1.

### 14.119C about FIG. 119C

In FIG. 119C, hyperlinks are already set up to jumps among “1F”, “2E”, and “3C” [character code “3” comes next to “2” in ascending order, and “C” that implies Chinese is connected to “3” ]. In this case, 3 (3−1)=6 jumps are required to exchange information to go back and forth from each other.

In FIG. 119C, the connection by one round is completed up to the position of 3C. In this case, the jump increases not only between the newly added B and C, but also between the existing A. That is, the amount of information round trip is not 1+1 but 1+“2”=3.

### 14.119D about FIG. 119D

In FIG. 119D, hyperlinks are already set up to jumps among “1F”, “2E”, “3C” and “4J”. [character code “4” comes next to “3” such that the character codes are arranged in ascending order, and “J” which implies Japanese is connected to “4”.]. In this case, 4 (4−1)=12 jumps are required to exchange information to go back and forth from each other.

In FIG. 119D, the connection by one round is completed up to the position of 4J. In this case, the jump increases not only between the newly added 3C and 4J, but also between the existing 1F and 2E. In other words, there are three increases in jumps to the existing ones. That is, the amount of information round trip is not 1+1+1=3 but 1+2+“3”=6.

### 14.119E about FIG. 119E

In FIG. 119E, jump by hyperlink is already set up among “1F”, “2E” “3C”, “4J” and “5D”. The “5” is added such that the character codes are arranged in ascending order, and “D” implying German is connected to “5”. In this case, 5 (5−1)=20 jumps are required to exchange information to go back and forth from each other.

In FIG. 119E, the connection by one round is completed up to the position of 5D. In this case, jumps increase not only between the newly added 4J and 5D, but also between the existing F, E, and C. In other words, there are now four jumps increasing to the existing corner. That is, the amount of information round trip is not 1+1+1+1=4, but 1+2+3+“4”=10.

### 14.119F about FIG. 119F

In FIG. 119F, hyperlinks are already set up jump among “1F”, “2E”, “3C”, “4J”, “5D” and “6R”. The “6” is added such that the character codes are arranged up in ascending order, and “R” that implies Russian is connected to “6”. In this case, 6 (6−1)=30 jumps are required to exchange information to go back and forth from each other.

In FIG. 119F, the connection by one round is completed up to the position of 6R. In this case, jumps increase not only between the newly added 5D and 6R but also between the existing F, E, C and J. In other words, there are now five jumps increasing to the existing corner. The amount of information round trip is not 1+1+1+1+1=5, but 1+2+3+4+“5”=15.

### 14.119G about FIG. 119G

In FIG. 119G, hyperlinks are already set up to jumps among “1F”, “2E”, “3C”, “4J”, “5D”, “6R” and “7S”. The “7” is added such that the character codes are arranged in ascending order, and “S” which implies Spanish is added to “7”. In this case, 7 (7−1)=42 jumps are required to exchange information to go back and forth from each other. The state at this time is the same as in FIG. 115H.

In FIG. 119G, all corners jump to all other corners. In this case, the jump increases not only between the newly added 6R and 7S, but also between the existing F, E, C, J, D and R. In other words, this time, the jump increase to the existing corner becomes six. The amount of information round trip is not 1+1+1+1+1+1=6 but becomes 1+2+3+4+5+“6”=21. As described above, it can be seen that the number of increases accompanying the transition increases one by one. These numbers are described by addition formulas in the lower part of the drawing. If the cross-reference is replaced by the hyperlinks, the number is doubled to 7(7−1)=42. This is because hyperlinks only perform a one-way jump in the direction of the anchor.

### 14.120. How to Program

By the way, the computer world consists of addresses, and when information is processed through software, information processing is performed on the address space in ascending order of character codes as shown in FIG. 3A and FIG. 3B. This is because people have been accustomed to processing numerical values by learning addition since elementary school, so the same idea was reflected in the program. Therefore, programming in the same manner as that flow leads to intelligent correction of information processing errors in the software program.

### 14.120A about FIG. 120A

FIG. 120A looks at FIG. 119A from another perspective. FIG. 120A has two heptagonal shapes. But, as shown in FIG. 120A, each two heptagonal is before the jump is created. However, in the case of the United Nations Convention on the Law of the Sea, there are 320 heptagonal shapes. It means all line segments of from Article 1 to Article 320.

FIG. 120A is a diagram which considers FIG. 119E from another viewpoint. From this viewpoint, it can be seen that the lower region of the name of the hyperlink or anchor has a different area called Article 1 or Article 2 at the right end of the drawing. Although omitted from Article 3, the existence of the final content Article is indicated in the lower right of the drawing.

### 14.120B about FIG. 120B

FIG. 120B looks at FIG. 119B from another perspective. FIG. 120B has two line shapes. In FIG. 120B, hyperlinks are only set up to jumps within each “1F” and “2E” of each shape. It is also written that two jumps are necessary to exchange information between the contents of Article Circle 1 (Article 1) in French “1F” and English “2E”. It means 2*(2-1)=2 In addition, it is written that two jumps are necessary to exchange (returnable) information between the contents of Article Circle 2 (Article 2) in French and English. It means 2*(2-1)=2 Therefore, it is written that a total of four jumps are needed to make cross-reference in bilateral direction of International Treaty with a total of two Articles in two languages.

FIG. 120B is a diagram viewed FIG. 119B from another angle. In this state, information go to and return for the verbatim part whose higher region of the anchor name is F and E. For that purpose, the information is reciprocated by doubling line segment. Further, this reciprocation must be generated so as to fill the inside of Article 1 and the inside of Article 2.

### 14.120C about FIG. 120C

FIG. 120C looks at FIG. 119C from another perspective. FIG. 120C has two triangle shapes. Hyperlinks are already set up to jumps between each 1F, 2E, and 3C of each shape. In this case, 6 jumps are needed to make information to go back and forth (returnable) among respective Article Circle 1 (Article 1) contents of these 3 materials. It means 3*(3−1)=6 Furthermore, 6 jumps are needed to make information to go back and forth (returnable) among respective Article Circle 2 (Article 2) contents. It means 3*(3-1)=6 Therefore, it is written that a total of 12 jumps are needed to make reciprocal cross-reference in three-language international treaty consisting of two articles in total.

FIG. 120C is a diagram viewed FIG. 119C from another angle. In this state, information go to and return for the verbatim part whose higher region of the anchor name is F, E and C For that purpose achieve, the information is reciprocated by doubling the outer circumference of triangle. Further, this reciprocation must be generated so as to fill the inside of Article 1 and the inside of Article 2.

### 14.120D about FIG. 120D

FIG. 120D looks at FIG. 119D from another perspective. FIG. 120D has two square shapes. Hyperlinks are already set up to jumps between each “1F”, “2E”, “3C”, and “4J” of each shape. In this case, 12 jumps are needed to make information back and forth (returnable) among respective Article Circle 1 (Article 1) contents of these 4 materials. It means 4*(4-1)=12 Furthermore, 12 jumps are needed to make information back and forth (returnable) among respective Article Circle 2 (Article 2) contents. It means 4*(4−1)=12 Therefore, it is written that a total of 24 jumps are needed to make reciprocal cross-reference in four-language international treaty consisting of two articles in total.

FIG. 120D is a diagram viewed FIG. 119D from another angle. In this state, information go to and return for the verbatim part whose higher region of the anchor name is F, E, C, and J. For that purpose achieve, the information is reciprocated by doubling the outer circumference of square. And plus by doubling diagonals. Further, this reciprocation must be generated so as to fill the inside of Article 1 and the inside of Article 2.

### 14.120E about FIG. 120E

FIG. 120E looks at FIG. 119E from another perspective. FIG. 120E has two pentagon shapes. Hyperlinks are already set up to jumps between each 1F, 2E, 3C, 4J and 5D of each shape. In this case, 20 jumps are needed to make information to go back and forth (returnable) among respective Article Circle 1 (Article 1) contents of these 5 materials. It means 5*(5−1)=20 Furthermore, 20 jumps are needed to make information to go back and forth (returnable) among respective Article Circle 2 (Article 2) contents. It means 5*(5−1)=20 Therefore, it is written that a total of 40 jumps are needed to make reciprocal cross-reference in five-language international treaty consisting of two articles in total.

FIG. 120E is a diagram viewed FIG. 119E from another angle. In this state, information go to and return for the verbatim part whose higher region of the anchor name is F, E, C, J and D. For that purpose achieve, the information is reciprocated by doubling the outer circumference of pentagon. And plus by doubling diagonals. Further, this reciprocation must be generated so as to fill the inside of Article 1 and the inside of Article 2.

### 14.120F about FIG. 120F

FIG. 120F looks at FIG. 119F from another perspective. FIG. 120F has two hexagon shapes. Hyperlinks are already set up to jumps between each “1F”, “2E”, “3C”, “4J”, “5D”, and “6R” of each shape. In this case, 30 jumps are needed to make information back and forth (returnable) among respective Article Circle 1 (Article 1) contents of these 6 materials. It means 6*5=30 Furthermore, 30 jumps are needed to make information back and forth (returnable) among respective Article Circle 2 (Article 2) contents. It means 6*5=30 Therefore, it is written that a total of 60 jumps are needed to make reciprocal cross-reference in six-language international treaty consisting of two articles in total.

FIG. 120F is a drawing viewed FIG. 119F from another angle. In this state, information go to and return for the verbatim part whose higher region of the anchor name is F, E, C, J, D, and R. For that purpose achieve, the information is reciprocated by doubling the outer circumference of hexagon. And plus by doubling diagonals. Further, this reciprocation must be generated so as to fill the inside of Article 1 and the inside of Article 2.

### 14.120G about FIG. 120G

FIG. 120G looks at FIG. 119G from another perspective. FIG. 120G has two heptagonal shapes. Hyperlinks are already set up to jumps perfectly between hyperlinks groups of each shape. In this case, 42 jumps are needed to make information back and forth (returnable) among respective Article Circle 1 (Article 1) contents of these 7 materials. It means 7*6=42 Furthermore, 42 jumps are needed to make information back and forth (returnable) among respective Article Circle 2 (Article 2) contents. It means 7*6=42 Therefore, it is written that a total of 84 jumps are needed to make reciprocal cross-reference in seven-language international treaty consisting of two articles in total. At this time, the state is the same as in FIG. 115J.

FIG. 120G is a diagram viewed FIG. 119G from another angle. In this state, information go to and return for the verbatim part whose higher region of the anchor name is F, E, C, J, D, R and S. For that purpose achieve, the information is reciprocated by doubling the outer circumference of heptagon. And plus by doubling diagonals. Further, this reciprocation must be generated so as to fill the inside of Article 1 and the inside of Article 2.

### 14.120H: Number of Hyperlinks and Anchors Required for Cross-Reference

In the same way as described above, when processing the UN Convention on the Law of the Sea from Article 1 to Article 320, the following number of hyperlinks is required. 7*(7−1)*320=13,440. In the case of automatic generation, based on this required number of replacements, it becomes possible to compare to the number of change processes for each time can be used to check whether all the processes have been completed.

At the bottom right of each of FIG. 119A to 120G, there is a description of Last Article Circle. This description is intended to address cases where there is a large number of articles (for example, the final article up to Article 320) in a multilingual international treaty. In such a case, it is written that the same principle is used. e.g, FIG. 120A to 120G.

### 14.121A about FIG. 121A

FIG. 121A is another view of FIG. 119A and FIG. 120A. In FIG. 121A, two verbatim can be seen which have the same lower names of “˜.1” and “˜.2”. And at the right end of FIG. 122A, two anchors can be seen. These two are French Article 1 (.1F. 1) and French Article 2 (.1F. 2). However, names of hyperlinks having the same names as those of these two anchors are not found in FIG. 121A. So, even when you click ---> locations in any way, you cannot jump to the anchors.

FIG. 121A is a drawing considered FIG. 119A and FIG. 120A from another angle. FIG. 121A shows the apparent and hidden names of hyperlinks and anchors. In the last line, the hidden name is described in two bytes. However, the anchor located at the right end of f-121A does not have the same name of the hyperlink, therefore can't receive jumped. Therefore, express the result, a thick line indicating a jump relationship is not described in FIGS. 119A and 120A.

### 14.121B about FIG. 121B

FIG. 121B is another view of FIG. 119B and FIG. 120B. In FIG. 121B, two verbatim are further added which have the same lower names of “˜.1” and “˜.2” Two anchors added at that time are displayed at the right end of FIG. 121B. These two names are for English Article 1 (.2E. 1), and for English Article 2 (.2E. 2). And, names of hyperlinks having the same names of four anchors exist as shown by broken lines in FIG. 122B. So, 4 jumps are established. Please look at this figure and imagine that it consists of 320 verbatim rather than two verbatim. note. It should be noted that the dots here represent the characters described in the FIG. 166.

FIG. 121B is a drawing considered FIG. 119B and FIG. 120B from another angle. FIG. 121B shows a case where another new electronic file having two verbatim setting regions are combined with FIG. 121A into one electronic file. Each of the four anchors indicate that jumps are received from the each one locations. Therefore, it can be seen that a total of 4 jumps is drawn in FIG. 121B. This returnable is represented by a solid line in FIGS. 119B and 120B. Observing this from the viewpoint of FIG. 119B, a line can be written which make bilateral jumps. And it consist of 2 (2−1)=bilateral two jumps. However, from the point of view of f-120B, it can be seen that the number of jumps is 4 because the lower segment is Article 1 and Article 2.

### 14.121C about FIG. 121C

FIG. 121C is another view of FIG. 119C and FIG. 120C. In FIG. 121C, two verbatim are further added which have the same lower names of “˜.1” and “˜.2” Two anchors added at that time are displayed at the right end of FIG. 121C. These two names are for Chinese Article 1 (.3C.1) and for Chinese Article 2(.3C.2). As shown by the broken lines in FIG. 121C, hyperlinks having the same names of these six anchorscan be seen.

So, in this case, 6×2=12 jumps are established. Please look at this figure and imagine that it consists of 320 verbatim rather than two verbatim.

FIG. 121C is a drawing which considers FIG. 119C and FIG. 120C from another angle. FIG. 121C shows a case where another new electronic file having two verbatim setting regions are combined with FIG. 121B into one electronic file. Each of the six anchor indicate that jumps have received from the each two locations. Therefore, it can be seen that a total of 12 jumps is drawn in FIG. 121C. Observing this from the viewpoint of FIG. 119C, the line become three lines. And three lines means 3 (3−1)=6 jumps. However, from the point of view of f-120C, it can be seen that the number of jumps is 12 because the lower segment is Article 1 and Article 2.

### 14.121D about FIG. 121D

FIG. 121D is another view of FIG. 119D and FIG. 120D. Samely, in FIG. 121D, two verbatim are further added which have the same lower names of “˜.1” and “˜.2” Two anchors added at that time are displayed at the right end of FIG. 121D. These two names are for Japanese Article 1(.4J.1) and for Japanese Article 2(.4J.2). So, in this case, 8×3=24 jumps are established. Since there is no corresponding anchor with any of the same names of hyperlinks with cross marks (X) in FIG. 121D, the portions where the hyperlinks dos not jump are clarified to make it easy to count the number of line segments that indicate jumping. The same applies to the subsequent drawings. Then, please look at this figure and imagine that it consists of 320 verbatim rather than two verbatim.

FIG. 121D is a drawing considered FIG. 119D and FIG. 120D from another angle. FIG. 121D shows a case where another new electronic file having two verbatim setting regions are combined with FIG. 121C into one electronic file. At the time, each of the eight anchors indicate that jumps have received from the each three locations. Observing this from the viewpoint of FIG. 119D, the lines will be 1+2+3=6. Therefore, the total number of jumps will be 12.

However, from the point of view of f-120D, it can be seen that the number of jumps is 24 because the lower segment is Article 1 and Article 2.

### 14.121E about FIG. 121E

FIG. 121E is another view of FIG. 119E and FIG. 120E. Samely, in FIG. 121E, two verbatim are further added which have the same lower names of “˜.1” and “˜.2” Two anchors added at that time are displayed at the right end of FIG. 121E. These two names are for German Article 1(.5D.1) and for German Article 2(.5D.2). So, 10×4=40 jumps are established. Please look at this figure and imagine that it consists of 320 verbatim rather than two verbatim.

FIG. 121E is a drawing considered FIG. 119E and FIG. 120E from another angle. FIG. 121E shows a case where another new electronic file having two verbatim setting regions are combined with FIG. 121D into one electronic file. Each of the ten anchors indicate that jumps have received from the each four locations. In other words, it shows that a jump can be made from the four hyperlinks per anchor. Therefore, it can be seen that a total of 40 jumps is drawn in FIG. 121E. Observing this from the viewpoint of FIG. 119E, the lines will be 1+2+3+4=10. And hyperlinks will be 5 (5−1)=20. However, from the viewpoint of FIG. 120E, it can be seen that the lower segment is doubled to 40 because of the existence of Article 1 and Article 2.

### 14.121F about FIG. 121F

FIG. 121F is another view of FIG. 119F and FIG. 120F. Samely, in FIG. 121F, two verbatim are further added which have the same lower names of “˜.1” and “˜.2” Two anchors added at that time are displayed at the right end of FIG. 121F. These two names are for Russian Article 1(.6R.1) and for Russian Article 2(.6R.2).

Names of hyperlinks having the same names as those of 12 anchors exist as shown by the broken lines in FIG. 121F. Therefore, 12×5=60 jumps are established. Please look at this figure and imagine that it consists of 320 verbatim rather than two verbatim.

FIG. 121F is a drawing considered FIG. 119F and FIG. 120F from another angle. FIG. 121F shows a case where another new electronic file having two verbatim setting regions are combined with FIG. 121E into one electronic file. Each of the twelve anchors indicate that jumps have received from the each five locations. Therefore, it can be seen that a total of 60 jumps is drawn in FIG. 121F. In other words, a returnable jump can be made between the each five hyperlinks. Observing this from the viewpoint of FIG. 119F, the lines will be 6 (6−1)=30. However, from the viewpoint of f-120F, it can be seen that the lower segment is doubled to 60 because of Article 1 and Article 2.

### 14.121G about FIG. 121G

FIG. 121G is another view of FIG. 119G and FIG. 120G. Samely, in FIG. 121G, two verbatim are further added which have the same lower names of “˜.1” and “˜.2” Two anchors added at that time are displayed at the right end of FIG. 121G. These two names are for Spanish Article 1(.7S.1) and for Spanish Article 2(.7S.2). Names of hyperlinks having the same names as those of 14 anchors exist as shown by the broken lines in FIG. 121G. Therefore, 14×6=84 jumps are established. Please look at this figure and imagine that it consists of 320 verbatim rather than two verbatim.

FIG. 121G is a drawing considered FIG. 119G and FIG. 120G from another angle. FIG. 121G shows a case in which another new electronic file having two verbatim setting regions are combined with FIG. 121F into one electronic file. At this time, since the 14 rightmost anchors have received jumps from each of the six hyperlinks, it can be seen that a total of 84 jumps is drawn in FIG. 121G. Observing this from the viewpoint of FIG. 119G, the lines will be 7 (7-1)=42. However, when observing from the viewpoint of FIG. 120G, it can be seen that the lower segment is doubled to 84 because of the existence of Article 1 and Article 2.

### 14.122 about FIG. 122

FIG. 122 is a reproduction of FIG. 115J, which is a representative drawing of the parent application. And this is a figure which shows the conceptual whole shape of this invention. This figure indicates that the strokes which is written in vertical lines and diagonal lines that are connected in sequence like 1F,2E,3C,4J,5G,6 R,7S as one continued line have many feedback circles structure that can repeat the jumps within the same circle. At this time, although each hyperlink is different in the upper layer portion such as 1F and 2E, the lower layer portion such as 0.01.01 shown at the right end has the same name in the each article.

### 14.123 about FIG. 123

FIG. 123 is the hidden side of FIG. 126. This figure shows that when viewing the hidden side of HTML using MSWord, 64 hyperlinks form a hyperlink group. In FIG. 119 to FIG. 121, a heptagonal jump area is generated. Here, it is required to generate a 64-sided jump zone. Strictly speaking, it is required to generate 4076 jumps for each plate in FIG. 122 according to the calculation formula of N(N−1).

In FIG. 139, a plate is formed each time the second double quote contains the same name. See, FIG. 163. In FIG. 139, all the portions having the same “Q00” constitute one plate. By the way, in FIG. 139, the plate assumes a heptagon. That is, it create 7 (7−1) effective jumps for each plate. FIG. 163 itself does not know whether there is any drop off or not. On the other hand, in FIG. 139, a negative portion without any drop off is also created. That is, FIG. 139 manifestly shows a case where there is no drop off. In this case, six htmls including a portion where an invalid jump is performed are created. Then, the same operation is performed for FIG. 126. That is, FIG. 123, which is the hidden side of FIG. 126, creates 8×8=64 different HTML files. That is, FIG. 123 is a single plate because all the portions surrounded by the second double quotation marks are same “Q00”. It means FIG. 123 is a single plate is formed with 64 corners. Of course, when a total of 64 different HTML files are created for replacement, the higher segment excluding the lower segment “Q00” will be one round. In this case, 64 (64−1)=4032 effective jumps are generated for each plate.

### 14.124 about FIG. 124

FIG. 124 explains how to increase another setting regions while repeatedly performing dropoffs and replenishment for hyperlinks. In this case, if the top segment of the anchor name increases one by one, the hyperlink that becomes the same as the anchor name will be dropped, and the dropped location will be filled with a hyperlink name that is younger than the anchor name. Therefore, the increase in anchors can be expressed with a plus character. It means bigger. In addition, the hyperlink replenishment can be expressed in minus. It means small. At this time, since this invention is replacement of the upper layer portion, plus or minus means plus or minus of the segment constituting the upper layer portion. In addition, replenishment of the minus drop out part is performed by supplementing the name that was previously dropped from the hyperlink groups. Once each electronic file was created and saved, the third process end. Details of the replacement at this time are shown in FIG. 47 to FIG. 61. However, the replacement of FIG. 47 to FIG. 61 is when links that jump contains to the index, which written in as an up arrow, are also created and changed. Therefore, this is a best replacement mode method.

FIG. 124 shows a hyperlink group (the setting area 5 in FIG. 1) when there is drops out. In this case, a minus is entered in a portion corresponding to the staircase line in FIG. 6E, and the same name as the anchor at the right end drops out of the hyperlink group, and the previously drop out name which becomes younger than anchor restored.

### 14.125 about FIG. 125

FIG. 125 describes how to establish jumps when the hyperlink which suggest content is not dropped off. In this case, same too, hyperlinks are arranged in ascending order of character numbers and the higher level segments of the names anchors increases it's name one by one. Like 1F--->2E, 2E--->3C. Please look, the same hyperlink name as the anchor name exists in the hyperlink groups. In that case, the hyperlink jumps to an anchor that exists on the same page. Therefore, the same name can be expressed by =. In other words, in this case, jumps only to the anchor at the right end of the same page. If there is no drop-off, FIG. 125 indicates that the move is a one-by-one move in sequence toward the right side where the character number to be changed increases. Equal marks moving to the right. That is, the equal part moves to the right. By the way, when there is a drop-off, it is necessary to describe a line segment in order to understand the location of the drop-off. e.g. stair line descending to the right of FIG. 6E. Then, when replaces all anchors are completed, the third process is finished. However, if this drop-off does not occur, it is recommended that these hyperlinks will be colored with a marker. This is because the apparent name of each equal part of FIG. 126 means same to it's content.

FIG. 125 shows a case where there are no drops out. In this case, the name of the hyperlink that become the same as the anchor jumps to the rightmost anchor. Therefore, even if a jump occurs, it cannot be sensed. And information transition through a hyperlink does not occur.

### 14.126 about FIG. 126

FIG. 126 is another view of FIG. 32. FIG. 32 shows a case where there are drops out, while FIG. 126 shows a case where there are no drops out. In the case of the setting region as shown in FIG. 126, the anchor may be arranged one page before the hyperlink. This is because content can be freely arranged without disturbed by the setting region with a large area.

In the present invention, in order to further increase the accuracy of processing by artificial intelligence, information is exchanged with many electronic files existing in the jump destination by providing a setting region as shown in FIG. 126. It plays the role of an electrical nerve. The following embodiment is an embodiment considering the configuration as shown in this drawing. And the drawings described hereafter the mainly describe a case where a plurality of electronic files jumps to different electronic files that are not combined.

### 14.127 about FIG. 127 Invention of Mount

FIG. 127 shows, it is conceivable in order to perform an autopilot system in a suburb, a system that collects data from multiple sides, transmits the data from the cloud to the traveling vehicle. Further obtains traveling information from the traveling vehicle, and transmits these data to the cloud. In this case, the present invention has an advantage in that data can be compared and examined without mixing multiple data and maintaining a multiple state. Therefore, accurate information processing can be expected rather than causing the mixed information to be processed by artificial intelligence as it is. See, FIG. 164. This is because artificial intelligence replaces human perception with computers, replacing data with simple descriptions that are less likely to be missed by humans has a great effect on accurate recognition of artificial intelligence. The present invention is considered to play a role of a mount for comparing the data for that purpose vertically and horizontally.

### 14.128 about FIG. 128

FIG. 128 is a diagram describing a method of transmitting data for automatic driving to a traveling vehicle in a city and collecting information from the traveling vehicle. Information gathering is more diverse in cities than in suburbs. First, attach a camera or oscillator to the building to collect multifaceted information. Next, it is conceivable to process this into secondary data suitable for transmitting vehicle driving information, and then send information from the cloud to the driving vehicle. On the other hand, it is conceivable to transmit the traveling data to the cloud from a camera or an oscillator attached to the traveling vehicle. In this case, continuous and consistent information is always required for safe driving. At this time, since the amount of information is dramatically increased, safe operation is enabled by increasing the number of data in FIG. 131 and FIG. 133B. That is, in the city center, since there is a lot of mixed information, further sorting and letting it be processed by artificial intelligence leads to safe driving of each vehicle and efficient driving of a plurality of vehicles.

### 14.129 about FIG. 129

FIG. 129 is a diagram showing that an automatic driving system based on artificial intelligence collects data on information on the vicinity of a vehicle from a cloud and operates while transmitting individual information obtained from a running vehicle to the cloud. In this case, in the higher region of the name of the hyperlink or anchor in each data is given file name and a lower region of the name of the hyperlink or anchor in each data is given an assigned road number or data street number so that artificial intelligence can process the each data based on the type of data already clear sorted. The fact that the road number or the data street number is the common means so that the same scene is viewed from multiple angles because the address is common as the plate number. Artificial intelligence will perform automatic driving safely based on this clear information.

### 14.130 about FIG. 130

FIG. 130 illustrates a case where hyperlinks capable of jumping to the multifaceted related information as in FIG. 126 are arranged along the route. FIG. 130 illustrates how the streets are transformed into data paths as the autopilot by artificial intelligence develops. Because it has multifaceted data, it will differ from simple line segment development.

### 14.131 about FIG. 131

FIG. 131 shows that the present invention associates various kinds of data with separated hyperlinks as separate electronic files. Data are considered to be mainly divided into three types of data, such as angle level, direction angle, and horizontal motion data. So, each one given a name and given hyperlinked and anchored. In FIG. 130, the first number of the data street describes vertical information of p1, p2, p3, and p4. After that, A, B, C, D, E, and F, which indicate the direction, are listed. And, in the last 0001 to 9999, a unique number is laid in units of roads, and it is possible to determine which road is just by looking at the number.

### 14.132 about FIG. 132

FIG. 132 is a diagram showing that a vehicle travels along a data street having various directions and angle data. At this time, it is depicted that the vehicle is traveling while being connected in a hyperlink structure while being multifaceted. In this case, a plurality of anchors may be required, and FIGS. 25 to 29 will be helpful. Because due to need of that data transfer processing at intersections with different data streets, anchors need doubled.

### 14.133A about FIG. 133A

In FIG. 133A, the arrangement of data having multiple directions and angles is described in the upper half of the drawing. This data indicates that the information is uploaded to the cloud from an oscillator arranged in a building or a car in the lower half of the drawing. The data is downloaded to a nearby vehicle after analyzing the data through artificial intelligence for safe driving of the nearby vehicle.

The total number of separate files described in the upper right of FIG. 139 was 7. However, here, a total of 8×8=64 separate files are created in FIG. 126. One of them, 5 C, is not a valid jump. Therefore, hyperlinks make a total of 63 successful information transitions. FIG. 133A is similar in situation to FIG. 126. In other words, 7×4=28 because there are seven rows when viewed horizontally and four rows when viewed vertically. In other words, in the case of FIG. 139, the replacement of the file name is performed a total of 27 times and make 28 files, of which 27 is a hyperlink used for valid information transition.

Further, in FIG. 133A the anchor is arranged on the same page, but it is better that the jump destination of the anchor is arranged on the page before the hyperlink, because the drawing can be freely expressed on a wide canvas.

### 14.133B about FIG. 133B

FIG. 133B is information having an elevation angle and an azimuth angle. The information is compacted and expressed as shown at the bottom of the figure. The bottom of the figure shows a vertical state toward the inside. By the way, if each hexagon in this figure functions as a theater video projection lens, the rays from the various lenses are multiplexed, and the glare of diffuse reflections gives the theater a sense of presence. The outline of the object projected by light rays emitted from many angles loses emphasis, but it is easy to draw the image that the audience is seeking, such as the atmosphere and the sense of presence. It is as if a famous actor is in the next seat, and the screen and mind are united.

### 14.133C about FIG. 133C

In FIG. 133C, information having the elevation and azimuth of FIG. 133B will be next arranged as horizontal driving data. The horizontally means the relationship between the article 1 and article 2 in FIG. 115J.

### 14.133D about FIG. 133D

FIG. 133D shows how each of the data having the vertical, directional, and horizontal information becomes a name when a hyperlink or an anchor is named. Worth of mentioning here is the example of the name of the hyperlink shown in the figure. Shows a sample data array. e.g. q1_A_0000.html#q001 In this case, the html of the vertical and horizontal arrangement in FIG. 133A starts from q001 and continues to the end of data street. In this case, the beginning and end of Data Street are represented by vertical lines of f-147. Of course, since FIG. 133A has 7×4=28 hyperlinks, it means 28 vertical lines in FIG. 147 are created. However, if the 28 jumps remain separated, not final combine, the replacement method would simply create different file names, as described in the upper right corner of FIG. 139. However, for electronic files with drawings inserted, “replace all” described in f-141 is required.

### 14.135 about FIG. 135

FIG. 135. It is conceivable that the present invention may be used to concurrently distribute various medical information to the surgical staff and to perform complicated processes. In other words, data on the current operation is collected from multiple angles. These data, in the associated separated state, are more subdivided according to the situation by artificial intelligence and distributed to each viewpoint. Artificial intelligence then automatically distributes situational videos that can be used as reference for the surgery being performed by the medical team. In this case, according to the present invention, it is possible to organize and save the data by associating the data with the hyperlinks in the vertical and horizontal planes of FIGS. 133A and 133B. Data can be distributed to the site from a plurality of viewpoints with highly relevant video information and the like, so that the recognition at the site of the distribution destination will be further enhanced.

### 14.136A about FIG. 136A

FIG. 136A shows information distributed to a part of the staff, in which the affected part is viewed from a specific position or a specific job is described. Data with different directions and vertical positions are distributed simultaneously. In addition, it will be possible to collect and upload surgical data from multiple sides on the Web. The present invention will provide a cross-referencing framework for that. As a result, more accurate and objective data can be grasped, which can contribute to reducing the risk of surgery.

### 14.136B about FIG. 136A

FIG. 136B is information obtained by capturing FIG. 136A from another viewpoint. The presence of two equal signs in the figure indicates that the hyperlink jumps to the same page where the hyperlink is located. That is, a case where there is no dropout is shown. That is, this indicates that the setting region in FIG. 125 different from the setting region in FIG. 124 has been created.

### 14.136C about FIG. 136C

FIG. 136C to 136G is another view of FIG. 136A. In the figure, the image is obtained by photographing the heart from another viewpoint, but may be an image in which information from the measuring device is projected.

### 14.136H about FIG. 136H

FIG. 136H is a drawing on the theme of remote medical care. Information collected as shown in FIGS. 136A to 136G is distributed as data for medical care performed in a remote place. At this time, since various kinds of information are arranged as shown in FIGS. 136A to 136G, understanding will be deepened through cross-references, and it will be helpful in preventing medical errors.

### 14.136I about FIG. 136H

FIG. 136I is a drawing on the theme of automation of surgery. The large number of cross-referenced data areas helps to deepen the perception of surgery for artificial intelligence and helps to prevent mistakes in automating surgery.

### 14.137 about FIG. 137

FIG. 137 is a drawing showing that information gathered from various points in a soccer stadium is collected and distributed to spectators in a stadium.

### 14.138 about FIG. 138

FIG. 138 further shows that, by simultaneously transmitting data taken by a spectator to other spectators, it is possible to know the movement of a player who cannot be seen from his/her own seat, so that he/she can participate in the game.

### 14.139 about FIG. 139

F-139 use the name of another file in the hyperlink. e.g. “q1A”, “q2B”, “q3C”, “q4D”, “q5E”, and “q6F”. Therefore, the file names are replaced in sequence with the names of these different files. When the file names are replaced one after another as shown in F-142, the generated electronic files jump to overlap each other, as shown at the bottom of the figure. When the file names are replaced one after another as shown in F-142, the generated electronic files jump to overlap each other as shown in the lower part of the figure.

### 14.140 about FIG. 140

In FIG. 140, the extension of docx is replaced with html. When replacing, it is preferable to save it as a Web Page without filtering. This is because the drawing is saved with an ID number such as “image001” inside the folder written as files. However, if the file is saved in this format, the name will be as shown in FIG. 141, and the hyperlink will not function.

### 14.141 about FIG. 141

FIG. 141. MS Word has a function that changes the file name of docx and saves it as a Web page. FIG. 142 shows the case where docx is replaced with html format using this function. In this case, additional files are created to save image file. In this occasion, the document can be reprocessed with the MS word, that is, the html can be operated from the MS word. Therefore when it operated with MSwords, it is possible to operate only the text on the apparent surface while keeping the grammatical part of XML hidden behind. In addition, since the word wrap function also works, it is easy to find a mistake even if the operation of the name of the hyperlink is wrong. This file format type is transformable and convenient format when hyperlinks are not finally combined. However, hyperlinks do not work when saving docX files in unfiltered html format. The cause can be understood by examining the name of the hyperlink. These hyperlinks replaced with unintended names. In other words, directory informations are added when replacing and saving. And it is attached identically to all hyperlinks. Therefore, this added part can be deleted uniformly.

### 14.142.1 about FIG. 142

FIG. 142 is a representative drawing expressing the feature of one round which is the theme of the present invention. Using this, a case where a jump occurs between different electronic files in FIG. 161 will be described. In this case, A.html at the top left is changed to another B.html. Further, each time replacement is performed, the electronic file name is changed to C, D, E, F. At this time, even if there are many anchors and hyperlinks in each electronic file, these are not changed at all. Then, the electronic file generated each time the replacement is performed is arranged on the Web and jumps between different electronic files.

### 14.142.2 about FIG. 142

Next, describe the case of final combination. In this case, anchor A at the top left is changed to anchor B when replaced by another file. Further, each time replacement is performed, the higher segment area of the anchor name is changed to C, D, E, or F. As a result, even when there are many lower segments of anchors, only the higher segment of anchors are changed while the lower segment remains the same. The electronic file generated each time replacement is combined into one electric file. At that moment, hyperlinks jumps to same name of anchors within one electronic file. In other words, it is imperative that a different anchor be created inside the file created in the third process.

### 14.142.3 about FIG. 142

The decisive difference between the two is the number of replacement processes. When jumping to a different electronic file, even in the case of FIG. 126 where the hyperlinks group is very large, a jump can be created for 64 (64−1)=4032 cross-references by generating 8×8=64 electronic files. This is because the process of renaming the anchors and the hyperlinks inside the electronic file is not required. In particular because the process of renaming the anchor inside the electronic file is not required. In particular, to change the name of a hyperlink or an anchor in docx or odt, which is a ZIP compression of an XML file, it is necessary to manipulate the document.xml or content.xml that exists inside it. At the top of FIG. 139, only a different html file has been created. In other words, replacing only file names that appear outside the file is efficient because of the small number of operations. Because, it is only one process.

### 14.143 about FIG. 143

In FIG. 143, an upward arrow is described at the lower left of the figure, and when this arrow is clicked, the hyperlink jumps to an anchor on the upper left of the figure. Then, when the hyperlink placed at the head of this anchor is clicked, the hyperlink jumps to the anchor on the lower left of the figure. After making the loop with drop off as shown in FIG. 124, then one round replacing the file name in such a situation all the hyperlinks including the upward arrow and the downward arrow perform an organic round. This up and down circulation strengthen the cross-reference function.

### 14.147 about FIG. 147

FIG. 147 shows the features of the present invention. That is, the lower segment of the anchor name is arranged so as to be larger in the order of the character code. Also, the upper segment of the anchor arranged so as to be larger in the order of the character code. Therefore, even if they are joined, all anchors are placed in character code order. Therefore, when a line is drawn in the order of the character code of the anchor, the state becomes one line segment.

### 14.161A about FIG. 161A

FIG. 161A shows a state of only A at the upper left in FIG. 142. FIGS. 161A to 161G and FIGS. 162A to 162G are drawings for explaining how jumps occur in the fourth process in which electronic files are not finally combined. FIG. 161A is very similar to FIG. 120A. Their names of hyperlinks and anchors consist of a higher segment and a lower segment. In each of the figures, the higher segment of the names of the anchors or hyperlinks is written in the vertical line portion, and the lower segment of the names of them are written on the plates appearing horizontally. In this case, if the corresponding file is expanded with MS words, the hyperlink is separated by two double quotation marks as shown in FIG. 139. However, if the file is expanded in html format, it will look like <a href “ABC.html#name”> hyperlink name <a>. In other words, it is represented by one double quotation mark.

### 14.161B about FIG. 161B

FIG. 161B describes that since the upper left A and B in FIG. 142 exist in one folder, jumps occurs between hyperlinks and anchors having the same name. At this time, 2 (2−1) jumps occur on each plate. Therefore, 8 jumps are described because the lower four segments are described in the whole drawing.

### 14.161C about FIG. 161C

FIG. 161C describes that since A to Con the upper left in FIG. 142 exist in one folder, jumps occurs between hyperlinks and anchors having the same name. At this time, 3 (3−1) jumps occur on each plate. Therefore, 24 jumps are described because the lower four segments are described in the whole drawing.

### 14.161D about FIG. 161D

FIG. 161D describes that since A to Don the upper left in FIG. 142 exist in one folder, jumps occurs between hyperlinks and anchors having the same name. At this time, 4 (4−1) jumps occur on each plate. Therefore, 48 jumps are described because the lower four segments are described in the whole drawing.

### 14.161E

FIG. 161E describes that since A to Eon the upper left in FIG. 142 exist in one folder, jumps occurs between hyperlinks and anchors having the same name. At this time, 5 (5−1) jumps occur on each plate. Therefore, 80 jumps are described because the lower four segments are described in the whole drawing.

### 14.161F about FIG. 161F

FIG. 161F describes that since A to F on the upper left in FIG. 142 exist in one folder, jumps occurs between hyperlinks and anchors having the same name. At this time, 6 (6−1) jumps occur on each plate. Therefore, 120 jumps are described because the lower four segments are described in the whole drawing.

### 14.161G about FIG. 161G

FIG. 161G describes that since A to G on the upper in FIG. 142 exist in one folder, jumps occurs between hyperlinks and anchors having the same name. At this time, 7 (7−1) jumps occur on each plate. Therefore, 168 jumps are described because the lower four segments are described in the whole drawing.

### 14.162A about FIG. 162A

FIG. 162A is a diagram of FIG. 161A viewed from another viewpoint. In FIG. 162A, the hidden names of the hyperlinks are described in italic characters. Here, the file name is p1A.html. At the right end, an anchor name at the location are described in which these hyperlinks are arranged as hyperlinks group. See, FIG. 1. If another electronic file sets the jump destination to these locations where those anchors are placed, it will be p1Ahtml#q01, p1Ahtml#q02, p1Ahtml#q03 or p1Ahtml#q04. This arrangement having dropped off as shown in FIG. 124 is described thereafter. And in the state of FIG. 162A, the hyperlink belonging to the hyperlink group does not have the same name as the anchor. Therefore, no jump occurs.

### 14.162B about FIG. 162B

FIG. 162B is a diagram of the state of FIG. 161B viewed from another viewpoint. In this figure, p2B to p7G, written horizontally, are the higher segment of the names of the hyperlinks that make up the hyperlinks group. And q01, q02, q03, and q04 written vertically on the left side of the drawing are the lower segments of the names of the hyperlinks. The two together make up the name of the hyperlink. The fact that the file name is written in the jump destination of the hyperlink indicates that the electronic file will not be finally combined. In this figure, the anchor name is simply written on the right side of the drawing, but the correct name is the electronic file name where the anchor is placed and the anchor name in the file. The surface of each of these hyperlinks and anchors is configured, for example, as shown in FIG. 1. In the case of MSword, when jumping to a specific location in another electronic file, two sets of double quotation marks are added to the hyperlink like FIG. 139. FIG. 162B shows a case where two electronic files can be jumped. At the time, the number of the jumps is 2 (2-1), but since the lower segments, which means verbatim, are composed of four, such as 01 to 04, the total number of jumps becomes 8 by the diagonal line. In the following, the case of four plates, which is a group of verbatim setting region, is taken as an example, but the same applies when there are more plates. See FIG. 163.

### 14.162C about FIG. 162C

FIG. 162C is a diagram of the state of FIG. 161C viewed from another viewpoint. In the case of FIG. 162C, four third verbatim have been added to the FIG. 162B.. Each anchor has two line segments which means jumps. And, there are 12 anchors. Therefore, 2×12=24.

Another solution. Three files have been placed on the Web. And there are four verbatim. Therefore, the total number of the jumps became 3 (3−1)×4=24. And actually, the number of oblique line segments is 24. And this number matches the case of FIG. 161C.

### 14.162D about FIG. 162D

FIG. 162D is a diagram of the state of FIG. 161D viewed from another viewpoint. Hyperlinks that do not jump are marked with a cross. In the case of FIG. 162D, four fourth verbatim have been added to the FIG. 162C. Each anchor has three line segments which means jumps. And, there are 16 anchors. Therefore, 3×16=48.

Another solution. Four files have been placed on the Web. And there are four verbatim. Therefore, the total number of the jumps became 4 (4−1)×4=48. And actually, the number of oblique line segments is 48. And this number matches the case of FIG. 161D.

### 14.162E about FIG. 162E

FIG. 162E is a diagram of the state of FIG. 161E viewed from another viewpoint. Hyperlinks that do not jump are marked with a cross. In the case of FIG. 162E, four fifth verbatim have been added to the FIG. 162D. Each anchor has four line segments which means jumps. And, there are 20 anchors. Therefore, 4×20=80.

Another solution. Five files have been placed on the Web. And there are four verbatim. Therefore, the total number of the jumps became 5 (5−1)×4=80. And actually, the number of oblique line segments is 80. And this number matches the case of FIG. 161E.

### 14.162F about FIG. 162F

FIG. 162F is a diagram of the state of FIG. 161F viewed from another viewpoint. Hyperlinks that do not jump are marked with a cross. In the case of FIG. 162F, four sixth verbatim have been added to the FIG. 162E.. Each anchor has five line segments which means jumps. And, there are 24 anchors. Therefore, 5×24=120.

Another solution. Six files have been placed on the Web. And there are four verbatim. Therefore, the total number of the jumps became 6 (6−1)×4=120. And actually, the number of oblique line segments is 120. And this number matches the case of FIG. 161F.

### 14.162G about FIG. 162G

FIG. 162G is a diagram of the state of FIG. 161G viewed from another viewpoint. All hyperlinks can jump. In the case of FIG. 162G, four seventh verbatim have been added to the FIG. 162F. Each anchor has six line segments which means jumps. And, there are 28 anchors. Therefore, 6×28=168.

Another solution. Seven files have been placed on the Web. And there are four verbatim. Therefore, 7 (7−1)×4=168. And actually, the number of oblique line segments is 168. And this number matches the case of FIG. 161G. No matter how many segments under the name increase, all hyperlinks will jump to the anchor.

### 14.163 about FIG. 162G

FIG. 163 describes that all lower segments are common to each plate. This plate means the verbatim in the setting region 4 in FIG. 1. When the final combination is not performed as shown in FIG. 139, two sets of the double quotation marks placed by MS word. However, when opened with Web creation software, there is only one double quotation mark. e.g. <a href=“p1A.html#q00”> name</a>.

### 14.166 about FIG. 166

FIG. 166 is a table for expressing two byte with one-byte. When a double-byte character is used in the present specification, it is a replacement table for expressing this by replacing it with one byte. If the specification is filed in double-byte characters, it will be forcibly replaced with single-byte characters upon publication. In this case, the replacement may be corrected by the applicant's unintended intention. This is to prevent that.

### DESCRIPTION OF REFERENCE NUMERALS

1, 55A, 72A . . . electronic file
A . . . anchor
B . . . abstract link
3 . . . science
4 . . . verbatim
5 . . . hyperlinks group
6 through 11 . . . link 6 through link 11
50 . . . electronic file generation apparatus
71 . . . name control unit
72 . . . storage unit
72A . . . currently-being-prepared name
72B . . . currently-being-created name
72C . . . already-combined name
73 . . . instruction information receiving unit
74 . . . name generation unit
75A . . . name incrementing unit
75B . . . name multiplicating unit
76 . . . name changing unit
77 . . . name evacuation unit
78 . . . name combining unit
79 . . . final combining unit
81 . . . theme region
82 . . . Article/Clause region
83 . . . control region
84 . . . highest level region
85 . . . growth point
86 . . . lower level region
87 . . . lowest level region
88 . . . intermediate level region

What is claimed is:

1. An electronic file generation method comprising the steps of:
firstly, in one electronic file, creating verbatim setting regions, which consist of the anchor and of the hyperlinks group, of which configuring to have same lower level segments of the names,
secondly, executing one-round replacement through the file names and thereby generating a plurality of different electronic files, and thereby generating a plurality of different electronic files, and
thirdly, putting the files in the same folder
thereby realize returnable multiply jumps among the same lower level segments of the verbatim setting regions in the different electronic files.

2. The electronic file generation method according to claim 1, in the middle of several generation processes,
maintaining a constant magnification regularity that the number of hyperlinks corresponding to one anchor is always the same ratio within the respective verbatim setting regions,
so that the hyperlinks enabled to make directly jumping to anchors existing in respective verbatim setting regions in different electronic files as a result and returnings are enabled directly to other anchors so that cross reference between the verbatim setting regions in the other different electronic files.

3. The electronic file generation method according to claim 1, in the middle of several generation processes,
the hyperlinks are arrayed in the ascending order of the character codes and samely copied to another file;
therefore, front and back relationship among the hyperlinks in the verbatim setting regions are not changed.

4. The electronic file generation method according to claim 1, in the middle of several generation processes,
the hidden names of the hyperlinks in the verbatim setting regions are opened from field code side, the character strings of the names of the hyperlinks are slipped down through a word-wrap function and as a result,
the column positions of the character strings of the names of the hyperlinks can be synchronized in the vertical and can be confirmed orderly aligned from the younger character code number.

5. The electronic file generation method according to claim 1, further comprising;
the names of the anchors of verbatim setting regions and the names of the hyperlinks in verbatim setting regions employ character types, of which use is prohibited by the world wide web Consortium.

6. A non-transitory computer-readable storage medium executes to display the following results of the steps:
firstly, in one electronic file, creating verbatim setting regions, which consist of the anchor and of the hyperlinks group, of which configuring to have same lower level segments of the names,
secondly, executing one-round replacement through the file names, thereby, generating a plurality of different electronic files, and
thereby, realize returnable multiply jumps among the verbatim setting regions which consist of the same lower level segments between different electronic files.

7. The non-transitory computer-readable storage medium for storing the setting regions according to claim 6 having,
wherein when the storage medium maintains a constant magnification regularity that the number of hyperlinks corresponding to one anchor is always the same ratio within the respective verbatim setting regions,
so that all the cross reference are enabled directly to other anchors in the other verbatim setting regions in the other different electronic files.

8. The non-transitory computer-readable storage medium for storing setting regions according to claim 6, further comprising,
in the middle of several generation processes the hyperlinks are arrayed in the ascending order of the character codes and samely copied to another file, so that
front-and-back relationship among the hyperlinks in the verbatim setting regions are not changed.

9. The non-transitory computer-readable storage medium for storing setting regions according to claim 6 further comprising,
wherein when the hidden names of the hyperlinks in the verbatim setting regions are opened from field code side, the character strings of the names of the hyperlinks are slipped down through a word-wrap function and
wherein the column positions of the character strings of the names of the hyperlinks can be synchronized in the vertical and can be confirmed orderly aligned from the younger character code number.

10. The non-transitory computer-readable storage medium for storing setting regions according to claim 6 further comprising;
the names of the anchors of verbatim setting regions and the names of the hyperlinks in verbatim setting regions employ character types, of which use is prohibited by the world wide web Consortium.

11. An electronic file generation method for the artificial intelligence comprising the steps of:
firstly, in one electronic file, creating verbatim setting regions, which consist of the anchor and of the hyperlinks group, of which configuring to have same lower level segments of the names,
secondly, executing one-round replacement through the file names and thereby generating a plurality of different electronic files,
so that it enables accurately recognizes information on contents by the returnable multiply jumps among the contents under the verbatim setting regions which consist from the same lower level segments.

12. The electronic file generation method for the artificial intelligence according to claim 11 further comprising of,
wherein when the hyperlinks corresponding to one anchor is always the same ratio within the respective verbatim setting regions in one electronic file, and further,
when despite increment of the electronic file, maintains a constant magnification regularity,
so that all the cross references are enabled directly to other anchors in the other verbatim setting regions in the other different electronic files.

13. The method for generating electronic files for the artificial intelligence according to claim 11 further comprising of,
the setting regions of the hyperlinks are arrayed in the ascending order of the ASCII character codes and copied to another file,
therefore front-and-back relationship among the hyperlinks in the verbatim setting regions are not changed.

14. The method for generating electronic files for the artificial intelligence according to claim 11 further comprising,
wherein when the hidden names of the hyperlinks in the verbatim setting regions are opened from field code side, the character strings of the names of the hyperlinks are slipping down through a word-wrap function and
wherein the column positions of the character strings of the names of the hyperlinks can be synchronized in the vertical and can be confirmed orderly aligned from the younger character code number.

15. The method for generating electronic files for the artificial intelligence according to claim 11 further comprising,
incrementing the ASCII code number of the anchors in the setting regions, then reducting the ASCII code of the hyperlinks in the setting regions,
in the meanwhile, the file names remaining unchanged.

16. A non-transitory computer-readable storage medium executes to display the following results of the steps:
firstly, in one electronic file, creating verbatim setting regions, which consist of the anchor and of the hyperlinks group, of which configuring to have same lower level segments of the names,
secondly, executing one-round replacement through the higher level segments of the names of the anchor and thereby generating a plurality of different electronic files, and
thirdly, adding a combination of a plurality of different electronic files, thereby, realize returnable multiply jumps between the verbatim setting regions which consist from the same lower level segments in one electronic file.

17. The non-transitory computer-readable storage medium for storing setting regions according to claim 16 having,
wherein when the storage medium maintains a constant magnification regularity that the number of hyperlinks corresponding to one anchor is always the same ratio within the respective verbatim setting regions, so that the hyperlinks enabled directly jumping to anchors existing in respective verbatim setting regions, and
the cross reference is enabled directly between other anchors in the other verbatim setting regions in the same electronic file.

18. The non-transitory computer-readable storage medium for storing setting regions according to claim 16, further comprising,
in the middle of several generation processes the hyperlinks group in setting regions are arrayed in the ascending order of the character codes and samely copied to another file,
therefore, front-and-back relationship among the hyperlinks in the verbatim setting regions are not changed.

19. The non-transitory computer-readable storage medium for storing setting regions according to claim 16 further comprising,
wherein, when the hidden names of the hyperlinks in the verbatim setting regions are opened from field code side, the character strings of the names of the hyperlinks are slipped down through a word-wrap function and
wherein the column positions of the character strings of the names of the hyperlinks can be synchronized in the vertical and can be confirmed orderly aligned from the younger character code number.

20. The non-transitory computer-readable storage medium for storing setting regions according to claim 16 further comprising replacement of the hyperlink with the following continuous iteration;
firstly, drop off the name of the hyperlink that become the same as the name of the anchor from the hyperlinks group,
secondly, after the character code of the name of the anchor has increased, restores the name of the hyperlink previously dropped off from the hyperlinks group.
